(19) United States
(12) Patent Application Publication
(10) Pub. No.: US 2025/0302037 A1
(43) Pub. Date: Oct. 2, 2025

(54) MULTICOMPONENT FUNGICIDES

(71) Applicant: ADAMA MAKHTESHIM LTD., Beer Sheva (IL)

(72) Inventors: Ernesto BENETTI, Londrina (BR); Juliano UEBEL, Londrina (BR); Marco Antonio TAVARES RODRIGUES, Sao Paulo (BR); Luiz Fernando COLLA, Londrina (BR)

(73) Assignee: ADAMA MAKHTESHIM LTD., Beer Sheva (IL)

(21) Appl. No.: 18/864,435

(22) PCT Filed: May 10, 2023
(86) PCT No.: PCT/IL2023/050482

§ 371 Date: Nov. 8, 2024

Related U.S. Application Data
(60) Provisional application No. 63/339,982, filed on May 10, 2022.

(51) Int. Cl. A01N 31/16; A01N 43/32; A01N 43/40; A01N 43/50; A01N 43/647; A01N 43/84; A01N 61/00; A01P 3/00

(52) U.S. Cl. CPC A01N 31/16; A01N 43/32; A01N 43/40; A01N 43/50; A01N 43/647; A01N 43/84; A01N 61/00; A01P 3/00

(57) ABSTRACT

The present invention relates to multi-component combinations comprising at least two components, (1) polyphenol-based component, and as component (2) at least one fungicide selected from the group of Qil fungicide, strobilurin fungicide, SDHI fungicide, an azole fungicide and morpholine fungicide. The combinations optionally comprise one or more compounds as component (3) selected from the group of Protectant fungicides and copper-based compounds. The present invention thus also relates to methods of using the combinations in forming compositions and as beneficial agricultural material, as well as methods of using polyphenol-based compounds to reduce the amount of fungicides required for fungicidal efficacy, and/or to reduce the amount or necessity of combining Protectant fungicides and/or copper-based compounds when using systemic fungicides.

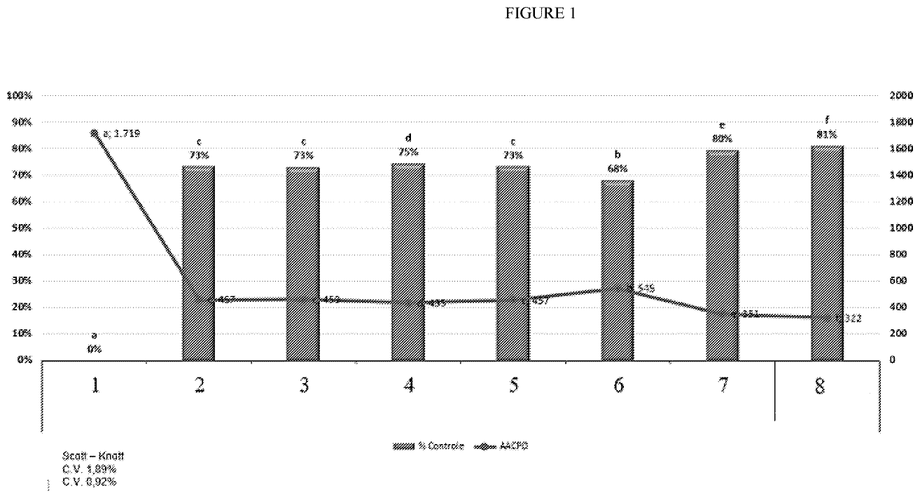

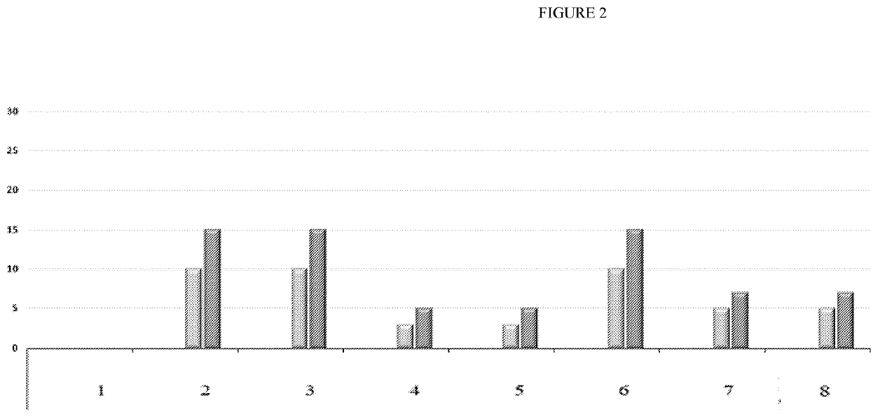

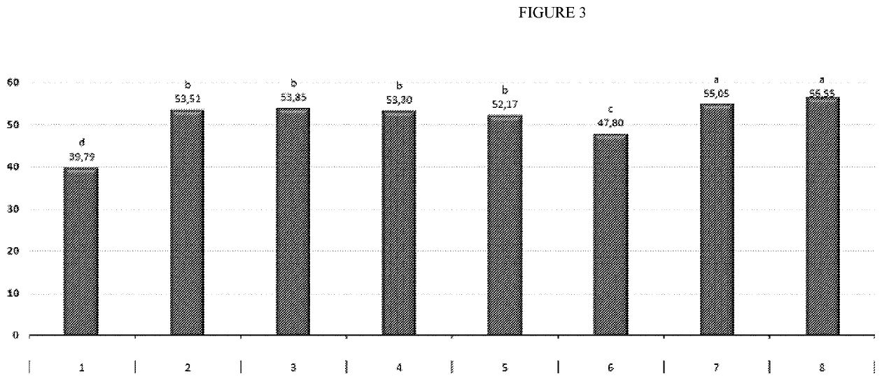

Throughout this application, various publications are cited. Disclosures of the documents and publications referred to herein are hereby incorporated in their entireties by reference into this application.

### FIELD OF THE PRESENT SUBJECT MATTER

The present invention relates to fungicidal combinations comprising at least two components (1) polyphenol-based component and (2) at least one fungicide component (A) selected from the group of QiI fungicides (QiI—Quinone inside Inhibitors); strobilurin fungicides (QoI—Quinone outside Inhibitor fungicides); carboxamide fungicides (SDHI—Succinate dehydrogenase inhibitors); azole fungicides (DMI—Demethylation Inhibitors); morpholine fungicides; and mixtures thereof.

The fungicidal combinations of the inventions can further comprise an additional component (3), chosen from copper-based compounds; protectant fungicides which are exemplified by fluazinam, chlorothalonil, mancozeb, sulfur, folpet, and captan; and combinations of both copper-based compounds and protectant fungicides. The invention can enable a reduction in the amounts of copper-based compounds and/or protectant fungicides used together with systemic fungicides or even eliminate the need for their use, often resulting in equivalent or superior fungicidal activity with reduced incidence of phytotoxicity.

Clearly, the invention thus also relates to several advantages obtainable by the use of polyphenol-based compounds, increase plant health; to enhance the efficacy of systemic and/or protectant fungicides; and to enable the reduction of the amount of both the systemic fungicides and protectant fungicides. This reduction enabled by the use of the polyphenol-based compounds being most notable and/or pronounced as regards the Protectant fungicides.

While the use of polyphenol-based compounds alone, is found to increase the efficacy of control; and increase plant health, additional advantages are available when the polyphenol-based compounds are optionally used in combination with even minimal amounts of copper-based compounds, which can further increase the consistency of control, improve performance and plant health and in some cases, eliminate the need for Protectant Fungicides entirely, notably without loss of efficacy and often with reduced levels of phytotoxicity.

In this respect the amounts of copper-based compounds when used is about 1 g/ha-350 g/ha, often in the range of about 5 g/ha-50 g/ha, or from about 8 g/ha up to the regular use levels for copper-based compounds.

In some noted embodiments, amounts of less than 10 g/ha metallic copper are more than sufficient.

Methods for controlling, treating, or preventing fungal and/or bacterial diseases in crop plants are also disclosed utilizing the combinations of the invention which methods are an integral part of the invention.

### BACKGROUND OF THE INVENTION

Fungicides as herein defined, are compounds of natural or synthetic origin which act to protect plants against damage caused by fungi and/or bacteria. In spite of the benefits derived from the use of fungicides in agriculture such as protection of crops and improved productivity, it is nowadays desirable to reduce the amount of fungicides used in the fields owing to the potential health risks associated with an intensive use of agrochemicals. In particular it would be desirable to reduce the amounts of either or both, copper-based compounds and/or protectant fungicides that are heretofore typically combined with systemic fungicides, without loss of benefit usually associated with their current use levels.

In addition, repeated usage of a single fungicide often leads to the development of resistance to that fungicide.

Another important issue associated with fungal and/or bacterial attacks is the concomitant loss of nutrients which leads to a decrease in the overall yield of the crop. Compositions comprising one single active ingredient have shown limited control over diseases.

Many known fungicides are effective for specific crop and have a limited activity. In addition, a resistance is developed and there is a need to revert, restore, increase and/or extend the activity.

There is therefore a need for improving the treatment or prevention of plant disease caused by pathogen that also often enables higher yields while preserving a high amount of nutrients in crops while enabling a reduction in the amounts of fungicides required, in particular enabling a reduction of Protectant Fungicides exemplified by any of Mancozeb, Chlorothalonil, or Fluazinam, and/or enabling a reduction of copper-based compounds.

In particular there is a need for reducing the amounts of either or both, copper-based compounds and/or protectant fungicides heretofore often included in fungicidal combinations of systemic fungicides, without reducing fungicidal efficacy, while maintaining or even improving on the levels of the treatment or prevention of plant disease caused by pathogens, inter alia enabling higher yields, non biotic stress mitigation, and reduced phytotoxicity, while preserving a high amount of nutrients in crops.

By implementing the invention herein disclosed, inventors have surprisingly found that it is possible to reduce the quantities of all the fungicides included in the inventive combinations by between 10-50% without loss of efficacy when compared to combinations of the same systemic and protectant fungicides absent the polyphenol-based component. In experiments the reduction of the rate of application of all fungicides in inventive combinations according to the invention by between 20%-40% was found to not result in significant loss of efficacy.

This clearly provides a significant environmental advantage by reducing the amount of agrochemicals applied however in addition, unexpected plant health benefits of application of compositions of the invention have been noted including effects like greening, more leaf duration, more photosynthesis, and less environmental stress, to name but a few that were noted during field trials.

Importantly inventors have surprisingly found that it is possible to reduce by at least 25%, the quantities of Mancozeb, Chlorothalonil, and/or Fluazinam that have often been combined to date with systemic fungicides exemplified by QiI fungicides (QiI—Quinone inside Inhibitors); strobilurin fungicides (QoI—Quinone outside Inhibitors); carboxamide fungicides (SDHI—Succinate dehydrogenase inhibitors); azole fungicides (DMI—DeMethylation Inhibitors); morpholine fungicides and mixtures thereof.

The reduction of e.g., mancozeb without loss of efficacy for example, has further surprising advantages as regards the quality of fungicidal compositions comprising combinations including mancozeb. Mancozeb is typically present in high concentrations in solid particulate form dispersed in compositions, and thus a reduction of the mancozeb content will improve the formulation quality as less solids need to be stably accommodated. Further when the combination is sprayed with a lower mancozeb application rate there is better dispersion and fungicide coverage. As previously mentioned, these advantages are additional to the maintenance of efficacy achieved by implementing the invention herein disclosed.

By implementing the invention, the enabled reduction in the level of copper-based compounds heretofore combined with systemic fungicides was surprisingly found to be more pronounced when combined with the polyphenol-based component, in many cases down to levels significantly below 10 g/ha without deleterious effect on the efficacy of the combinations and with unexpected benefits in addition to the reduction in the prohibitive costs of copper based compounds.

### SUMMARY OF THE PRESENT SUBJECT MATTER

The present invention provides a multi-component combination which comprises at least two components (1) polyphenol-based component and as component (2) at least one (systemic), fungicide component (A) selected from the group of QiI fungicides (QiI—Quinone inside Inhibitors); strobilurin fungicides (QoI—Quinone outside Inhibitors); carboxamide fungicides (SDHI—Succinate dehydrogenase inhibitors); azole fungicides (DMI—DeMethylation Inhibitors); and morpholine fungicides, with the proviso that the polyphenol-based component (1), contains naturally sourced or derived, polyphenol-based compounds, and that lignosulphonates, if present in the combination, are not the sole polyphenol-based compound.

The combination of the invention can further include an additional component (3) comprising one or more of, protectant fungicides, exemplified by fluazinam, chlorothalonil, mancozeb, sulfur, folpet, captan; and all mixtures thereof. Component (3) can also or alternatively be comprised of one or more copper-based compound.

When component (3) comprises one or more protectant fungicides in mixtures with the polyphenol-based component (1) and systemic fungicides of component (2), the absolute and/or relative content of protectant fungicides in the combination may be reduced by at least 25% and advantageously, almost eliminated without any detrimental effect on efficacy, and displaying improved benefits including benefits to the crop plant or locus to which they are applied, and improved pesticidal characteristics, compared to mixtures of the same protectant fungicides and the same systemic fungicides.

When component (3) comprises one or more copper-based compound, the combination with Polyphenol-based component (1), results in enabling a reduced amount or advantageously, elimination of, protectant fungicides in mixtures with the systemic fungicides of component (2). Thus, the absolute and/or relative content of protectant fungicides in the combination may be reduced by at least 25% and advantageously, even eliminated without any detrimental effect on efficacy and displaying improved benefits including benefits to the crop plant or locus to which they are applied, and improved pesticidal characteristics, compared to mixtures of the same protectant fungicides and the same systemic fungicides.

Thus, some aspects the invention are methods of reducing the amount of Protectant fungicides to be included in combinations with systemic fungicides, wherein the method comprises, combining said systemic fungicides with polyphenol-based compounds.

The present invention also provides a multi-component combination comprising at least two components, (1) an amount of polyphenol-based component, and (2) an amount of at least one (systemic) fungicide component (A) selected from the group of:
(a) QiI fungicide;
(b) strobilurin fungicide (QoI fungicide)
(c) succinate dehydrogenase inhibitor (SDHI) fungicide;
(d) triazole (azole) fungicide (DMI);
(e) morpholine fungicide; and
(f) any mixtures thereof;
wherein the combination is more effective for treating a plant or soil against fungal and/or bacterial disease than if each component in the combination, at the same amount is applied alone, with the proviso that the polyphenol-based component (1), contains at least one polyphenol which is not a lignosulfonate, and that lignosulphonates, if present in the combination, or in compositions comprising the combination, are not the sole polyphenol-based compound.

The present invention also provides a multi-component combination comprising at least two components (1) an amount of polyphenol-based component, and (2) an amount of at least one (systemic) fungicide component (A) selected from the group of:
(a) QiI fungicide;
(b) strobilurin fungicide (QoI fungicide)
(c) succinate dehydrogenase inhibitor (SDHI) fungicide;
(d) triazole (azole) fungicide (DMI);
(e) morpholine fungicide; and
(f) any mixtures thereof;
wherein the combination is more effective for treating a plant or soil against fungal and/or bacterial disease than if each component in the combination, at the same amount is applied alone, with the proviso that the polyphenol-based component (1), contains naturally sourced polyphenol-based compounds, and that lignosulphonates, if present in the combination, or in compositions comprising the combination, are not the sole polyphenol-based compound.

The present invention additionally provides a multi-component combination comprising at least two components,
(1) polyphenol-based component and
(2) at least one fungicide (A) selected from the group of:
   (a) QiI fungicide;
   (b) strobilurin fungicide;
   (c) succinate dehydrogenase inhibitor (SDHI) fungicide;
   (d) triazole fungicide;
   (e) morpholine fungicide; and
   any and all mixtures of two or more of (a)-(e); and optionally,
(3) compounds selected from the group of,
   i. protectant fungicide(s);
   ii. copper-based compound(s); and
   iii. any and all mixtures thereof;
wherein the combination is more effective for treating a plant or soil against fungal disease than when each fungicide at the same amount is applied either alone or as a mixture of fungicides, without the polyphenol-based component, with the proviso that the polyphenol-based component (1) contains naturally sourced or derived, polyphenol-based compounds, and that lignosulphonates, if present in the combination, or in compositions comprising the combination, are not the sole polyphenol-based compound.

Furthermore, the present invention also provides a combination comprising at least two components,
Component (1) an amount of polyphenol-based component,
Component (2) an amount of at least one fungicide component (A) selected from the group of:
   (a) QiI fungicide;
   (b) strobilurin fungicide (QoI fungicide);
   (c) succinate dehydrogenase inhibitor (SDHI) fungicide;
   (d) triazole (azole) fungicide (DMI);
   (e) morpholine fungicide; and
   (f) mixtures of two or more thereof;
The combination optionally, or advantageously further contains, an additional Component (3) selected from the group of:
   (g) protectant fungicides exemplified by fluazinam, chlorothalonil, mancozeb, sulfur, folpet, and captan;
   (h) copper-based compound(s); and
   (i) any and all mixtures thereof,
with the proviso that the polyphenol-based component (1), contains at least one, preferably naturally sourced or derived, polyphenol-based compound, which is not a lignosulfonate, and that lignosulphonates, if present in the combination or in compositions comprising the combination, are not the sole polyphenol-based compound.

Further, present invention also provides combinations wherein the amount of polyphenol-based component (1) and the amount of the fungicide (A) of component (2), if applied together is more effective for treating or protecting plants or soil against fungal and/or bacterial infection than if each component at the same amount is applied alone, and wherein the amounts of component (3) when present, are reduced (or may be reduced without deleterious effect), as compared to comparable fungicidal combinations comprising the same amount of the fungicide (A) of component (2), where the polyphenol-based component (1) is absent.

To be clear though, the addition of superfluous active ingredients of component (3) or amounts thereof superfluous to requirements, to combinations of the inventions will not remove the combinations from the envisioned scope of the invention.

Thus, the invention also provides a method comprising the use of polyphenol-based materials to enable reducing the amount of either copper-based compounds and/or protectant fungicides that are typically included in fungicidal mixtures with systemic fungicides.

In several three-component embodiments of the invention, the inventive combination comprises a mixture of the polyphenol-based component (1) with one or both of copper-based compound(s) and Protectant fungicide(s), component (3) which are combined with a separately prepared component (2) comprising systemic fungicide(s) (A). Thus, the invention also includes the mixture of component (1) with component (3) alone, but especially adapted for use in combination with one or more component (2) systemic fungicides, for example as part of a kit, or otherwise adapted for use for combining with one or more component (2) systemic fungicides to prepare the three-component embodiments of the inventive combinations.

Notable, are combinations of polyphenol-based component (1) together with copper-based component (3) compound(s) intended, or with instructions or otherwise adapted to be combined with separately combined systemic fungicide(s) of component (2), or with separately combined, systemic and protectant fungicide(s) of combined components (2) and (3).

### DETAILED DESCRIPTION OF SPECIFIC EMBODIMENTS OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains

Throughout the application, descriptions of various embodiments use the term “comprising”; however, it will be understood by one of skill in the art, that in some specific instances, an embodiment can alternatively be described using the language “consisting essentially of” or “consisting of.”

Often when relating to a list of options, or optional choices of ingredient etc., the phrase “selected from the group consisting of” has been used in this disclosure, however, in all cases the corresponding phrase “selected from the group of” is specifically intended as an option, and vice versa, unless the context requires the specific interpretation.

All disclosed lists of optional ingredients etc., should be seen as a disclosure of both closed and open lists as two independently disclosed alternatives.

The term “a” or “an” as used herein includes the singular and the plural, unless specifically stated otherwise. Therefore, the terms “a,” “an” or “at least one” can be used interchangeably in this application, to be clear that the use of terms “a,” or “an” does not intend to convey the absence of multiples unless the context requires it.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. Inventors intend to report numerical values rounded up to no more than one digit after the decimal point. While every effort has been expended to avoid the error, if a numerical value disclosed herein has been mistakenly recorded as having more than one numeral after the decimal point, it should be considered to have been an inadvertent error and the figure should be understood to be that value rounded up or down to a maximum of a single numeral after the decimal point, e.g., within this disclosure, a typographical error that records a figure of “147. 4821”, should be understood that inventors intention was to refer to a correct value of “148”, unless the context makes clear that 147.5 is required. Likewise values actually below 0.05 will of course be recorded so as to not be record a value of zero, e.g., 0.02 will not be rounded down to 0.0.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, ±20%, ±10%, or ±5% of the stated value.

In this regard, use of the term “about” herein specifically includes ±10% from the indicated values in the range and unless it is clear from the context, the term about is understood to be ±10% from the indicated value.

In addition, the endpoints of all ranges directed to the same component or property herein are inclusive of the endpoints, are independently combinable, and specifically include all intermediate points and ranges. Thus, it is understood that where a parameter range is provided, all integers within that range, and tenths thereof, are also provided by the invention, and as with all numbers, accepted principles of numerical rounding should be employed. For example, a range of “10%-50%” specifically includes 9.5%, 10%, 10.1%, 10.2%, etc. up to 50.4%.

As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it may be directly in contact with the other element or intervening elements may be present therebetween. In contrast, when an element is referred to as being “directly on” another element, there are no intervening elements present that may create a barrier between them.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing or illustrating particular embodiments only and is not intended to be limiting. As used herein, the singular forms “a,” “an,” and “the” are intended to include the plural forms as well, unless the context clearly indicates otherwise.

The term “or” means “and/or” unless the context requires otherwise. It will be further understood that the terms “comprises” and/or “comprising,” or “includes” and/or “including” or “contains” and/or “containing”, if used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “mixture” as regards agrochemicals, includes, but is not limited to, an assemblage of agrochemicals typically, for application either by simultaneous, contemporaneous, concomitant, sequential and/or succession/successive application.

Thus, the term “mixture” as regards components includes a combination in any time of application of the individual components e.g., simultaneous, contemporaneous, concomitant, and/or succession/successive application and/or in any physical form, e.g., composition, blend, solution, suspension, dispersion, emulsion, alloy, or the like. Mixture or mixing also may refer to combining and applying the active components as one composition and/or formulating each of the active component in the mixture or combination as separated compositions and application at the same time or in separated applications at the same time or different times, these mixture of components can be provided in a kit, or otherwise adapted for combination according to the invention.

As used herein, the term “simultaneous” if used in connection with application of agrochemicals means that the agrochemicals (of the mixture) are applied in an admixture, for example, a tank mix. For simultaneous application, the combination (mixture), may be the admixture itself, or separate containers each containing an agrochemical component or mixture of some components that are combined prior to application, typically provided as a kit, or otherwise adapted for end-use combination.

As used herein, the term “contemporaneous” if used in connection with application of agrochemicals (of the mixture) means that an individual agrochemical is applied perhaps separately from another agrochemical or premixture at the same time or at times sufficiently close together that a synergistic activity or an activity that is additive or more than additive relative to the activity of either agrochemical alone at the same dose is achieved.

As used herein, the term “succession” or “successive” if used in connection with the application of agrochemicals (of the combination) means that an individual agrochemical is applied at separate application starting times from another agrochemical, one after the other.

As used herein, the specific term “fungicidally effective amount” of an active component refers to an amount of the active component that is commercially recommended for use, for example, to control the relevant fungi on the relevant crop. In some instances, however it will be clear from the context that an amount which is effective fungicidally, is a reduced though, still effective amount of an active component enabled by implementing the invention, as compared to the commercially recommended amount. The commercially recommended amount for each active component, often specified as application rates of the commercial formulation, may be found on the label accompanying the commercial formulation. The commercially recommended application rates of the commercial formulation may vary depending on factors such as the plant species and the fungus to be controlled.

For example, if a fungicide concentrated composition comprising 300 g/L of a single fungicidal ingredient is marketed to treat a specific fungal infection of a specific crop with a recommendation to apply 800 g ai/ha, less than this amount of that fungicide is considered less than its fungicidally effective amount.

In general, if application of particular amount of a specific fungicide achieves less than 70% control of a specific fungal pathogen in a specific crop (less than 70% efficacy), it is considered that that amount of that fungicide is less than a fungicidally effective amount.

Of course, when considering intransigent or difficult to treat fungal infections, the level of control is based on the industry standard, so that if the maximum level of control achievable with a specific solo fungicide to-date for a particular fungal infection is considerably less than 80% control, the term less than a fungicidally effective amount, will be based on the amount known to achieve that maximum levels of control.

As used herein the term “protectant fungicide” does not include copper-based compounds even though the term is generally understood to encompasses these classes of compounds too. However, in the specific context of this invention where the copper-based compounds are typically advantageously used in amounts that are significantly below the fungicidally effective amount, the class of copper-based fungicides are addressed separately from other protectant fungicides and strictly for the purposes of this invention, will not be referred to as “protectant fungicide” even though they belong to a chemical class known to have this function.

As used herein, the term “treating a plant or soil against fungal infection” includes, but is not limited to, protecting the plant or soil against fungal attack, preventing fungal infection of the plant or soil, controlling fungal disease infecting the plant or soil, and reducing fungal infection of the plant or soil.

As used herein, the term “more effective” includes, but is not limited to, increasing efficacy of fungal disease control, prolonging protection and reducing the amount of time needed to achieve a given level of fungal control, prolonging the duration of protection against fungal attack after application and extending the protection period against fungal attack and/or reducing the amount of time needed to achieve a level of fungal control compared to when each fungicide at the same amount is applied alone.

As used herein, the term “effective” if used in connection with any combination, mixture or composition may be but is not limited to any of, effective in controlling fungal disease, effective in preventing fungal disease, effective to decrease time for effectively controlling fungal disease, effective to decrease the amount of the fungicide(s) required for effectively controlling fungal disease, effective in extending the controlling effect of the individual combination, mixture and/or composition the mixture in terms of type of crop and disease, effective to prolong the time of controlling effect of the mixture compared to the individual combination, mixture and/or composition the mixture in terms of type of crop and disease, effective to prolong the time of controlling effect of the individual combination, mixture and/or composition the mixture in terms of type of crop and disease.

As used herein, the term “effective amount” typically refers to an amount of the agrochemical composition or of the mixture which is sufficient for controlling harmful fungi on crop plants and does not cause significant damage to the treated crop plants.

As used herein, the term “agriculturally acceptable carrier” means carriers which are known and accepted in the art for the formation of compositions for agricultural or horticultural use.

As used herein, the term “adjuvant” is broadly defined as any substance that itself is not an active ingredient, but which enhances or is intended to enhance the effectiveness of the pesticide with which it is used. Adjuvants may be understood to include, but are not limited to, spreading agents, penetrants, compatibility agents, and drift retardants.

As used herein, the term “agriculturally acceptable inert additives” is defined as any substance that itself is not an active ingredient but is added to the composition such as thickening agent, sticking agents, surfactants, anti-oxidation agent, anti-foaming agents and thickeners.

As used herein, the term “tank mix” means that one or more chemical pesticides or compositions are mixed in the spray tank at the time of spray application.

As used herein, the term “ready mix” means a composition that may be applied to plants directly after dilution. The composition comprises the combination of the active ingredients.

As used herein the term “plant” or “crop” includes reference to agricultural crops including field crops (soybean, maize, wheat, rice, etc.), vegetable crops (potatoes, cabbages, etc.), fruits (peach, etc.), semi-perennial crops (sugarcane) and perennial crops (coffee and guava).

As used herein the term “plant” or “crop” includes reference to whole plants, plant organs (e.g., leaves, stems, twigs, roots, trunks, limbs, shoots, fruits etc.), plant cells, seedling, cutting or plant seeds. This term also encompasses plant crops such as fruits.

The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts, basal shoots, stolons, and buds and other parts of plants, including seedlings and young plants, which are to be transplanted after germination, rooting or after emergence from soil or any other kind of substrate, be it artificial or natural.

As used herein the term “propagation material” is to be understood to denote all the generative parts of the plant such as seeds and spores, vegetative structures such as bulbs, corms, tubers, rhizomes, roots stems, basal shoots, stolons, and buds.

As used herein, the term “locus” includes not only areas where fungal infection/disease may already be shown, but also areas where fungal infection/disease have yet to show and also area under cultivation. Locus includes but is not limited to soil and other plant growth medium.

As used herein, the term “locus” includes a habitat, breeding ground, plant, propagation material, soil, area, material, or environment in which a fungal disease is growing or may grow.

As used herein the term “ha” refers to hectare.

As used herein, the terms “control” or “controlling” or “treating” include but are not limited to, preventing fungal disease, protecting plants from fungal disease, delaying the onset of fungal disease, and combating or killing fungal disease. They also may include the curative and/or eradication action of compounds and compositions on underway fungal and/or bacterial diseases. Controlling fungal disease infecting the plant, propagation material of the plant or locus of the plant, controlling a plant or soil disease caused by phytopathologic fungi and/or bacteria (pathogen), controlling fungal attack on the plant or, propagation material of the plant or locus of the plant includes curative application and/or protectant/preventive application and/or persistence application to do so.

The term “applying” or “application”, as used herein, includes but is not limited to applying the compounds and compositions including those of the invention, to the plant, to a site of infestation by fungi and/or bacteria, to a potential site of infestation by the fungi and/or bacteria, which may require protection from infestation, or the environment around the habitat or potential habitat of the fungi and/or bacteria. It also includes reference to the activity of compounds and compositions on plants and fungal and/or bacterial tissues with which they come into contact. The application may be by methods described in the present invention such as by spraying, dipping, etc.

As used herein the term “curative application” means, inter alia, an application of one or more compounds including fungicide for controlling fungal and/or bacterial infection of the plant or locus, wherein the fungicidal combination, mixture or composition is applied after an infection or after disease symptoms are shown, and wherein the fungal and/or bacterial infection is reduced and/or curing a plant or soil disease caused by phytopathologic fungi and/or bacteria.

As used herein, the term “curative treatment” or “curative activity” means an application of one or more pesticides, and particularly fungicidal material for controlling pest infection of the plant or locus, after an infection or after disease symptoms are shown and/or when the disease pressure is high. Disease pressure may be assessed based on the conditions associated with disease development such as spore concentration and certain environmental conditions. In some embodiments, the pest is a fungus and/or bacteria.

As used herein, the term “protectant application” means an application of one or more fungicidal combination, mixture, or composition, for preventing fungal and/or bacterial infection of the plant or locus, wherein the fungicidal combination, mixture or composition is applied before infection/disease occurs, before any disease symptoms are shown or when the disease pressure is low. Disease pressure may be assessed based on the conditions associated with disease development such as spore concentration and certain environmental conditions.

As used herein, the term “preventative treatment” or “preventative activity” means an application of one or more pesticide for controlling pest infection of the plant or locus, before an infection or before disease symptoms are shown and/or when the disease pressure is low. Disease pressure may be assessed based on the conditions associated with disease development such as spore concentration and certain environmental conditions. In some embodiments, the pest is a fungus and/or bacteria.

As used herein, the term “cultivated plants” includes plants which have been modified by breeding, mutagenesis, or genetic engineering. Genetically modified plants are plants, which their genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance or improved non biotic stress mitigation (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), shortening of stalks, increased diameter of stalks, increased shoot growth, enhanced plant vigor, increased plant stand and early and better germination; or any other advantages familiar to a person skilled in the art.

As used herein, the phrase “agriculturally acceptable carrier” means carriers which are known and accepted in the art for the formation of compositions for agricultural or horticultural use.

In some embodiments, the disease is fungal disease.

In some embodiments, infection is disease and/or disease caused by pathogen.

The term “enhancing crop plants” as used herein means improving one or more of plant quality, plant vigor, nutrient uptake, root system, tolerance to stress factors or improved non biotic stress mitigation, and/or yield in a plant to which the mixture or composition described herein is applied as compared to a control plant grown under the same conditions except to which the mixture or composition described herein is not applied.

The term “improving plant quality” as used herein means that one or more traits are improved qualitatively or quantitatively in a plant to which the mixture or composition described herein is applied as compared to the same trait in a control plant grown under the same conditions except to which the mixture or composition described herein is not applied. Such traits include but are not limited to improved visual appearance and composition of the plant (i.e. improved color, density, uniformity, compactness), reduced ethylene (reduced production and/or inhibition of reception), improved visual appearance and composition of harvested material (i.e. seeds, fruits, leaves, vegetables, shoot/stem/cane), improved carbohydrate content (i.e. increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e. improved taste), improved consumer health benefits (i.e. increased levels of vitamins and antioxidants), improved post-harvest characteristics (i.e. enhanced shelf-life and/or storage stability, easier processability, easier extraction of compounds), and/or improved seed quality (i.e. for use in following seasons).

As used herein, the term “plant growth regulation” or “regulating plant growth” includes restricting vertical stem growth, promoting root growth, stunting, increasing stem diameter and stem-wall thickness, and the like.

As used herein, the term “plants” refers to any and all physical parts of a plant, including but not limited to seeds, seedlings, saplings, roots, tubers, stems, stalks, foliage, and fruits.

### Combinations and Mixtures

The present invention provides combinations often referred to as multi-component combinations comprising at least two components (1) an amount of polyphenol-based component, and as component (2) an amount of at least one fungicide (A) which are typically referred to as systemic fungicides, selected from the group consisting of: QiI fungicide; strobilurin fungicide (QoI); SDHI fungicide; azole fungicide (DMI); and morpholine fungicide.

### Combination Embodiments #1

In noted embodiments the inventive combinations often comprise, additional component (3) compound(s) selected from the group of Protectant Fungicides, exemplified by fluazinam, chlorothalonil, mancozeb, sulfur, folpet, captan; and mixtures thereof and/or copper-based compounds, wherein the amount of polyphenol-based component (1) and the amount of the component (2) (systemic), fungicide component (A), if applied together is more effective for treating or protecting plants or soil against fungal and/or bacterial infection than if each component at the same amount is applied alone, and wherein the amounts of component (3) compounds when present, are reduced without loss of efficacy and often with enhanced activity and benefits, as compared to comparable fungicidal combinations comprising the same amount of the fungicide(s) component (A), where the polyphenol-based component is absent.

In noted embodiments the reductions in Protectant Fungicide and or copper, enabled by combinations of the invention can result in the following exemplified ranges of amounts in fungicidal mixtures when they are included in fungicidal combinations of the invention comprising components (1), (2) and (3).
fluazinam, about 200 g/ha-500 g/ha, typically about 300 g/ha,
chlorothalonil, about 400 g/ha-1200 g/ha, sometimes about 1000 g/ha typically, about 700 g/ha,
mancozeb, about 400 g/ha-1500 g/ha, sometimes about 900 g/ha, typically about 700 g/ha, or
metallic copper, about 1 g/ha-350 g/ha, often in the range of about 5 g/ha-50 g/ha, and in some noted embodiments, amounts of less than 10 g/ha metallic copper are more than sufficient.

### DISCUSSION

As can immediately be understood and appreciated by those skilled in the arts, the above amounts of Protectant Fungicides, including ethylene bisdithiocarbamates (EBDC) exemplified by mancozeb, are significantly reduced in comparison with known mixtures with systemic fungicides and represent drastically reduced amounts of metallic copper as compared to those which were heretofore encountered in previously known fungicidal mixtures of Protectant Fungicides and/or copper with systemic fungicides.

Without being bound by theory, it is possible that, in the multi-component combinations of the invention, wherein copper-based compound(s) are included in component (3), the copper compound(s) act in concert with the Polyphenol-based component (1) enhancing the effects of the Polyphenol-based component (1) on the fungicidal efficacy of the fungicide (A) compounds of component (2), rather than the copper-based compounds being significantly fungicidally active themselves, this might explain why such reduced amounts of copper are sufficient in the combinations of the invention to achieve the desired efficacy.

Without being bound by theory, it is possible that, in the multi-component combinations of the invention, wherein copper compound(s) are included in component (3), they become so fungicidally enhanced in concert with the Polyphenol-based component (1) such that drastically reduced amounts of copper are sufficient in the combinations of the invention to achieve the levels of copper-based fungicidal efficacy normally encountered with fungicidal combinations comprising far greater copper content.

The ability to drastically reduce the copper content in these types of the inventive combinations is advantageous in itself even if fungicidal efficacy remains equivalent, not only due to reduced material costs but also the allowing the possibility of reduced phytotoxicity and environmental deleterious effects.

Without being bound by theory, it is possible that, in the multi-component combinations of the invention, wherein Protectant fungicide compound(s) as defined above, are included in component (3), the Protectant fungicide(s) act in concert with the Polyphenol-based component (1) enhancing the effects of the Polyphenol-based component (1) on the fungicidal efficacy of the (systemic), fungicide (A) compounds of component (2), rather than being solely fungicidally active. While not wishing to be bound by any theory, this enhancement might explain why reduced amounts of Protectant fungicides are sufficient in the combinations of the invention to achieve the desired efficacy.

Without being bound by theory, it is possible that, in the multi-component combinations of the invention, wherein Protectant fungicide compound(s) as defined above, are included in component (3), they become so fungicidally enhanced in concert with the Polyphenol-based component (1) such that significantly reduced amounts of Protectant fungicide compound(s) are sufficient in the combinations of the invention to achieve the levels of fungicidal efficacy normally encountered with fungicidal combinations comprising far greater Protectant fungicide content.

The ability to reduce the protectant fungicide content in these types of the inventive combinations is especially advantageous in itself even if fungicidal efficacy remains equivalent, not only due to reduced material costs but also the possibility of reduced phytotoxicity and environmental deleterious effects.

### Combination Embodiments #2

In some noted embodiments based on previously known mixtures of the ethylene bisdithiocarbamate (EBDC), group of fungicides together with systemic fungicides exemplified by strobilurins and/or triazoles, the inventive additional combination with the polyphenol-based compounds, can allow a reduction in the content of the EBDC fungicide by 25% or more compared with the “fungicidally effective amount”, as defined herein without loss of activity.

In some noted embodiments based on previously known mixtures of the ethylene bisdithiocarbamate (EBDC), group of fungicides together with systemic fungicides exemplified by strobilurins and/or triazoles, the inventive additional combination with the polyphenol-based compounds, can allow a reduction in the content of all of each of the EBDC, the strobilurin fungicides and/or triazoles fungicides by between about 10-50% compared with the fungicidally effective amount of the combination of the same ethylene bisdithiocarbamate (EBDC), fungicide together with the same systemic fungicides without loss of activity. Most commonly the reduction in fungicide content is between about 20% and about 40% without loss of fungicidal efficacy.

Typically, the level of fungicidal performance encountered with these inventive combinations of systemic fungicides with reduced content of EBDC protectant fungicides is actually improved when in combination with polyphenol-based compounds as compared to mixtures of the same systemic fungicides with the previously encountered unreduced content of the same EBDC protectant fungicides without polyphenol-based compound.

The present invention also provides as embodiments, increased effectiveness multi-component combinations comprising at least (1) an amount of polyphenol-based-component, and as component (2) an amount of at least one (typically, systemic) fungicide selected from the group of:
(a) QiI fungicide;
(b) strobilurin fungicide (QoI fungicide);
(c) succinate dehydrogenase inhibitor (SDHI) fungicide;
(d) triazole (azole) fungicide (DMI); and
(e) morpholine fungicide;
   and optionally, an additional component (3) comprising at least one of,
(g) protectant fungicide, exemplified by at least one of, fluazinam, chlorothalonil, mancozeb, sulfur, folpet, captan; and
(h) copper-based compounds; and
(i) any and all mixtures thereof;
   wherein the combinations are more effective for treating a plant or soil against fungal and/or bacterial disease than if each component at the same amount is applied alone, and wherein if present, the amounts of compounds comprising component (3) are advantageously reduced compared to the amounts in previously encountered fungicidal combinations.

The present invention also provides as embodiments, a combination of at least two components, (1) an amount of polyphenol-based component, and as component (2) an amount of at least one fungicide (A) selected from the group of:
(a) a QiI fungicide;
(b) a strobilurin fungicide (QoI fungicide);
(c) a succinate dehydrogenase inhibitor (SDHI) fungicide;
(d) a triazole (azole) fungicide (DMI); and
(e) a morpholine fungicide;
wherein the amount of polyphenol-based component (1) and the amount of the fungicide (A) comprising component (2), if applied together or in concert, etc., is more effective for treating plant or soil against fungal and/or bacterial infection than if each component at the same amount is applied alone without the other.

The present invention also provides as embodiments a combination comprising at least two components
(1) an amount of polyphenol-based component, and component
(2), an amount of at least one systemic fungicide (A) selected from the group of:
   (a) QiI fungicide;
   (b) strobilurin fungicide (QoI fungicide);
   (c) succinate dehydrogenase inhibitor (SDHI) fungicide;
   (d) triazole azole fungicide (DMI);
   (e) morpholine fungicide;
   (f) mixtures of any two or more of (a)-(e),
wherein the amount of at least one of the fungicide(s) (A) in the combination, and advantageously the amount of all of the fungicide(s) (A) in the combination, is less than the fungicidally effective amount of each fungicide (A) compound(s), when the fungicide (A) is used alone rather than in the combination.

In some embodiments, where the combination comprises a third component (3) comprising,
g) at least one or a mixture of protectant fungicide(s) exemplified by fluazinam, chlorothalonil, mancozeb, sulfur, folpet, or captan, and/or
h) copper-based compounds,
i) mixtures of any two or more of (g) and (h),
   the amount of protectant fungicide(s) and/or copper compound in the combination is less than the fungicidally effective amount of protectant fungicide(s) and/or copper-based compound when protectant fungicide and/or copper is used with the same fungicide(s) (A) alone and not in combination with polyphenol-based component (1), or when the mixture of the fungicides of component (2) are used in absence of the polyphenol-based component (1).

In one aspect of the invention embodiments, minimal amounts, exemplified by 50 g/ha or less of metallic copper in component (3) are used in order to boost the fungicidally enhancing effects of the polyphenol-based compounds of component (1) on the systemic fungicides (A) of component (2).

Without wishing to be bound by any theory, it may be that the function of the copper-based compounds are changed when combined with the polyphenol-based compounds and they are not themselves antifungal to an appreciable degree in the combination, but rather as explained above, simply able to significantly enhance the activity of the polyphenol-based component in boosting the fungicidal activity of the systemic fungicides (A), this may explain why such drastic reductions in copper are made possible in the inventive combinations herein disclosed.

In some embodiments, when the combination comprises two or more fungicides (A) as component (2), the amount of either, one, both or all of the fungicides (A) in the combination is less than if only one fungicide (A) is used.

The present invention also provides as embodiments a combination comprising at least two components (1) an amount of polyphenol-based component, and as component (2), an amount of at least one fungicide (A) selected from the group of:
(a) one or more QiI fungicide, exemplified by, imidazole, picolinamide and sulfonamide fungicides;
(b) one or more strobilurin fungicide (QoI);
(c) one or more succinate dehydrogenase inhibitor (SDHI) fungicide, exemplified by pyrazole-carboxamide fungicides;
(d) one or more triazole azole fungicide (DMI);
(e) one or more morpholine fungicide
(f) mixtures of any two or more of (a)-(e).

The Polyphenol-based component (1), is often, typically, or even advantageously comprised of a mixture of different chemical compounds each including at least two phenol functional groups.

### Polyphenol-Based Component Embodiments #3

In noted embodiments the polyphenol-based component comprises but is not limited to natural, naturally sourced or derived polyphenols. In some circumstances the naturally sourced polyphenol-based component (1) includes at least a portion of one or more synthetic polyphenol compounds without departing from the invention.

In some notedly advantageous embodiments, the polyphenol-based component comprises at least one polyphenol which is not a lignosulfonate. In some circumstances the polyphenol-based component (1) of the combination of the invention, or compositions comprising the combination includes at least a portion of one or more lignosulphonates without departing from the invention.

Polyphenol-based compound is represented by a group including phenolic acids, stilbenes, lignans, hydrolyzable tannins, tannic acid, lignins, flavonoids and combination thereof. Castalagin; extracts of water-soluble tannins; extracts of water-soluble Proanthocyanidins

In some embodiments, flavonoids refers but not limited to flavones, aurones, anthocyanins, leucoanthocyanidins, flavonols, flavanols, flavanones, chalcones, isoflavonoids, proanthocyanidins and combination thereof.

In some embodiments, the polyphenol-based component is comprised of one or more extracts which each comprise at least one structure/source of polyphenols.

To be clear, commonly used lignosulphonates (for example as dispersants), are not intended to be included in the term Polyphenol-based component (1). However, the incorporation of lignosulphonates and other similar known pesticide ingredients into compositions comprising the inventive combinations, does not depart from the scope of the invention so long as both the polyphenol-based component (1), and the at least one (systemic), fungicide (A) compound of component (2) are included in the combination.

In useful embodiments, tannins include various types of tannins, such as condensed and/or hydrolyzable tannins, and/or phlorotannins. Noted are, condensed tannins of the procyanidin and/or prodelphinidin type, such as of maritime pine (Pinus pinaster), of Chilean pine (Araucaria Araucana), of Pecan nuts (pecan), of Spruce (Picea abies), of Douglas, of fir etc, and/or condensed tannins of the prorobinetinidin and/or profisetinidin type, such as of Mimosa (Acacia mearnsii, Acacia mollissima, Acacia mangium, Acacia catechu), of Quebracho Schinopsis lorentzii, Schinopsis balansae), of gambier uncaria gambir), etc, and/or hydrolysable tannins, such as of chestnut (Castanea sativa, Castanea vesca), of Tara Caesalpinia spinosa), etc., and/or—phlorotannins extracted from algae. These tannins can be possibly employed also in their form purified by extraction with organic solvents, through processes such as acylation, methylation, ethoxylation, propoxylation, etc., and/or in their form modified or transformed by means of various chemical and physical reactions, such as polymerization, oxidation or enzymatic or chemical hydrolysis, and/or with the introduction of amino groups, so that the tannins can also be in the form of sulphited, sulphonated, oxidized, acetylated, esterified, ethoxylated or propoxylated substances, or possible mixtures thereof.

In some embodiments the polyphenol compounds of the polyphenol-based component (1) comprise Castalagin, either alone or with other natural polyphenol compounds

In some noted and exemplified embodiments, polyphenol compounds of the polyphenol-based component (1) are extracts of water-soluble tannins and proanthocyanidins.

In some embodiments, the inventive combination further comprises at least one additional polyphenol-based component ingredient.

### Component (3) Embodiments #4

In some embodiments, protectant fungicide of component (3) is selected from the group of fluazinam; chlorothalonil; mancozeb; sulphur; folpet; captan and mixtures thereof.

In some embodiments, component (3) comprises compounds selected from the group of copper based compounds, either alone or in combination with Protectant fungicides.

In some embodiments, component (3) comprises compounds selected from the group of copper based compounds, either alone or in combination with Protectant fungicides.

In some embodiments, component (3) comprises Protectant Fungicide compounds at least one of which is present at concentrations and/or amounts significantly below the levels that are currently used in known combinations with the fungicides (A), sometimes referred to as systemic fungicides.

In some embodiments, component (3) is comprised of both of, at least one protectant fungicide, selected from the group of fluazinam; chlorothalonil; mancozeb; sulphur; folpet; captan together with at least one copper based compound.

In some embodiments, the protectant fungicide is fluazinam

In some embodiments, the protectant fungicide is chlorothalonil

In some embodiments, the protectant fungicide is a dithiocarbamate.

In some embodiments, where present, the dithiocarbamate may be, though not limited to, any one of, some, or all of, mancozeb, zineb, propineb, and maneb.

In some embodiments, the protectant fungicide comprises mancozeb.

In some embodiments, the protectant fungicide comprises sulphur.

In some embodiments, the protectant fungicide comprises one or more phthalimide fungicide.

In some embodiments, phthalimide fungicide is exemplified by one or more of, folpet, captan and captafol.

In some embodiments, the protectant fungicide comprises folpet.

In some embodiments, the protectant fungicide comprises captan.

### Copper-Based Component (3) Embodiments #5

In some embodiments, the protectant fungicide is combined with copper-based compounds as component (3).

In some embodiments, component (3) of the combination comprises copper-based compounds exemplified by copper-based fungicides and/or metallic copper, without any protectant fungicide as defined above.

In some embodiments, the component (3) of the multi-component combination of the invention, comprises copper-based compound, selected from the group of cupric acetate; cupric chloride; cupric chlorate; cupric formate; cupric hexafluorosilicate; cupric nitrate; cupric chromate; copper sulfate pentahydrate; bordeaux mixture; copper hydroxide; copper oxychloride sulfate (COCS); tribasic copper sulfate such as cupric sulfate; tricupric hydroxide; hemihydrate; chelated (or complexed), copper with EDTA; Copper chelated (or complexed), with amino acids; copper chelated/complexed with both EDTA and Amino acid; copper glycinate; copper alaninates; and any and all combinations thereof.

In some embodiments, the copper-based compound may include, but is not limited to, cupric acetate, cupric chloride, cupric chlorate, cupric formate, cupric hexafluorosilicate, cupric nitrate, cupric chromate, copper sulfate pentahydrate, bordeaux mixture, copper hydroxide, copper oxychloride sulfate (COCS), tribasic copper sulfate such as cupric sulfate, tricupric hydroxide, hemihydrate, chelated (or complexed), copper with EDTA; Copper chelated (or complexed), with amino acids; copper chelated/complexed with both EDTA and Amino acid; copper glycinate; copper alaninates; or any and all combinations thereof.

In some embodiments, the copper-based compound is selected from the group consisting of cupric acetate, cupric chloride, cupric chlorate, cupric formate, cupric hexafluorosilicate, cupric nitrate, cupric chromate, copper sulfate pentahydrate, Bordeaux mixture and any and all combinations thereof.

In some embodiments, the copper-based compound is Bordeaux mixture.

In some embodiments, the copper-based compound is copper hydroxide.

In some embodiments, the copper-based compound is copper oxychloride.

In some embodiments, the copper-based compound is selected from the group consisting of copper sulfate pentahydrate, Bordeaux mixture and any combination thereof.

In some highlighted embodiments the copper-based compounds of component (3) include copper complexed, or chelated with, for example EDTA, amino acids, exemplified by glycine etc.

In some particularly noted embodiments, the polyphenol-based compound(s) of component (1) is used as a mixture with the copper-based compound of component (3), before combination with component (2) systemic fungicides. Some unwanted interactions can occur with some copper compounds and thus there are particularly useful copper-based compounds that avoid such interactions exemplified by certain copper complexes etc.

### Improvement Embodiments #6

Thus, in the above improved combination embodiments of the invention, yet further improvements of each combination embodiment can be achieved wherein each of, Bordeaux mixture; copper hydroxide; copper oxychloride; and copper sulfate pentahydrate; are each respectively replaced by copper complex(es), or chelated copper compound(s).

In some noted embodiments the further improvements of the inventive combinations comprising both polyphenol-based component (1) and an amount of copper complexed, or chelated with, for example EDTA, amino acids, etc., or other copper complexes, as component (3) compounds, lies in the fact that a significantly reduced amount of the polyphenol-based component (1) can be usefully employed to either or both, enhance the fungicidal efficacy of the systemic fungicide(s) component (2) and/or reduce or even eliminate the amount of Protectant Fungicides exemplified by fluazinam; chlorothalonil; a dithiocarbamate e.g. mancozeb, zineb, propineb, and maneb; sulphur; phthalimide fungicide exemplified by folpet, captan, captafol etc., —typically encountered in previous combinations with the compounds comprising component (2).

In some embodiments comprising three component combinations, a mixture of polyphenol-based component (1) and Copper-based component (3) are provided as a single composition for combining with separately prepared composition(s) of component (2) comprising the (systemic) fungicide(s) (A) of component (2), before application. In several embodiments this combining is accomplished by mixing both types of composition in a Tank-mix, or else, the two compositions are applied separately in any of simultaneous, contemporaneous, concomitant, sequential and/or succession/successive applications. In some embodiments comprising three component combinations comprising both Copper-based as well as Protectant fungicides as component (3), a mixture of polyphenol-based component (1) and the Copper-based compounds of component (3) are provided as a single composition for combining with separately prepared composition(s) of the (systemic) fungicide(s) (A) of component (2) and the protectant fungicides compounds of component (3), before application. In several embodiments this combining is accomplished by mixing both types of composition in a Tank-mix, or else, the two compositions are applied separately in any of simultaneous, contemporaneous, concomitant, sequential and/or succession/successive applications.

As can be appreciated, mixtures of polyphenolic compounds with copper compounds can be considered an integral part and embodiments of the instant invention where the amounts or concentrations of the copper compounds are significantly below the levels required to have a fungicidal effect. As can be immediately appreciated and/or understood, such a mixture of a Polyphenol compound together with sub-therapeutic negligibly fungicidal content of copper, can be usefully considered as having only practical utility as a fungicidal combination when combined with the fungicides (A) of component (2), rather than any simple fungicidal product of commerce. Thus, such a combination of Polyphenol-based (1) and a minimal content of copper compound (3) can be termed a combination of Polyphenolic and copper compounds, adapted for use in preparing the multi-component combinations of the invention where it behaves to enhance the effect of the polyphenol-based component. These mixtures of polyphenolic compounds with copper compounds can usefully be provided in kit form together with a separate mixture of fungicidally active component (2).

Without being bound by any theory, to the extent that the invention can be viewed in one aspect, as a method of enhancing the fungicidal effect of the systemic fungicides (A) as defined above, by combining said fungicides with polyphenolic compounds, the minimal amounts of copper used in the above embodiments can be viewed as boosting the fungicidal-enhancing power of the polyphenolic compounds, rather than displaying any significant pesticidal efficacy or even directly affecting the Fungicides (A) themselves.

As will be appreciated, the minimal amount of copper-based compounds that are included in some embodiments together with polyphenolic compounds typically have minimal or no phytotoxic effects, in marked contrast to the amounts of copper-based compounds previously used in much higher doses as fungicidally active compounds themselves or as protectants.

### Fungicide Combination Embodiments #7

In some embodiments, the combination of the invention, comprises polyphenol-based component and QiI fungicide.

In some embodiments, the combination of the invention, comprises polyphenol-based component and azole fungicide.

In some embodiments, the combination of the invention, comprises polyphenol-based component and morpholine fungicide.

In some embodiments, the combination of the invention, comprises polyphenol-based component and SDHI fungicide.

In some embodiments, the combination of the invention, comprises polyphenol-based component and strobilurin fungicide.

In some embodiments, the combination of the invention, comprises polyphenol-based component, QiI fungicide and azole fungicide.

In some embodiments, the combination of the invention, comprises polyphenol-based component, morpholine fungicide and SDHI fungicide.

In some embodiments, the combination of the invention, comprises polyphenol-based component, morpholine fungicide and strobilurin fungicide.

In some embodiments, the combination of the invention, comprises polyphenol-based component, morpholine fungicide and azole fungicide.

In some embodiments, the combination of the invention, comprises polyphenol-based component, SDHI fungicide and strobilurin fungicide.

In some embodiments, the combination of the invention, comprises polyphenol-based component, morpholine fungicide and strobilurin fungicide.

In some embodiments, the combination of the invention, comprises polyphenol-based component, QiI fungicide, azole fungicide and protectant fungicide.

In some embodiments, the combination of the invention, comprises polyphenol-based component, morpholine fungicide, SDHI and protectant fungicide.

In some embodiments, the combination of the invention, comprises polyphenol-based component, morpholine fungicide, strobilurin fungicide and protectant fungicide.

In some embodiments, the combination of the invention, comprises polyphenol-based component, morpholine fungicide, azole fungicide and protectant fungicide.

In some embodiments, the combination of the invention, comprises polyphenol-based component, SDHI fungicide, strobilurin fungicide and protectant fungicide.

In some embodiments, the combination of the invention, comprises polyphenol-based component, morpholine fungicide, strobilurin fungicide and protectant fungicide.

In some embodiments, the combination of the invention, comprises polyphenol-based component, QiI fungicide and protectant fungicide.

In some embodiments, the combination of the invention, comprises polyphenol-based component, azole fungicide and protectant fungicide.

In some embodiments, the combination of the invention, comprises polyphenol-based component, morpholine fungicide and protectant fungicide.

In some embodiments, the combination of the invention, comprises polyphenol-based component, SDHI fungicide and protectant fungicide.

In some embodiments, the combination of the invention, comprises polyphenol-based component, strobilurin fungicide and protectant fungicide.

In some embodiments, the combination of the invention, comprises polyphenol-based component, copper-based compound, and QiI fungicide.

In some embodiments, the combination of the invention, comprises polyphenol-based component, copper-based compound, and azole fungicide.

In some embodiments, the combination of the invention, comprises polyphenol-based component, copper-based compound, and morpholine fungicide

In some embodiments, the combination of the invention, comprises polyphenol-based component, copper-based compound, and SDHI fungicide.

In some embodiments, the combination of the invention, comprises polyphenol-based component, copper-based compound, and strobilurin fungicide.

In some embodiments, the combination of the invention, comprises polyphenol-based component, copper-based compound, QiI fungicide and azole fungicide.

In some embodiments, the combination of the invention, comprises polyphenol-based component, copper-based compound, morpholine fungicide, and SDHI fungicide.

In some embodiments, the combination of the invention, comprises polyphenol-based component, copper-based compound, morpholine fungicide and strobilurin fungicide.

In some embodiments, the combination of the invention, comprises polyphenol-based component, copper-based compound, morpholine fungicide and azole fungicide.

In some embodiments, the combination of the invention, comprises polyphenol-based component, copper-based compound, SDHI fungicide and strobilurin fungicide.

In some embodiments, the combination of the invention, comprises polyphenol-based component, copper-based compound, morpholine fungicide and strobilurin fungicide.

In some embodiments, the combination of the invention, comprises polyphenol-based component, copper-based compound, QiI fungicide, azole fungicide and protectant fungicide

In some embodiments, the combination of the invention, comprises polyphenol-based component, copper-based compound, morpholine fungicide, SDHI and protectant fungicide.

In some embodiments, the combination of the invention, comprises polyphenol-based component, copper-based compound, morpholine fungicide, strobilurin fungicide and protectant fungicide.

In some embodiments, the combination of the invention, comprises polyphenol-based component, copper-based compound, morpholine fungicide, azole fungicide and protectant fungicide.

In some embodiments, the combination of the invention, comprises polyphenol-based component, copper-based compound, SDHI fungicide, strobilurin fungicide and protectant fungicide.

In some embodiments, the combination of the invention, comprises polyphenol-based component, copper-based compound, morpholine fungicide, strobilurin fungicide and protectant fungicide.

In some embodiments, the combination of the invention, comprises polyphenol-based component, copper-based compound, QiI fungicide and protectant fungicide.

In some embodiments, the combination of the invention, comprises polyphenol-based component, copper-based compound, an azole fungicide, and protectant fungicide.

In some embodiments, the combination of the invention, comprises polyphenol-based component, copper-based compound, morpholine fungicide and protectant fungicide.

In some embodiments, the combination of the invention, comprises polyphenol-based component, copper-based compound, SDHI fungicide and protectant fungicide.

In some embodiments, the combination of the invention, comprises polyphenol-based component, copper-based compound, strobilurin fungicide and protectant fungicide.

In some embodiments, azole fungicide may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole, mefentrifluconazole, and any mixtures thereof.

In some embodiments, the azole fungicide is tebuconazole

In some embodiments, the azole fungicide is prothioconazole

In some embodiments, the azole fungicide is cyproconazole

In some embodiments, the azole fungicide is difenoconazole

In some embodiments, strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, metyltetraprole, fluoxastrobin, and any mixtures thereof.

In some embodiments, the strobilurin fungicide is selected from the group of picoxystrobin, trifloxystrobin, azoxystrobin, pyraclostrobin, metominostrobin, metyltetraprole, mandestrobin and any combination thereof.

In some embodiments, the strobilurin fungicide is picoxystrobin

In some embodiments, the strobilurin fungicide is azoxystrobin

In some embodiments, the SDHI fungicide may include but is not limited to penthiopyrad, boscalid, flutolanil, fluxapyroxad, inpyrfluxam, fluopyram, fluindapyr, benzovindiflupyr, bixafen pydiflumetofen (Adepidyn), and any mixtures thereof.

In some embodiments, the SDHI fungicide is selected from the group of bixafen; fluxapyroxad; fluindapyr; inpyrfluxam; benzovindiflupyr; pydiflumetofen, and any mixtures thereof.

In some embodiments, the SDHI fungicide is fluxapyroxad.

In some embodiments, QiI fungicide may include but is not limited to cyazofamid, amisulbrom and fenpicoxamid.

In some embodiments, QiI is fenpicoxamid.

In some embodiments, morpholines may include but is not limited to aldimorph, benzamorf, carbamorph, dimethomorph, fenpropimorph, flumorph, tridemorph, trimorphamide, dodemorph, spiroxamine, piperalin, and fenpropidin.

In some embodiments, the protectant fungicide comprises any of mancozeb; sulphur; folpet; captan fluazinam; chlorothalonil; dithiocarbamate; zineb; propineb; maneb.

In some embodiments, the protectant fungicide comprises mancozeb.

In some embodiments, the protectant fungicide comprises sulphur compound(s).

In some embodiments, the protectant fungicide comprises one or more phthalimide fungicide.

In some embodiments, phthalimide fungicide is exemplified by one or more of, folpet, captan and captafol.

In some embodiments, the protectant fungicide comprises folpet.

In some embodiments, the protectant fungicide comprises captan.

### SPECIFIC COMBINATION EMBODIMENTS

The following embodiments including the illustrative Table 1 of exemplary combinations, are used to illustrate the breadth of the scope of the combinations of the invention. The list of embodiments below is not intended to be in any way comprehensive but rather to provide an understanding of the range of types of combination that is contemplated. Based on these enumerated embodiments, a person skilled in these arts will immediately appreciate and be aware of variants that would be in the scope of the disclosure even if they are not specifically recorded here.

The presence or absence of a particular combination embodiment or form of any ingredient used in the components of the listed combination embodiments below, does not in any way indicate that these are preferred embodiments, or even that they are of particular note unless indicated as such.

For example, in all the following listed and tabulated embodiments of the inventive combinations where component (3) includes a copper-based compound, the corresponding combination wherein the copper-based compound included in each listed embodiment is replaced with one or more of, copper complex, exemplified by copper-amino acid complex exemplified by copper glycinate and/or chelated copper with agents like EDTA, are understood to be of particular note and are often more useful than the listed copper-based compound of the disclosed embodiment.

In advantageous forms of the listed and tabulated embodiments herein disclosed and alluded to, the polyphenol-based component includes combined extracts of natural water-soluble Tannins and Proanthocyanidins as sources of the polyphenols, and thus the polyphenol-based compounds herein inventively utilized in the inventive combinations, compositions and methods herein disclosed etc. are typically mixtures of several, often naturally sourced or derived, water-soluble Tannins and Proanthocyanidins. Notably, the further inclusion of synthetic polyphenol-based compounds has not yet been found to adversely affect the benefits that have been achieved with these natural Tannins and Proanthocyanidins, and thus, the inclusion of synthetic polyphenol-based compounds in the inventive combinations is not a departure from the invention, and thus does not remove the combinations comprising them from the scope of protection being sought.

Proanthocyanidins are a class of polyphenols found in many plants. Chemically, they are oligomeric flavonoids. More complex polyphenols, having the same polymeric building block, form the group of Tannins.

Tannins are complex chemical substances derived from phenolic acids which are found in many species of plants. They are typically large polyphenolic molecules that bind readily with proteins, cellulose, starches, and minerals. In general, Tannins are found commonly in the bark of trees, wood, leaves, buds, stems, fruits, seeds, roots, and plant galls. Tannins are believed to help to protect the individual plant species. Tannins that become stored in the bark of trees, for example can, to some degree, protect the tree from being infected by certain bacteria or fungi.

Without being bound by any theory, it is believed that while, the polyphenol-based compounds herein inventively utilized in the inventive combinations, compositions, and methods etc., often have a degree of protective or fungicidal activity, the improved pesticidal, or degree of fungicidally enhanced efficacy of the combinations of the invention, cannot be explained simply or purely, by the intrinsic protective attributes of the Polyphenol-based compounds utilized.

Generally, the polyphenol-based compounds as component (1) can be used either in solid or liquid form.

For illustrative purposes, typical embodiments of the liquid forms of the polyphenol-based component include a liquid comprising any of, 7.5%, 10%, 12.5%, 15%, 17.5%, 20%, 22.5%, 25%, 27.5%, 30%, 32.5%, 35%, 37.5%, 40%, 42.5% or 45%, of mixtures of several, often naturally sourced or derived water-soluble Tannins and Proanthocyanidins.

Clearly, use of compositions comprising different numerical percentage content of polyphenol-based compounds as component (1) i.e. in dilute or concentrated forms, do not depart from the scope of this invention in any way but rather these above exemplified percentages make the calculations of ratios of components easier to compute.

In the embodiments herein listed, tabulated, and/or alluded to, the content of polyphenol-based component (1) is often, between about 10 g/ha and about 350 g/ha, and in several common instances the content of polyphenol-based component (1) is between about 40 g/ha and about 90 g/ha exemplified as, though not limed to, between 43.75 g/ha and 87.5 g/ha.

To be clear, when discussing the content of an agriculturally applied ingredient in an agricultural composition, particularly in concentrated form, it is often convenient to refer to the intended rate of application. For example, an ingredient content described as 10 g/ha in a concentrate designed to be diluted before use, is understood to be an amount of that ingredient that when diluted and applied from a typical Tank-mix dilution and liquid spraying rates (e.g., 150 L/ha), will be applied 10 g/ha. When the content of an ingredient in an agricultural composition is defined by g/ha, it is clear that the concentrate has the same content even if the final dilution and/or spray rate is changed, this however is an accepted description of such ingredient content in agriculture.

### Specific Combination Embodiments #8

In some embodiments, the combination comprises polyphenol-based component, picoxystrobin, tebuconazole and Bordeaux mixture.

In some embodiments, the combination comprises polyphenol-based component, picoxystrobin, tebuconazole and fluazinam.

In some embodiments, the combination comprises polyphenol-based component, picoxystrobin, Tebuconazole and Folpet.

In some embodiments, the combination comprises polyphenol-based component, picoxystrobin, Tebuconazole and Sulphur.

In some embodiments, the combination comprises polyphenol-based component, picoxystrobin, Prothioconazole and Mancozeb.

In some embodiments, the combination comprises polyphenol-based component, picoxystrobin, Prothioconazole and Copper Oxychloride.

In some embodiments, the combination comprises polyphenol-based component, picoxystrobin, Prothioconazole and Copper Hydroxide.

In some embodiments, the combination comprises polyphenol-based component, picoxystrobin, Prothioconazole and Bordeaux mixture.

In some embodiments, the combination comprises polyphenol-based component, picoxystrobin, Prothioconazole and Fluazinam.

In some embodiments, the combination comprises polyphenol-based component, picoxystrobin, Prothioconazole and Captan.

In some embodiments, the combination comprises polyphenol-based component, picoxystrobin, Prothioconazole and Folpet.

In some embodiments, the combination comprises polyphenol-based component, picoxystrobin, Prothioconazole and Sulphur.

In some embodiments, the combination comprises polyphenol-based component, fluxapyroxad, Tebuconazole and Mancozeb.

In some embodiments, the combination comprises polyphenol-based component, fluxapyroxad, Tebuconazole and Copper Oxychloride.

In some embodiments, the combination comprises polyphenol-based component, fluxapyroxad, Tebuconazole and Copper Hydroxide.

In some embodiments, the combination comprises polyphenol-based component, fluxapyroxad, Tebuconazole and Bordeaux mixture.

In some embodiments, the combination comprises polyphenol-based component, fluxapyroxad, Tebuconazole and Fluazinam.

In some embodiments, the combination comprises polyphenol-based component, fluxapyroxad, Tebuconazole and Chlorothalonil.

In some embodiments, the combination comprises polyphenol-based component, fluxapyroxad, Tebuconazole and Captan.

In some embodiments, the combination comprises polyphenol-based component, fluxapyroxad, Tebuconazole and Folpet.

In some embodiments, the combination comprises polyphenol-based component, fluxapyroxad, Tebuconazole and Sulphur.

In some embodiments, the combination comprises polyphenol-based component, fluxapyroxad, Prothioconazole and Mancozeb.

In some embodiments, the combination comprises polyphenol-based component, fluxapyroxad, Prothioconazole and Copper Oxychloride.

In some embodiments, the combination comprises polyphenol-based component, fluxapyroxad, Prothioconazole and Copper Hydroxide.

In some embodiments, the combination comprises polyphenol-based component, fluxapyroxad, Prothioconazole and Bordeaux mixture.

In some embodiments, the combination comprises polyphenol-based component, fluxapyroxad, Prothioconazole and Fluazinam.

In some embodiments, the combination comprises polyphenol-based component, fluxapyroxad, Prothioconazole and Chlorothalonil.

In some embodiments, the combination comprises polyphenol-based component, fluxapyroxad, Prothioconazole and Captan.

In some embodiments, the combination comprises polyphenol-based component, fluxapyroxad, Prothioconazole and Folpet.

In some embodiments, the combination comprises polyphenol-based component, Fluxapyroxad, Prothioconazole and Sulphur.

In some embodiments, the combination comprises polyphenol-based component, picoxystrobin, Fenpropidin and Mancozeb.

In some embodiments, the combination comprises polyphenol-based component, picoxystrobin, Fenpropidin and Copper Oxychloride.

In some embodiments, the combination comprises polyphenol-based component, picoxystrobin, Fenpropidin and Copper Hydroxide.

In some embodiments, the combination comprises polyphenol-based component, picoxystrobin, Fenpropidin and Bordeaux Mixture.

In some embodiments, the combination comprises polyphenol-based component, picoxystrobin, Fenpropidin and Fluazinam.

In some embodiments, the combination comprises polyphenol-based component, picoxystrobin, Fenpropidin and Chlorothalonil.

In some embodiments, the combination comprises polyphenol-based component, picoxystrobin, Fenpropidin and Captan.

In some embodiments, the combination comprises polyphenol-based component, picoxystrobin, Fenpropidin and Folpet.

In some embodiments, the combination comprises polyphenol-based component, picoxystrobin, Fenpropidin and Sulphur.

In some embodiments, the combination comprises polyphenol-based component, Fluxapyroxad, Fenpropidin and Mancozeb.

In some embodiments, the combination comprises polyphenol-based component, Fluxapyroxad, Fenpropidin and Copper Oxychloride.

In some embodiments, the combination comprises polyphenol-based component, Fluxapyroxad, Fenpropidin and Copper Hydroxide.

In some embodiments, the combination comprises polyphenol-based component, Fluxapyroxad, Fenpropidin and Bordeaux mixture.

In some embodiments, the combination comprises polyphenol-based component, Fluxapyroxad, Fenpropidin and Fluazinam.

In some embodiments, the combination comprises polyphenol-based component, fenpropidin, Fluxapyroxad and Chlorothalonil.

In some embodiments, the combination comprises polyphenol-based component, Fluxapyroxad, Fenpropidin and Captan.

In some embodiments, the combination comprises polyphenol-based component, Fluxapyroxad Fenpropidin and Folpet.

In some embodiments, the combination comprises polyphenol-based component, Fluxapyroxad, Fenpropidin and Sulphur.

In some embodiments, the combination comprises polyphenol-based component, Prothioconazole, Fenpropidin and Mancozeb.

In some embodiments, the combination comprises polyphenol-based component, Prothioconazole, Fenpropidin and Copper Oxychloride.

In some embodiments, the combination comprises polyphenol-based component, Prothioconazole, Fenpropidin and Copper Hydroxide.

In some embodiments, the combination comprises polyphenol-based component, Prothioconazole, Fenpropidin and Bordeaux mixture.

In some embodiments, the combination comprises polyphenol-based component, Prothioconazole, Fenpropidin and Fluazinam.

In some embodiments, the combination comprises polyphenol-based component, Prothioconazole, Fenpropidin and Chlorothalonil.

In some embodiments, the combination comprises polyphenol-based component, Prothioconazole, Fenpropidin and Captan.

In some embodiments, the combination comprises polyphenol-based component, Prothioconazole, Fenpropidin and Folpet.

In some embodiments, the combination comprises polyphenol-based component, Prothioconazole, Fenpropidin and Sulphur.

In some embodiments, the combination comprises polyphenol-based component, Tebuconazole, Fenpropidin and Mancozeb.

In some embodiments, the combination comprises polyphenol-based component, Tebuconazole, Fenpropidin and Copper Oxychloride.

In some embodiments, the combination comprises polyphenol-based component, Tebuconazole, Fenpropidin and Copper Hydroxide.

In some embodiments, the combination comprises polyphenol-based component, Tebuconazole, Fenpropidin and Bordeaux mixture.

In some embodiments, the combination comprises polyphenol-based component, Tebuconazole, Fenpropidin and Fluazinam.

In some embodiments, the combination comprises polyphenol-based component, Tebuconazole, Fenpropidin and Chlorothalonil.

In some embodiments, the combination comprises polyphenol-based component, Tebuconazole, Fenpropidin and Captan.

In some embodiments, the combination comprises polyphenol-based component, Tebuconazole, Fenpropidin and Folpet.

In some embodiments, the combination comprises polyphenol-based component, Tebuconazole, Fenpropidin and Sulphur.

In some embodiments, the combination comprises polyphenol-based component, Azoxystrobin, Difenoconazole and Chlorothalonil.

In some embodiments, the combination comprises polyphenol-based component, cyproconazole, mancozeb and metyltetraprole.

In some embodiments, the combination comprises polyphenol-based component, cyproconazole, mancozeb and metyltetraprole.

In some embodiments, the combination comprises polyphenol-based component, mancozeb, Cyproconazole and metyltetraprole.

In some embodiments, the combination comprises polyphenol-based component, mancozeb, Cyproconazole and picoxystrobin.

In some embodiments, the combination comprises polyphenol-based component, mancozeb, Cyproconazole and Fluxapyroxad.

In some embodiments, the combination comprises polyphenol-based component, mancozeb, Cyproconazole and Azoxystrobin.

In some embodiments, the combination comprises polyphenol-based component, mancozeb, Cyproconazole and Trifloxystrobin.

In some embodiments, the combination comprises polyphenol-based component, mancozeb, Cyproconazole and Pyraclostrobin.

In some embodiments, the combination comprises polyphenol-based component, mancozeb, Cyproconazole and metominostrobin.

In some embodiments, the combination comprises polyphenol-based component, mancozeb, Cyproconazole and Bixafen.

In some embodiments, the combination comprises polyphenol-based component, mancozeb, Cyproconazole and Inpyrfluxam.

In some embodiments, the combination comprises polyphenol-based component, mancozeb, Cyproconazole and Fluindapyr.

In some embodiments, the combination comprises polyphenol-based component, mancozeb, Cyproconazole and benzovindiflupyr.

In some embodiments, the combination comprises polyphenol-based component, mancozeb, Cyproconazole and pydiflumetofen.

In some embodiments, the combination comprises polyphenol-based component, mancozeb, difenoconazole and metyltetraprole.

In some embodiments, the combination comprises polyphenol-based component, mancozeb, difenoconazole and picoxystrobin.

In some embodiments, the combination comprises polyphenol-based component, mancozeb, difenoconazole and Fluxapyroxad.

In some embodiments, the combination comprises polyphenol-based component, mancozeb, difenoconazole and Azoxystrobin.

In some embodiments, the combination comprises polyphenol-based component, mancozeb, difenoconazole and trifloxystrobin.

In some embodiments, the combination comprises polyphenol-based component, mancozeb, difenoconazole and pyraclostrobin.

In some embodiments, the combination comprises polyphenol-based component, mancozeb, difenoconazole and metominostrobin.

In some embodiments, the combination comprises polyphenol-based component, mancozeb, difenoconazole and Bixafen.

In some embodiments, the combination comprises polyphenol-based component, mancozeb, difenoconazole and inpyrfluxam.

In some embodiments, the combination comprises polyphenol-based component, mancozeb, difenoconazole and fluindapyr.

In some embodiments, the combination comprises polyphenol-based component, mancozeb, difenoconazole and benzovindiflupyr.

In some embodiments, the combination comprises polyphenol-based component, mancozeb, difenoconazole and pydiflumetofen.

In some embodiments, the combination comprises polyphenol-based component, mancozeb, difenoconazole and fenpicoxamid.

In some embodiments, the combination comprises polyphenol-based component, mancozeb, mefentrifluconazole and metyltetraprole.

In some embodiments, the combination comprises polyphenol-based component, mancozeb, mefentrifluconazole and picoxystrobin.

In some embodiments, the combination comprises polyphenol-based component, mancozeb, mefentrifluconazole and fluxapyroxad.

In some embodiments, the combination comprises polyphenol-based component, mancozeb, mefentrifluconazole and Azoxystrobin.

In some embodiments, the combination comprises polyphenol-based component, mancozeb, mefentrifluconazole and Trifloxystrobin.

In some embodiments, the combination comprises polyphenol-based component, mancozeb, mefentrifluconazole and Pyraclostrobin.

In some embodiments, the combination comprises polyphenol-based component, mancozeb, mefentrifluconazole and metominostrobin.

In some embodiments, the combination comprises polyphenol-based component, mancozeb, mefentrifluconazole and Bixafen.

In some embodiments, the combination comprises polyphenol-based component, mancozeb, mefentrifluconazole and Inpyrfluxam.

In some embodiments, the combination comprises polyphenol-based component, mancozeb, mefentrifluconazole and Fluindapyr.

In some embodiments, the combination comprises polyphenol-based component, mancozeb, mefentrifluconazole and benzovindiflupyr.

In some embodiments, the combination comprises polyphenol-based component, mancozeb, mefentrifluconazole and pydiflumetofen.

In some embodiments, the combination comprises polyphenol-based component, mancozeb, mefentrifluconazole and fenpicoxamid.

In some embodiments, the combination comprises polyphenol-based component, mancozeb, difenoconazole and fenpicoxamid.

In some embodiments, the combination comprises polyphenol-based component, mancozeb, mefentrifluconazole and metyltetraprole.

In some embodiments, the combination comprises polyphenol-based component, mancozeb, mefentrifluconazole and picoxystrobin.

In some embodiments, the combination comprises polyphenol-based component, mancozeb, mefentrifluconazole and Fluxapyroxad.

In some embodiments, the combination comprises polyphenol-based component, mancozeb, mefentrifluconazole and Azoxystrobin.

In some embodiments, the combination comprises polyphenol-based component, mancozeb, mefentrifluconazole and Trifloxystrobin.

In some embodiments, the combination comprises polyphenol-based component, mancozeb, mefentrifluconazole and Pyraclostrobin.

In some embodiments, the combination comprises polyphenol-based component, mancozeb, mefentrifluconazole and metominostrobin.

In some embodiments, the combination comprises polyphenol-based component, mancozeb, mefentrifluconazole and Bixafen.

In some embodiments, the combination comprises polyphenol-based component, mancozeb, mefentrifluconazole and Inpyrfluxam

In some embodiments, the combination comprises polyphenol-based component, mancozeb, mefentrifluconazole and Fluindapyr.

In some embodiments, the combination comprises polyphenol-based component, mancozeb, mefentrifluconazole and benzovindiflupyr.

In some embodiments, the combination comprises polyphenol-based component, mancozeb, mefentrifluconazole and pydiflumetofen.

In some embodiments, the combination comprises polyphenol-based component, mancozeb, mefentrifluconazole and fenpicoxamid.

In some embodiments, the combination comprises polyphenol-based component, mancozeb, prothioconazole and fenpicoxamid.

In some embodiments, the combination comprises polyphenol-based component, mancozeb, prothioconazole and metyltetraprole.

In some embodiments, the combination comprises polyphenol-based component, mancozeb, prothioconazole and picoxystrobin.

In some embodiments, the combination comprises polyphenol-based component, mancozeb, prothioconazole and Fluxapyroxad.

In some embodiments, the combination comprises polyphenol-based component, mancozeb, prothioconazole and Azoxystrobin.

In some embodiments, the combination comprises polyphenol-based component, mancozeb, prothioconazole and Trifloxystrobin.

In some embodiments, the combination comprises polyphenol-based component, mancozeb, prothioconazole and Pyraclostrobin.

In some embodiments, the combination comprises polyphenol-based component, mancozeb, prothioconazole and metominostrobin.

In some embodiments, the combination comprises polyphenol-based component, mancozeb, prothioconazole and Bixafen.

In some embodiments, the combination comprises polyphenol-based component, mancozeb, prothioconazole and Inpyrfluxam.

In some embodiments, the combination comprises polyphenol-based component, mancozeb, prothioconazole and Fluindapyr.

In some embodiments, the combination comprises polyphenol-based component, mancozeb, prothioconazole and benzovindiflupyr.

In some embodiments, the combination comprises polyphenol-based component, mancozeb, prothioconazole and pydiflumetofen.

In some embodiments, the combination comprises polyphenol-based component, mancozeb, prothioconazole and fenpicoxamid.

In some embodiments, the combination comprises polyphenol-based component, mancozeb, tebuconazole and fenpicoxamid.

In some embodiments, the combination comprises polyphenol-based component, mancozeb, prothioconazole and metyltetraprole.

In some embodiments, the combination comprises polyphenol-based component, mancozeb, tebuconazole and Fluxapyroxad.

In some embodiments, the combination comprises polyphenol-based component, mancozeb, prothioconazole and Fluxapyroxad.

In some embodiments, the combination comprises polyphenol-based component, mancozeb, tebuconazole and Azoxystrobin.

In some embodiments, the combination comprises polyphenol-based component, mancozeb, tebuconazole and Trifloxystrobin.

In some embodiments, the combination comprises polyphenol-based component, mancozeb, tebuconazole and Pyraclostrobin.

In some embodiments, the combination comprises polyphenol-based component, mancozeb, tebuconazole and metominostrobin.

In some embodiments, the combination comprises polyphenol-based component, mancozeb, tebuconazole and Bixafen.

In some embodiments, the combination comprises polyphenol-based component, mancozeb, tebuconazole and Inpyrfluxam.

In some embodiments, the combination comprises polyphenol-based component, mancozeb, tebuconazole and Fluindapyr.

In some embodiments, the combination comprises polyphenol-based component, mancozeb, tebuconazole and benzovindiflupyr.

In some embodiments, the combination comprises polyphenol-based component, mancozeb, prothioconazole and pydiflumetofen.

In some embodiments, the combination comprises polyphenol-based component, mancozeb, prothioconazole and fenpicoxamid.

In some embodiments, the combination comprises polyphenol-based component, mancozeb, tebuconazole and Mandestrobin.

In some embodiments, the combination comprises polyphenol-based component, mancozeb, tebuconazole and metyltetraprole

In some embodiments, the combination comprises polyphenol-based component, mancozeb, tebuconazole and pydiflumetofen.

In some embodiments, the combination comprises polyphenol-based component, cyproconazole, copper-based compound and metyltetraprole.

In some embodiments, the combination comprises polyphenol-based component, cyproconazole, copper-based compound and metyltetraprole.

In some embodiments, the combination comprises polyphenol-based component, copper-based fungicide, Cyproconazole and metyltetraprole.

In some embodiments, the combination comprises polyphenol-based component, copper-based fungicide, Cyproconazole and picoxystrobin.

In some embodiments, the combination comprises polyphenol-based component, copper-based fungicide, Cyproconazole and Fluxapyroxad.

In some embodiments, the combination comprises polyphenol-based component, copper-based fungicide, Cyproconazole and Azoxystrobin.

In some embodiments, the combination comprises polyphenol-based component, copper-based fungicide, Cyproconazole and Trifloxystrobin.

In some embodiments, the combination comprises polyphenol-based component, copper-based fungicide, Cyproconazole and Pyraclostrobin.

In some embodiments, the combination comprises polyphenol-based component, copper-based fungicide, Cyproconazole and metominostrobin.

In some embodiments, the combination comprises polyphenol-based component, copper-based fungicide, Cyproconazole and Bixafen.

In some embodiments, the combination comprises polyphenol-based component, copper-based fungicide, Cyproconazole and Inpyrfluxam.

In some embodiments, the combination comprises polyphenol-based component, copper-based fungicide, Cyproconazole and Fluindapyr.

In some embodiments, the combination comprises polyphenol-based component, copper-based fungicide, Cyproconazole and benzovindiflupyr

In some embodiments, the combination comprises polyphenol-based component, copper-based fungicide, Cyproconazole and pydiflumetofen.

In some embodiments, the combination comprises polyphenol-based component, copper-based fungicide, difenoconazole and metyltetraprole.

In some embodiments, the combination comprises polyphenol-based component, copper-based fungicide, difenoconazole and picoxystrobin.

In some embodiments, the combination comprises polyphenol-based component, copper-based fungicide, difenoconazole and Fluxapyroxad.

In some embodiments, the combination comprises polyphenol-based component, copper-based fungicide, difenoconazole and Azoxystrobin.

In some embodiments, the combination comprises polyphenol-based component, copper-based fungicide, difenoconazole and trifloxystrobin.

In some embodiments, the combination comprises polyphenol-based component, copper-based fungicide, difenoconazole and pyraclostrobin.

In some embodiments, the combination comprises polyphenol-based component, copper-based fungicide, difenoconazole and metominostrobin.

In some embodiments, the combination comprises polyphenol-based component, copper-based fungicide, difenoconazole and Bixafen.

In some embodiments, the combination comprises polyphenol-based component, copper-based fungicide, difenoconazole and inpyrfluxam.

In some embodiments, the combination comprises polyphenol-based component, copper-based fungicide, difenoconazole and fluindapyr.

In some embodiments, the combination comprises polyphenol-based component, copper-based fungicide, difenoconazole and benzovindiflupyr.

In some embodiments, the combination comprises polyphenol-based component, copper-based fungicide, difenoconazole and pydiflumetofen.

In some embodiments, the combination comprises polyphenol-based component, copper-based fungicide, difenoconazole and fenpicoxamid.

In some embodiments, the combination comprises polyphenol-based component, copper-based fungicide, mefentrifluconazole and metyltetraprole.

In some embodiments, the combination comprises polyphenol-based component, copper-based fungicide, mefentrifluconazole and picoxystrobin.

In some embodiments, the combination comprises polyphenol-based component, copper-based fungicide, mefentrifluconazole and fluxapyroxad.

In some embodiments, the combination comprises polyphenol-based component, copper-based fungicide, mefentrifluconazole and Azoxystrobin.

In some embodiments, the combination comprises polyphenol-based component, copper-based fungicide, mefentrifluconazole and Trifloxystrobin.

In some embodiments, the combination comprises polyphenol-based component, copper-based fungicide, mefentrifluconazole and Pyraclostrobin.

In some embodiments, the combination comprises polyphenol-based component, copper-based fungicide, mefentrifluconazole and metominostrobin.

In some embodiments, the combination comprises polyphenol-based component, copper-based fungicide, mefentrifluconazole and Bixafen.

In some embodiments, the combination comprises polyphenol-based component, copper-based fungicide, mefentrifluconazole and Inpyrfluxam.

In some embodiments, the combination comprises polyphenol-based component, copper-based fungicide, mefentrifluconazole and Fluindapyr.

In some embodiments, the combination comprises polyphenol-based component, copper-based fungicide, mefentrifluconazole and benzovindiflupyr.

In some embodiments, the combination comprises polyphenol-based component, copper-based fungicide, mefentrifluconazole and pydiflumetofen.

In some embodiments, the combination comprises polyphenol-based component, copper-based fungicide, mefentrifluconazole and fenpicoxamid.

In some embodiments, the combination comprises polyphenol-based component, copper-based fungicide, difenoconazole and fenpicoxamid.

In some embodiments, the combination comprises polyphenol-based component, copper-based fungicide, mefentrifluconazole and metyltetraprole.

In some embodiments, the combination comprises polyphenol-based component, copper-based fungicide, mefentrifluconazole and picoxystrobin.

In some embodiments, the combination comprises polyphenol-based component, copper-based fungicide, mefentrifluconazole and Fluxapyroxad.

In some embodiments, the combination comprises polyphenol-based component, copper-based fungicide, mefentrifluconazole and Azoxystrobin.

In some embodiments, the combination comprises polyphenol-based component, copper-based fungicide, mefentrifluconazole and Trifloxystrobin.

In some embodiments, the combination comprises polyphenol-based component, copper-based fungicide, mefentrifluconazole and Pyraclostrobin.

In some embodiments, the combination comprises is polyphenol-based component, copper-based fungicide, mefentrifluconazole and metominostrobin.

In some embodiments, the combination comprises polyphenol-based component, copper-based fungicide, mefentrifluconazole and Bixafen.

In some embodiments, the combination comprises polyphenol-based component, copper-based fungicide, mefentrifluconazole and Inpyrfluxam.

In some embodiments, the combination comprises polyphenol-based component, copper-based fungicide, mefentrifluconazole and Fluindapyr.

In some embodiments, the combination comprises polyphenol-based component, copper-based fungicide, mefentrifluconazole and benzovindiflupyr.

In some embodiments, the combination comprises polyphenol-based component, copper-based fungicide, mefentrifluconazole and pydiflumetofen.

In some embodiments, the combination comprises polyphenol-based component, copper-based fungicide, mefentrifluconazole and fenpicoxamid.

In some embodiments, the combination comprises polyphenol-based component, copper-based fungicide, prothioconazole and fenpicoxamid.

In some embodiments, the combination comprises polyphenol-based component, copper-based fungicide, prothioconazole and metyltetraprole.

In some embodiments, the combination comprises polyphenol-based component, copper-based fungicide, prothioconazole and picoxystrobin.

In some embodiments, the combination comprises polyphenol-based component, copper-based fungicide, prothioconazole and Fluxapyroxad.

In some embodiments, the combination comprises polyphenol-based component, copper-based fungicide, prothioconazole and Azoxystrobin.

In some embodiments, the combination comprises polyphenol-based component, copper-based fungicide, prothioconazole and Trifloxystrobin.

In some embodiments, the combination comprises polyphenol-based component, copper-based fungicide, prothioconazole and Pyraclostrobin.

In some embodiments, the combination comprises polyphenol-based component, copper-based fungicide, prothioconazole and metominostrobin.

In some embodiments, the combination comprises polyphenol-based component, copper-based fungicide, prothioconazole and Bixafen.

In some embodiments, the combination comprises polyphenol-based component, copper-based fungicide, prothioconazole and Inpyrfluxam.

In some embodiments, the combination comprises polyphenol-based component, copper-based fungicide, prothioconazole and Fluindapyr.

In some embodiments, the combination comprises polyphenol-based component, copper-based fungicide, prothioconazole and Benzodiflupyr (benzovindiflupyr).

In some embodiments, the combination comprises polyphenol-based component, copper-based fungicide, prothioconazole and pydiflumetofen.

In some embodiments, the combination comprises polyphenol-based component, copper-based fungicide, prothioconazole and fenpicoxamid.

In some embodiments, the combination comprises polyphenol-based component, copper-based fungicide, tebuconazole and picoxystrobin.

In some embodiments, the combination comprises polyphenol-based component, copper-based fungicide, tebuconazole and fenpicoxamid.

In some embodiments, the combination comprises polyphenol-based component, copper-based fungicide, prothioconazole and metyltetraprole.

In some embodiments, the combination comprises polyphenol-based component, copper-based fungicide, tebuconazole and picoxystrobin.

In some embodiments, the combination comprises polyphenol-based component, copper-based fungicide, tebuconazole and Fluxapyroxad.

In some embodiments, the combination comprises polyphenol-based component, copper-based fungicide, prothioconazole and Fluxapyroxad.

In some embodiments, the combination comprises polyphenol-based component, copper-based fungicide, tebuconazole and Azoxystrobin.

In some embodiments, the combination comprises polyphenol-based component, copper-based fungicide, tebuconazole and Trifloxystrobin.

In some embodiments, the combination comprises polyphenol-based component, copper-based fungicide, tebuconazole and Pyraclostrobin.

In some embodiments, the combination comprises polyphenol-based component, copper-based fungicide, tebuconazole and metominostrobin.

In some embodiments, the combination comprises polyphenol-based component, copper-based fungicide, tebuconazole and Bixafen.

In some embodiments, the combination comprises polyphenol-based component, copper-based fungicide, tebuconazole and Inpyrfluxam.

In some embodiments, the combination comprises polyphenol-based component, copper-based fungicide, tebuconazole and Fluindapyr.

In some embodiments, the combination comprises polyphenol-based component, copper-based fungicide, tebuconazole and benzovindiflupyr (benzovindiflupyr).

In some embodiments, the combination comprises polyphenol-based component, copper-based fungicide, prothioconazole and pydiflumetofen.

In some embodiments, the combination comprises polyphenol-based component, copper-based fungicide, prothioconazole and fenpicoxamid.

In some embodiments, the combination comprises polyphenol-based component, copper-based fungicide, tebuconazole and Mandestrobin.

In some embodiments, the combination comprises polyphenol-based component, copper-based fungicide, tebuconazole and metyltetraprole.

In some embodiments, the combination comprises polyphenol-based component, copper-based fungicide, tebuconazole and pydiflumetofen.

As extended illustrations of the range of possible combinations within the scope of the invention, Tables 1 and 2 below outline some, though clearly not all, combinations that were specifically and individually contemplated by the inventors. Clearly, other combinations are not excluded from the scope simply by their absence from the following illustrative table. Each line in the table represents individual independent embodiments of the invention. While Table 1, provides some exemplified specific combination embodiments (each row is a separate and independently claimed embodiment), Table 2, presents a matrix allowing for multiple selections of compounds for each embodiment. In each table, a blank cell indicates the absence of the ingredient class in that specific embodiment.

TABLE 1
Illustrative Embodiments #9

| Component | Component | | | | | |
|---|---|---|---|---|---|---|
| (1) | (3) | | COMPONENT (2) Fungicide (A) | | | |
| Polyphenol | Copper | Protectant | Azole | Strobilurin | SDHI | Morpholine |
| Polyphenol | Copper | Fluazinam | | azoxystrobin | Adepidyn | Fenpropidin |
| Polyphenol | Copper | Fluazinam | | azoxystrobin | benzovindiflupyr | Fenpropidin |
| Polyphenol | Copper | Fluazinam | | azoxystrobin | bixafen | Fenpropidin |
| Polyphenol | Copper | Fluazinam | | azoxystrobin | Fluindapyr | Fenpropidin |
| Polyphenol | Copper | Fluazinam | | azoxystrobin | fluxapyroxad | Fenpropidin |
| Polyphenol | Copper | Fluazinam | | azoxystrobin | Inpyrfluxam | Fenpropidin |
| Polyphenol | Copper | Fluazinam | | azoxystrobin | Adepidyn | Fenpropimorph |
| Polyphenol | Copper | Fluazinam | | azoxystrobin | benzovindiflupyr | Fenpropimorph |
| Polyphenol | Copper | Fluazinam | | azoxystrobin | bixafen | Fenpropimorph |
| Polyphenol | Copper | Fluazinam | | azoxystrobin | Fluindapyr | Fenpropimorph |
| Polyphenol | Copper | Fluazinam | | azoxystrobin | fluxapyroxad | Fenpropimorph |
| Polyphenol | Copper | Fluazinam | | azoxystrobin | Inpyrfluxam | Fenpropimorph |
| Polyphenol | Copper | Fluazinam | | azoxystrobin | Adepidyn | |
| Polyphenol | Copper | Fluazinam | | azoxystrobin | benzovindiflupyr | |
| Polyphenol | Copper | Fluazinam | | azoxystrobin | bixafen | |
| Polyphenol | Copper | Fluazinam | | azoxystrobin | Fluindapyr | |
| Polyphenol | Copper | Fluazinam | | azoxystrobin | fluxapyroxad | |
| Polyphenol | Copper | Fluazinam | | azoxystrobin | Inpyrfluxam | |
| Polyphenol | Copper | Fluazinam | cyproconazole | azoxystrobin | | |
| Polyphenol | Copper | Fluazinam | difenoconazole | azoxystrobin | | |
| Polyphenol | Copper | Fluazinam | flutriafol | azoxystrobin | | |
| Polyphenol | Copper | Fluazinam | mefentrifluconazole | azoxystrobin | | |
| Polyphenol | Copper | Fluazinam | prothioconazole | azoxystrobin | | |
| Polyphenol | Copper | Fluazinam | tebuconazole | azoxystrobin | | |
| Polyphenol | Copper | Fluazinam | tetraconazole | azoxystrobin | | |
| Polyphenol | Copper | Fluazinam | | Mandestrobin | Adepidyn | fenpropidin |
| Polyphenol | Copper | Fluazinam | | Mandestrobin | benzovindiflupyr | fenpropidin |
| Polyphenol | Copper | Fluazinam | | Mandestrobin | bixafen | fenpropidin |
| Polyphenol | Copper | Fluazinam | | Mandestrobin | Fluindapyr | fenpropidin |
| Polyphenol | Copper | Fluazinam | | Mandestrobin | fluxapyroxad | fenpropidin |
| Polyphenol | Copper | Fluazinam | | Mandestrobin | Inpyrfluxam | fenpropidin |
| Polyphenol | Copper | Fluazinam | | Mandestrobin | Adepidyn | Fenpropimorph |
| Polyphenol | Copper | Fluazinam | | Mandestrobin | benzovindiflupyr | Fenpropimorph |
| Polyphenol | Copper | Fluazinam | | Mandestrobin | bixafen | Fenpropimorph |
| Polyphenol | Copper | Fluazinam | | Mandestrobin | Fluindapyr | Fenpropimorph |
| Polyphenol | Copper | Fluazinam | | Mandestrobin | fluxapyroxad | Fenpropimorph |
| Polyphenol | Copper | Fluazinam | | Mandestrobin | Inpyrfluxam | Fenpropimorph |
| Polyphenol | Copper | Fluazinam | | Mandestrobin | | Fenpropimorph |
| Polyphenol | Copper | Fluazinam | | Mandestrobin | | Fenpropidin |
| Polyphenol | Copper | Fluazinam | | Mandestrobin | Adepidyn | |
| Polyphenol | Copper | Fluazinam | | Mandestrobin | benzovindiflupyr | |
| Polyphenol | Copper | Fluazinam | | Mandestrobin | bixafen | |
| Polyphenol | Copper | Fluazinam | | Mandestrobin | Fluindapyr | |
| Polyphenol | Copper | Fluazinam | | Mandestrobin | fluxapyroxad | |
| Polyphenol | Copper | Fluazinam | | Mandestrobin | Inpyrfluxam | |
| Polyphenol | Copper | Fluazinam | cyproconazole | Mandestrobin | | |
| Polyphenol | Copper | Fluazinam | difenoconazole | Mandestrobin | | |
| Polyphenol | Copper | Fluazinam | flutriafol | Mandestrobin | | |
| Polyphenol | Copper | Fluazinam | mefentrifluconazole | Mandestrobin | | |
| Polyphenol | Copper | Fluazinam | prothioconazole | Mandestrobin | | |
| Polyphenol | Copper | Fluazinam | tebuconazole | Mandestrobin | | |
| Polyphenol | Copper | Fluazinam | tetraconazole | Mandestrobin | | |
| Polyphenol | Copper | Fluazinam | | Metyltetraprole | Adepidyn | fenpropidin |
| Polyphenol | Copper | Fluazinam | | Metyltetraprole | benzovindiflupyr | fenpropidin |
| Polyphenol | Copper | Fluazinam | | Metyltetraprole | bixafen | fenpropidin |
| Polyphenol | Copper | Fluazinam | | Metyltetraprole | Fluindapyr | fenpropidin |
| Polyphenol | Copper | Fluazinam | | Metyltetraprole | fluxapyroxad | fenpropidin |
| Polyphenol | Copper | Fluazinam | | Metyltetraprole | Inpyrfluxam | fenpropidin |
| Polyphenol | Copper | Fluazinam | | Metyltetraprole | Adepidyn | Fenpropimorph |
| Polyphenol | Copper | Fluazinam | | Metyltetraprole | benzovindiflupyr | Fenpropimorph |
| Polyphenol | Copper | Fluazinam | | Metyltetraprole | bixafen | Fenpropimorph |
| Polyphenol | Copper | Fluazinam | | Metyltetraprole | Fluindapyr | Fenpropimorph |
| Polyphenol | Copper | Fluazinam | | Metyltetraprole | fluxapyroxad | Fenpropimorph |
| Polyphenol | Copper | Fluazinam | | Metyltetraprole | Inpyrfluxam | Fenpropimorph |
| Polyphenol | Copper | Fluazinam | | Metyltetraprole | | Fenpropimorph |
| Polyphenol | Copper | Fluazinam | | Metyltetraprole | | Fenpropidin |
| Polyphenol | Copper | Fluazinam | | Metyltetraprole | Adepidyn | |
| Polyphenol | Copper | Fluazinam | | Metyltetraprole | benzovindiflupyr | |
| Polyphenol | Copper | Fluazinam | | Metyltetraprole | bixafen | |
| Polyphenol | Copper | Fluazinam | | Metyltetraprole | Fluindapyr | |
| Polyphenol | Copper | Fluazinam | | Metyltetraprole | fluxapyroxad | |
| Polyphenol | Copper | Fluazinam | | Metyltetraprole | Inpyrfluxam | |
| Polyphenol | Copper | Fluazinam | cyproconazole | Metyltetraprole | | |
| Polyphenol | Copper | Fluazinam | difenoconazole | Metyltetraprole | | |
| Polyphenol | Copper | Fluazinam | flutriafol | Metyltetraprole | | |
| Polyphenol | Copper | Fluazinam | mefentrifluconazole | Metyltetraprole | | |
| Polyphenol | Copper | Fluazinam | prothioconazole | Metyltetraprole | | |
| Polyphenol | Copper | Fluazinam | tebuconazole | Metyltetraprole | | |
| Polyphenol | Copper | Fluazinam | tetraconazole | Metyltetraprole | | |
| Polyphenol | Copper | Fluazinam | | metominostrobin | Adepidyn | fenpropidin |
| Polyphenol | Copper | Fluazinam | | metominostrobin | benzovindiflupyr | fenpropidin |
| Polyphenol | Copper | Fluazinam | | metominostrobin | Bixafen | fenpropidin |
| Polyphenol | Copper | Fluazinam | | metominostrobin | Fluindapyr | fenpropidin |
| Polyphenol | Copper | Fluazinam | | metominostrobin | fluxapyroxad | fenpropidin |
| Polyphenol | Copper | Fluazinam | | metominostrobin | Inpyrfluxam | fenpropidin |
| Polyphenol | Copper | Fluazinam | | metominostrobin | Adepidyn | Fenpropimorph |
| Polyphenol | Copper | Fluazinam | | metominostrobin | benzovindiflupyr | Fenpropimorph |
| Polyphenol | Copper | Fluazinam | | metominostrobin | Bixafen | Fenpropimorph |
| Polyphenol | Copper | Fluazinam | | metominostrobin | Fluindapyr | Fenpropimorph |
| Polyphenol | Copper | Fluazinam | | metominostrobin | fluxapyroxad | Fenpropimorph |
| Polyphenol | Copper | Fluazinam | | metominostrobin | Inpyrfluxam | Fenpropimorph |
| Polyphenol | Copper | Fluazinam | | metominostrobin | | Fenpropimorph |
| Polyphenol | Copper | Fluazinam | | metominostrobin | | Fenpropidin |
| Polyphenol | Copper | Fluazinam | | metominostrobin | Adepidyn | |
| Polyphenol | Copper | Fluazinam | | metominostrobin | benzovindiflupyr | |
| Polyphenol | Copper | Fluazinam | | metominostrobin | bixafen | |
| Polyphenol | Copper | Fluazinam | | metominostrobin | Fluindapyr | |
| Polyphenol | Copper | Fluazinam | | metominostrobin | fluxapyroxad | |
| Polyphenol | Copper | Fluazinam | | metominostrobin | Inpyrfluxam | |
| Polyphenol | Copper | Fluazinam | cyproconazole | metominostrobin | | |
| Polyphenol | Copper | Fluazinam | difenoconazole | metominostrobin | | |
| Polyphenol | Copper | Fluazinam | flutriafol | metominostrobin | | |
| Polyphenol | Copper | Fluazinam | mefentrifluconazole | metominostrobin | | |
| Polyphenol | Copper | Fluazinam | prothioconazole | metominostrobin | | |
| Polyphenol | Copper | Fluazinam | tebuconazole | metominostrobin | | |
| Polyphenol | Copper | Fluazinam | tetraconazole | metominostrobin | | |
| Polyphenol | Copper | Fluazinam | | picoxystrobin | Adepidyn | Fenpropidin |
| Polyphenol | Copper | Fluazinam | | picoxystrobin | benzovindiflupyr | Fenpropidin |
| Polyphenol | Copper | Fluazinam | | picoxystrobin | bixafen | Fenpropidin |
| Polyphenol | Copper | Fluazinam | | picoxystrobin | Fluindapyr | Fenpropidin |
| Polyphenol | Copper | Fluazinam | | picoxystrobin | fluxapyroxad | Fenpropidin |
| Polyphenol | Copper | Fluazinam | | picoxystrobin | Inpyrfluxam | Fenpropidin |
| Polyphenol | Copper | Fluazinam | | picoxystrobin | Adepidyn | Fenpropimorph |
| Polyphenol | Copper | Fluazinam | | picoxystrobin | benzovindiflupyr | Fenpropimorph |
| Polyphenol | Copper | Fluazinam | | picoxystrobin | bixafen | Fenpropimorph |
| Polyphenol | Copper | Fluazinam | | picoxystrobin | Fluindapyr | Fenpropimorph |
| Polyphenol | Copper | Fluazinam | | picoxystrobin | fluxapyroxad | Fenpropimorph |
| Polyphenol | Copper | Fluazinam | | picoxystrobin | Inpyrfluxam | Fenpropimorph |
| Polyphenol | Copper | Fluazinam | | picoxystrobin | | Fenpropimorph |
| Polyphenol | Copper | Fluazinam | | picoxystrobin | | Fenpropidin |
| Polyphenol | Copper | Fluazinam | | picoxystrobin | Adepidyn | |
| Polyphenol | Copper | Fluazinam | | picoxystrobin | benzovindiflupyr | |
| Polyphenol | Copper | Fluazinam | | picoxystrobin | Bixafen | |
| Polyphenol | Copper | Fluazinam | | picoxystrobin | Fluindapyr | |
| Polyphenol | Copper | Fluazinam | | picoxystrobin | fluxapyroxad | |
| Polyphenol | Copper | Fluazinam | | picoxystrobin | Inpyrfluxam | |
| Polyphenol | Copper | Fluazinam | cyproconazole | picoxystrobin | | |
| Polyphenol | Copper | Fluazinam | difenoconazole | picoxystrobin | | |
| Polyphenol | Copper | Fluazinam | flutriafol | picoxystrobin | | |
| Polyphenol | Copper | Fluazinam | mefentrifluconazole | picoxystrobin | | |
| Polyphenol | Copper | Fluazinam | prothioconazole | picoxystrobin | | |
| Polyphenol | Copper | Fluazinam | tebuconazole | picoxystrobin | | |
| Polyphenol | Copper | Fluazinam | tetraconazole | picoxystrobin | | |
| Polyphenol | Copper | Fluazinam | | Pyraclostrobin | Adepidyn | fenpropidin |
| Polyphenol | Copper | Fluazinam | | Pyraclostrobin | benzovindiflupyr | fenpropidin |
| Polyphenol | Copper | Fluazinam | | Pyraclostrobin | bixafen | fenpropidin |
| Polyphenol | Copper | Fluazinam | | Pyraclostrobin | Fluindapyr | fenpropidin |
| Polyphenol | Copper | Fluazinam | | Pyraclostrobin | fluxapyroxad | fenpropidin |
| Polyphenol | Copper | Fluazinam | | Pyraclostrobin | Inpyrfluxam | fenpropidin |
| Polyphenol | Copper | Fluazinam | | Pyraclostrobin | Adepidyn | Fenpropimorph |
| Polyphenol | Copper | Fluazinam | | Pyraclostrobin | benzovindiflupyr | Fenpropimorph |
| Polyphenol | Copper | Fluazinam | | Pyraclostrobin | bixafen | Fenpropimorph |
| Polyphenol | Copper | Fluazinam | | Pyraclostrobin | Fluindapyr | Fenpropimorph |
| Polyphenol | Copper | Fluazinam | | Pyraclostrobin | fluxapyroxad | Fenpropimorph |
| Polyphenol | Copper | Fluazinam | | Pyraclostrobin | Inpyrfluxam | Fenpropimorph |
| Polyphenol | Copper | Fluazinam | | Pyraclostrobin | | Fenpropimorph |
| Polyphenol | Copper | Fluazinam | | Pyraclostrobin | | Fenpropidin |
| Polyphenol | Copper | Fluazinam | | Pyraclostrobin | Adepidyn | |
| Polyphenol | Copper | Fluazinam | | Pyraclostrobin | benzovindiflupyr | |
| Polyphenol | Copper | Fluazinam | | Pyraclostrobin | bixafen | |
| Polyphenol | Copper | Fluazinam | | Pyraclostrobin | Fluindapyr | |
| Polyphenol | Copper | Fluazinam | | Pyraclostrobin | fluxapyroxad | |
| Polyphenol | Copper | Fluazinam | | Pyraclostrobin | Inpyrfluxam | |
| Polyphenol | Copper | Fluazinam | cyproconazole | Pyraclostrobin | | |
| Polyphenol | Copper | Fluazinam | difenoconazole | Pyraclostrobin | | |
| Polyphenol | Copper | Fluazinam | flutriafol | Pyraclostrobin | | |
| Polyphenol | Copper | Fluazinam | mefentrifluconazole | Pyraclostrobin | | |
| Polyphenol | Copper | Fluazinam | prothioconazole | Pyraclostrobin | | |
| Polyphenol | Copper | Fluazinam | tebuconazole | Pyraclostrobin | | |
| Polyphenol | Copper | Fluazinam | tetraconazole | Pyraclostrobin | | |
| Polyphenol | Copper | Fluazinam | | trifloxystrobin | Adepidyn | fenpropidin |
| Polyphenol | Copper | Fluazinam | | trifloxystrobin | benzovindiflupyr | fenpropidin |
| Polyphenol | Copper | Fluazinam | | trifloxystrobin | bixafen | fenpropidin |
| Polyphenol | Copper | Fluazinam | | trifloxystrobin | Fluindapyr | fenpropidin |
| Polyphenol | Copper | Fluazinam | | trifloxystrobin | fluxapyroxad | fenpropidin |
| Polyphenol | Copper | Fluazinam | | trifloxystrobin | Inpyrfluxam | fenpropidin |
| Polyphenol | Copper | Fluazinam | | trifloxystrobin | Adepidyn | Fenpropimorph |
| Polyphenol | Copper | Fluazinam | | trifloxystrobin | benzovindiflupyr | Fenpropimorph |
| Polyphenol | Copper | Fluazinam | | trifloxystrobin | bixafen | Fenpropimorph |
| Polyphenol | Copper | Fluazinam | | trifloxystrobin | Fluindapyr | Fenpropimorph |
| Polyphenol | Copper | Fluazinam | | trifloxystrobin | fluxapyroxad | Fenpropimorph |
| Polyphenol | Copper | Fluazinam | | trifloxystrobin | Inpyrfluxam | Fenpropimorph |
| Polyphenol | Copper | Fluazinam | | trifloxystrobin | | Fenpropimorph |
| Polyphenol | Copper | Fluazinam | | trifloxystrobin | | Fenpropidin |
| Polyphenol | Copper | Fluazinam | | trifloxystrobin | Adepidyn | |
| Polyphenol | Copper | Fluazinam | | trifloxystrobin | benzovindiflupyr | |
| Polyphenol | Copper | Fluazinam | | trifloxystrobin | bixafen | |
| Polyphenol | Copper | Fluazinam | | trifloxystrobin | Fluindapyr | |
| Polyphenol | Copper | Fluazinam | | trifloxystrobin | fluxapyroxad | |
| Polyphenol | Copper | Fluazinam | | trifloxystrobin | Inpyrfluxam | |
| Polyphenol | Copper | Fluazinam | cyproconazole | trifloxystrobin | | |
| Polyphenol | Copper | Fluazinam | difenoconazole | trifloxystrobin | | |
| Polyphenol | Copper | Fluazinam | flutriafol | trifloxystrobin | | |
| Polyphenol | Copper | Fluazinam | mefentrifluconazole | trifloxystrobin | | |
| Polyphenol | Copper | Fluazinam | prothioconazole | trifloxystrobin | | |
| Polyphenol | Copper | Fluazinam | tebuconazole | trifloxystrobin | | |
| Polyphenol | Copper | Fluazinam | tetraconazole | trifloxystrobin | | |
| Polyphenol | Copper | Fluazinam | cyproconazole | | | Fenpropidin |
| Polyphenol | Copper | Fluazinam | difenoconazole | | | Fenpropidin |
| Polyphenol | Copper | Fluazinam | flutriafol | | | Fenpropidin |
| Polyphenol | Copper | Fluazinam | mefentrifluconazole | | | Fenpropidin |
| Polyphenol | Copper | Fluazinam | prothioconazole | | | Fenpropidin |
| Polyphenol | Copper | Fluazinam | tebuconazole | | | Fenpropidin |
| Polyphenol | Copper | Fluazinam | tetraconazole | | | Fenpropidin |
| Polyphenol | Copper | Fluazinam | cyproconazole | | | Fenpropimorph |
| Polyphenol | Copper | Fluazinam | difenoconazole | | | Fenpropimorph |
| Polyphenol | Copper | Fluazinam | flutriafol | | | Fenpropimorph |
| Polyphenol | Copper | Fluazinam | mefentrifluconazole | | | Fenpropimorph |
| Polyphenol | Copper | Fluazinam | prothioconazole | | | Fenpropimorph |
| Polyphenol | Copper | Fluazinam | tebuconazole | | | Fenpropimorph |
| Polyphenol | Copper | Fluazinam | tetraconazole | | | Fenpropimorph |
| Polyphenol | Copper | Fluazinam | | | Adepidyn | Fenpropimorph |
| Polyphenol | Copper | Fluazinam | | | benzovindiflupyr | Fenpropimorph |
| Polyphenol | Copper | Fluazinam | | | bixafen | Fenpropimorph |
| Polyphenol | Copper | Fluazinam | | | Fluindapyr | Fenpropimorph |
| Polyphenol | Copper | Fluazinam | | | fluxapyroxad | Fenpropimorph |
| Polyphenol | Copper | Fluazinam | | | Inpyrfluxam | Fenpropimorph |
| Polyphenol | Copper | Fluazinam | | | Adepidyn | Fenpropidin |
| Polyphenol | Copper | Fluazinam | | | benzovindiflupyr | Fenpropidin |
| Polyphenol | Copper | Fluazinam | | | bixafen | Fenpropidin |
| Polyphenol | Copper | Fluazinam | | | Fluindapyr | Fenpropidin |
| Polyphenol | Copper | Fluazinam | | | fluxapyroxad | Fenpropidin |
| Polyphenol | Copper | Fluazinam | | | Inpyrfluxam | Fenpropidin |
| Polyphenol | Copper | Fluazinam | cyproconazole | | Adepidyn | |
| Polyphenol | Copper | Fluazinam | difenoconazole | | Adepidyn | |
| Polyphenol | Copper | Fluazinam | flutriafol | | Adepidyn | |
| Polyphenol | Copper | Fluazinam | flutriafol | | Adepidyn | |
| Polyphenol | Copper | Fluazinam | flutriafol | | Adepidyn | |
| Polyphenol | Copper | Fluazinam | mefentrifluconazole | | Adepidyn | |
| Polyphenol | Copper | Fluazinam | prothioconazole | | Adepidyn | |
| Polyphenol | Copper | Fluazinam | tebuconazole | | Adepidyn | |
| Polyphenol | Copper | Fluazinam | tetraconazole | | Adepidyn | |
| Polyphenol | Copper | Fluazinam | cyproconazole | | benzovindiflupyr | |
| Polyphenol | Copper | Fluazinam | difenoconazole | | benzovindiflupyr | |
| Polyphenol | Copper | Fluazinam | flutriafol | | benzovindiflupyr | |
| Polyphenol | Copper | Fluazinam | mefentrifluconazole | | benzovindiflupyr | |
| Polyphenol | Copper | Fluazinam | prothioconazole | | benzovindiflupyr | |
| Polyphenol | Copper | Fluazinam | tebuconazole | | benzovindiflupyr | |
| Polyphenol | Copper | Fluazinam | tetraconazole | | benzovindiflupyr | |
| Polyphenol | Copper | Fluazinam | cyproconazole | | bixafen | |
| Polyphenol | Copper | Fluazinam | difenoconazole | | bixafen | |
| Polyphenol | Copper | Fluazinam | flutriafol | | bixafen | |
| Polyphenol | Copper | Fluazinam | mefentrifluconazole | | bixafen | |
| Polyphenol | Copper | Fluazinam | prothioconazole | | bixafen | |
| Polyphenol | Copper | Fluazinam | tebuconazole | | bixafen | |
| Polyphenol | Copper | Fluazinam | tetraconazole | | bixafen | |
| Polyphenol | Copper | Fluazinam | cyproconazole | | Fluindapyr | |
| Polyphenol | Copper | Fluazinam | difenoconazole | | Fluindapyr | |
| Polyphenol | Copper | Fluazinam | mefentrifluconazole | | Fluindapyr | |
| Polyphenol | Copper | Fluazinam | prothioconazole | | Fluindapyr | |
| Polyphenol | Copper | Fluazinam | tebuconazole | | Fluindapyr | |
| Polyphenol | Copper | Fluazinam | tetraconazole | | Fluindapyr | |
| Polyphenol | Copper | Fluazinam | cyproconazole | | fluxapyroxad | |
| Polyphenol | Copper | Fluazinam | difenoconazole | | fluxapyroxad | |
| Polyphenol | Copper | Fluazinam | flutriafol | | fluxapyroxad | |
| Polyphenol | Copper | Fluazinam | mefentrifluconazole | | fluxapyroxad | |
| Polyphenol | Copper | Fluazinam | prothioconazole | | fluxapyroxad | |
| Polyphenol | Copper | Fluazinam | tebuconazole | | fluxapyroxad | |
| Polyphenol | Copper | Fluazinam | tetraconazole | | fluxapyroxad | |
| Polyphenol | Copper | Fluazinam | cyproconazole | | Inpyrfluxam | |
| Polyphenol | Copper | Fluazinam | difenoconazole | | Inpyrfluxam | |
| Polyphenol | Copper | Fluazinam | flutriafol | | Inpyrfluxam | |
| Polyphenol | Copper | Fluazinam | mefentrifluconazole | | Inpyrfluxam | |
| Polyphenol | Copper | Fluazinam | prothioconazole | | Inpyrfluxam | |
| Polyphenol | Copper | Fluazinam | tebuconazole | | Inpyrfluxam | |
| Polyphenol | Copper | Fluazinam | tetraconazole | | Inpyrfluxam | |
| Polyphenol | | Fluazinam | | azoxystrobin | Adepidyn | Fenpropidin |
| Polyphenol | | Fluazinam | | azoxystrobin | benzovindiflupyr | Fenpropidin |
| Polyphenol | | Fluazinam | | azoxystrobin | bixafen | Fenpropidin |
| Polyphenol | | Fluazinam | | azoxystrobin | Fluindapyr | Fenpropidin |
| Polyphenol | | Fluazinam | | azoxystrobin | fluxapyroxad | Fenpropidin |
| Polyphenol | | Fluazinam | | azoxystrobin | Inpyrfluxam | Fenpropidin |
| Polyphenol | | Fluazinam | | azoxystrobin | Adepidyn | Fenpropimorph |
| Polyphenol | | Fluazinam | | azoxystrobin | benzovindiflupyr | Fenpropimorph |
| Polyphenol | | Fluazinam | | azoxystrobin | bixafen | Fenpropimorph |
| Polyphenol | | Fluazinam | | azoxystrobin | Fluindapyr | Fenpropimorph |
| Polyphenol | | Fluazinam | | azoxystrobin | fluxapyroxad | Fenpropimorph |
| Polyphenol | | Fluazinam | | azoxystrobin | Inpyrfluxam | Fenpropimorph |
| Polyphenol | | Fluazinam | | azoxystrobin | Adepidyn | |
| Polyphenol | | Fluazinam | | azoxystrobin | benzovindiflupyr | |
| Polyphenol | | Fluazinam | | azoxystrobin | Bixafen | |
| Polyphenol | | Fluazinam | | azoxystrobin | Fluindapyr | |
| Polyphenol | | Fluazinam | | azoxystrobin | fluxapyroxad | |
| Polyphenol | | Fluazinam | | azoxystrobin | Inpyrfluxam | |
| Polyphenol | | Fluazinam | cyproconazole | azoxystrobin | | |
| Polyphenol | | Fluazinam | difenoconazole | azoxystrobin | | |
| Polyphenol | | Fluazinam | flutriafol | azoxystrobin | | |
| Polyphenol | | Fluazinam | mefentrifluconazole | azoxystrobin | | |
| Polyphenol | | Fluazinam | prothioconazole | azoxystrobin | | |
| Polyphenol | | Fluazinam | tebuconazole | azoxystrobin | | |
| Polyphenol | | Fluazinam | tetraconazole | azoxystrobin | | |
| Polyphenol | | Fluazinam | | Mandestrobin | Adepidyn | fenpropidin |
| Polyphenol | | Fluazinam | | Mandestrobin | benzovindiflupyr | fenpropidin |
| Polyphenol | | Fluazinam | | Mandestrobin | bixafen | fenpropidin |
| Polyphenol | | Fluazinam | | Mandestrobin | Fluindapyr | fenpropidin |
| Polyphenol | | Fluazinam | | Mandestrobin | fluxapyroxad | fenpropidin |
| Polyphenol | | Fluazinam | | Mandestrobin | Inpyrfluxam | fenpropidin |
| Polyphenol | | Fluazinam | | Mandestrobin | Adepidyn | Fenpropimorph |
| Polyphenol | | Fluazinam | | Mandestrobin | benzovindiflupyr | Fenpropimorph |
| Polyphenol | | Fluazinam | | Mandestrobin | bixafen | Fenpropimorph |
| Polyphenol | | Fluazinam | | Mandestrobin | Fluindapyr | Fenpropimorph |
| Polyphenol | | Fluazinam | | Mandestrobin | fluxapyroxad | Fenpropimorph |
| Polyphenol | | Fluazinam | | Mandestrobin | Inpyrfluxam | Fenpropimorph |
| Polyphenol | | Fluazinam | | Mandestrobin | | Fenpropimorph |
| Polyphenol | | Fluazinam | | Mandestrobin | | Fenpropidin |
| Polyphenol | | Fluazinam | | Mandestrobin | Adepidyn | |
| Polyphenol | | Fluazinam | | Mandestrobin | benzovindiflupyr | |
| Polyphenol | | Fluazinam | | Mandestrobin | bixafen | |
| Polyphenol | | Fluazinam | | Mandestrobin | Fluindapyr | |
| Polyphenol | | Fluazinam | | Mandestrobin | fluxapyroxad | |
| Polyphenol | | Fluazinam | | Mandestrobin | Inpyrfluxam | |
| Polyphenol | | Fluazinam | cyproconazole | Mandestrobin | | |
| Polyphenol | | Fluazinam | difenoconazole | Mandestrobin | | |
| Polyphenol | | Fluazinam | flutriafol | Mandestrobin | | |
| Polyphenol | | Fluazinam | mefentrifluconazole | Mandestrobin | | |
| Polyphenol | | Fluazinam | prothioconazole | Mandestrobin | | |
| Polyphenol | | Fluazinam | tebuconazole | Mandestrobin | | |
| Polyphenol | | Fluazinam | tetraconazole | Mandestrobin | | |
| Polyphenol | | Fluazinam | | Metyltetraprole | Adepidyn | fenpropidin |
| Polyphenol | | Fluazinam | | Metyltetraprole | benzovindiflupyr | fenpropidin |
| Polyphenol | | Fluazinam | | Metyltetraprole | bixafen | fenpropidin |
| Polyphenol | | Fluazinam | | Metyltetraprole | Fluindapyr | fenpropidin |
| Polyphenol | | Fluazinam | | Metyltetraprole | fluxapyroxad | fenpropidin |
| Polyphenol | | Fluazinam | | Metyltetraprole | Inpyrfluxam | fenpropidin |
| Polyphenol | | Fluazinam | | Metyltetraprole | Adepidyn | Fenpropimorph |
| Polyphenol | | Fluazinam | | Metyltetraprole | benzovindiflupyr | Fenpropimorph |
| Polyphenol | | Fluazinam | | Metyltetraprole | bixafen | Fenpropimorph |
| Polyphenol | | Fluazinam | | Metyltetraprole | Fluindapyr | Fenpropimorph |
| Polyphenol | | Fluazinam | | Metyltetraprole | fluxapyroxad | Fenpropimorph |
| Polyphenol | | Fluazinam | | Metyltetraprole | Inpyrfluxam | Fenpropimorph |
| Polyphenol | | Fluazinam | | Metyltetraprole | | Fenpropimorph |
| Polyphenol | | Fluazinam | | Metyltetraprole | | Fenpropidin |
| Polyphenol | | Fluazinam | | Metyltetraprole | Adepidyn | |
| Polyphenol | | Fluazinam | | Metyltetraprole | benzovindiflupyr | |
| Polyphenol | | Fluazinam | | Metyltetraprole | bixafen | |
| Polyphenol | | Fluazinam | | Metyltetraprole | Fluindapyr | |
| Polyphenol | | Fluazinam | | Metyltetraprole | fluxapyroxad | |
| Polyphenol | | Fluazinam | | Metyltetraprole | Inpyrfluxam | |
| Polyphenol | | Fluazinam | cyproconazole | Metyltetraprole | | |
| Polyphenol | | Fluazinam | difenoconazole | Metyltetraprole | | |
| Polyphenol | | Fluazinam | flutriafol | Metyltetraprole | | |
| Polyphenol | | Fluazinam | mefentrifluconazole | Metyltetraprole | | |
| Polyphenol | | Fluazinam | prothioconazole | Metyltetraprole | | |
| Polyphenol | | Fluazinam | tebuconazole | Metyltetraprole | | |
| Polyphenol | | Fluazinam | tetraconazole | Metyltetraprole | | |
| Polyphenol | | Fluazinam | | metominostrobin | Adepidyn | fenpropidin |
| Polyphenol | | Fluazinam | | metominostrobin | benzovindiflupyr | fenpropidin |
| Polyphenol | | Fluazinam | | metominostrobin | Bixafen | fenpropidin |
| Polyphenol | | Fluazinam | | metominostrobin | Fluindapyr | fenpropidin |
| Polyphenol | | Fluazinam | | metominostrobin | fluxapyroxad | fenpropidin |
| Polyphenol | | Fluazinam | | metominostrobin | Inpyrfluxam | fenpropidin |
| Polyphenol | | Fluazinam | | metominostrobin | Adepidyn | Fenpropimorph |
| Polyphenol | | Fluazinam | | metominostrobin | benzovindiflupyr | Fenpropimorph |
| Polyphenol | | Fluazinam | | metominostrobin | bixafen | Fenpropimorph |
| Polyphenol | | Fluazinam | | metominostrobin | Fluindapyr | Fenpropimorph |
| Polyphenol | | Fluazinam | | metominostrobin | fluxapyroxad | Fenpropimorph |
| Polyphenol | | Fluazinam | | metominostrobin | Inpyrfluxam | Fenpropimorph |
| Polyphenol | | Fluazinam | | metominostrobin | | Fenpropimorph |
| Polyphenol | | Fluazinam | | metominostrobin | | Fenpropidin |
| Polyphenol | | Fluazinam | | metominostrobin | Adepidyn | |
| Polyphenol | | Fluazinam | | metominostrobin | benzovindiflupyr | |
| Polyphenol | | Fluazinam | | metominostrobin | bixafen | |
| Polyphenol | | Fluazinam | | metominostrobin | Fluindapyr | |
| Polyphenol | | Fluazinam | | metominostrobin | fluxapyroxad | |
| Polyphenol | | Fluazinam | | metominostrobin | Inpyrfluxam | |
| Polyphenol | | Fluazinam | cyproconazole | metominostrobin | | |
| Polyphenol | | Fluazinam | difenoconazole | metominostrobin | | |
| Polyphenol | | Fluazinam | flutriafol | metominostrobin | | |
| Polyphenol | | Fluazinam | mefentrifluconazole | metominostrobin | | |
| Polyphenol | | Fluazinam | prothioconazole | metominostrobin | | |
| Polyphenol | | Fluazinam | tebuconazole | metominostrobin | | |
| Polyphenol | | Fluazinam | tetraconazole | metominostrobin | | |
| Polyphenol | | Fluazinam | | picoxystrobin | Adepidyn | Fenpropidin |
| Polyphenol | | Fluazinam | | picoxystrobin | benzovindiflupyr | Fenpropidin |
| Polyphenol | | Fluazinam | | picoxystrobin | bixafen | Fenpropidin |
| Polyphenol | | Fluazinam | | picoxystrobin | Fluindapyr | Fenpropidin |
| Polyphenol | | Fluazinam | | picoxystrobin | fluxapyroxad | Fenpropidin |
| Polyphenol | | Fluazinam | | picoxystrobin | Inpyrfluxam | Fenpropidin |
| Polyphenol | | Fluazinam | | picoxystrobin | Adepidyn | Fenpropimorph |
| Polyphenol | | Fluazinam | | picoxystrobin | benzovindiflupyr | Fenpropimorph |
| Polyphenol | | Fluazinam | | picoxystrobin | bixafen | Fenpropimorph |
| Polyphenol | | Fluazinam | | picoxystrobin | Fluindapyr | Fenpropimorph |
| Polyphenol | | Fluazinam | | picoxystrobin | fluxapyroxad | Fenpropimorph |
| Polyphenol | | Fluazinam | | picoxystrobin | Inpyrfluxam | Fenpropimorph |
| Polyphenol | | Fluazinam | | picoxystrobin | | Fenpropimorph |
| Polyphenol | | Fluazinam | | picoxystrobin | | Fenpropidin |
| Polyphenol | | Fluazinam | | picoxystrobin | Adepidyn | |
| Polyphenol | | Fluazinam | | picoxystrobin | benzovindiflupyr | |
| Polyphenol | | Fluazinam | | picoxystrobin | bixafen | |
| Polyphenol | | Fluazinam | | picoxystrobin | Fluindapyr | |
| Polyphenol | | Fluazinam | | picoxystrobin | fluxapyroxad | |
| Polyphenol | | Fluazinam | | picoxystrobin | Inpyrfluxam | |
| Polyphenol | | Fluazinam | cyproconazole | picoxystrobin | | |
| Polyphenol | | Fluazinam | difenoconazole | picoxystrobin | | |
| Polyphenol | | Fluazinam | flutriafol | picoxystrobin | | |
| Polyphenol | | Fluazinam | mefentrifluconazole | picoxystrobin | | |
| Polyphenol | | Fluazinam | prothioconazole | picoxystrobin | | |
| Polyphenol | | Fluazinam | tebuconazole | picoxystrobin | | |
| Polyphenol | | Fluazinam | tetraconazole | picoxystrobin | | |
| Polyphenol | | Fluazinam | | Pyraclostrobin | Adepidyn | fenpropidin |
| Polyphenol | | Fluazinam | | Pyraclostrobin | benzovindiflupyr | fenpropidin |
| Polyphenol | | Fluazinam | | Pyraclostrobin | bixafen | fenpropidin |
| Polyphenol | | Fluazinam | | Pyraclostrobin | Fluindapyr | fenpropidin |
| Polyphenol | | Fluazinam | | Pyraclostrobin | fluxapyroxad | fenpropidin |
| Polyphenol | | Fluazinam | | Pyraclostrobin | Inpyrfluxam | fenpropidin |
| Polyphenol | | Fluazinam | | Pyraclostrobin | Adepidyn | Fenpropimorph |
| Polyphenol | | Fluazinam | | Pyraclostrobin | benzovindiflupyr | Fenpropimorph |
| Polyphenol | | Fluazinam | | Pyraclostrobin | bixafen | Fenpropimorph |
| Polyphenol | | Fluazinam | | Pyraclostrobin | Fluindapyr | Fenpropimorph |
| Polyphenol | | Fluazinam | | Pyraclostrobin | fluxapyroxad | Fenpropimorph |
| Polyphenol | | Fluazinam | | Pyraclostrobin | Inpyrfluxam | Fenpropimorph |
| Polyphenol | | Fluazinam | | Pyraclostrobin | | Fenpropimorph |
| Polyphenol | | Fluazinam | | Pyraclostrobin | | Fenpropidin |
| Polyphenol | | Fluazinam | | Pyraclostrobin | Adepidyn | |
| Polyphenol | | Fluazinam | | Pyraclostrobin | benzovindiflupyr | |
| Polyphenol | | Fluazinam | | Pyraclostrobin | bixafen | |
| Polyphenol | | Fluazinam | | Pyraclostrobin | Fluindapyr | |
| Polyphenol | | Fluazinam | | Pyraclostrobin | fluxapyroxad | |
| Polyphenol | | Fluazinam | | Pyraclostrobin | Inpyrfluxam | |
| Polyphenol | | Fluazinam | cyproconazole | Pyraclostrobin | | |
| Polyphenol | | Fluazinam | difenoconazole | Pyraclostrobin | | |
| Polyphenol | | Fluazinam | flutriafol | Pyraclostrobin | | |
| Polyphenol | | Fluazinam | mefentrifluconazole | Pyraclostrobin | | |
| Polyphenol | | Fluazinam | prothioconazole | Pyraclostrobin | | |
| Polyphenol | | Fluazinam | tebuconazole | Pyraclostrobin | | |
| Polyphenol | | Fluazinam | tetraconazole | Pyraclostrobin | | |
| Polyphenol | | Fluazinam | | trifloxystrobin | Adepidyn | fenpropidin |
| Polyphenol | | Fluazinam | | trifloxystrobin | benzovindiflupyr | fenpropidin |
| Polyphenol | | Fluazinam | | trifloxystrobin | bixafen | fenpropidin |
| Polyphenol | | Fluazinam | | trifloxystrobin | Fluindapyr | fenpropidin |
| Polyphenol | | Fluazinam | | trifloxystrobin | fluxapyroxad | fenpropidin |
| Polyphenol | | Fluazinam | | trifloxystrobin | Inpyrfluxam | fenpropidin |
| Polyphenol | | Fluazinam | | trifloxystrobin | Adepidyn | Fenpropimorph |
| Polyphenol | | Fluazinam | | trifloxystrobin | benzovindiflupyr | Fenpropimorph |
| Polyphenol | | Fluazinam | | trifloxystrobin | bixafen | Fenpropimorph |
| Polyphenol | | Fluazinam | | trifloxystrobin | Fluindapyr | Fenpropimorph |
| Polyphenol | | Fluazinam | | trifloxystrobin | fluxapyroxad | Fenpropimorph |
| Polyphenol | | Fluazinam | | trifloxystrobin | Inpyrfluxam | Fenpropimorph |
| Polyphenol | | Fluazinam | | trifloxystrobin | | Fenpropimorph |
| Polyphenol | | Fluazinam | | trifloxystrobin | | Fenpropidin |
| Polyphenol | | Fluazinam | | trifloxystrobin | Adepidyn | |
| Polyphenol | | Fluazinam | | trifloxystrobin | benzovindiflupyr | |
| Polyphenol | | Fluazinam | | trifloxystrobin | bixafen | |
| Polyphenol | | Fluazinam | | trifloxystrobin | Fluindapyr | |
| Polyphenol | | Fluazinam | | trifloxystrobin | fluxapyroxad | |
| Polyphenol | | Fluazinam | | trifloxystrobin | Inpyrfluxam | |
| Polyphenol | | Fluazinam | cyproconazole | trifloxystrobin | | |
| Polyphenol | | Fluazinam | difenoconazole | trifloxystrobin | | |
| Polyphenol | | Fluazinam | flutriafol | trifloxystrobin | | |
| Polyphenol | | Fluazinam | mefentrifluconazole | trifloxystrobin | | |
| Polyphenol | | Fluazinam | prothioconazole | trifloxystrobin | | |
| Polyphenol | | Fluazinam | tebuconazole | trifloxystrobin | | |
| Polyphenol | | Fluazinam | tetraconazole | trifloxystrobin | | |
| Polyphenol | | Fluazinam | cyproconazole | | | Fenpropidin |
| Polyphenol | | Fluazinam | difenoconazole | | | Fenpropidin |
| Polyphenol | | Fluazinam | flutriafol | | | Fenpropidin |
| Polyphenol | | Fluazinam | mefentrifluconazole | | | Fenpropidin |
| Polyphenol | | Fluazinam | prothioconazole | | | Fenpropidin |
| Polyphenol | | Fluazinam | tebuconazole | | | Fenpropidin |
| Polyphenol | | Fluazinam | tetraconazole | | | Fenpropidin |
| Polyphenol | | Fluazinam | cyproconazole | | | Fenpropimorph |
| Polyphenol | | Fluazinam | difenoconazole | | | Fenpropimorph |
| Polyphenol | | Fluazinam | flutriafol | | | Fenpropimorph |
| Polyphenol | | Fluazinam | mefentrifluconazole | | | Fenpropimorph |
| Polyphenol | | Fluazinam | prothioconazole | | | Fenpropimorph |
| Polyphenol | | Fluazinam | tebuconazole | | | Fenpropimorph |
| Polyphenol | | Fluazinam | tetraconazole | | | Fenpropimorph |
| Polyphenol | | Fluazinam | | | Adepidyn | Fenpropimorph |
| Polyphenol | | Fluazinam | | | benzovindiflupyr | Fenpropimorph |
| Polyphenol | | Fluazinam | | | bixafen | Fenpropimorph |
| Polyphenol | | Fluazinam | | | Fluindapyr | Fenpropimorph |
| Polyphenol | | Fluazinam | | | fluxapyroxad | Fenpropimorph |
| Polyphenol | | Fluazinam | | | Inpyrfluxam | Fenpropimorph |
| Polyphenol | | Fluazinam | | | Adepidyn | Fenpropidin |
| Polyphenol | | Fluazinam | | | benzovindiflupyr | Fenpropidin |
| Polyphenol | | Fluazinam | | | bixafen | Fenpropidin |
| Polyphenol | | Fluazinam | | | Fluindapyr | Fenpropidin |
| Polyphenol | | Fluazinam | | | fluxapyroxad | Fenpropidin |
| Polyphenol | | Fluazinam | | | Inpyrfluxam | Fenpropidin |
| Polyphenol | | Fluazinam | cyproconazole | | Adepidyn | |
| Polyphenol | | Fluazinam | difenoconazole | | Adepidyn | |
| Polyphenol | | Fluazinam | flutriafol | | Adepidyn | |
| Polyphenol | | Fluazinam | flutriafol | | Adepidyn | |
| Polyphenol | | Fluazinam | flutriafol | | Adepidyn | |
| Polyphenol | | Fluazinam | mefentrifluconazole | | Adepidyn | |
| Polyphenol | | Fluazinam | prothioconazole | | Adepidyn | |
| Polyphenol | | Fluazinam | tebuconazole | | Adepidyn | |
| Polyphenol | | Fluazinam | tetraconazole | | Adepidyn | |
| Polyphenol | | Fluazinam | cyproconazole | | benzovindiflupyr | |
| Polyphenol | | Fluazinam | difenoconazole | | benzovindiflupyr | |
| Polyphenol | | Fluazinam | flutriafol | | benzovindiflupyr | |
| Polyphenol | | Fluazinam | mefentrifluconazole | | benzovindiflupyr | |
| Polyphenol | | Fluazinam | prothioconazole | | benzovindiflupyr | |
| Polyphenol | | Fluazinam | tebuconazole | | benzovindiflupyr | |
| Polyphenol | | Fluazinam | tetraconazole | | benzovindiflupyr | |
| Polyphenol | | Fluazinam | cyproconazole | | bixafen | |
| Polyphenol | | Fluazinam | difenoconazole | | bixafen | |
| Polyphenol | | Fluazinam | flutriafol | | bixafen | |
| Polyphenol | | Fluazinam | mefentrifluconazole | | bixafen | |
| Polyphenol | | Fluazinam | prothioconazole | | bixafen | |
| Polyphenol | | Fluazinam | tebuconazole | | bixafen | |
| Polyphenol | | Fluazinam | tetraconazole | | bixafen | |
| Polyphenol | | Fluazinam | cyproconazole | | Fluindapyr | |
| Polyphenol | | Fluazinam | difenoconazole | | Fluindapyr | |
| Polyphenol | | Fluazinam | mefentrifluconazole | | Fluindapyr | |
| Polyphenol | | Fluazinam | prothioconazole | | Fluindapyr | |
| Polyphenol | | Fluazinam | tebuconazole | | Fluindapyr | |
| Polyphenol | | Fluazinam | tetraconazole | | Fluindapyr | |
| Polyphenol | | Fluazinam | cyproconazole | | fluxapyroxad | |
| Polyphenol | | Fluazinam | difenoconazole | | fluxapyroxad | |
| Polyphenol | | Fluazinam | flutriafol | | fluxapyroxad | |
| Polyphenol | | Fluazinam | mefentrifluconazole | | fluxapyroxad | |
| Polyphenol | | Fluazinam | prothioconazole | | fluxapyroxad | |
| Polyphenol | | Fluazinam | tebuconazole | | fluxapyroxad | |
| Polyphenol | | Fluazinam | tetraconazole | | fluxapyroxad | |
| Polyphenol | | Fluazinam | cyproconazole | | Inpyrfluxam | |
| Polyphenol | | Fluazinam | difenoconazole | | Inpyrfluxam | |
| Polyphenol | | Fluazinam | flutriafol | | Inpyrfluxam | |
| Polyphenol | | Fluazinam | mefentrifluconazole | | Inpyrfluxam | |
| Polyphenol | | Fluazinam | prothioconazole | | Inpyrfluxam | |
| Polyphenol | | Fluazinam | tebuconazole | | Inpyrfluxam | |
| Polyphenol | | Fluazinam | tetraconazole | | Inpyrfluxam | |
| Polyphenol | Copper | Mancozeb | | azoxystrobin | Adepidyn | Fenpropidin |
| Polyphenol | Copper | Mancozeb | | azoxystrobin | benzovindiflupyr | Fenpropidin |
| Polyphenol | Copper | Mancozeb | | azoxystrobin | bixafen | Fenpropidin |
| Polyphenol | Copper | Mancozeb | | azoxystrobin | Fluindapyr | Fenpropidin |
| Polyphenol | Copper | Mancozeb | | azoxystrobin | fluxapyroxad | Fenpropidin |
| Polyphenol | Copper | Mancozeb | | azoxystrobin | Inpyrfluxam | Fenpropidin |
| Polyphenol | Copper | Mancozeb | | azoxystrobin | Adepidyn | Fenpropimorph |
| Polyphenol | Copper | Mancozeb | | azoxystrobin | benzovindiflupyr | Fenpropimorph |
| Polyphenol | Copper | Mancozeb | | azoxystrobin | bixafen | Fenpropimorph |
| Polyphenol | Copper | Mancozeb | | azoxystrobin | Fluindapyr | Fenpropimorph |
| Polyphenol | Copper | Mancozeb | | azoxystrobin | fluxapyroxad | Fenpropimorph |
| Polyphenol | Copper | Mancozeb | | azoxystrobin | Inpyrfluxam | Fenpropimorph |
| Polyphenol | Copper | Mancozeb | | azoxystrobin | Adepidyn | |
| Polyphenol | Copper | Mancozeb | | azoxystrobin | benzovindiflupyr | |
| Polyphenol | Copper | Mancozeb | | azoxystrobin | Bixafen | |
| Polyphenol | Copper | Mancozeb | | azoxystrobin | Fluindapyr | |
| Polyphenol | Copper | Mancozeb | | azoxystrobin | fluxapyroxad | |
| Polyphenol | Copper | Mancozeb | | azoxystrobin | Inpyrfluxam | |
| Polyphenol | Copper | Mancozeb | cyproconazole | azoxystrobin | | |
| Polyphenol | Copper | Mancozeb | difenoconazole | azoxystrobin | | |
| Polyphenol | Copper | Mancozeb | flutriafol | azoxystrobin | | |
| Polyphenol | Copper | Mancozeb | mefentrifluconazole | azoxystrobin | | |
| Polyphenol | Copper | Mancozeb | prothioconazole | azoxystrobin | | |
| Polyphenol | Copper | Mancozeb | tebuconazole | azoxystrobin | | |
| Polyphenol | Copper | Mancozeb | tetraconazole | azoxystrobin | | |
| Polyphenol | Copper | Mancozeb | | Mandestrobin | Adepidyn | fenpropidin |
| Polyphenol | Copper | Mancozeb | | Mandestrobin | benzovindiflupyr | fenpropidin |
| Polyphenol | Copper | Mancozeb | | Mandestrobin | bixafen | fenpropidin |
| Polyphenol | Copper | Mancozeb | | Mandestrobin | Fluindapyr | fenpropidin |
| Polyphenol | Copper | Mancozeb | | Mandestrobin | fluxapyroxad | fenpropidin |
| Polyphenol | Copper | Mancozeb | | Mandestrobin | Inpyrfluxam | fenpropidin |
| Polyphenol | Copper | Mancozeb | | Mandestrobin | Adepidyn | Fenpropimorph |
| Polyphenol | Copper | Mancozeb | | Mandestrobin | benzovindiflupyr | Fenpropimorph |
| Polyphenol | Copper | Mancozeb | | Mandestrobin | bixafen | Fenpropimorph |
| Polyphenol | Copper | Mancozeb | | Mandestrobin | Fluindapyr | Fenpropimorph |
| Polyphenol | Copper | Mancozeb | | Mandestrobin | fluxapyroxad | Fenpropimorph |
| Polyphenol | Copper | Mancozeb | | Mandestrobin | Inpyrfluxam | Fenpropimorph |
| Polyphenol | Copper | Mancozeb | | Mandestrobin | | Fenpropimorph |
| Polyphenol | Copper | Mancozeb | | Mandestrobin | | Fenpropidin |
| Polyphenol | Copper | Mancozeb | | Mandestrobin | Adepidyn | |
| Polyphenol | Copper | Mancozeb | | Mandestrobin | benzovindiflupyr | |
| Polyphenol | Copper | Mancozeb | | Mandestrobin | bixafen | |
| Polyphenol | Copper | Mancozeb | | Mandestrobin | Fluindapyr | |
| Polyphenol | Copper | Mancozeb | | Mandestrobin | fluxapyroxad | |
| Polyphenol | Copper | Mancozeb | | Mandestrobin | Inpyrfluxam | |
| Polyphenol | Copper | Mancozeb | cyproconazole | Mandestrobin | | |
| Polyphenol | Copper | Mancozeb | difenoconazole | Mandestrobin | | |
| Polyphenol | Copper | Mancozeb | flutriafol | Mandestrobin | | |
| Polyphenol | Copper | Mancozeb | mefentrifluconazole | Mandestrobin | | |
| Polyphenol | Copper | Mancozeb | prothioconazole | Mandestrobin | | |
| Polyphenol | Copper | Mancozeb | tebuconazole | Mandestrobin | | |
| Polyphenol | Copper | Mancozeb | tetraconazole | Mandestrobin | | |
| Polyphenol | Copper | Mancozeb | | Metyltetraprole | Adepidyn | fenpropidin |
| Polyphenol | Copper | Mancozeb | | Metyltetraprole | benzovindiflupyr | fenpropidin |
| Polyphenol | Copper | Mancozeb | | Metyltetraprole | bixafen | fenpropidin |
| Polyphenol | Copper | Mancozeb | | Metyltetraprole | Fluindapyr | fenpropidin |
| Polyphenol | Copper | Mancozeb | | Metyltetraprole | fluxapyroxad | fenpropidin |
| Polyphenol | Copper | Mancozeb | | Metyltetraprole | Inpyrfluxam | fenpropidin |
| Polyphenol | Copper | Mancozeb | | Metyltetraprole | Adepidyn | Fenpropimorph |
| Polyphenol | Copper | Mancozeb | | Metyltetraprole | benzovindiflupyr | Fenpropimorph |
| Polyphenol | Copper | Mancozeb | | Metyltetraprole | bixafen | Fenpropimorph |
| Polyphenol | Copper | Mancozeb | | Metyltetraprole | Fluindapyr | Fenpropimorph |
| Polyphenol | Copper | Mancozeb | | Metyltetraprole | fluxapyroxad | Fenpropimorph |
| Polyphenol | Copper | Mancozeb | | Metyltetraprole | Inpyrfluxam | Fenpropimorph |
| Polyphenol | Copper | Mancozeb | | Metyltetraprole | | Fenpropimorph |
| Polyphenol | Copper | Mancozeb | | Metyltetraprole | | Fenpropidin |
| Polyphenol | Copper | Mancozeb | | Metyltetraprole | Adepidyn | |
| Polyphenol | Copper | Mancozeb | | Metyltetraprole | benzovindiflupyr | |
| Polyphenol | Copper | Mancozeb | | Metyltetraprole | bixafen | |
| Polyphenol | Copper | Mancozeb | | Metyltetraprole | Fluindapyr | |
| Polyphenol | Copper | Mancozeb | | Metyltetraprole | fluxapyroxad | |
| Polyphenol | Copper | Mancozeb | | Metyltetraprole | Inpyrfluxam | |
| Polyphenol | Copper | Mancozeb | cyproconazole | Metyltetraprole | | |
| Polyphenol | Copper | Mancozeb | difenoconazole | Metyltetraprole | | |
| Polyphenol | Copper | Mancozeb | flutriafol | Metyltetraprole | | |
| Polyphenol | Copper | Mancozeb | mefentrifluconazole | Metyltetraprole | | |
| Polyphenol | Copper | Mancozeb | prothioconazole | Metyltetraprole | | |
| Polyphenol | Copper | Mancozeb | tebuconazole | Metyltetraprole | | |
| Polyphenol | Copper | Mancozeb | tetraconazole | Metyltetraprole | | |
| Polyphenol | Copper | Mancozeb | | metominostrobin | Adepidyn | fenpropidin |
| Polyphenol | Copper | Mancozeb | | metominostrobin | benzovindiflupyr | fenpropidin |
| Polyphenol | Copper | Mancozeb | | metominostrobin | Bixafen | fenpropidin |
| Polyphenol | Copper | Mancozeb | | metominostrobin | Fluindapyr | fenpropidin |
| Polyphenol | Copper | Mancozeb | | metominostrobin | fluxapyroxad | fenpropidin |
| Polyphenol | Copper | Mancozeb | | metominostrobin | Inpyrfluxam | fenpropidin |
| Polyphenol | Copper | Mancozeb | | metominostrobin | Adepidyn | Fenpropimorph |
| Polyphenol | Copper | Mancozeb | | metominostrobin | benzovindiflupyr | Fenpropimorph |
| Polyphenol | Copper | Mancozeb | | metominostrobin | Bixafen | Fenpropimorph |
| Polyphenol | Copper | Mancozeb | | metominostrobin | Fluindapyr | Fenpropimorph |
| Polyphenol | Copper | Mancozeb | | metominostrobin | fluxapyroxad | Fenpropimorph |
| Polyphenol | Copper | Mancozeb | | metominostrobin | Inpyrfluxam | Fenpropimorph |
| Polyphenol | Copper | Mancozeb | | metominostrobin | | Fenpropimorph |
| Polyphenol | Copper | Mancozeb | | metominostrobin | | Fenpropidin |
| Polyphenol | Copper | Mancozeb | | metominostrobin | Adepidyn | |
| Polyphenol | Copper | Mancozeb | | metominostrobin | benzovindiflupyr | |
| Polyphenol | Copper | Mancozeb | | metominostrobin | Bixafen | |
| Polyphenol | Copper | Mancozeb | | metominostrobin | Fluindapyr | |
| Polyphenol | Copper | Mancozeb | | metominostrobin | fluxapyroxad | |
| Polyphenol | Copper | Mancozeb | | metominostrobin | Inpyrfluxam | |
| Polyphenol | Copper | Mancozeb | cyproconazole | metominostrobin | | |
| Polyphenol | Copper | Mancozeb | difenoconazole | metominostrobin | | |
| Polyphenol | Copper | Mancozeb | flutriafol | metominostrobin | | |
| Polyphenol | Copper | Mancozeb | mefentrifluconazole | metominostrobin | | |
| Polyphenol | Copper | Mancozeb | prothioconazole | metominostrobin | | |
| Polyphenol | Copper | Mancozeb | tebuconazole | metominostrobin | | |
| Polyphenol | Copper | Mancozeb | tetraconazole | metominostrobin | | |
| Polyphenol | Copper | Mancozeb | | picoxystrobin | Adepidyn | Fenpropidin |
| Polyphenol | Copper | Mancozeb | | picoxystrobin | benzovindiflupyr | Fenpropidin |
| Polyphenol | Copper | Mancozeb | | picoxystrobin | bixafen | Fenpropidin |
| Polyphenol | Copper | Mancozeb | | picoxystrobin | Fluindapyr | Fenpropidin |
| Polyphenol | Copper | Mancozeb | | picoxystrobin | fluxapyroxad | Fenpropidin |
| Polyphenol | Copper | Mancozeb | | picoxystrobin | Inpyrfluxam | Fenpropidin |
| Polyphenol | Copper | Mancozeb | | picoxystrobin | Adepidyn | Fenpropimorph |
| Polyphenol | Copper | Mancozeb | | picoxystrobin | benzovindiflupyr | Fenpropimorph |
| Polyphenol | Copper | Mancozeb | | picoxystrobin | bixafen | Fenpropimorph |
| Polyphenol | Copper | Mancozeb | | picoxystrobin | Fluindapyr | Fenpropimorph |
| Polyphenol | Copper | Mancozeb | | picoxystrobin | fluxapyroxad | Fenpropimorph |
| Polyphenol | Copper | Mancozeb | | picoxystrobin | Inpyrfluxam | Fenpropimorph |
| Polyphenol | Copper | Mancozeb | | picoxystrobin | | Fenpropimorph |
| Polyphenol | Copper | Mancozeb | | picoxystrobin | | Fenpropidin |
| Polyphenol | Copper | Mancozeb | | picoxystrobin | Adepidyn | |
| Polyphenol | Copper | Mancozeb | | picoxystrobin | benzovindiflupyr | |
| Polyphenol | Copper | Mancozeb | | picoxystrobin | bixafen | |
| Polyphenol | Copper | Mancozeb | | picoxystrobin | Fluindapyr | |
| Polyphenol | Copper | Mancozeb | | picoxystrobin | fluxapyroxad | |
| Polyphenol | Copper | Mancozeb | | picoxystrobin | Inpyrfluxam | |
| Polyphenol | Copper | Mancozeb | cyproconazole | picoxystrobin | | |
| Polyphenol | Copper | Mancozeb | difenoconazole | picoxystrobin | | |
| Polyphenol | Copper | Mancozeb | flutriafol | picoxystrobin | | |
| Polyphenol | Copper | Mancozeb | mefentrifluconazole | picoxystrobin | | |
| Polyphenol | Copper | Mancozeb | prothioconazole | picoxystrobin | | |
| Polyphenol | Copper | Mancozeb | tebuconazole | picoxystrobin | | |
| Polyphenol | Copper | Mancozeb | tetraconazole | picoxystrobin | | |
| Polyphenol | Copper | Mancozeb | | Pyraclostrobin | Adepidyn | fenpropidin |
| Polyphenol | Copper | Mancozeb | | Pyraclostrobin | benzovindiflupyr | fenpropidin |
| Polyphenol | Copper | Mancozeb | | Pyraclostrobin | bixafen | fenpropidin |
| Polyphenol | Copper | Mancozeb | | Pyraclostrobin | Fluindapyr | fenpropidin |
| Polyphenol | Copper | Mancozeb | | Pyraclostrobin | fluxapyroxad | fenpropidin |
| Polyphenol | Copper | Mancozeb | | Pyraclostrobin | Inpyrfluxam | fenpropidin |
| Polyphenol | Copper | Mancozeb | | Pyraclostrobin | Adepidyn | Fenpropimorph |
| Polyphenol | Copper | Mancozeb | | Pyraclostrobin | benzovindiflupyr | Fenpropimorph |
| Polyphenol | Copper | Mancozeb | | Pyraclostrobin | bixafen | Fenpropimorph |
| Polyphenol | Copper | Mancozeb | | Pyraclostrobin | Fluindapyr | Fenpropimorph |
| Polyphenol | Copper | Mancozeb | | Pyraclostrobin | fluxapyroxad | Fenpropimorph |
| Polyphenol | Copper | Mancozeb | | Pyraclostrobin | Inpyrfluxam | Fenpropimorph |
| Polyphenol | Copper | Mancozeb | | Pyraclostrobin | | Fenpropimorph |
| Polyphenol | Copper | Mancozeb | | Pyraclostrobin | | Fenpropidin |
| Polyphenol | Copper | Mancozeb | | Pyraclostrobin | Adepidyn | |
| Polyphenol | Copper | Mancozeb | | Pyraclostrobin | benzovindiflupyr | |
| Polyphenol | Copper | Mancozeb | | Pyraclostrobin | bixafen | |
| Polyphenol | Copper | Mancozeb | | Pyraclostrobin | Fluindapyr | |
| Polyphenol | Copper | Mancozeb | | Pyraclostrobin | fluxapyroxad | |
| Polyphenol | Copper | Mancozeb | | Pyraclostrobin | Inpyrfluxam | |
| Polyphenol | Copper | Mancozeb | cyproconazole | Pyraclostrobin | | |
| Polyphenol | Copper | Mancozeb | difenoconazole | Pyraclostrobin | | |
| Polyphenol | Copper | Mancozeb | flutriafol | Pyraclostrobin | | |
| Polyphenol | Copper | Mancozeb | mefentrifluconazole | Pyraclostrobin | | |
| Polyphenol | Copper | Mancozeb | prothioconazole | Pyraclostrobin | | |
| Polyphenol | Copper | Mancozeb | tebuconazole | Pyraclostrobin | | |
| Polyphenol | Copper | Mancozeb | tetraconazole | Pyraclostrobin | | |
| Polyphenol | Copper | Mancozeb | | trifloxystrobin | Adepidyn | fenpropidin |
| Polyphenol | Copper | Mancozeb | | trifloxystrobin | benzovindiflupyr | fenpropidin |
| Polyphenol | Copper | Mancozeb | | trifloxystrobin | bixafen | fenpropidin |
| Polyphenol | Copper | Mancozeb | | trifloxystrobin | Fluindapyr | fenpropidin |
| Polyphenol | Copper | Mancozeb | | trifloxystrobin | fluxapyroxad | fenpropidin |
| Polyphenol | Copper | Mancozeb | | trifloxystrobin | Inpyrfluxam | fenpropidin |
| Polyphenol | Copper | Mancozeb | | trifloxystrobin | Adepidyn | Fenpropimorph |
| Polyphenol | Copper | Mancozeb | | trifloxystrobin | benzovindiflupyr | Fenpropimorph |
| Polyphenol | Copper | Mancozeb | | trifloxystrobin | bixafen | Fenpropimorph |
| Polyphenol | Copper | Mancozeb | | trifloxystrobin | Fluindapyr | Fenpropimorph |
| Polyphenol | Copper | Mancozeb | | trifloxystrobin | fluxapyroxad | Fenpropimorph |
| Polyphenol | Copper | Mancozeb | | trifloxystrobin | Inpyrfluxam | Fenpropimorph |
| Polyphenol | Copper | Mancozeb | | trifloxystrobin | | Fenpropimorph |
| Polyphenol | Copper | Mancozeb | | trifloxystrobin | | Fenpropidin |
| Polyphenol | Copper | Mancozeb | | trifloxystrobin | Adepidyn | |
| Polyphenol | Copper | Mancozeb | | trifloxystrobin | benzovindiflupyr | |
| Polyphenol | Copper | Mancozeb | | trifloxystrobin | bixafen | |
| Polyphenol | Copper | Mancozeb | | trifloxystrobin | Fluindapyr | |
| Polyphenol | Copper | Mancozeb | | trifloxystrobin | fluxapyroxad | |
| Polyphenol | Copper | Mancozeb | | trifloxystrobin | Inpyrfluxam | |
| Polyphenol | Copper | Mancozeb | cyproconazole | trifloxystrobin | | |
| Polyphenol | Copper | Mancozeb | difenoconazole | trifloxystrobin | | |
| Polyphenol | Copper | Mancozeb | flutriafol | trifloxystrobin | | |
| Polyphenol | Copper | Mancozeb | mefentrifluconazole | trifloxystrobin | | |
| Polyphenol | Copper | Mancozeb | prothioconazole | trifloxystrobin | | |
| Polyphenol | Copper | Mancozeb | tebuconazole | trifloxystrobin | | |
| Polyphenol | Copper | Mancozeb | tetraconazole | trifloxystrobin | | |
| Polyphenol | Copper | Mancozeb | cyproconazole | | | Fenpropidin |
| Polyphenol | Copper | Mancozeb | difenoconazole | | | Fenpropidin |
| Polyphenol | Copper | Mancozeb | flutriafol | | | Fenpropidin |
| Polyphenol | Copper | Mancozeb | mefentrifluconazole | | | Fenpropidin |
| Polyphenol | Copper | Mancozeb | prothioconazole | | | Fenpropidin |
| Polyphenol | Copper | Mancozeb | tebuconazole | | | Fenpropidin |
| Polyphenol | Copper | Mancozeb | tetraconazole | | | Fenpropidin |
| Polyphenol | Copper | Mancozeb | cyproconazole | | | Fenpropimorph |
| Polyphenol | Copper | Mancozeb | difenoconazole | | | Fenpropimorph |
| Polyphenol | Copper | Mancozeb | flutriafol | | | Fenpropimorph |
| Polyphenol | Copper | Mancozeb | mefentrifluconazole | | | Fenpropimorph |
| Polyphenol | Copper | Mancozeb | prothioconazole | | | Fenpropimorph |
| Polyphenol | Copper | Mancozeb | tebuconazole | | | Fenpropimorph |
| Polyphenol | Copper | Mancozeb | tetraconazole | | | Fenpropimorph |
| Polyphenol | Copper | Mancozeb | | | Adepidyn | Fenpropimorph |
| Polyphenol | Copper | Mancozeb | | | benzovindiflupyr | Fenpropimorph |
| Polyphenol | Copper | Mancozeb | | | bixafen | Fenpropimorph |
| Polyphenol | Copper | Mancozeb | | | Fluindapyr | Fenpropimorph |
| Polyphenol | Copper | Mancozeb | | | fluxapyroxad | Fenpropimorph |
| Polyphenol | Copper | Mancozeb | | | Inpyrfluxam | Fenpropimorph |
| Polyphenol | Copper | Mancozeb | | | Adepidyn | Fenpropidin |
| Polyphenol | Copper | Mancozeb | | | benzovindiflupyr | Fenpropidin |
| Polyphenol | Copper | Mancozeb | | | bixafen | Fenpropidin |
| Polyphenol | Copper | Mancozeb | | | Fluindapyr | Fenpropidin |
| Polyphenol | Copper | Mancozeb | | | fluxapyroxad | Fenpropidin |
| Polyphenol | Copper | Mancozeb | | | Inpyrfluxam | Fenpropidin |
| Polyphenol | Copper | Mancozeb | cyproconazole | | Adepidyn | |
| Polyphenol | Copper | Mancozeb | difenoconazole | | Adepidyn | |
| Polyphenol | Copper | Mancozeb | flutriafol | | Adepidyn | |
| Polyphenol | Copper | Mancozeb | flutriafol | | Adepidyn | |
| Polyphenol | Copper | Mancozeb | flutriafol | | Adepidyn | |
| Polyphenol | Copper | Mancozeb | mefentrifluconazole | | Adepidyn | |
| Polyphenol | Copper | Mancozeb | prothioconazole | | Adepidyn | |
| Polyphenol | Copper | Mancozeb | tebuconazole | | Adepidyn | |
| Polyphenol | Copper | Mancozeb | tetraconazole | | Adepidyn | |
| Polyphenol | Copper | Mancozeb | cyproconazole | | benzovindiflupyr | |
| Polyphenol | Copper | Mancozeb | difenoconazole | | benzovindiflupyr | |
| Polyphenol | Copper | Mancozeb | flutriafol | | benzovindiflupyr | |
| Polyphenol | Copper | Mancozeb | mefentrifluconazole | | benzovindiflupyr | |
| Polyphenol | Copper | Mancozeb | prothioconazole | | benzovindiflupyr | |
| Polyphenol | Copper | Mancozeb | tebuconazole | | benzovindiflupyr | |
| Polyphenol | Copper | Mancozeb | tetraconazole | | benzovindiflupyr | |
| Polyphenol | Copper | Mancozeb | cyproconazole | | bixafen | |
| Polyphenol | Copper | Mancozeb | difenoconazole | | bixafen | |
| Polyphenol | Copper | Mancozeb | flutriafol | | bixafen | |
| Polyphenol | Copper | Mancozeb | mefentrifluconazole | | bixafen | |
| Polyphenol | Copper | Mancozeb | prothioconazole | | bixafen | |
| Polyphenol | Copper | Mancozeb | tebuconazole | | bixafen | |
| Polyphenol | Copper | Mancozeb | tetraconazole | | bixafen | |
| Polyphenol | Copper | Mancozeb | cyproconazole | | Fluindapyr | |
| Polyphenol | Copper | Mancozeb | difenoconazole | | Fluindapyr | |
| Polyphenol | Copper | Mancozeb | mefentrifluconazole | | Fluindapyr | |
| Polyphenol | Copper | Mancozeb | prothioconazole | | Fluindapyr | |
| Polyphenol | Copper | Mancozeb | tebuconazole | | Fluindapyr | |
| Polyphenol | Copper | Mancozeb | tetraconazole | | Fluindapyr | |
| Polyphenol | Copper | Mancozeb | cyproconazole | | fluxapyroxad | |
| Polyphenol | Copper | Mancozeb | difenoconazole | | fluxapyroxad | |
| Polyphenol | Copper | Mancozeb | flutriafol | | fluxapyroxad | |
| Polyphenol | Copper | Mancozeb | mefentrifluconazole | | fluxapyroxad | |
| Polyphenol | Copper | Mancozeb | prothioconazole | | fluxapyroxad | |
| Polyphenol | Copper | Mancozeb | tebuconazole | | fluxapyroxad | |
| Polyphenol | Copper | Mancozeb | tetraconazole | | fluxapyroxad | |
| Polyphenol | Copper | Mancozeb | cyproconazole | | Inpyrfluxam | |
| Polyphenol | Copper | Mancozeb | difenoconazole | | Inpyrfluxam | |
| Polyphenol | Copper | Mancozeb | flutriafol | | Inpyrfluxam | |
| Polyphenol | Copper | Mancozeb | mefentrifluconazole | | Inpyrfluxam | |
| Polyphenol | Copper | Mancozeb | prothioconazole | | Inpyrfluxam | |
| Polyphenol | Copper | Mancozeb | tebuconazole | | Inpyrfluxam | |
| Polyphenol | Copper | Mancozeb | tetraconazole | | Inpyrfluxam | |
| Polyphenol | | Mancozeb | | azoxystrobin | Adepidyn | Fenpropidin |
| Polyphenol | | Mancozeb | | azoxystrobin | benzovindiflupyr | Fenpropidin |
| Polyphenol | | Mancozeb | | azoxystrobin | bixafen | Fenpropidin |
| Polyphenol | | Mancozeb | | azoxystrobin | Fluindapyr | Fenpropidin |
| Polyphenol | | Mancozeb | | azoxystrobin | fluxapyroxad | Fenpropidin |
| Polyphenol | | Mancozeb | | azoxystrobin | Inpyrfluxam | Fenpropidin |
| Polyphenol | | Mancozeb | | azoxystrobin | Adepidyn | Fenpropimorph |
| Polyphenol | | Mancozeb | | azoxystrobin | benzovindiflupyr | Fenpropimorph |
| Polyphenol | | Mancozeb | | azoxystrobin | bixafen | Fenpropimorph |
| Polyphenol | | Mancozeb | | azoxystrobin | Fluindapyr | Fenpropimorph |
| Polyphenol | | Mancozeb | | azoxystrobin | fluxapyroxad | Fenpropimorph |
| Polyphenol | | Mancozeb | | azoxystrobin | Inpyrfluxam | Fenpropimorph |
| Polyphenol | | Mancozeb | | azoxystrobin | Adepidyn | |
| Polyphenol | | Mancozeb | | azoxystrobin | benzovindiflupyr | |
| Polyphenol | | Mancozeb | | azoxystrobin | Bixafen | |
| Polyphenol | | Mancozeb | | azoxystrobin | Fluindapyr | |
| Polyphenol | | Mancozeb | | azoxystrobin | fluxapyroxad | |
| Polyphenol | | Mancozeb | | azoxystrobin | Inpyrfluxam | |
| Polyphenol | | Mancozeb | cyproconazole | azoxystrobin | | |
| Polyphenol | | Mancozeb | difenoconazole | azoxystrobin | | |
| Polyphenol | | Mancozeb | flutriafol | azoxystrobin | | |
| Polyphenol | | Mancozeb | mefentrifluconazole | azoxystrobin | | |
| Polyphenol | | Mancozeb | prothioconazole | azoxystrobin | | |
| Polyphenol | | Mancozeb | tebuconazole | azoxystrobin | | |
| Polyphenol | | Mancozeb | tetraconazole | azoxystrobin | | |
| Polyphenol | | Mancozeb | | Mandestrobin | Adepidyn | fenpropidin |
| Polyphenol | | Mancozeb | | Mandestrobin | benzovindiflupyr | fenpropidin |
| Polyphenol | | Mancozeb | | Mandestrobin | bixafen | fenpropidin |
| Polyphenol | | Mancozeb | | Mandestrobin | Fluindapyr | fenpropidin |
| Polyphenol | | Mancozeb | | Mandestrobin | fluxapyroxad | fenpropidin |
| Polyphenol | | Mancozeb | | Mandestrobin | Inpyrfluxam | fenpropidin |
| Polyphenol | | Mancozeb | | Mandestrobin | Adepidyn | Fenpropimorph |
| Polyphenol | | Mancozeb | | Mandestrobin | benzovindiflupyr | Fenpropimorph |
| Polyphenol | | Mancozeb | | Mandestrobin | bixafen | Fenpropimorph |
| Polyphenol | | Mancozeb | | Mandestrobin | Fluindapyr | Fenpropimorph |
| Polyphenol | | Mancozeb | | Mandestrobin | fluxapyroxad | Fenpropimorph |
| Polyphenol | | Mancozeb | | Mandestrobin | Inpyrfluxam | Fenpropimorph |
| Polyphenol | | Mancozeb | | Mandestrobin | | Fenpropimorph |
| Polyphenol | | Mancozeb | | Mandestrobin | | Fenpropidin |
| Polyphenol | | Mancozeb | | Mandestrobin | Adepidyn | |
| Polyphenol | | Mancozeb | | Mandestrobin | benzovindiflupyr | |
| Polyphenol | | Mancozeb | | Mandestrobin | bixafen | |
| Polyphenol | | Mancozeb | | Mandestrobin | Fluindapyr | |
| Polyphenol | | Mancozeb | | Mandestrobin | fluxapyroxad | |
| Polyphenol | | Mancozeb | | Mandestrobin | Inpyrfluxam | |
| Polyphenol | | Mancozeb | cyproconazole | Mandestrobin | | |
| Polyphenol | | Mancozeb | difenoconazole | Mandestrobin | | |
| Polyphenol | | Mancozeb | flutriafol | Mandestrobin | | |
| Polyphenol | | Mancozeb | mefentrifluconazole | Mandestrobin | | |
| Polyphenol | | Mancozeb | prothioconazole | Mandestrobin | | |
| Polyphenol | | Mancozeb | tebuconazole | Mandestrobin | | |
| Polyphenol | | Mancozeb | tetraconazole | Mandestrobin | | |
| Polyphenol | | Mancozeb | | Metyltetraprole | Adepidyn | fenpropidin |
| Polyphenol | | Mancozeb | | Metyltetraprole | benzovindiflupyr | fenpropidin |
| Polyphenol | | Mancozeb | | Metyltetraprole | bixafen | fenpropidin |
| Polyphenol | | Mancozeb | | Metyltetraprole | Fluindapyr | fenpropidin |
| Polyphenol | | Mancozeb | | Metyltetraprole | fluxapyroxad | fenpropidin |
| Polyphenol | | Mancozeb | | Metyltetraprole | Inpyrfluxam | fenpropidin |
| Polyphenol | | Mancozeb | | Metyltetraprole | Adepidyn | Fenpropimorph |
| Polyphenol | | Mancozeb | | Metyltetraprole | benzovindiflupyr | Fenpropimorph |
| Polyphenol | | Mancozeb | | Metyltetraprole | bixafen | Fenpropimorph |
| Polyphenol | | Mancozeb | | Metyltetraprole | Fluindapyr | Fenpropimorph |
| Polyphenol | | Mancozeb | | Metyltetraprole | fluxapyroxad | Fenpropimorph |
| Polyphenol | | Mancozeb | | Metyltetraprole | Inpyrfluxam | Fenpropimorph |
| Polyphenol | | Mancozeb | | Metyltetraprole | | Fenpropimorph |
| Polyphenol | | Mancozeb | | Metyltetraprole | | Fenpropidin |
| Polyphenol | | Mancozeb | | Metyltetraprole | Adepidyn | |
| Polyphenol | | Mancozeb | | Metyltetraprole | benzovindiflupyr | |
| Polyphenol | | Mancozeb | | Metyltetraprole | bixafen | |
| Polyphenol | | Mancozeb | | Metyltetraprole | Fluindapyr | |
| Polyphenol | | Mancozeb | | Metyltetraprole | fluxapyroxad | |
| Polyphenol | | Mancozeb | | Metyltetraprole | Inpyrfluxam | |
| Polyphenol | | Mancozeb | cyproconazole | Metyltetraprole | | |
| Polyphenol | | Mancozeb | difenoconazole | Metyltetraprole | | |
| Polyphenol | | Mancozeb | flutriafol | Metyltetraprole | | |
| Polyphenol | | Mancozeb | mefentrifluconazole | Metyltetraprole | | |
| Polyphenol | | Mancozeb | prothioconazole | Metyltetraprole | | |
| Polyphenol | | Mancozeb | tebuconazole | Metyltetraprole | | |
| Polyphenol | | Mancozeb | tetraconazole | Metyltetraprole | | |
| Polyphenol | | Mancozeb | | metominostrobin | Adepidyn | fenpropidin |
| Polyphenol | | Mancozeb | | metominostrobin | benzovindiflupyr | fenpropidin |
| Polyphenol | | Mancozeb | | metominostrobin | bixafen | fenpropidin |
| Polyphenol | | Mancozeb | | metominostrobin | Fluindapyr | fenpropidin |
| Polyphenol | | Mancozeb | | metominostrobin | fluxapyroxad | fenpropidin |
| Polyphenol | | Mancozeb | | metominostrobin | Inpyrfluxam | fenpropidin |
| Polyphenol | | Mancozeb | | metominostrobin | Adepidyn | Fenpropimorph |
| Polyphenol | | Mancozeb | | metominostrobin | benzovindiflupyr | Fenpropimorph |
| Polyphenol | | Mancozeb | | metominostrobin | bixafen | Fenpropimorph |
| Polyphenol | | Mancozeb | | metominostrobin | Fluindapyr | Fenpropimorph |
| Polyphenol | | Mancozeb | | metominostrobin | fluxapyroxad | Fenpropimorph |
| Polyphenol | | Mancozeb | | metominostrobin | Inpyrfluxam | Fenpropimorph |
| Polyphenol | | Mancozeb | | metominostrobin | | Fenpropimorph |
| Polyphenol | | Mancozeb | | metominostrobin | | Fenpropidin |
| Polyphenol | | Mancozeb | | metominostrobin | Adepidyn | |
| Polyphenol | | Mancozeb | | metominostrobin | benzovindiflupyr | |
| Polyphenol | | Mancozeb | | metominostrobin | bixafen | |
| Polyphenol | | Mancozeb | | metominostrobin | Fluindapyr | |
| Polyphenol | | Mancozeb | | metominostrobin | fluxapyroxad | |
| Polyphenol | | Mancozeb | | metominostrobin | Inpyrfluxam | |
| Polyphenol | | Mancozeb | cyproconazole | metominostrobin | | |
| Polyphenol | | Mancozeb | difenoconazole | metominostrobin | | |
| Polyphenol | | Mancozeb | flutriafol | metominostrobin | | |
| Polyphenol | | Mancozeb | mefentrifluconazole | metominostrobin | | |
| Polyphenol | | Mancozeb | prothioconazole | metominostrobin | | |
| Polyphenol | | Mancozeb | tebuconazole | metominostrobin | | |
| Polyphenol | | Mancozeb | tetraconazole | metominostrobin | | |
| Polyphenol | | Mancozeb | | picoxystrobin | Adepidyn | Fenpropidin |
| Polyphenol | | Mancozeb | | picoxystrobin | benzovindiflupyr | Fenpropidin |
| Polyphenol | | Mancozeb | | picoxystrobin | bixafen | Fenpropidin |
| Polyphenol | | Mancozeb | | picoxystrobin | Fluindapyr | Fenpropidin |
| Polyphenol | | Mancozeb | | picoxystrobin | fluxapyroxad | Fenpropidin |
| Polyphenol | | Mancozeb | | picoxystrobin | Inpyrfluxam | Fenpropidin |
| Polyphenol | | Mancozeb | | picoxystrobin | Adepidyn | Fenpropimorph |
| Polyphenol | | Mancozeb | | picoxystrobin | benzovindiflupyr | Fenpropimorph |
| Polyphenol | | Mancozeb | | picoxystrobin | bixafen | Fenpropimorph |
| Polyphenol | | Mancozeb | | picoxystrobin | Fluindapyr | Fenpropimorph |
| Polyphenol | | Mancozeb | | picoxystrobin | fluxapyroxad | Fenpropimorph |
| Polyphenol | | Mancozeb | | picoxystrobin | Inpyrfluxam | Fenpropimorph |
| Polyphenol | | Mancozeb | | picoxystrobin | | Fenpropimorph |
| Polyphenol | | Mancozeb | | picoxystrobin | | Fenpropidin |
| Polyphenol | | Mancozeb | | picoxystrobin | Adepidyn | |
| Polyphenol | | Mancozeb | | picoxystrobin | benzovindiflupyr | |
| Polyphenol | | Mancozeb | | picoxystrobin | bixafen | |
| Polyphenol | | Mancozeb | | picoxystrobin | Fluindapyr | |
| Polyphenol | | Mancozeb | | picoxystrobin | fluxapyroxad | |
| Polyphenol | | Mancozeb | | picoxystrobin | Inpyrfluxam | |
| Polyphenol | | Mancozeb | cyproconazole | picoxystrobin | | |
| Polyphenol | | Mancozeb | difenoconazole | picoxystrobin | | |
| Polyphenol | | Mancozeb | flutriafol | picoxystrobin | | |
| Polyphenol | | Mancozeb | mefentrifluconazole | picoxystrobin | | |
| Polyphenol | | Mancozeb | prothioconazole | picoxystrobin | | |
| Polyphenol | | Mancozeb | tebuconazole | picoxystrobin | | |
| Polyphenol | | Mancozeb | tetraconazole | picoxystrobin | | |
| Polyphenol | | Mancozeb | | Pyraclostrobin | Adepidyn | fenpropidin |
| Polyphenol | | Mancozeb | | Pyraclostrobin | benzovindiflupyr | fenpropidin |
| Polyphenol | | Mancozeb | | Pyraclostrobin | bixafen | fenpropidin |
| Polyphenol | | Mancozeb | | Pyraclostrobin | Fluindapyr | fenpropidin |
| Polyphenol | | Mancozeb | | Pyraclostrobin | fluxapyroxad | fenpropidin |
| Polyphenol | | Mancozeb | | Pyraclostrobin | Inpyrfluxam | fenpropidin |
| Polyphenol | | Mancozeb | | Pyraclostrobin | Adepidyn | Fenpropimorph |
| Polyphenol | | Mancozeb | | Pyraclostrobin | benzovindiflupyr | Fenpropimorph |
| Polyphenol | | Mancozeb | | Pyraclostrobin | bixafen | Fenpropimorph |
| Polyphenol | | Mancozeb | | Pyraclostrobin | Fluindapyr | Fenpropimorph |
| Polyphenol | | Mancozeb | | Pyraclostrobin | fluxapyroxad | Fenpropimorph |
| Polyphenol | | Mancozeb | | Pyraclostrobin | Inpyrfluxam | Fenpropimorph |
| Polyphenol | | Mancozeb | | Pyraclostrobin | | Fenpropimorph |
| Polyphenol | | Mancozeb | | Pyraclostrobin | | Fenpropidin |
| Polyphenol | | Mancozeb | | Pyraclostrobin | Adepidyn | |
| Polyphenol | | Mancozeb | | Pyraclostrobin | benzovindiflupyr | |
| Polyphenol | | Mancozeb | | Pyraclostrobin | bixafen | |
| Polyphenol | | Mancozeb | | Pyraclostrobin | Fluindapyr | |
| Polyphenol | | Mancozeb | | Pyraclostrobin | fluxapyroxad | |
| Polyphenol | | Mancozeb | | Pyraclostrobin | Inpyrfluxam | |
| Polyphenol | | Mancozeb | cyproconazole | Pyraclostrobin | | |
| Polyphenol | | Mancozeb | difenoconazole | Pyraclostrobin | | |
| Polyphenol | | Mancozeb | flutriafol | Pyraclostrobin | | |
| Polyphenol | | Mancozeb | mefentrifluconazole | Pyraclostrobin | | |
| Polyphenol | | Mancozeb | prothioconazole | Pyraclostrobin | | |
| Polyphenol | | Mancozeb | tebuconazole | Pyraclostrobin | | |
| Polyphenol | | Mancozeb | tetraconazole | Pyraclostrobin | | |
| Polyphenol | | Mancozeb | | trifloxystrobin | Adepidyn | fenpropidin |
| Polyphenol | | Mancozeb | | trifloxystrobin | benzovindiflupyr | fenpropidin |
| Polyphenol | | Mancozeb | | trifloxystrobin | bixafen | fenpropidin |
| Polyphenol | | Mancozeb | | trifloxystrobin | Fluindapyr | fenpropidin |
| Polyphenol | | Mancozeb | | trifloxystrobin | fluxapyroxad | fenpropidin |
| Polyphenol | | Mancozeb | | trifloxystrobin | Inpyrfluxam | fenpropidin |
| Polyphenol | | Mancozeb | | trifloxystrobin | Adepidyn | Fenpropimorph |
| Polyphenol | | Mancozeb | | trifloxystrobin | benzovindiflupyr | Fenpropimorph |
| Polyphenol | | Mancozeb | | trifloxystrobin | bixafen | Fenpropimorph |
| Polyphenol | | Mancozeb | | trifloxystrobin | Fluindapyr | Fenpropimorph |
| Polyphenol | | Mancozeb | | trifloxystrobin | fluxapyroxad | Fenpropimorph |
| Polyphenol | | Mancozeb | | trifloxystrobin | Inpyrfluxam | Fenpropimorph |
| Polyphenol | | Mancozeb | | trifloxystrobin | | Fenpropimorph |
| Polyphenol | | Mancozeb | | trifloxystrobin | | Fenpropidin |
| Polyphenol | | Mancozeb | | trifloxystrobin | Adepidyn | |
| Polyphenol | | Mancozeb | | trifloxystrobin | benzovindiflupyr | |
| Polyphenol | | Mancozeb | | trifloxystrobin | bixafen | |
| Polyphenol | | Mancozeb | | trifloxystrobin | Fluindapyr | |
| Polyphenol | | Mancozeb | | trifloxystrobin | fluxapyroxad | |
| Polyphenol | | Mancozeb | | trifloxystrobin | Inpyrfluxam | |
| Polyphenol | | Mancozeb | cyproconazole | trifloxystrobin | | |
| Polyphenol | | Mancozeb | difenoconazole | trifloxystrobin | | |
| Polyphenol | | Mancozeb | flutriafol | trifloxystrobin | | |
| Polyphenol | | Mancozeb | mefentrifluconazole | trifloxystrobin | | |
| Polyphenol | | Mancozeb | prothioconazole | trifloxystrobin | | |
| Polyphenol | | Mancozeb | tebuconazole | trifloxystrobin | | |
| Polyphenol | | Mancozeb | tetraconazole | trifloxystrobin | | |
| Polyphenol | | Mancozeb | cyproconazole | | | Fenpropidin |
| Polyphenol | | Mancozeb | difenoconazole | | | Fenpropidin |
| Polyphenol | | Mancozeb | flutriafol | | | Fenpropidin |
| Polyphenol | | Mancozeb | mefentrifluconazole | | | Fenpropidin |
| Polyphenol | | Mancozeb | prothioconazole | | | Fenpropidin |
| Polyphenol | | Mancozeb | tebuconazole | | | Fenpropidin |
| Polyphenol | | Mancozeb | tetraconazole | | | Fenpropidin |
| Polyphenol | | Mancozeb | cyproconazole | | | Fenpropimorph |
| Polyphenol | | Mancozeb | difenoconazole | | | Fenpropimorph |
| Polyphenol | | Mancozeb | flutriafol | | | Fenpropimorph |
| Polyphenol | | Mancozeb | mefentrifluconazole | | | Fenpropimorph |
| Polyphenol | | Mancozeb | prothioconazole | | | Fenpropimorph |
| Polyphenol | | Mancozeb | tebuconazole | | | Fenpropimorph |
| Polyphenol | | Mancozeb | tetraconazole | | | Fenpropimorph |
| Polyphenol | | Mancozeb | | | Adepidyn | Fenpropimorph |
| Polyphenol | | Mancozeb | | | benzovindiflupyr | Fenpropimorph |
| Polyphenol | | Mancozeb | | | bixafen | Fenpropimorph |
| Polyphenol | | Mancozeb | | | Fluindapyr | Fenpropimorph |
| Polyphenol | | Mancozeb | | | fluxapyroxad | Fenpropimorph |
| Polyphenol | | Mancozeb | | | Inpyrfluxam | Fenpropimorph |
| Polyphenol | | Mancozeb | | | Adepidyn | Fenpropidin |
| Polyphenol | | Mancozeb | | | benzovindiflupyr | Fenpropidin |
| Polyphenol | | Mancozeb | | | bixafen | Fenpropidin |
| Polyphenol | | Mancozeb | | | Fluindapyr | Fenpropidin |
| Polyphenol | | Mancozeb | | | fluxapyroxad | Fenpropidin |
| Polyphenol | | Mancozeb | | | Inpyrfluxam | Fenpropidin |
| Polyphenol | | Mancozeb | cyproconazole | | Adepidyn | |
| Polyphenol | | Mancozeb | difenoconazole | | Adepidyn | |
| Polyphenol | | Mancozeb | flutriafol | | Adepidyn | |
| Polyphenol | | Mancozeb | flutriafol | | Adepidyn | |
| Polyphenol | | Mancozeb | flutriafol | | Adepidyn | |
| Polyphenol | | Mancozeb | mefentrifluconazole | | Adepidyn | |
| Polyphenol | | Mancozeb | prothioconazole | | Adepidyn | |
| Polyphenol | | Mancozeb | tebuconazole | | Adepidyn | |
| Polyphenol | | Mancozeb | tetraconazole | | Adepidyn | |
| Polyphenol | | Mancozeb | cyproconazole | | benzovindiflupyr | |
| Polyphenol | | Mancozeb | difenoconazole | | benzovindiflupyr | |
| Polyphenol | | Mancozeb | flutriafol | | benzovindiflupyr | |
| Polyphenol | | Mancozeb | mefentrifluconazole | | benzovindiflupyr | |
| Polyphenol | | Mancozeb | prothioconazole | | benzovindiflupyr | |
| Polyphenol | | Mancozeb | tebuconazole | | benzovindiflupyr | |
| Polyphenol | | Mancozeb | tetraconazole | | benzovindiflupyr | |
| Polyphenol | | Mancozeb | cyproconazole | | bixafen | |
| Polyphenol | | Mancozeb | difenoconazole | | bixafen | |
| Polyphenol | | Mancozeb | flutriafol | | bixafen | |
| Polyphenol | | Mancozeb | mefentrifluconazole | | bixafen | |
| Polyphenol | | Mancozeb | prothioconazole | | bixafen | |
| Polyphenol | | Mancozeb | tebuconazole | | bixafen | |
| Polyphenol | | Mancozeb | tetraconazole | | bixafen | |
| Polyphenol | | Mancozeb | cyproconazole | | Fluindapyr | |
| Polyphenol | | Mancozeb | difenoconazole | | Fluindapyr | |
| Polyphenol | | Mancozeb | mefentrifluconazole | | Fluindapyr | |
| Polyphenol | | Mancozeb | prothioconazole | | Fluindapyr | |
| Polyphenol | | Mancozeb | tebuconazole | | Fluindapyr | |
| Polyphenol | | Mancozeb | tetraconazole | | Fluindapyr | |
| Polyphenol | | Mancozeb | cyproconazole | | fluxapyroxad | |
| Polyphenol | | Mancozeb | difenoconazole | | fluxapyroxad | |
| Polyphenol | | Mancozeb | flutriafol | | fluxapyroxad | |
| Polyphenol | | Mancozeb | mefentrifluconazole | | fluxapyroxad | |
| Polyphenol | | Mancozeb | prothioconazole | | fluxapyroxad | |
| Polyphenol | | Mancozeb | tebuconazole | | fluxapyroxad | |
| Polyphenol | | Mancozeb | tetraconazole | | fluxapyroxad | |
| Polyphenol | | Mancozeb | cyproconazole | | Inpyrfluxam | |
| Polyphenol | | Mancozeb | difenoconazole | | Inpyrfluxam | |
| Polyphenol | | Mancozeb | flutriafol | | Inpyrfluxam | |
| Polyphenol | | Mancozeb | mefentrifluconazole | | Inpyrfluxam | |
| Polyphenol | | Mancozeb | prothioconazole | | Inpyrfluxam | |
| Polyphenol | | Mancozeb | tebuconazole | | Inpyrfluxam | |
| Polyphenol | | Mancozeb | tetraconazole | | Inpyrfluxam | |
| Polyphenol | | Chlorothalonil | | azoxystrobin | Adepidyn | Fenpropidin |
| Polyphenol | | Chlorothalonil | | azoxystrobin | benzovindiflupyr | Fenpropidin |
| Polyphenol | | Chlorothalonil | | azoxystrobin | bixafen | Fenpropidin |
| Polyphenol | | Chlorothalonil | | azoxystrobin | Fluindapyr | Fenpropidin |
| Polyphenol | | Chlorothalonil | | azoxystrobin | fluxapyroxad | Fenpropidin |
| Polyphenol | | Chlorothalonil | | azoxystrobin | Inpyrfluxam | Fenpropidin |
| Polyphenol | | Chlorothalonil | | azoxystrobin | Adepidyn | Fenpropimorph |
| Polyphenol | | Chlorothalonil | | azoxystrobin | benzovindiflupyr | Fenpropimorph |
| Polyphenol | | Chlorothalonil | | azoxystrobin | bixafen | Fenpropimorph |
| Polyphenol | | Chlorothalonil | | azoxystrobin | Fluindapyr | Fenpropimorph |
| Polyphenol | | Chlorothalonil | | azoxystrobin | fluxapyroxad | Fenpropimorph |
| Polyphenol | | Chlorothalonil | | azoxystrobin | Inpyrfluxam | Fenpropimorph |
| Polyphenol | | Chlorothalonil | | azoxystrobin | Adepidyn | |
| Polyphenol | | Chlorothalonil | | azoxystrobin | benzovindiflupyr | |
| Polyphenol | | Chlorothalonil | | azoxystrobin | bixafen | |
| Polyphenol | | Chlorothalonil | | azoxystrobin | Fluindapyr | |
| Polyphenol | | Chlorothalonil | | azoxystrobin | fluxapyroxad | |
| Polyphenol | | Chlorothalonil | | azoxystrobin | Inpyrfluxam | |
| Polyphenol | | Chlorothalonil | cyproconazole | azoxystrobin | | |
| Polyphenol | | Chlorothalonil | difenoconazole | azoxystrobin | | |
| Polyphenol | | Chlorothalonil | flutriafol | azoxystrobin | | |
| Polyphenol | | Chlorothalonil | mefentrifluconazole | azoxystrobin | | |
| Polyphenol | | Chlorothalonil | prothioconazole | azoxystrobin | | |
| Polyphenol | | Chlorothalonil | tebuconazole | azoxystrobin | | |
| Polyphenol | | Chlorothalonil | tetraconazole | azoxystrobin | | |
| Polyphenol | | Chlorothalonil | | Mandestrobin | Adepidyn | fenpropidin |
| Polyphenol | | Chlorothalonil | | Mandestrobin | benzovindiflupyr | fenpropidin |
| Polyphenol | | Chlorothalonil | | Mandestrobin | bixafen | fenpropidin |
| Polyphenol | | Chlorothalonil | | Mandestrobin | Fluindapyr | fenpropidin |
| Polyphenol | | Chlorothalonil | | Mandestrobin | fluxapyroxad | fenpropidin |
| Polyphenol | | Chlorothalonil | | Mandestrobin | Inpyrfluxam | fenpropidin |
| Polyphenol | | Chlorothalonil | | Mandestrobin | Adepidyn | Fenpropimorph |
| Polyphenol | | Chlorothalonil | | Mandestrobin | benzovindiflupyr | Fenpropimorph |
| Polyphenol | | Chlorothalonil | | Mandestrobin | bixafen | Fenpropimorph |
| Polyphenol | | Chlorothalonil | | Mandestrobin | Fluindapyr | Fenpropimorph |
| Polyphenol | | Chlorothalonil | | Mandestrobin | fluxapyroxad | Fenpropimorph |
| Polyphenol | | Chlorothalonil | | Mandestrobin | Inpyrfluxam | Fenpropimorph |
| Polyphenol | | Chlorothalonil | | Mandestrobin | | Fenpropimorph |
| Polyphenol | | Chlorothalonil | | Mandestrobin | | Fenpropidin |
| Polyphenol | | Chlorothalonil | | Mandestrobin | Adepidyn | |
| Polyphenol | | Chlorothalonil | | Mandestrobin | benzovindiflupyr | |
| Polyphenol | | Chlorothalonil | | Mandestrobin | bixafen | |
| Polyphenol | | Chlorothalonil | | Mandestrobin | Fluindapyr | |
| Polyphenol | | Chlorothalonil | | Mandestrobin | fluxapyroxad | |
| Polyphenol | | Chlorothalonil | | Mandestrobin | Inpyrfluxam | |
| Polyphenol | | Chlorothalonil | cyproconazole | Mandestrobin | | |
| Polyphenol | | Chlorothalonil | difenoconazole | Mandestrobin | | |
| Polyphenol | | Chlorothalonil | flutriafol | Mandestrobin | | |
| Polyphenol | | Chlorothalonil | mefentrifluconazole | Mandestrobin | | |
| Polyphenol | | Chlorothalonil | prothioconazole | Mandestrobin | | |
| Polyphenol | | Chlorothalonil | tebuconazole | Mandestrobin | | |
| Polyphenol | | Chlorothalonil | tetraconazole | Mandestrobin | | |
| Polyphenol | | Chlorothalonil | | Metyltetraprole | Adepidyn | fenpropidin |
| Polyphenol | | Chlorothalonil | | Metyltetraprole | benzovindiflupyr | fenpropidin |
| Polyphenol | | Chlorothalonil | | Metyltetraprole | bixafen | fenpropidin |
| Polyphenol | | Chlorothalonil | | Metyltetraprole | Fluindapyr | fenpropidin |
| Polyphenol | | Chlorothalonil | | Metyltetraprole | fluxapyroxad | fenpropidin |
| Polyphenol | | Chlorothalonil | | Metyltetraprole | Inpyrfluxam | fenpropidin |
| Polyphenol | | Chlorothalonil | | Metyltetraprole | Adepidyn | Fenpropimorph |
| Polyphenol | | Chlorothalonil | | Metyltetraprole | benzovindiflupyr | Fenpropimorph |
| Polyphenol | | Chlorothalonil | | Metyltetraprole | bixafen | Fenpropimorph |
| Polyphenol | | Chlorothalonil | | Metyltetraprole | Fluindapyr | Fenpropimorph |
| Polyphenol | | Chlorothalonil | | Metyltetraprole | fluxapyroxad | Fenpropimorph |
| Polyphenol | | Chlorothalonil | | Metyltetraprole | Inpyrfluxam | Fenpropimorph |
| Polyphenol | | Chlorothalonil | | Metyltetraprole | | Fenpropimorph |
| Polyphenol | | Chlorothalonil | | Metyltetraprole | | Fenpropidin |
| Polyphenol | | Chlorothalonil | | Metyltetraprole | Adepidyn | |
| Polyphenol | | Chlorothalonil | | Metyltetraprole | benzovindiflupyr | |
| Polyphenol | | Chlorothalonil | | Metyltetraprole | bixafen | |
| Polyphenol | | Chlorothalonil | | Metyltetraprole | Fluindapyr | |
| Polyphenol | | Chlorothalonil | | Metyltetraprole | fluxapyroxad | |
| Polyphenol | | Chlorothalonil | | Metyltetraprole | Inpyrfluxam | |
| Polyphenol | | Chlorothalonil | cyproconazole | Metyltetraprole | | |
| Polyphenol | | Chlorothalonil | difenoconazole | Metyltetraprole | | |
| Polyphenol | | Chlorothalonil | flutriafol | Metyltetraprole | | |
| Polyphenol | | Chlorothalonil | mefentrifluconazole | Metyltetraprole | | |
| Polyphenol | | Chlorothalonil | prothioconazole | Metyltetraprole | | |
| Polyphenol | | Chlorothalonil | tebuconazole | Metyltetraprole | | |
| Polyphenol | | Chlorothalonil | tetraconazole | Metyltetraprole | | |
| Polyphenol | | Chlorothalonil | | metominostrobin | Adepidyn | fenpropidin |
| Polyphenol | | Chlorothalonil | | metominostrobin | benzovindiflupyr | fenpropidin |
| Polyphenol | | Chlorothalonil | | metominostrobin | bixafen | fenpropidin |
| Polyphenol | | Chlorothalonil | | metominostrobin | Fluindapyr | fenpropidin |
| Polyphenol | | Chlorothalonil | | metominostrobin | fluxapyroxad | fenpropidin |
| Polyphenol | | Chlorothalonil | | metominostrobin | Inpyrfluxam | fenpropidin |
| Polyphenol | | Chlorothalonil | | metominostrobin | Adepidyn | Fenpropimorph |
| Polyphenol | | Chlorothalonil | | metominostrobin | benzovindiflupyr | Fenpropimorph |
| Polyphenol | | Chlorothalonil | | metominostrobin | bixafen | Fenpropimorph |
| Polyphenol | | Chlorothalonil | | metominostrobin | Fluindapyr | Fenpropimorph |
| Polyphenol | | Chlorothalonil | | metominostrobin | fluxapyroxad | Fenpropimorph |
| Polyphenol | | Chlorothalonil | | metominostrobin | Inpyrfluxam | Fenpropimorph |
| Polyphenol | | Chlorothalonil | | metominostrobin | | Fenpropimorph |
| Polyphenol | | Chlorothalonil | | metominostrobin | | Fenpropidin |
| Polyphenol | | Chlorothalonil | | metominostrobin | Adepidyn | |
| Polyphenol | | Chlorothalonil | | metominostrobin | benzovindiflupyr | |
| Polyphenol | | Chlorothalonil | | metominostrobin | bixafen | |
| Polyphenol | | Chlorothalonil | | metominostrobin | Fluindapyr | |
| Polyphenol | | Chlorothalonil | | metominostrobin | fluxapyroxad | |
| Polyphenol | | Chlorothalonil | | metominostrobin | Inpyrfluxam | |
| Polyphenol | | Chlorothalonil | cyproconazole | metominostrobin | | |
| Polyphenol | | Chlorothalonil | difenoconazole | metominostrobin | | |
| Polyphenol | | Chlorothalonil | flutriafol | metominostrobin | | |
| Polyphenol | | Chlorothalonil | mefentrifluconazole | metominostrobin | | |
| Polyphenol | | Chlorothalonil | prothioconazole | metominostrobin | | |
| Polyphenol | | Chlorothalonil | tebuconazole | metominostrobin | | |
| Polyphenol | | Chlorothalonil | tetraconazole | metominostrobin | | |
| Polyphenol | | Chlorothalonil | | picoxystrobin | Adepidyn | Fenpropidin |
| Polyphenol | | Chlorothalonil | | picoxystrobin | benzovindiflupyr | Fenpropidin |
| Polyphenol | | Chlorothalonil | | picoxystrobin | bixafen | Fenpropidin |
| Polyphenol | | Chlorothalonil | | picoxystrobin | Fluindapyr | Fenpropidin |
| Polyphenol | | Chlorothalonil | | picoxystrobin | fluxapyroxad | Fenpropidin |
| Polyphenol | | Chlorothalonil | | picoxystrobin | Inpyrfluxam | Fenpropidin |
| Polyphenol | | Chlorothalonil | | picoxystrobin | Adepidyn | Fenpropimorph |
| Polyphenol | | Chlorothalonil | | picoxystrobin | benzovindiflupyr | Fenpropimorph |
| Polyphenol | | Chlorothalonil | | picoxystrobin | bixafen | Fenpropimorph |
| Polyphenol | | Chlorothalonil | | picoxystrobin | Fluindapyr | Fenpropimorph |
| Polyphenol | | Chlorothalonil | | picoxystrobin | fluxapyroxad | Fenpropimorph |
| Polyphenol | | Chlorothalonil | | picoxystrobin | Inpyrfluxam | Fenpropimorph |
| Polyphenol | | Chlorothalonil | | picoxystrobin | | Fenpropimorph |
| Polyphenol | | Chlorothalonil | | picoxystrobin | | Fenpropidin |
| Polyphenol | | Chlorothalonil | | picoxystrobin | Adepidyn | |
| Polyphenol | | Chlorothalonil | | picoxystrobin | benzovindiflupyr | |
| Polyphenol | | Chlorothalonil | | picoxystrobin | bixafen | |
| Polyphenol | | Chlorothalonil | | picoxystrobin | Fluindapyr | |
| Polyphenol | | Chlorothalonil | | picoxystrobin | fluxapyroxad | |
| Polyphenol | | Chlorothalonil | | picoxystrobin | Inpyrfluxam | |
| Polyphenol | | Chlorothalonil | cyproconazole | picoxystrobin | | |
| Polyphenol | | Chlorothalonil | difenoconazole | picoxystrobin | | |
| Polyphenol | | Chlorothalonil | flutriafol | picoxystrobin | | |
| Polyphenol | | Chlorothalonil | mefentrifluconazole | picoxystrobin | | |
| Polyphenol | | Chlorothalonil | prothioconazole | picoxystrobin | | |
| Polyphenol | | Chlorothalonil | tebuconazole | picoxystrobin | | |
| Polyphenol | | Chlorothalonil | tetraconazole | picoxystrobin | | |
| Polyphenol | | Chlorothalonil | | Pyraclostrobin | Adepidyn | fenpropidin |
| Polyphenol | | Chlorothalonil | | Pyraclostrobin | benzovindiflupyr | fenpropidin |
| Polyphenol | | Chlorothalonil | | Pyraclostrobin | bixafen | fenpropidin |
| Polyphenol | | Chlorothalonil | | Pyraclostrobin | Fluindapyr | fenpropidin |
| Polyphenol | | Chlorothalonil | | Pyraclostrobin | fluxapyroxad | fenpropidin |
| Polyphenol | | Chlorothalonil | | Pyraclostrobin | Inpyrfluxam | fenpropidin |
| Polyphenol | | Chlorothalonil | | Pyraclostrobin | Adepidyn | Fenpropimorph |
| Polyphenol | | Chlorothalonil | | Pyraclostrobin | benzovindiflupyr | Fenpropimorph |
| Polyphenol | | Chlorothalonil | | Pyraclostrobin | bixafen | Fenpropimorph |
| Polyphenol | | Chlorothalonil | | Pyraclostrobin | Fluindapyr | Fenpropimorph |
| Polyphenol | | Chlorothalonil | | Pyraclostrobin | fluxapyroxad | Fenpropimorph |
| Polyphenol | | Chlorothalonil | | Pyraclostrobin | Inpyrfluxam | Fenpropimorph |
| Polyphenol | | Chlorothalonil | | Pyraclostrobin | | Fenpropimorph |
| Polyphenol | | Chlorothalonil | | Pyraclostrobin | | Fenpropidin |
| Polyphenol | | Chlorothalonil | | Pyraclostrobin | Adepidyn | |
| Polyphenol | | Chlorothalonil | | Pyraclostrobin | benzovindiflupyr | |
| Polyphenol | | Chlorothalonil | | Pyraclostrobin | bixafen | |
| Polyphenol | | Chlorothalonil | | Pyraclostrobin | Fluindapyr | |
| Polyphenol | | Chlorothalonil | | Pyraclostrobin | fluxapyroxad | |
| Polyphenol | | Chlorothalonil | | Pyraclostrobin | Inpyrfluxam | |
| Polyphenol | | Chlorothalonil | cyproconazole | Pyraclostrobin | | |
| Polyphenol | | Chlorothalonil | difenoconazole | Pyraclostrobin | | |
| Polyphenol | | Chlorothalonil | flutriafol | Pyraclostrobin | | |
| Polyphenol | | Chlorothalonil | mefentrifluconazole | Pyraclostrobin | | |
| Polyphenol | | Chlorothalonil | prothioconazole | Pyraclostrobin | | |
| Polyphenol | | Chlorothalonil | tebuconazole | Pyraclostrobin | | |
| Polyphenol | | Chlorothalonil | tetraconazole | Pyraclostrobin | | |
| Polyphenol | | Chlorothalonil | | trifloxystrobin | Adepidyn | fenpropidin |
| Polyphenol | | Chlorothalonil | | trifloxystrobin | benzovindiflupyr | fenpropidin |
| Polyphenol | | Chlorothalonil | | trifloxystrobin | bixafen | fenpropidin |
| Polyphenol | | Chlorothalonil | | trifloxystrobin | Fluindapyr | fenpropidin |
| Polyphenol | | Chlorothalonil | | trifloxystrobin | fluxapyroxad | fenpropidin |
| Polyphenol | | Chlorothalonil | | trifloxystrobin | Inpyrfluxam | fenpropidin |
| Polyphenol | | Chlorothalonil | | trifloxystrobin | Adepidyn | Fenpropimorph |
| Polyphenol | | Chlorothalonil | | trifloxystrobin | benzovindiflupyr | Fenpropimorph |
| Polyphenol | | Chlorothalonil | | trifloxystrobin | bixafen | Fenpropimorph |
| Polyphenol | | Chlorothalonil | | trifloxystrobin | Fluindapyr | Fenpropimorph |
| Polyphenol | | Chlorothalonil | | trifloxystrobin | fluxapyroxad | Fenpropimorph |
| Polyphenol | | Chlorothalonil | | trifloxystrobin | Inpyrfluxam | Fenpropimorph |
| Polyphenol | | Chlorothalonil | | trifloxystrobin | | Fenpropimorph |
| Polyphenol | | Chlorothalonil | | trifloxystrobin | | Fenpropidin |
| Polyphenol | | Chlorothalonil | | trifloxystrobin | Adepidyn | |
| Polyphenol | | Chlorothalonil | | trifloxystrobin | benzovindiflupyr | |
| Polyphenol | | Chlorothalonil | | trifloxystrobin | bixafen | |
| Polyphenol | | Chlorothalonil | | trifloxystrobin | Fluindapyr | |
| Polyphenol | | Chlorothalonil | | trifloxystrobin | fluxapyroxad | |
| Polyphenol | | Chlorothalonil | | trifloxystrobin | Inpyrfluxam | |
| Polyphenol | | Chlorothalonil | cyproconazole | trifloxystrobin | | |
| Polyphenol | | Chlorothalonil | difenoconazole | trifloxystrobin | | |
| Polyphenol | | Chlorothalonil | flutriafol | trifloxystrobin | | |
| Polyphenol | | Chlorothalonil | mefentrifluconazole | trifloxystrobin | | |
| Polyphenol | | Chlorothalonil | prothioconazole | trifloxystrobin | | |
| Polyphenol | | Chlorothalonil | tebuconazole | trifloxystrobin | | |
| Polyphenol | | Chlorothalonil | tetraconazole | trifloxystrobin | | |
| Polyphenol | | Chlorothalonil | cyproconazole | | | Fenpropidin |
| Polyphenol | | Chlorothalonil | difenoconazole | | | Fenpropidin |
| Polyphenol | | Chlorothalonil | flutriafol | | | Fenpropidin |
| Polyphenol | | Chlorothalonil | mefentrifluconazole | | | Fenpropidin |
| Polyphenol | | Chlorothalonil | prothioconazole | | | Fenpropidin |
| Polyphenol | | Chlorothalonil | tebuconazole | | | Fenpropidin |
| Polyphenol | | Chlorothalonil | tetraconazole | | | Fenpropidin |
| Polyphenol | | Chlorothalonil | cyproconazole | | | Fenpropimorph |
| Polyphenol | | Chlorothalonil | difenoconazole | | | Fenpropimorph |
| Polyphenol | | Chlorothalonil | flutriafol | | | Fenpropimorph |
| Polyphenol | | Chlorothalonil | mefentrifluconazole | | | Fenpropimorph |
| Polyphenol | | Chlorothalonil | prothioconazole | | | Fenpropimorph |
| Polyphenol | | Chlorothalonil | tebuconazole | | | Fenpropimorph |
| Polyphenol | | Chlorothalonil | tetraconazole | | | Fenpropimorph |
| Polyphenol | | Chlorothalonil | | | Adepidyn | Fenpropimorph |
| Polyphenol | | Chlorothalonil | | | benzovindiflupyr | Fenpropimorph |
| Polyphenol | | Chlorothalonil | | | bixafen | Fenpropimorph |
| Polyphenol | | Chlorothalonil | | | Fluindapyr | Fenpropimorph |
| Polyphenol | | Chlorothalonil | | | fluxapyroxad | Fenpropimorph |
| Polyphenol | | Chlorothalonil | | | Inpyrfluxam | Fenpropimorph |
| Polyphenol | | Chlorothalonil | | | Adepidyn | Fenpropidin |
| Polyphenol | | Chlorothalonil | | | benzovindiflupyr | Fenpropidin |
| Polyphenol | | Chlorothalonil | | | bixafen | Fenpropidin |
| Polyphenol | | Chlorothalonil | | | Fluindapyr | Fenpropidin |
| Polyphenol | | Chlorothalonil | | | fluxapyroxad | Fenpropidin |
| Polyphenol | | Chlorothalonil | | | Inpyrfluxam | Fenpropidin |
| Polyphenol | | Chlorothalonil | cyproconazole | | Adepidyn | |
| Polyphenol | | Chlorothalonil | difenoconazole | | Adepidyn | |
| Polyphenol | | Chlorothalonil | flutriafol | | Adepidyn | |
| Polyphenol | | Chlorothalonil | flutriafol | | Adepidyn | |
| Polyphenol | | Chlorothalonil | flutriafol | | Adepidyn | |
| Polyphenol | | Chlorothalonil | mefentrifluconazole | | Adepidyn | |
| Polyphenol | | Chlorothalonil | prothioconazole | | Adepidyn | |
| Polyphenol | | Chlorothalonil | tebuconazole | | Adepidyn | |
| Polyphenol | | Chlorothalonil | tetraconazole | | Adepidyn | |
| Polyphenol | | Chlorothalonil | cyproconazole | | benzovindiflupyr | |
| Polyphenol | | Chlorothalonil | difenoconazole | | benzovindiflupyr | |
| Polyphenol | | Chlorothalonil | flutriafol | | benzovindiflupyr | |
| Polyphenol | | Chlorothalonil | mefentrifluconazole | | benzovindiflupyr | |
| Polyphenol | | Chlorothalonil | prothioconazole | | benzovindiflupyr | |
| Polyphenol | | Chlorothalonil | tebuconazole | | benzovindiflupyr | |
| Polyphenol | | Chlorothalonil | tetraconazole | | benzovindiflupyr | |
| Polyphenol | | Chlorothalonil | cyproconazole | | bixafen | |
| Polyphenol | | Chlorothalonil | difenoconazole | | bixafen | |
| Polyphenol | | Chlorothalonil | flutriafol | | bixafen | |
| Polyphenol | | Chlorothalonil | mefentrifluconazole | | bixafen | |
| Polyphenol | | Chlorothalonil | prothioconazole | | bixafen | |
| Polyphenol | | Chlorothalonil | tebuconazole | | bixafen | |
| Polyphenol | | Chlorothalonil | tetraconazole | | bixafen | |
| Polyphenol | | Chlorothalonil | cyproconazole | | Fluindapyr | |
| Polyphenol | | Chlorothalonil | difenoconazole | | Fluindapyr | |
| Polyphenol | | Chlorothalonil | mefentrifluconazole | | Fluindapyr | |
| Polyphenol | | Chlorothalonil | prothioconazole | | Fluindapyr | |
| Polyphenol | | Chlorothalonil | tebuconazole | | Fluindapyr | |
| Polyphenol | | Chlorothalonil | tetraconazole | | Fluindapyr | |
| Polyphenol | | Chlorothalonil | cyproconazole | | fluxapyroxad | |
| Polyphenol | | Chlorothalonil | difenoconazole | | fluxapyroxad | |
| Polyphenol | | Chlorothalonil | flutriafol | | fluxapyroxad | |
| Polyphenol | | Chlorothalonil | mefentrifluconazole | | fluxapyroxad | |
| Polyphenol | | Chlorothalonil | prothioconazole | | fluxapyroxad | |
| Polyphenol | | Chlorothalonil | tebuconazole | | fluxapyroxad | |
| Polyphenol | | Chlorothalonil | tetraconazole | | fluxapyroxad | |
| Polyphenol | | Chlorothalonil | cyproconazole | | Inpyrfluxam | |
| Polyphenol | | Chlorothalonil | difenoconazole | | Inpyrfluxam | |
| Polyphenol | | Chlorothalonil | flutriafol | | Inpyrfluxam | |
| Polyphenol | | Chlorothalonil | mefentrifluconazole | | Inpyrfluxam | |
| Polyphenol | | Chlorothalonil | prothioconazole | | Inpyrfluxam | |
| Polyphenol | | Chlorothalonil | tebuconazole | | Inpyrfluxam | |
| Polyphenol | | Chlorothalonil | tetraconazole | | Inpyrfluxam | |
| Polyphenol | Copper | | | azoxystrobin | Adepidyn | Fenpropidin |
| Polyphenol | Copper | | | azoxystrobin | benzovindiflupyr | Fenpropidin |
| Polyphenol | Copper | | | azoxystrobin | bixafen | Fenpropidin |
| Polyphenol | Copper | | | azoxystrobin | Fluindapyr | Fenpropidin |
| Polyphenol | Copper | | | azoxystrobin | fluxapyroxad | Fenpropidin |
| Polyphenol | Copper | | | azoxystrobin | Inpyrfluxam | Fenpropidin |
| Polyphenol | Copper | | | azoxystrobin | Adepidyn | Fenpropimorph |
| Polyphenol | Copper | | | azoxystrobin | benzovindiflupyr | Fenpropimorph |
| Polyphenol | Copper | | | azoxystrobin | bixafen | Fenpropimorph |
| Polyphenol | Copper | | | azoxystrobin | Fluindapyr | Fenpropimorph |
| Polyphenol | Copper | | | azoxystrobin | fluxapyroxad | Fenpropimorph |
| Polyphenol | Copper | | | azoxystrobin | Inpyrfluxam | Fenpropimorph |
| Polyphenol | Copper | | | azoxystrobin | Adepidyn | |
| Polyphenol | Copper | | | azoxystrobin | benzovindiflupyr | |
| Polyphenol | Copper | | | azoxystrobin | bixafen | |
| Polyphenol | Copper | | | azoxystrobin | Fluindapyr | |
| Polyphenol | Copper | | | azoxystrobin | fluxapyroxad | |
| Polyphenol | Copper | | | azoxystrobin | Inpyrfluxam | |
| Polyphenol | Copper | | cyproconazole | azoxystrobin | | |
| Polyphenol | Copper | | difenoconazole | azoxystrobin | | |
| Polyphenol | Copper | | flutriafol | azoxystrobin | | |
| Polyphenol | Copper | | mefentrifluconazole | azoxystrobin | | |
| Polyphenol | Copper | | prothioconazole | azoxystrobin | | |
| Polyphenol | Copper | | tebuconazole | azoxystrobin | | |
| Polyphenol | Copper | | tetraconazole | azoxystrobin | | |
| Polyphenol | Copper | | | Mandestrobin | Adepidyn | fenpropidin |
| Polyphenol | Copper | | | Mandestrobin | benzovindiflupyr | fenpropidin |
| Polyphenol | Copper | | | Mandestrobin | bixafen | fenpropidin |
| Polyphenol | Copper | | | Mandestrobin | Fluindapyr | fenpropidin |
| Polyphenol | Copper | | | Mandestrobin | fluxapyroxad | fenpropidin |
| Polyphenol | Copper | | | Mandestrobin | Inpyrfluxam | fenpropidin |
| Polyphenol | Copper | | | Mandestrobin | Adepidyn | Fenpropimorph |
| Polyphenol | Copper | | | Mandestrobin | benzovindiflupyr | Fenpropimorph |
| Polyphenol | Copper | | | Mandestrobin | bixafen | Fenpropimorph |
| Polyphenol | Copper | | | Mandestrobin | Fluindapyr | Fenpropimorph |
| Polyphenol | Copper | | | Mandestrobin | fluxapyroxad | Fenpropimorph |
| Polyphenol | Copper | | | Mandestrobin | Inpyrfluxam | Fenpropimorph |
| Polyphenol | Copper | | | Mandestrobin | | Fenpropimorph |
| Polyphenol | Copper | | | Mandestrobin | | Fenpropidin |
| Polyphenol | Copper | | | Mandestrobin | Adepidyn | |
| Polyphenol | Copper | | | Mandestrobin | benzovindiflupyr | |
| Polyphenol | Copper | | | Mandestrobin | bixafen | |
| Polyphenol | Copper | | | Mandestrobin | Fluindapyr | |
| Polyphenol | Copper | | | Mandestrobin | fluxapyroxad | |
| Polyphenol | Copper | | | Mandestrobin | Inpyrfluxam | |
| Polyphenol | Copper | | cyproconazole | Mandestrobin | | |
| Polyphenol | Copper | | difenoconazole | Mandestrobin | | |
| Polyphenol | Copper | | flutriafol | Mandestrobin | | |
| Polyphenol | Copper | | mefentrifluconazole | Mandestrobin | | |
| Polyphenol | Copper | | prothioconazole | Mandestrobin | | |
| Polyphenol | Copper | | tebuconazole | Mandestrobin | | |
| Polyphenol | Copper | | tetraconazole | Mandestrobin | | |
| Polyphenol | Copper | | | Metyltetraprole | Adepidyn | fenpropidin |
| Polyphenol | Copper | | | Metyltetraprole | benzovindiflupyr | fenpropidin |
| Polyphenol | Copper | | | Metyltetraprole | bixafen | fenpropidin |
| Polyphenol | Copper | | | Metyltetraprole | Fluindapyr | fenpropidin |
| Polyphenol | Copper | | | Metyltetraprole | fluxapyroxad | fenpropidin |
| Polyphenol | Copper | | | Metyltetraprole | Inpyrfluxam | fenpropidin |
| Polyphenol | Copper | | | Metyltetraprole | Adepidyn | Fenpropimorph |
| Polyphenol | Copper | | | Metyltetraprole | benzovindiflupyr | Fenpropimorph |
| Polyphenol | Copper | | | Metyltetraprole | bixafen | Fenpropimorph |
| Polyphenol | Copper | | | Metyltetraprole | Fluindapyr | Fenpropimorph |
| Polyphenol | Copper | | | Metyltetraprole | fluxapyroxad | Fenpropimorph |
| Polyphenol | Copper | | | Metyltetraprole | Inpyrfluxam | Fenpropimorph |
| Polyphenol | Copper | | | Metyltetraprole | | Fenpropimorph |
| Polyphenol | Copper | | | Metyltetraprole | | Fenpropidin |
| Polyphenol | Copper | | | Metyltetraprole | Adepidyn | |
| Polyphenol | Copper | | | Metyltetraprole | benzovindiflupyr | |
| Polyphenol | Copper | | | Metyltetraprole | bixafen | |
| Polyphenol | Copper | | | Metyltetraprole | Fluindapyr | |
| Polyphenol | Copper | | | Metyltetraprole | fluxapyroxad | |
| Polyphenol | Copper | | | Metyltetraprole | Inpyrfluxam | |
| Polyphenol | Copper | | cyproconazole | Metyltetraprole | | |
| Polyphenol | Copper | | difenoconazole | Metyltetraprole | | |
| Polyphenol | Copper | | flutriafol | Metyltetraprole | | |
| Polyphenol | Copper | | mefentrifluconazole | Metyltetraprole | | |
| Polyphenol | Copper | | prothioconazole | Metyltetraprole | | |
| Polyphenol | Copper | | tebuconazole | Metyltetraprole | | |
| Polyphenol | Copper | | tetraconazole | Metyltetraprole | | |
| Polyphenol | Copper | | | metominostrobin | Adepidyn | fenpropidin |
| Polyphenol | Copper | | | metominostrobin | benzovindiflupyr | fenpropidin |
| Polyphenol | Copper | | | metominostrobin | bixafen | fenpropidin |
| Polyphenol | Copper | | | metominostrobin | Fluindapyr | fenpropidin |
| Polyphenol | Copper | | | metominostrobin | fluxapyroxad | fenpropidin |
| Polyphenol | Copper | | | metominostrobin | Inpyrfluxam | fenpropidin |
| Polyphenol | Copper | | | metominostrobin | Adepidyn | Fenpropimorph |
| Polyphenol | Copper | | | metominostrobin | benzovindiflupyr | Fenpropimorph |
| Polyphenol | Copper | | | metominostrobin | bixafen | Fenpropimorph |
| Polyphenol | Copper | | | metominostrobin | Fluindapyr | Fenpropimorph |
| Polyphenol | Copper | | | metominostrobin | fluxapyroxad | Fenpropimorph |
| Polyphenol | Copper | | | metominostrobin | Inpyrfluxam | Fenpropimorph |
| Polyphenol | Copper | | | metominostrobin | | Fenpropimorph |
| Polyphenol | Copper | | | metominostrobin | | Fenpropidin |
| Polyphenol | Copper | | | metominostrobin | Adepidyn | |
| Polyphenol | Copper | | | metominostrobin | benzovindiflupyr | |
| Polyphenol | Copper | | | metominostrobin | bixafen | |
| Polyphenol | Copper | | | metominostrobin | Fluindapyr | |
| Polyphenol | Copper | | | metominostrobin | fluxapyroxad | |
| Polyphenol | Copper | | | metominostrobin | Inpyrfluxam | |
| Polyphenol | Copper | | cyproconazole | metominostrobin | | |
| Polyphenol | Copper | | difenoconazole | metominostrobin | | |
| Polyphenol | Copper | | flutriafol | metominostrobin | | |
| Polyphenol | Copper | | mefentrifluconazole | metominostrobin | | |
| Polyphenol | Copper | | prothioconazole | metominostrobin | | |
| Polyphenol | Copper | | tebuconazole | metominostrobin | | |
| Polyphenol | Copper | | tetraconazole | metominostrobin | | |
| Polyphenol | Copper | | | picoxystrobin | Adepidyn | Fenpropidin |
| Polyphenol | Copper | | | picoxystrobin | benzovindiflupyr | Fenpropidin |
| Polyphenol | Copper | | | picoxystrobin | bixafen | Fenpropidin |
| Polyphenol | Copper | | | picoxystrobin | Fluindapyr | Fenpropidin |
| Polyphenol | Copper | | | picoxystrobin | fluxapyroxad | Fenpropidin |
| Polyphenol | Copper | | | picoxystrobin | Inpyrfluxam | Fenpropidin |
| Polyphenol | Copper | | | picoxystrobin | Adepidyn | Fenpropimorph |
| Polyphenol | Copper | | | picoxystrobin | benzovindiflupyr | Fenpropimorph |
| Polyphenol | Copper | | | picoxystrobin | bixafen | Fenpropimorph |
| Polyphenol | Copper | | | picoxystrobin | Fluindapyr | Fenpropimorph |
| Polyphenol | Copper | | | picoxystrobin | fluxapyroxad | Fenpropimorph |
| Polyphenol | Copper | | | picoxystrobin | Inpyrfluxam | Fenpropimorph |
| Polyphenol | Copper | | | picoxystrobin | | Fenpropimorph |
| Polyphenol | Copper | | | picoxystrobin | | Fenpropidin |
| Polyphenol | Copper | | | picoxystrobin | Adepidyn | |
| Polyphenol | Copper | | | picoxystrobin | benzovindiflupyr | |
| Polyphenol | Copper | | | picoxystrobin | bixafen | |
| Polyphenol | Copper | | | picoxystrobin | Fluindapyr | |
| Polyphenol | Copper | | | picoxystrobin | fluxapyroxad | |
| Polyphenol | Copper | | | picoxystrobin | Inpyrfluxam | |
| Polyphenol | Copper | | cyproconazole | picoxystrobin | | |
| Polyphenol | Copper | | difenoconazole | picoxystrobin | | |
| Polyphenol | Copper | | flutriafol | picoxystrobin | | |
| Polyphenol | Copper | | mefentrifluconazole | picoxystrobin | | |
| Polyphenol | Copper | | prothioconazole | picoxystrobin | | |
| Polyphenol | Copper | | tebuconazole | picoxystrobin | | |
| Polyphenol | Copper | | tetraconazole | picoxystrobin | | |
| Polyphenol | Copper | | | Pyraclostrobin | Adepidyn | fenpropidin |
| Polyphenol | Copper | | | Pyraclostrobin | benzovindiflupyr | fenpropidin |
| Polyphenol | Copper | | | Pyraclostrobin | bixafen | fenpropidin |
| Polyphenol | Copper | | | Pyraclostrobin | Fluindapyr | fenpropidin |
| Polyphenol | Copper | | | Pyraclostrobin | fluxapyroxad | fenpropidin |
| Polyphenol | Copper | | | Pyraclostrobin | Inpyrfluxam | fenpropidin |
| Polyphenol | Copper | | | Pyraclostrobin | Adepidyn | Fenpropimorph |
| Polyphenol | Copper | | | Pyraclostrobin | benzovindiflupyr | Fenpropimorph |
| Polyphenol | Copper | | | Pyraclostrobin | bixafen | Fenpropimorph |
| Polyphenol | Copper | | | Pyraclostrobin | Fluindapyr | Fenpropimorph |
| Polyphenol | Copper | | | Pyraclostrobin | fluxapyroxad | Fenpropimorph |
| Polyphenol | Copper | | | Pyraclostrobin | Inpyrfluxam | Fenpropimorph |
| Polyphenol | Copper | | | Pyraclostrobin | | Fenpropimorph |
| Polyphenol | Copper | | | Pyraclostrobin | | Fenpropidin |
| Polyphenol | Copper | | | Pyraclostrobin | Adepidyn | |
| Polyphenol | Copper | | | Pyraclostrobin | benzovindiflupyr | |
| Polyphenol | Copper | | | Pyraclostrobin | bixafen | |
| Polyphenol | Copper | | | Pyraclostrobin | Fluindapyr | |
| Polyphenol | Copper | | | Pyraclostrobin | fluxapyroxad | |
| Polyphenol | Copper | | | Pyraclostrobin | Inpyrfluxam | |
| Polyphenol | Copper | | cyproconazole | Pyraclostrobin | | |
| Polyphenol | Copper | | difenoconazole | Pyraclostrobin | | |
| Polyphenol | Copper | | flutriafol | Pyraclostrobin | | |
| Polyphenol | Copper | | mefentrifluconazole | Pyraclostrobin | | |
| Polyphenol | Copper | | prothioconazole | Pyraclostrobin | | |
| Polyphenol | Copper | | tebuconazole | Pyraclostrobin | | |
| Polyphenol | Copper | | tetraconazole | Pyraclostrobin | | |
| Polyphenol | Copper | | | trifloxystrobin | Adepidyn | fenpropidin |
| Polyphenol | Copper | | | trifloxystrobin | benzovindiflupyr | fenpropidin |
| Polyphenol | Copper | | | trifloxystrobin | bixafen | fenpropidin |
| Polyphenol | Copper | | | trifloxystrobin | Fluindapyr | fenpropidin |
| Polyphenol | Copper | | | trifloxystrobin | fluxapyroxad | fenpropidin |
| Polyphenol | Copper | | | trifloxystrobin | Inpyrfluxam | fenpropidin |
| Polyphenol | Copper | | | trifloxystrobin | Adepidyn | Fenpropimorph |
| Polyphenol | Copper | | | trifloxystrobin | benzovindiflupyr | Fenpropimorph |
| Polyphenol | Copper | | | trifloxystrobin | bixafen | Fenpropimorph |
| Polyphenol | Copper | | | trifloxystrobin | Fluindapyr | Fenpropimorph |
| Polyphenol | Copper | | | trifloxystrobin | fluxapyroxad | Fenpropimorph |
| Polyphenol | Copper | | | trifloxystrobin | Inpyrfluxam | Fenpropimorph |
| Polyphenol | Copper | | | trifloxystrobin | | Fenpropimorph |
| Polyphenol | Copper | | | trifloxystrobin | | Fenpropidin |
| Polyphenol | Copper | | | trifloxystrobin | Adepidyn | |
| Polyphenol | Copper | | | trifloxystrobin | benzovindiflupyr | |
| Polyphenol | Copper | | | trifloxystrobin | bixafen | |
| Polyphenol | Copper | | | trifloxystrobin | Fluindapyr | |
| Polyphenol | Copper | | | trifloxystrobin | fluxapyroxad | |
| Polyphenol | Copper | | | trifloxystrobin | Inpyrfluxam | |
| Polyphenol | Copper | | cyproconazole | trifloxystrobin | | |
| Polyphenol | Copper | | difenoconazole | trifloxystrobin | | |
| Polyphenol | Copper | | flutriafol | trifloxystrobin | | |
| Polyphenol | Copper | | mefentrifluconazole | trifloxystrobin | | |
| Polyphenol | Copper | | prothioconazole | trifloxystrobin | | |
| Polyphenol | Copper | | tebuconazole | trifloxystrobin | | |
| Polyphenol | Copper | | tetraconazole | trifloxystrobin | | |
| Polyphenol | Copper | | cyproconazole | | | Fenpropidin |
| Polyphenol | Copper | | difenoconazole | | | Fenpropidin |
| Polyphenol | Copper | | flutriafol | | | Fenpropidin |
| Polyphenol | Copper | | mefentrifluconazole | | | Fenpropidin |
| Polyphenol | Copper | | prothioconazole | | | Fenpropidin |
| Polyphenol | Copper | | tebuconazole | | | Fenpropidin |
| Polyphenol | Copper | | tetraconazole | | | Fenpropidin |
| Polyphenol | Copper | | cyproconazole | | | Fenpropimorph |
| Polyphenol | Copper | | difenoconazole | | | Fenpropimorph |
| Polyphenol | Copper | | flutriafol | | | Fenpropimorph |
| Polyphenol | Copper | | mefentrifluconazole | | | Fenpropimorph |
| Polyphenol | Copper | | prothioconazole | | | Fenpropimorph |
| Polyphenol | Copper | | tebuconazole | | | Fenpropimorph |
| Polyphenol | Copper | | tetraconazole | | | Fenpropimorph |
| Polyphenol | Copper | | | | Adepidyn | Fenpropimorph |
| Polyphenol | Copper | | | | benzovindiflupyr | Fenpropimorph |
| Polyphenol | Copper | | | | bixafen | Fenpropimorph |
| Polyphenol | Copper | | | | Fluindapyr | Fenpropimorph |
| Polyphenol | Copper | | | | fluxapyroxad | Fenpropimorph |
| Polyphenol | Copper | | | | Inpyrfluxam | Fenpropimorph |
| Polyphenol | Copper | | | | Adepidyn | Fenpropidin |
| Polyphenol | Copper | | | | benzovindiflupyr | Fenpropidin |
| Polyphenol | Copper | | | | bixafen | Fenpropidin |
| Polyphenol | Copper | | | | Fluindapyr | Fenpropidin |
| Polyphenol | Copper | | | | fluxapyroxad | Fenpropidin |
| Polyphenol | Copper | | | | Inpyrfluxam | Fenpropidin |
| Polyphenol | Copper | | cyproconazole | | Adepidyn | |
| Polyphenol | Copper | | difenoconazole | | Adepidyn | |
| Polyphenol | Copper | | flutriafol | | Adepidyn | |
| Polyphenol | Copper | | flutriafol | | Adepidyn | |
| Polyphenol | Copper | | flutriafol | | Adepidyn | |
| Polyphenol | Copper | | mefentrifluconazole | | Adepidyn | |
| Polyphenol | Copper | | prothioconazole | | Adepidyn | |
| Polyphenol | Copper | | tebuconazole | | Adepidyn | |
| Polyphenol | Copper | | tetraconazole | | Adepidyn | |
| Polyphenol | Copper | | cyproconazole | | benzovindiflupyr | |
| Polyphenol | Copper | | difenoconazole | | benzovindiflupyr | |
| Polyphenol | Copper | | flutriafol | | benzovindiflupyr | |
| Polyphenol | Copper | | mefentrifluconazole | | benzovindiflupyr | |
| Polyphenol | Copper | | prothioconazole | | benzovindiflupyr | |
| Polyphenol | Copper | | tebuconazole | | benzovindiflupyr | |
| Polyphenol | Copper | | tetraconazole | | benzovindiflupyr | |
| Polyphenol | Copper | | cyproconazole | | bixafen | |
| Polyphenol | Copper | | difenoconazole | | bixafen | |
| Polyphenol | Copper | | flutriafol | | bixafen | |
| Polyphenol | Copper | | mefentrifluconazole | | bixafen | |
| Polyphenol | Copper | | prothioconazole | | bixafen | |
| Polyphenol | Copper | | tebuconazole | | bixafen | |
| Polyphenol | Copper | | tetraconazole | | bixafen | |
| Polyphenol | Copper | | cyproconazole | | Fluindapyr | |
| Polyphenol | Copper | | difenoconazole | | Fluindapyr | |
| Polyphenol | Copper | | mefentrifluconazole | | Fluindapyr | |
| Polyphenol | Copper | | prothioconazole | | Fluindapyr | |
| Polyphenol | Copper | | tebuconazole | | Fluindapyr | |
| Polyphenol | Copper | | tetraconazole | | Fluindapyr | |
| Polyphenol | Copper | | cyproconazole | | fluxapyroxad | |
| Polyphenol | Copper | | difenoconazole | | fluxapyroxad | |
| Polyphenol | Copper | | flutriafol | | fluxapyroxad | |
| Polyphenol | Copper | | mefentrifluconazole | | fluxapyroxad | |
| Polyphenol | Copper | | prothioconazole | | fluxapyroxad | |
| Polyphenol | Copper | | tebuconazole | | fluxapyroxad | |
| Polyphenol | Copper | | tetraconazole | | fluxapyroxad | |
| Polyphenol | Copper | | cyproconazole | | Inpyrfluxam | |
| Polyphenol | Copper | | difenoconazole | | Inpyrfluxam | |
| Polyphenol | Copper | | flutriafol | | Inpyrfluxam | |
| Polyphenol | Copper | | mefentrifluconazole | | Inpyrfluxam | |
| Polyphenol | Copper | | prothioconazole | | Inpyrfluxam | |
| Polyphenol | Copper | | tebuconazole | | Inpyrfluxam | |
| Polyphenol | Copper | | tetraconazole | | Inpyrfluxam | |
| Polyphenol | | | | azoxystrobin | Adepidyn | Fenpropidin |
| Polyphenol | | | | azoxystrobin | benzovindiflupyr | Fenpropidin |
| Polyphenol | | | | azoxystrobin | bixafen | Fenpropidin |
| Polyphenol | | | | azoxystrobin | Fluindapyr | Fenpropidin |
| Polyphenol | | | | azoxystrobin | fluxapyroxad | Fenpropidin |
| Polyphenol | | | | azoxystrobin | Inpyrfluxam | Fenpropidin |
| Polyphenol | | | | azoxystrobin | Adepidyn | Fenpropimorph |
| Polyphenol | | | | azoxystrobin | benzovindiflupyr | Fenpropimorph |
| Polyphenol | | | | azoxystrobin | bixafen | Fenpropimorph |
| Polyphenol | | | | azoxystrobin | Fluindapyr | Fenpropimorph |
| Polyphenol | | | | azoxystrobin | fluxapyroxad | Fenpropimorph |
| Polyphenol | | | | azoxystrobin | Inpyrfluxam | Fenpropimorph |
| Polyphenol | | | | azoxystrobin | Adepidyn | |
| Polyphenol | | | | azoxystrobin | benzovindiflupyr | |
| Polyphenol | | | | azoxystrobin | bixafen | |
| Polyphenol | | | | azoxystrobin | Fluindapyr | |
| Polyphenol | | | | azoxystrobin | fluxapyroxad | |
| Polyphenol | | | | azoxystrobin | Inpyrfluxam | |
| Polyphenol | | | cyproconazole | azoxystrobin | | |
| Polyphenol | | | difenoconazole | azoxystrobin | | |
| Polyphenol | | | flutriafol | azoxystrobin | | |
| Polyphenol | | | mefentrifluconazole | azoxystrobin | | |
| Polyphenol | | | prothioconazole | azoxystrobin | | |
| Polyphenol | | | tebuconazole | azoxystrobin | | |
| Polyphenol | | | tetraconazole | azoxystrobin | | |
| Polyphenol | | | | Mandestrobin | Adepidyn | fenpropidin |
| Polyphenol | | | | Mandestrobin | benzovindiflupyr | fenpropidin |
| Polyphenol | | | | Mandestrobin | bixafen | fenpropidin |
| Polyphenol | | | | Mandestrobin | Fluindapyr | fenpropidin |
| Polyphenol | | | | Mandestrobin | fluxapyroxad | fenpropidin |
| Polyphenol | | | | Mandestrobin | Inpyrfluxam | fenpropidin |
| Polyphenol | | | | Mandestrobin | Adepidyn | Fenpropimorph |
| Polyphenol | | | | Mandestrobin | benzovindiflupyr | Fenpropimorph |
| Polyphenol | | | | Mandestrobin | bixafen | Fenpropimorph |
| Polyphenol | | | | Mandestrobin | Fluindapyr | Fenpropimorph |
| Polyphenol | | | | Mandestrobin | fluxapyroxad | Fenpropimorph |
| Polyphenol | | | | Mandestrobin | Inpyrfluxam | Fenpropimorph |
| Polyphenol | | | | Mandestrobin | | Fenpropimorph |
| Polyphenol | | | | Mandestrobin | | Fenpropidin |
| Polyphenol | | | | Mandestrobin | Adepidyn | |
| Polyphenol | | | | Mandestrobin | benzovindiflupyr | |
| Polyphenol | | | | Mandestrobin | bixafen | |
| Polyphenol | | | | Mandestrobin | Fluindapyr | |
| Polyphenol | | | | Mandestrobin | fluxapyroxad | |
| Polyphenol | | | | Mandestrobin | Inpyrfluxam | |
| Polyphenol | | | cyproconazole | Mandestrobin | | |
| Polyphenol | | | difenoconazole | Mandestrobin | | |
| Polyphenol | | | flutriafol | Mandestrobin | | |
| Polyphenol | | | mefentrifluconazole | Mandestrobin | | |
| Polyphenol | | | prothioconazole | Mandestrobin | | |
| Polyphenol | | | tebuconazole | Mandestrobin | | |
| Polyphenol | | | tetraconazole | Mandestrobin | | |
| Polyphenol | | | | Metyltetraprole | Adepidyn | fenpropidin |
| Polyphenol | | | | Metyltetraprole | benzovindiflupyr | fenpropidin |
| Polyphenol | | | | Metyltetraprole | bixafen | fenpropidin |
| Polyphenol | | | | Metyltetraprole | Fluindapyr | fenpropidin |
| Polyphenol | | | | Metyltetraprole | fluxapyroxad | fenpropidin |
| Polyphenol | | | | Metyltetraprole | Inpyrfluxam | fenpropidin |
| Polyphenol | | | | Metyltetraprole | Adepidyn | Fenpropimorph |
| Polyphenol | | | | Metyltetraprole | benzovindiflupyr | Fenpropimorph |
| Polyphenol | | | | Metyltetraprole | bixafen | Fenpropimorph |
| Polyphenol | | | | Metyltetraprole | Fluindapyr | Fenpropimorph |
| Polyphenol | | | | Metyltetraprole | fluxapyroxad | Fenpropimorph |
| Polyphenol | | | | Metyltetraprole | Inpyrfluxam | Fenpropimorph |
| Polyphenol | | | | Metyltetraprole | | Fenpropimorph |
| Polyphenol | | | | Metyltetraprole | | Fenpropidin |
| Polyphenol | | | | Metyltetraprole | Adepidyn | |
| Polyphenol | | | | Metyltetraprole | benzovindiflupyr | |
| Polyphenol | | | | Metyltetraprole | bixafen | |
| Polyphenol | | | | Metyltetraprole | Fluindapyr | |
| Polyphenol | | | | Metyltetraprole | fluxapyroxad | |
| Polyphenol | | | | Metyltetraprole | Inpyrfluxam | |
| Polyphenol | | | cyproconazole | Metyltetraprole | | |
| Polyphenol | | | difenoconazole | Metyltetraprole | | |
| Polyphenol | | | flutriafol | Metyltetraprole | | |
| Polyphenol | | | mefentrifluconazole | Metyltetraprole | | |
| Polyphenol | | | prothioconazole | Metyltetraprole | | |
| Polyphenol | | | tebuconazole | Metyltetraprole | | |
| Polyphenol | | | tetraconazole | Metyltetraprole | | |
| Polyphenol | | | | metominostrobin | Adepidyn | fenpropidin |
| Polyphenol | | | | metominostrobin | benzovindiflupyr | fenpropidin |
| Polyphenol | | | | metominostrobin | bixafen | fenpropidin |
| Polyphenol | | | | metominostrobin | Fluindapyr | fenpropidin |
| Polyphenol | | | | metominostrobin | fluxapyroxad | fenpropidin |
| Polyphenol | | | | metominostrobin | Inpyrfluxam | fenpropidin |
| Polyphenol | | | | metominostrobin | Adepidyn | Fenpropimorph |
| Polyphenol | | | | metominostrobin | benzovindiflupyr | Fenpropimorph |
| Polyphenol | | | | metominostrobin | bixafen | Fenpropimorph |
| Polyphenol | | | | metominostrobin | Fluindapyr | Fenpropimorph |
| Polyphenol | | | | metominostrobin | fluxapyroxad | Fenpropimorph |
| Polyphenol | | | | metominostrobin | Inpyrfluxam | Fenpropimorph |
| Polyphenol | | | | metominostrobin | | Fenpropimorph |
| Polyphenol | | | | metominostrobin | | Fenpropidin |
| Polyphenol | | | | metominostrobin | Adepidyn | |
| Polyphenol | | | | metominostrobin | benzovindiflupyr | |
| Polyphenol | | | | metominostrobin | bixafen | |
| Polyphenol | | | | metominostrobin | Fluindapyr | |
| Polyphenol | | | | metominostrobin | fluxapyroxad | |
| Polyphenol | | | | metominostrobin | Inpyrfluxam | |
| Polyphenol | | | cyproconazole | metominostrobin | | |
| Polyphenol | | | difenoconazole | metominostrobin | | |
| Polyphenol | | | flutriafol | metominostrobin | | |
| Polyphenol | | | mefentrifluconazole | metominostrobin | | |
| Polyphenol | | | prothioconazole | metominostrobin | | |
| Polyphenol | | | tebuconazole | metominostrobin | | |
| Polyphenol | | | tetraconazole | metominostrobin | | |
| Polyphenol | | | | picoxystrobin | Adepidyn | Fenpropidin |
| Polyphenol | | | | picoxystrobin | benzovindiflupyr | Fenpropidin |
| Polyphenol | | | | picoxystrobin | Bixafen | Fenpropidin |
| Polyphenol | | | | picoxystrobin | Fluindapyr | Fenpropidin |
| Polyphenol | | | | picoxystrobin | fluxapyroxad | Fenpropidin |
| Polyphenol | | | | picoxystrobin | Inpyrfluxam | Fenpropidin |
| Polyphenol | | | | picoxystrobin | Adepidyn | Fenpropimorph |
| Polyphenol | | | | picoxystrobin | benzovindiflupyr | Fenpropimorph |
| Polyphenol | | | | picoxystrobin | Bixafen | Fenpropimorph |
| Polyphenol | | | | picoxystrobin | Fluindapyr | Fenpropimorph |
| Polyphenol | | | | picoxystrobin | fluxapyroxad | Fenpropimorph |
| Polyphenol | | | | picoxystrobin | Inpyrfluxam | Fenpropimorph |
| Polyphenol | | | | picoxystrobin | | Fenpropimorph |
| Polyphenol | | | | picoxystrobin | | Fenpropidin |
| Polyphenol | | | | picoxystrobin | Adepidyn | |
| Polyphenol | | | | picoxystrobin | benzovindiflupyr | |
| Polyphenol | | | | picoxystrobin | bixafen | |
| Polyphenol | | | | picoxystrobin | Fluindapyr | |
| Polyphenol | | | | picoxystrobin | fluxapyroxad | |
| Polyphenol | | | | picoxystrobin | Inpyrfluxam | |
| Polyphenol | | | cyproconazole | picoxystrobin | | |
| Polyphenol | | | difenoconazole | picoxystrobin | | |
| Polyphenol | | | flutriafol | picoxystrobin | | |
| Polyphenol | | | mefentrifluconazole | picoxystrobin | | |
| Polyphenol | | | prothioconazole | picoxystrobin | | |
| Polyphenol | | | tebuconazole | picoxystrobin | | |
| Polyphenol | | | tetraconazole | picoxystrobin | | |
| Polyphenol | | | | Pyraclostrobin | Adepidyn | fenpropidin |
| Polyphenol | | | | Pyraclostrobin | benzovindiflupyr | fenpropidin |
| Polyphenol | | | | Pyraclostrobin | bixafen | fenpropidin |
| Polyphenol | | | | Pyraclostrobin | Fluindapyr | fenpropidin |
| Polyphenol | | | | Pyraclostrobin | fluxapyroxad | fenpropidin |
| Polyphenol | | | | Pyraclostrobin | Inpyrfluxam | fenpropidin |
| Polyphenol | | | | Pyraclostrobin | Adepidyn | Fenpropimorph |
| Polyphenol | | | | Pyraclostrobin | benzovindiflupyr | Fenpropimorph |
| Polyphenol | | | | Pyraclostrobin | bixafen | Fenpropimorph |
| Polyphenol | | | | Pyraclostrobin | Fluindapyr | Fenpropimorph |
| Polyphenol | | | | Pyraclostrobin | fluxapyroxad | Fenpropimorph |
| Polyphenol | | | | Pyraclostrobin | Inpyrfluxam | Fenpropimorph |
| Polyphenol | | | | Pyraclostrobin | | Fenpropimorph |
| Polyphenol | | | | Pyraclostrobin | | Fenpropidin |
| Polyphenol | | | | Pyraclostrobin | Adepidyn | |
| Polyphenol | | | | Pyraclostrobin | benzovindiflupyr | |
| Polyphenol | | | | Pyraclostrobin | bixafen | |
| Polyphenol | | | | Pyraclostrobin | Fluindapyr | |
| Polyphenol | | | | Pyraclostrobin | fluxapyroxad | |
| Polyphenol | | | | Pyraclostrobin | Inpyrfluxam | |
| Polyphenol | | | cyproconazole | Pyraclostrobin | | |
| Polyphenol | | | difenoconazole | Pyraclostrobin | | |
| Polyphenol | | | flutriafol | Pyraclostrobin | | |
| Polyphenol | | | mefentrifluconazole | Pyraclostrobin | | |
| Polyphenol | | | prothioconazole | Pyraclostrobin | | |
| Polyphenol | | | tebuconazole | Pyraclostrobin | | |
| Polyphenol | | | tetraconazole | Pyraclostrobin | | |
| Polyphenol | | | | trifloxystrobin | Adepidyn | fenpropidin |
| Polyphenol | | | | trifloxystrobin | benzovindiflupyr | fenpropidin |
| Polyphenol | | | | trifloxystrobin | bixafen | fenpropidin |
| Polyphenol | | | | trifloxystrobin | Fluindapyr | fenpropidin |
| Polyphenol | | | | trifloxystrobin | fluxapyroxad | fenpropidin |
| Polyphenol | | | | trifloxystrobin | Inpyrfluxam | fenpropidin |
| Polyphenol | | | | trifloxystrobin | Adepidyn | Fenpropimorph |
| Polyphenol | | | | trifloxystrobin | benzovindiflupyr | Fenpropimorph |
| Polyphenol | | | | trifloxystrobin | bixafen | Fenpropimorph |
| Polyphenol | | | | trifloxystrobin | Fluindapyr | Fenpropimorph |
| Polyphenol | | | | trifloxystrobin | fluxapyroxad | Fenpropimorph |
| Polyphenol | | | | trifloxystrobin | Inpyrfluxam | Fenpropimorph |
| Polyphenol | | | | trifloxystrobin | | Fenpropimorph |
| Polyphenol | | | | trifloxystrobin | | Fenpropidin |
| Polyphenol | | | | trifloxystrobin | Adepidyn | |
| Polyphenol | | | | trifloxystrobin | benzovindiflupyr | |
| Polyphenol | | | | trifloxystrobin | bixafen | |
| Polyphenol | | | | trifloxystrobin | Fluindapyr | |
| Polyphenol | | | | trifloxystrobin | fluxapyroxad | |
| Polyphenol | | | | trifloxystrobin | Inpyrfluxam | |
| Polyphenol | | | cyproconazole | trifloxystrobin | | |
| Polyphenol | | | difenoconazole | trifloxystrobin | | |
| Polyphenol | | | flutriafol | trifloxystrobin | | |
| Polyphenol | | | mefentrifluconazole | trifloxystrobin | | |
| Polyphenol | | | prothioconazole | trifloxystrobin | | |
| Polyphenol | | | tebuconazole | trifloxystrobin | | |
| Polyphenol | | | tetraconazole | trifloxystrobin | | |
| Polyphenol | | | cyproconazole | | | Fenpropidin |
| Polyphenol | | | difenoconazole | | | Fenpropidin |
| Polyphenol | | | flutriafol | | | Fenpropidin |
| Polyphenol | | | mefentrifluconazole | | | Fenpropidin |
| Polyphenol | | | prothioconazole | | | Fenpropidin |
| Polyphenol | | | tebuconazole | | | Fenpropidin |
| Polyphenol | | | tetraconazole | | | Fenpropidin |
| Polyphenol | | | cyproconazole | | | Fenpropimorph |
| Polyphenol | | | difenoconazole | | | Fenpropimorph |
| Polyphenol | | | flutriafol | | | Fenpropimorph |
| Polyphenol | | | mefentrifluconazole | | | Fenpropimorph |
| Polyphenol | | | prothioconazole | | | Fenpropimorph |
| Polyphenol | | | tebuconazole | | | Fenpropimorph |
| Polyphenol | | | tetraconazole | | | Fenpropimorph |
| Polyphenol | | | | | Adepidyn | Fenpropimorph |
| Polyphenol | | | | | benzovindiflupyr | Fenpropimorph |
| Polyphenol | | | | | bixafen | Fenpropimorph |
| Polyphenol | | | | | Fluindapyr | Fenpropimorph |
| Polyphenol | | | | | fluxapyroxad | Fenpropimorph |
| Polyphenol | | | | | Inpyrfluxam | Fenpropimorph |
| Polyphenol | | | | | Adepidyn | Fenpropidin |
| Polyphenol | | | | | benzovindiflupyr | Fenpropidin |
| Polyphenol | | | | | bixafen | Fenpropidin |
| Polyphenol | | | | | Fluindapyr | Fenpropidin |
| Polyphenol | | | | | fluxapyroxad | Fenpropidin |
| Polyphenol | | | | | Inpyrfluxam | Fenpropidin |
| Polyphenol | | | cyproconazole | | Adepidyn | |
| Polyphenol | | | difenoconazole | | Adepidyn | |
| Polyphenol | | | flutriafol | | Adepidyn | |
| Polyphenol | | | flutriafol | | Adepidyn | |
| Polyphenol | | | flutriafol | | Adepidyn | |
| Polyphenol | | | mefentrifluconazole | | Adepidyn | |
| Polyphenol | | | prothioconazole | | Adepidyn | |
| Polyphenol | | | tebuconazole | | Adepidyn | |
| Polyphenol | | | tetraconazole | | Adepidyn | |
| Polyphenol | | | cyproconazole | | benzovindiflupyr | |
| Polyphenol | | | difenoconazole | | benzovindiflupyr | |
| Polyphenol | | | flutriafol | | benzovindiflupyr | |
| Polyphenol | | | mefentrifluconazole | | benzovindiflupyr | |
| Polyphenol | | | prothioconazole | | benzovindiflupyr | |
| Polyphenol | | | tebuconazole | | benzovindiflupyr | |
| Polyphenol | | | tetraconazole | | benzovindiflupyr | |
| Polyphenol | | | cyproconazole | | bixafen | |
| Polyphenol | | | difenoconazole | | bixafen | |
| Polyphenol | | | flutriafol | | bixafen | |
| Polyphenol | | | mefentrifluconazole | | bixafen | |
| Polyphenol | | | prothioconazole | | bixafen | |
| Polyphenol | | | tebuconazole | | bixafen | |
| Polyphenol | | | tetraconazole | | bixafen | |
| Polyphenol | | | cyproconazole | | Fluindapyr | |
| Polyphenol | | | difenoconazole | | Fluindapyr | |
| Polyphenol | | | mefentrifluconazole | | Fluindapyr | |
| Polyphenol | | | prothioconazole | | Fluindapyr | |
| Polyphenol | | | tebuconazole | | Fluindapyr | |
| Polyphenol | | | tetraconazole | | Fluindapyr | |
| Polyphenol | | | cyproconazole | | fluxapyroxad | |
| Polyphenol | | | difenoconazole | | fluxapyroxad | |
| Polyphenol | | | flutriafol | | fluxapyroxad | |
| Polyphenol | | | mefentrifluconazole | | fluxapyroxad | |
| Polyphenol | | | prothioconazole | | fluxapyroxad | |
| Polyphenol | | | tebuconazole | | fluxapyroxad | |
| Polyphenol | | | tetraconazole | | fluxapyroxad | |
| Polyphenol | | | cyproconazole | | Inpyrfluxam | |
| Polyphenol | | | difenoconazole | | Inpyrfluxam | |
| Polyphenol | | | flutriafol | | Inpyrfluxam | |
| Polyphenol | | | mefentrifluconazole | | Inpyrfluxam | |
| Polyphenol | | | prothioconazole | | Inpyrfluxam | |
| Polyphenol | | | tebuconazole | | Inpyrfluxam | |
| Polyphenol | | | tetraconazole | | Inpyrfluxam | |

### Illustrative Table 2 Matrix Embodiments #10

In the following matrix presented as Table 2 displaying four options for the multi-component combinations, each row represents several possible individual embodiments wherein, each occasion of Protectant is at least one, or any mixtures of Mancozeb, Chlorothalonil or Fluazinam; each occasion of Azole is at least one, or any mixtures of Cyproconazole, Difenoconazole, Flutriafol, mefentrifluconazole, Prothioconazole, Tebuconazole, Tetraconazole, each occasion of Strobilurin is at least one, or any mixtures of Azoxystrobin, Mandestrobin, metominostrobin, Metyltetraprole, picoxystrobin, Pyraclostrobin, trifloxystrobin; each occasion of SDHI is at least one, or any mixtures of Adepidyn, benzovindiflupyr, Bixafen, Fluindapyr, Fluxapyroxad, Inpyrfluxam; and each occasion of Morphline is at least one, or any mixtures of fenpropidin or Fenpropimorh

TABLE 2
Four Matrix Options

| Component (1) | Component (3) | | COMPONENT (2) Fungicide (A) | | | |
|---|---|---|---|---|---|---|
| Polyphenol | Copper | Protectant | Azole | Strobilurin | SDHI | Morpholine |

Option #1 without Protectant

| | | | | | |
|---|---|---|---|---|---|
| x | x | x | x | | |
| x | x | x | | x | |
| x | x | x | | | x |
| x | x | | x | | x |
| x | x | | | x | x |
| X | x | | x | x | |

Option #2 with Neither Copper nor Protectant

| | | | | |
|---|---|---|---|---|
| x | x | x | | |
| x | x | | x | |
| x | x | | | x |
| x | | x | | x |
| x | | | x | x |
| x | | x | x | |

Option #3 with Both Protectant and Copper

| | | | | | | |
|---|---|---|---|---|---|---|
| x | x | x | x | x | | |
| x | x | x | x | | x | |
| x | x | x | x | | | x |
| x | x | x | | x | | x |
| x | x | x | | | x | x |
| x | x | x | | x | x | |

Option #4 with Protectant without Copper

| | | | | | |
|---|---|---|---|---|---|
| x | x | x | x | | |
| x | x | x | | x | |
| x | x | x | | | x |
| x | x | | x | | x |
| x | x | | | x | x |
| x | x | | x | x | |

### Dose Embodiments #11

In some embodiments, the combination of the invention, comprises between about 10 g/ha and 350 g/ha of polyphenol-based component (1); and strobilurin fungicide and Azole fungicide as component (2).

In some embodiments, the combination of the invention, comprises between about 10 g/ha and 350 g/ha of polyphenol-based component (1); between about 40 g/ha and 200 g/ha of strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; and fluoxastrobin; and any mixtures thereof in combination with at least one Azole fungicide as component (2).

In some embodiments, the combination of the invention, comprises between about 10 g/ha and 350 g/ha of polyphenol-based component (1); and as component (2), strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; and fluoxastrobin; and any mixtures thereof in combination with at least one Azole fungicide selected from azaconazole; bitertanol; bromuconazole; cyproconazole; difenoconazole; diniconazole; epoxiconazole; etaconazole; fenbuconazole; fluquinconazole; flusilazole; flutriafol; hexaconazole; imibenconazole; ipconazole; metconazole; myclobutanil, penconazole, propiconazole, simeconazole, tebuconazole, tetraconazole, triadimefon, triadimenol, triticonazole, prothioconazole, mefentrifluconazole, and any mixtures thereof.

In some embodiments, the combination of the invention, comprises between about 10 g/ha and 350 g/ha of polyphenol-based component (1); and as component (2), strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; fluoxastrobin; and any strobilurin mixtures thereof, in combination with at least one Azole fungicide selected from azaconazole; bitertanol; bromuconazole; 15 g/ha-80 g/ha cyproconazole; 30 g/ha-100 g/ha difenoconazole; diniconazole; epoxiconazole; etaconazole; fenbuconazole; 50 g/ha-150 g/ha fluquinconazole; flusilazole; flutriafol; hexaconazole; imibenconazole; ipconazole; metconazole; myclobutanil, penconazole, propiconazole, simeconazole, 40 g/ha-150 g/ha tebuconazole, 40 g/ha-100 g/ha tetraconazole, triadimefon, triadimenol, triticonazole, 40 g/ha-120 g/ha prothioconazole, 50 g/ha-150 g/ha mefentrifluconazole, and any azole fungicide mixtures thereof.

In some embodiments, the combination of the invention, comprises between about 40 g/ha and about 90 g/ha sometimes, between about 43.75 g/ha and 87.5 g/ha, of polyphenol-based component (1); and as component (2), strobilurin fungicide selected from 40 g a.i./ha-200 g a.i./ha picoxystrobin, 50 g a.i./ha-150 g a.i./ha picoxystrobin, about 60 g a.i./ha picoxystrobin, 60 g/ha-70 g/ha picoxystrobin, and typically about 65 g/ha picoxystrobin; in combination with at least one Azole fungicide selected from about 40 g/ha-150 g/ha tebuconazole;
about 75 g/ha-about 110 g a.i./ha tebuconazole;
about 80 g/ha tebuconazole;
75 g/ha-110 g/ha tebuconazole;
about 80 g/ha tebuconazole;
40 g a.i./ha to about 120 g a.i./ha prothioconazole;
60 g/ha-80 g/ha prothioconazole;
about 70 g/ha prothioconazole;
about 63 g/ha prothioconazole; and
azole fungicide mixtures thereof.

In some embodiments, the combination of the invention, comprises between about 10 g/ha and 350 g/ha typically about 40 g/ha-90 g/ha commonly, 43.75 g/ha-87.5 g/ha, of polyphenol-based component (1); and Azole fungicide combined with SDHI fungicide selected from the group of penthiopyrad; boscalid; flutolanil; fluxapyroxad; fluopyram; fluindapyr; bixafen; pydiflumetofen; inpyrfluxam; benzovindiflupyr (Adepidyn) and any SDHI fungicide combinations thereof, as component (2).

In some embodiments, the combination of the invention, comprises between about 10 g/ha and 350 g/ha of polyphenol-based component (1); a combination of strobilurin fungicide and Azole fungicide as component (2) and protectant fungicide selected from fluazinam; chlorothalonil; mancozeb; sulphur; folpet; maneb; metiram; polycarbamate; propineb, zineb captan and mixtures thereof as component (3).

In some embodiments, the combination of the invention, comprises between about 10 g/ha and 350 g/ha of polyphenol-based component (1); between about 40 g/ha and 200 g/ha of strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; and fluoxastrobin; and any mixtures thereof in combination with at least one azole fungicide as component (2) and protectant fungicide selected from fluazinam; chlorothalonil; mancozeb; sulphur; folpet; maneb; metiram; polycarbamate; propineb; zineb captan and mixtures thereof as component (3).

In some embodiments, the combination of the invention, comprises between about 10 g/ha and 350 g/ha of polyphenol-based component (1); and as component (2), strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; and fluoxastrobin; and any mixtures thereof in combination with at least one Azole fungicide selected from azaconazole; bitertanol; bromuconazole; cyproconazole; difenoconazole; diniconazole; epoxiconazole; etaconazole; fenbuconazole; fluquinconazole; flusilazole; flutriafol; hexaconazole; imibenconazole; ipconazole; metconazole; myclobutanil, penconazole, propiconazole, simeconazole, tebuconazole, tetraconazole, triadimefon, triadimenol, triticonazole, prothioconazole, mefentrifluconazole, and any mixtures thereof, and protectant fungicide selected from fluazinam; chlorothalonil; (EBDC) mancozeb; sulphur; folpet; maneb; metiram; polycarbamate; propineb; zineb captan and mixtures thereof as component (3).

In some embodiments, the combination of the invention, comprises between about 10 g/ha and 350 g/ha of polyphenol-based component (1); and as component (2), strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; fluoxastrobin; and any strobilurin mixtures thereof, in combination with at least one Azole fungicide selected from azaconazole; bitertanol; bromuconazole; 15 g/ha-80 g/ha cyproconazole; 30 g/ha-100 g/ha difenoconazole; diniconazole; epoxiconazole; etaconazole; fenbuconazole; 50 g/ha-150 g/ha fluquinconazole; flusilazole; flutriafol; hexaconazole; imibenconazole; ipconazole; metconazole; myclobutanil, penconazole, propiconazole, simeconazole, 40 g/ha-150 g/ha tebuconazole, 40 g/ha-100 g/ha tetraconazole, triadimefon, triadimenol, triticonazole, 40 g/ha-120 g/ha prothioconazole, 50 g/ha-150 g/ha mefentrifluconazole, and any azole fungicide mixtures thereof with protectant fungicide selected from fluazinam; chlorothalonil; (EBDC) mancozeb; sulphur; folpet; maneb; metiram; polycarbamate; propineb; zineb captan and mixtures thereof as component (3).

In some embodiments, the combination of the invention, comprises between about 40 g/ha and about 90 g/ha often, between about 43.75 g/ha and 87.5 g/ha of polyphenol-based component (1); and as component (2), strobilurin fungicide selected from,
i. 40 g a.i./ha-200 g a.i./ha picoxystrobin,
ii. 50 g a.i./ha-150 g a.i./ha picoxystrobin
iii. about 60 g a.i./ha picoxystrobin
iv. 60 g/ha-70 g/ha picoxystrobin,
v. about 65 g/ha picoxystrobin;
in combination with at least one azole fungicide selected from
   i. about 75 g/ha-110 g/ha tebuconazole;
   ii. about 80 g/ha tebuconazole; and
   iii 60 g/ha-80 g/ha prothioconazole,
   iv. about 63 g/ha prothioconazole; and
   v. azole fungicide mixtures thereof,
often combined with protectant fungicide selected from
   a. about 200 g/ha-500 g/ha fluazinam;
   b. about 300 g/ha fluazinam;
   c. about 400 g/ha-1200 g/ha chlorothalonil;
   d. about 400 g/ha-1000 g/ha chlorothalonil;
   e. about 700 g/ha chlorothalonil;
   f. (EBDC) 400 g/ha-1500 g/ha mancozeb;
   g. 400 g/ha-900 g/ha mancozeb;
   h. about 700 g/ha mancozeb; and
   i. protectant fungicide mixtures thereof
as component (3).

In some embodiments, the combination of the invention, comprises between about 10 g/ha and 350 g/ha typically about 40 g/ha-90 g/ha (e.g., 43.8-87.5 g/ha) of polyphenol-based component (1); and Azole fungicide combined with SDHI fungicide selected from the group of penthiopyrad; boscalid; flutolanil; fluxapyroxad; fluopyram; fluindapyr; bixafen; pydiflumetofen; inpyrfluxam; benzovindiflupyr (Adepidyn) and any SDHI fungicide combinations thereof, as component (2) combined with protectant fungicide selected from about 200 g/ha-500 g/ha, typically about 300 g/ha fluazinam; about 400 g/ha-1200 g/ha commonly about 700 g/ha chlorothalonil; (EBDC) about 400 g/ha-1500 g/ha commonly about 700 g/ha mancozeb; and protectant fungicide mixtures thereof as component (3).

In some embodiments, the combination of the invention, comprises between about 10 g/ha and 350 g/ha of polyphenol-based component (1); a combination of strobilurin fungicide and Azole fungicide as component (2) and copper-based compound selected from cupric acetate, cupric chloride, cupric chlorate, cupric formate, cupric hexafluoro silicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, chelated (or complexed), copper with e.g., EDTA; Copper chelated (or complexed), with amino acids; copper glycinate; copper alaninates; or any and all combinations thereof, as component (3).

In some embodiments, the combination of the invention, comprises between about 10 g/ha and 350 g/ha of polyphenol-based component (1); between about 40 g/ha and 200 g/ha of strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; and fluoxastrobin; and any mixtures thereof in combination with at least one Azole fungicide as component (2) and about 1 g/ha-350 g/ha and preferably 5 g/ha-50 g/ha metallic copper in the form of copper-based compound selected from cupric acetate, cupric chloride, cupric chlorate, cupric formate, cupric hexafluoro silicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, chelated (or complexed), copper with e.g., EDTA; Copper chelated (or complexed), with amino acids; copper glycinate; copper alaninates; or any and all combinations thereof, as component (3).

In some embodiments, the combination of the invention, comprises between about 10 g/ha and 350 g/ha of polyphenol-based component (1); and as component (2), strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; and fluoxastrobin; and any mixtures thereof in combination with at least one Azole fungicide selected from azaconazole; bitertanol; bromuconazole; cyproconazole; difenoconazole; diniconazole; epoxiconazole; etaconazole; fenbuconazole; fluquinconazole; flusilazole; flutriafol; hexaconazole; imibenconazole; ipconazole; metconazole; myclobutanil, penconazole, propiconazole, simeconazole, tebuconazole, tetraconazole, triadimefon, triadimenol, triticonazole, prothioconazole, mefentrifluconazole, and any azole mixtures thereof, and about 1 g/ha-350 g/ha and preferably 5 g/ha-50 g/ha metallic copper in the form of copper-based compound selected from cupric acetate, cupric chloride, cupric chlorate, cupric formate, cupric hexafluoro silicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, chelated (or complexed), copper with e.g., EDTA; Copper chelated (or complexed), with amino acids; copper glycinate; copper alaninates; or any and all combinations thereof, as component (3).

In some embodiments, the combination of the invention, comprises between about 10 g/ha and 350 g/ha of polyphenol-based component (1); and as component (2), strobilurin fungicide selected from azoxystrobin; coumoxystrobin; enoxastrobin; flufenoxystrobin; picoxystrobin; pyraoxystrobin; mandestrobin; pyraclostrobin; pyrametostrobin; triclopyricarb; kresoxim-methyl; trifloxystrobin; dimoxystrobin; fenaminstrobin; metominostrobin; orysastrobin; metyltetraprole; fluoxastrobin; and any strobilurin mixtures thereof, in combination with at least one Azole fungicide selected from azaconazole; bitertanol; bromuconazole; 15 g/ha-80 g/ha cyproconazole; 30 g/ha-100 g/ha difenoconazole; diniconazole; epoxiconazole; etaconazole; fenbuconazole; 50 g/ha-150 g/ha fluquinconazole; flusilazole; flutriafol; hexaconazole; imibenconazole; ipconazole; metconazole; myclobutanil, penconazole, propiconazole, simeconazole, 40 g/ha-150 g/ha tebuconazole, 40 g/ha-100 g/ha tetraconazole, triadimefon, triadimenol, triticonazole, 40 g/ha-120 g/ha prothioconazole, 50 g/ha-150 g/ha mefentrifluconazole, and any azole fungicide mixtures thereof with about 1 g/ha-350 g/ha and preferably 5 g/ha-50 g/ha metallic copper in the form of copper-based compound selected from cupric acetate, cupric chloride, cupric chlorate, cupric formate, cupric hexafluoro silicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, chelated (or complexed), copper with e.g., EDTA; Copper chelated (or complexed), with amino acids; or both; copper glycinate; copper alaninates; or any and all combinations thereof, as component (3).

In some embodiments, the combination of the invention, comprises between about 40 g/ha and about 90 g/ha, commonly between about 43.75 g/ha and 87.5 g/ha of polyphenol-based component (1); and as component (2), strobilurin fungicide selected from 60 g/ha-70 g/ha, preferably about 65 g/ha picoxystrobin; in combination with at least one Azole fungicide selected from about 75 g/ha-110 g/ha preferably about 80 g/ha tebuconazole; and 60 g/ha-80 g/ha, exemplified by about 63 g/ha prothioconazole; and azole fungicide mixtures thereof combined with copper-based compound selected from cupric acetate, cupric chloride, cupric chlorate, cupric formate, cupric hexafluoro silicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, chelated (or complexed), copper with e.g., EDTA; Copper chelated (or complexed), with amino acids; copper glycinate; copper alaninates; or any and all combinations thereof, as component (3).

In some embodiments, the combination of the invention, comprises between about 10 g/ha and 350 g/ha typically 40 g/ha-90 g/ha of polyphenol-based component (1); and Azole fungicide combined with SDHI fungicide selected from the group of penthiopyrad; boscalid; flutolanil; fluxapyroxad; fluopyram; fluindapyr; bixafen; pydiflumetofen; inpyrfluxam; benzovindiflupyr (Adepidyn) and any SDHI fungicide combinations thereof, as component (2) combined with copper-based compound selected from cupric acetate, cupric chloride, cupric chlorate, cupric formate, cupric hexafluoro silicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, chelated (or complexed), copper with e.g., EDTA; Copper chelated (or complexed), with amino acids; copper glycinate; copper alaninates; or any and all combinations thereof, as component (3).

In preferred embodiments comprising polyphenol-based component (1), systemic fungicide compound(s) (A) as component (2), component (3) does not comprise any Protectant fungicide but rather, comprises only copper-based compounds selected from cupric acetate, cupric chloride, cupric chlorate, cupric formate, cupric hexafluoro silicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, chelated (or complexed), copper with e.g., EDTA; Copper chelated (or complexed), with amino acids; copper glycinate; copper alaninates; or any and all combinations thereof.

In several embodiments, the combination of the invention, comprises about 40 g/ha-90 g/ha commonly, about 43.75 g/ha-87.5 g/ha, combined extracts of natural water-soluble Tannins and Proanthocyanidins as polyphenol-based component (1), a combination of 80 g/ha tebuconazole and 65 g/ha picoxystrobin as component (2).

In several embodiments, the combination of the invention, comprises about 40 g/ha-90 g/ha commonly, about 43.75 g/ha-87.5 g/ha, combined extracts of natural water-soluble Tannins and Proanthocyanidins as polyphenol-based component (1), a combination of 80 g/ha tebuconazole and 65 g/ha picoxystrobin as component (2) and 8.75 g/ha metallic copper in the form of chelated (or complexed), copper with e.g., EDTA; copper chelated (or complexed), with amino acids; copper glycinate; copper alaninates; or any and all copper-based combinations thereof as component (3).

In several embodiments, the combination of the invention, comprises about 40 g/ha, combined extracts of natural water-soluble Tannins and Proanthocyanidins as polyphenol-based component (1), a combination of 80 g/ha tebuconazole and 65 g/ha picoxystrobin as component (2) and 8.75 g/ha metallic copper in the form of chelated (or complexed), copper with e.g., EDTA; copper chelated (or complexed), with amino acids; copper glycinate; copper alaninates; or any and all copper-based combinations thereof, as component (3).

In an embodiment, the combination of the invention, comprises about 40 g/ha-90 g/ha commonly, about 43.75 g/ha-87.5 g/ha combined extracts of natural water-soluble Tannins and Proanthocyanidins as polyphenol-based component (1), a combination of 80 g/ha tebuconazole and 65 g/ha picoxystrobin as component (2) and 600 g/ha protectant fungicide exemplified by EBDC mancozeb as component (3).

In an embodiment, the combination of the invention, comprises about 40 g/ha-90 g/ha commonly, about 43.75 g/ha-87.5 g/ha, combined extracts of natural water-soluble Tannins and Proanthocyanidins as polyphenol-based component (1), a combination of 80 g/ha tebuconazole and 65 g/ha picoxystrobin as component (2) and a mixture of 600 g/ha protectant fungicide exemplified by EBDC mancozeb and 8.75 g/ha metallic copper in the form of chelated (or complexed), copper with e.g., EDTA; copper chelated (or complexed), with amino acids; copper glycinate; copper alaninates; or any and all copper-based combinations thereof, as component (3).

In an embodiment, the combination of the invention, comprises about 40 g/ha combined extracts of natural water-soluble Tannins and Proanthocyanidins as polyphenol-based component (1), a combination of 80 g/ha tebuconazole and 65 g/ha picoxystrobin as component (2) and a mixture of 600 g/ha protectant fungicide exemplified by EBDC mancozeb and 8.75 g/ha metallic copper in the form of chelated (or complexed), copper with e.g., EDTA; copper chelated (or complexed), with amino acids; copper glycinate; copper alaninates; or any and all copper-based combinations thereof.

In some embodiments, the combination of the invention, comprises a combination of components (1) and (3) for combination with the systemic fungicides of component (2) selected from any one of the following mixtures or other mixtures that maintain the ratios of each of the following

$$Polyphenol = 88 + Copper 7.5 g / ha , about 12 : 1$$

$$Polyphenol = 88 + Copper 7.5 g / ha + mancozeb 600 g / ha , about 12 : 1 : 80$$

$$Polyphenol = 44 + Copper 7.5 g / ha , about 6 : 1$$

$$Polyphenol = 44 + Copper 7.5 g / ha + mancozeb 600 g / ha , about 6 : 1 : 80$$

$$Polyphenol = 87.5 + Copper 175 g / ha , about 1 : 2$$

$$Polyphenol = 87. 5 + 175 g / ha , + mancozeb 600 g / ha , about 1 : 2 : 3.4 {[}^{\sim} 1 : 2 : 3 ]$$

$$Polyphenol = 44 + Copper 8.75 g / ha , about 5 : 1$$

$$Polyphenol = 44 + Copper 8.75 g / ha + mancozeb 600 g / ha , about 5 : 1 : 69$$

$$Polyphenol = 87.5 + Copper 8.75 g / ha , about 10 : 1$$

$$Polyphenol = 87.5 + Copper 8.75 g / ha + mancozeb 600 g / ha , about 10 : 1 : 69$$

$$Polyphenol = 44 + Copper 3.75 g / ha about 12 : 1$$

$$Polyphenol = 22 + Copper 3.75 g / ha + mancozeb 300 g / ha about 6 : 1 : 80$$

$$Polyphenol = 7.5 g / ha + Copper 10 g / ha , about 3 : 4$$

$$Polyphenol = 7.5 g / ha + Copper 10 g / ha + mancozeb 300 g / ha about 3 : 4 : 120$$

$$Polyphenol = 15 g / ha + Copper 20 g / ha about , 3 : 4.$$

$$Polyphenol = 15 g / ha + Copper 20 g / ha + mancozeb 300 g / ha about , 3 : 4 : 120.$$

$$Polyphenol 35 \% + Chelated Copper 30 \%$$

$$Polyphenol 35 \% + Chelated Copper 3 \%$$

In some particularly noted embodiments, the component (2) systemic fungicides for combining with the above combination of components (1) and (3), are chosen from combinations of at least two of, picoxystrobin; Azoxystrobin; fluxapyroxad; tebuconazole, and prothioconazole.

### Dose Format Embodiments #12

In particular embodiments the combination of the invention is prepared by combining a composition of Polyphenol-based compound with copper-based compound(s) [components (1) and (3)] with a separate mixture/composition of two systemic fungicides, and optionally Mancozeb (EBDC) [component (2) or component (2)+Protectant component (3)]. The preparative combining can be at the point of use or Tank-mix from a kit or from separate commercially available compositions etc., comprising the two compositions, or from compositions with instructions or otherwise adapted to be combined within the scope of this invention.

In some embodiments, the combination is mixture. In some embodiments the combination is a kit of parts intended or adapted for mixing before application. In some embodiments the parts of the kit are individual compositions that are both diluted combined and/or mixed.

In some embodiments, the weight ratio of the polyphenol-based component (1) to component (2) comprising fungicide(s) (A) in any combination disclosed or alluded to herein is from about 1:100 to about 100:1 In some embodiments, the weight ratio of the polyphenol-based component (1) to component (2) comprising fungicide(s) (A) in any combination disclosed or alluded to herein is from about 1:25 to about 25:1. In some embodiments, the weight ratio of the polyphenol-based component (1) to component (2) comprising fungicide(s) (A) in any combination disclosed or alluded to herein is from about 1:10 to 10:1. In some embodiments, the weight ratio of the polyphenol-based component (1) to component (2) comprising fungicide(s) (A) in any combination disclosed or alluded to herein is from about 1:5 to 5:1. In some embodiments, the weight ratio of the polyphenol-based component (1) to component (2) comprising fungicide(s) (A) in any combination disclosed or alluded to herein is from about 1:2 to 2:1 In some embodiments, the weight ratio of the polyphenol-based component (1) to component (2) comprising fungicide(s) (A) in any combination disclosed or alluded to herein is from about 1:1.

In some embodiments the component (2) fungicide (A) is a combination of two or more fungicides from the same fungicidal classification group or from different fungicidal classification groups, fungicides being classified either by chemical structure or their mode of action

In some embodiments, a difference in fungicidal group refers to, but is not limited to the differences in the chemical structure(s) and/or mode of action of the fungicides. e.g., QiI fungicide (quinone inside inhibitors), SDHI fungicide (succinate dehydrogenase inhibitors), azole fungicide, morpholine fungicide, strobilurin fungicide.

### Improved Combination Embodiments #13

In some embodiments, the combination comprises an improved combination in that it is synergistic, inter alia, in its fungicidal efficacy, or other beneficial attribute associated with any one or more of the active compounds that are included in the combination as compared to when they are each employed independently.

In some embodiments, the combination comprises improved combinations in that they are synergistic, inter alia, in their fungicidal efficacy, or other beneficial attribute associated with the combination of active compounds of component (2) and component (3), when present, that are included in the combination together with component (1) as compared to when only component (2) and component (3) when present, is employed in the absence of component (1).

In some copper-containing embodiments, the inventive combination comprises improved combinations in that they improve Plant Health benefits exemplified by reducing the stress, e.g., improved non biotic stress mitigation, and Phytotoxicity from Copper that is associated with comparable copper containing fungicidal combinations without the polyphenol-based component, which require much higher levels of copper.

In some embodiments, the combination comprises an improved combination in that the amount of the polyphenol-based component (1) and the amount of component (2) comprising at least one fungicide (A) are more effective in combination application as described previously, for treating a plant or locus against fungal and/or bacterial infection than when the amount of the polyphenol-based component (1) and the amount of component (2) fungicide (A) are applied alone without the other.

In some embodiments, the combination of the invention comprises an improved combination in that the amount of the amount of the polyphenol-based component (1), and the amount of component (2) comprising at least one fungicide (A) are more effective for treating a plant or locus against fungal and/or bacterial/microbial infection if applied in combination than if the same amount of the component (2) is not applied in combination with the same amount of the polyphenol-based component.

In some embodiments, the combination comprises an improved combination in that the amount of the polyphenol-based component (1) is more effective for treating a plant or locus against fungal infection if applied in combination with the amount of the component (2) comprising fungicide (A) than if the same amount of the polyphenol-based component is not applied in combination with the same amount of the fungicide (A).

In some embodiments, the combination comprises an improved combination in that the amount of the polyphenol-based component (1) improves the fungicidal efficacy of the amount of the component (2) fungicide(s) compared to when the same amount of the fungicide(s) is applied not in combination with the amount of the polyphenol-based component

In some embodiments, the locus is soil.

In some embodiments, the combination comprises an improved combination in that the amount of the polyphenol-based component (1) improves the beneficial effects of applying the amount of the fungicide(s) component (2) compared to when the same amount of the fungicide(s) is not applied in combination with the amount of the polyphenol-based component. These beneficial effects are any of improved emergence, crop yields, protein content, oil content, starch content, more developed root system (improved root growth), improved stress tolerance or improved non biotic stress mitigation (e.g. against drought, heat, salt, UV, water, cold), reduced ethylene (reduced production and/or inhibition of reception), reduced phytotoxicity, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), shortening of stalks, increased diameter of stalks, increased shoot growth, enhanced plant vigor, increased plant stand and early and better germination.

In some embodiments, the combination of the invention comprises an improved three-component combination in that the amount of either the copper-based compound and/or the protectant fungicide of component (3) are significantly reduced without any loss of efficacy when applied in combination with the amount of the polyphenol-based component (1) and the amount of component (2) comprising at least one fungicide (A) in combination application as described previously, for treating a plant or locus against fungal and/or bacterial infection, compared to combinations that include the same amount of component (2) fungicide(s) (A) and the same copper-based compound and/or the protectant fungicide of component (3) applied without the amount of the polyphenol-based component (1).

In some embodiments, the reduction in the amounts of either the copper-based compound(s) and/or the protectant fungicide(s) of component (3) as described above, without loss of efficacy, in three component fungicidal combinations of the invention are exemplified by any or all of, fluazinam content between about 200 g/ha-500 g/ha and preferably about 300 g/ha; chlorothalonil content between about 400 g/ha-1200 g/ha and preferably about 700 g/ha; mancozeb content between about 400 g/ha-1500 g/ha and preferably about 700 g/ha, copper-based compounds (based on the metallic copper content), of between about 1 g/ha-350 g/ha preferably between about 5 g/ha-50 g/ha, and even more preferably less than 20 g/ha and desirably, below 10 g/ha. The invention can enable a reduction in the amounts of copper-based compounds and/or protectant fungicides exemplified by ethylene bisdithiocarbamate fungicides e.g., Mancozeb, required for fungicidal efficacy of systemic fungicides or even eliminate the need for their use, often resulting in equivalent or superior fungicidal activity with reduced incidence of phytotoxicity.

In some embodiments, the multi-component compositions of the invention comprise polyphenol-based compounds as component (1) and a mixture of triazole and strobilurin fungicides as component (2) and ethylene bisdithiocarbamate (EBDC) fungicide as component (3) wherein the amount of EBDC is reduced by at least 25% as compared to previously known fungicidal combinations of the same mixture of triazole and strobilurin fungicides and EBDC.

In some embodiments, the multi-component compositions of the invention comprise polyphenol-based compounds as component (1) and a mixture of triazole and strobilurin fungicides as component (2) and chelated copper or complexed copper as component (3). In these combinations the copper compounds can significantly reduce the amount of ethylene bisdithiocarbamate (EBDC) Protectant fungicide encountered in previously known fungicidal combinations which contain the same mixture of triazole and strobilurin fungicides and EBDC such as mancozeb, or entirely replace the EBDC Protectant fungicide.

In some multi-component combination embodiments, fungicidal efficacy of the compounds comprising component (2), is increased by at least 10%, about 20% or more, or about 30% and above, compared to when the same amount of the systemic fungicide component (2) compound(s) (A), is/are applied alone. In some embodiments, fungicidal efficacy is increased by at least 50%, about 100% or more, about 200% or more or about 300% or more, compared to when the same amount of the fungicide is applied alone.

In some embodiments, fungicidal efficacy is measured in a treated area of the plant. In some embodiments, fungicidal efficacy is measured in an untreated area of the plant. In some embodiments, fungicidal efficacy is increased in a treated area of the soil or locus. In some embodiments, fungicidal efficacy is increased in an untreated area of the soil or locus.

In some embodiments, fungicidal efficacy is measured at least 7 days after initial and/or each, treatment, or application.

In some embodiments, fungicidal efficacy is measured at least 14 days after initial and/or each, treatment, or application. In some embodiments, fungicidal efficacy is measured at least 21 days after initial and/or each, treatment, or application. In some embodiments, fungicidal efficacy is measured at least 28 days after initial and/or each, treatment, or application.

In some embodiments, the combination comprises an improved combination in that a substantially similar level of fungicidal efficacy is achieved by using a lesser amount of the polyphenol-based component and/or the (typically systemic), fungicide (A).

While the polyphenol-based compounds comprising component (1), may themselves have some degree of intrinsic fungicidal efficacy, in some embodiments, the amount of polyphenol-based component in the combination comprises less than the fungicidally effective amount of that polyphenol-based component when polyphenol-based component is used alone. In some embodiments, the amount of the polyphenol-based component is less than its fungicidally effective amount.

In some embodiments, the amount of the fungicide compound(s) (A) of component (2) is/are less than the fungicidally effective amount of the fungicide when the fungicide is used alone.

In some embodiments, the combination comprises an improved combination in that the amount of the polyphenol-based component is effective to increase sensitivity of the fungus to the amount of the (typically, systemic) fungicide component (2), compared to the sensitivity of the fungus to the amount of the fungicide when it is not applied in combination with the amount of the polyphenol-based component.

In some embodiments, the combination comprises an improved combination in that the amount of the polyphenol-based component is effective to increase bioavailability of the amount of the component (2) (systemic) fungicide compared to the bioavailability of the amount of the additional fungicide when it is not applied in combination with the amount of the polyphenol-based component.

In some embodiments, the combination comprises an improved combination in that the amount of the polyphenol-based component in the range of effective to increase bioavailability of the amount of the component (2) (systemic) fungicide compared to the bioavailability of the amount of the additional fungicide when it is not applied in combination with the amount of the polyphenol-based component.

In some embodiments, the combination comprises an improved combination in that the inclusion of a copper-based compound as component (3) can reduce the amount of the polyphenol-based component required to effectively increase the bioavailability of the amount of the component (2) (systemic) fungicide compared to the bioavailability of the amount of the component (2) fungicide when it is not applied in combination with the amount of the polyphenol-based component, due to the effect of the copper-based compound upon the polyphenol-based component.

In some embodiments, the combination comprises an improved combination in that the inclusion of a minimal amount of copper-based compound, exemplified by being significantly below 50 g/ha, as component (3), can reduce by approximately half or less the amount of the polyphenol-based component required to effectively increase the bioavailability of the amount of the component (2) (systemic) fungicide compared to the bioavailability of the amount of the component (2) fungicide when it is not applied in combination with the amount of the polyphenol-based component, due to the effect of the copper-based compound upon the polyphenol-based component.

Increasing bioavailability includes increasing penetration of the amount of the (systemic), fungicide(s) (A) of component (2) to the plant. The component (2) fungicide compound(s) may penetrate into the plant by penetrating into leaves (including penetrating leaf cuticle) and/or roots. In some embodiments, the combination of the amount of the component (2) fungicide (A) and the amount of the polyphenol-based component increases penetration of the amount of the component (2) (systemic), fungicide to the plant. In some embodiments, the combination of the amount of the component (2) (systemic), fungicide and the amount of the polyphenol-based component increases penetration of the amount of the systemic fungicide to the plant leaf. In some embodiments, the combination of the amount of the additional fungicide and the amount of the polyphenol-based component increases penetration of the additional fungicide to the plant root.

Increasing bioavailability also includes increased translocation of the amount of the systemic fungicide once inside the plant, including leaves. In some embodiments, the combination of the amount of the additional fungicide and the amount of the polyphenol-based component increases translocation of the amount of the additional fungicide after penetration into the plant.

While not wishing to be bound by theory, it may be that the increases in bioavailability of the systemic fungicide(s) (A) alluded to above, which are typically achieved by the combination with Polyphenol-based compound, allows for application of combinations comprising reduced amounts of systemic fungicides without any loss in fungicidal efficacy and the possibility of reduced levels of phytotoxicity.

In some embodiments, the combination comprises an improved combination in that it is more effective in treating the plant or locus against fungal and/or bacterial/microbial infection than when each fungicide comprising component (2) at the same amount is applied alone.

In some embodiments, wherein fungicide component (2) of the inventive multi-component combination comprises two or more individual compounds chosen from systemic fungicides (A), the combination of fungicides (A) is even more effective in treating the plant or locus against fungal infection than if the same fungicidal compounds were applied in combination at the same amount in the absence of polyphenol-based component (1). Thus, for example, wherein a mixture of two systemic fungicides have known but only, additive levels of fungicidal efficacy in combination application, the inclusion of polyphenol-based component (1) can transform the efficacy of the same mixture of fungicidal compounds to a level considered fungicidally synergistic.

Without wishing to be bound by any theory, the increased effectiveness or efficacy of the inventive combinations compared to combinations absent the polyphenol-based component, may be due to increased bioavailability and/or uptake of systemic fungicides by the fungal pathogen.

In some embodiments, the combination comprises an improved combination in that the amount of the fungicide compounds of component (2) and the amount of the polyphenol-based component (1) are more effective in combination for treating a plant or locus against fungal and/or bacterial/microbial infection than when the amount of the polyphenol-based component and the amount of systemic fungicide are applied alone. In some embodiments, the combination of the polyphenol-based component (1) and at least one of the component (2) fungicides (A) is more effective in treating the plant or soil against fungal infection than when the fungicide compound(s) component is applied alone at the same amount or rate.

### Treatment, Efficacy and Benefits Embodiments #14

In some embodiments, the combination of the invention comprises one or more of, combination, mixture and/or compositions and the combination of the polyphenol-based component (1) and at least one of the fungicide (A) compounds is more effective in treating the plant or soil against fungal infection than when each fungicide (A) compound at the same amount is applied alone, and not in combination-application with polyphenol-based compounds.

In some embodiments, treating a plant or locus against fungal infection comprises inhibiting fungal mycelium formation.

In some embodiments, treating a plant or locus against fungal and/or bacterial infection comprises combating phytopathogenic diseases on the plant or locus.

In some embodiments, treating the plant or locus against fungal and/or bacterial infection comprises protecting the plant or locus from fungal and/or bacterial attack.

In some embodiments, treating the plant or locus against fungal infection comprises preventing fungal and/or bacterial infection of the plant or locus.

In some embodiments, treating the plant or locus against fungal and/or bacterial infection comprises controlling fungal and/or bacterial disease affecting the plant or locus.

In some embodiments, treating the plant or locus against fungal and/or bacterial infection comprises controlling a fungal and/or bacterial pathogen, a fungal and/or bacterial pathogen group or a fungal and/or bacterial pathogen class affecting the plant or locus.

In some embodiments, treating the plant or locus against fungal and/or bacterial infection comprises controlling a fungal disease caused by a fungal and/or bacterial pathogen, a fungal and/or bacterial pathogen group or a fungal and/or bacterial pathogen class affecting the plant or locus.

In some embodiments, treating the plant or locus against fungal and/or bacterial infection comprises reducing fungal and/or bacterial infection of the plant or locus.

In some embodiments, the combination comprises an improved combination in that it prolongs the period of protection against fungal and/or bacterial infection and/or control of fungal and/or bacterial infection than when the amount of the polyphenol-based component and the amount of systemic fungicide are applied alone.

In some embodiments, the period of protection against fungal infection and/or control of fungal and/or bacterial infection is prolonged by at least 7 days, 14 day, 21 days, or 28 days.

In some embodiments, the combination comprises an improved combination in that it reduces the amount of time needed to achieve a level of fungal and/or bacterial control than when the amount of the polyphenol-based component and the amount of systemic fungicide are applied alone.

An example for reduction is, if each systemic fungicide is applied alone achieves 50% control of fungal disease 7 days after application, the combination disclosed herein achieves 50% control of fungal and/or bacterial diseases 2 days after application where each combination, mixture and/or compositions applied at the amount.

In some embodiments, the amount of time needed to achieve a level of fungal and/or bacterial control is reduced by at least 1 day, 2 days, 3 days, 4 day, 5 days, 7 days, 10 days, 14 days or 21 days, or 28 days.

In some embodiments, the combination comprises an improved combination in that it improves plant development compared to the development of a plant affected by the same type and degree of fungal and/or bacterial infection to which the combination is not applied. In some embodiments, the plant is a crop plant. In some embodiments, the additional fungicide as part of the combination comprises more effective in improving plant development than if applied at the same amount alone. In some embodiments, the polyphenol-based component as part of the combination is more effective in improving plant development than if applied at the same amount alone.

In some embodiments, the plant development is improved by treating the plant against fungal and/or bacterial attack.

In some embodiments, improving plant development comprises enhancing crop plants. In some embodiment, improving plant development comprises improving plant quality.

Improving plant development includes, but is not limited to, enhancing the root systems, enhancing shoot of the plant, enhancing plant vigor, enhancing greening effect on leaves and/or enhancing plant potential yield.

In some embodiments, improving plant development comprises enhancing the root system. In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, the combination is more effective in controlling pathogen than each of the AI in combination used alone or as combination of one.

In some embodiments, the amount is optimized to provide a synergistic effect.

In some embodiments, the combinations display synergistic effect between polyphenol-based component and the at least one fungicide.

In some embodiments, the amount of polyphenol-based component and the amount of the at least one systemic fungicides if applied in combination is more effective in treating a plant or soil against fungal and/or bacterial infection than if each fungicide at the same amount is applied alone.

In some embodiments, the amount of polyphenol-based component and the amount of the at least one additional fungicides if applied together is more effective in treating a plant or soil against fungal infection than if each fungicide at the same amount is applied alone.

In some embodiments, the amount of polyphenol-based component, the amount of the at least one systemic fungicides in the combination, mixture and/or composition if applied in combination, is more effective in treating a plant or soil against fungal infection than if each fungicide at the same amount is applied alone.

In noted embodiments, the combinations according to the invention may also comprise more than one of the active components (a), (b), (c), (d) (e) below, increasing and/or broadening of the spectrum of disease control when desired.

(a) a QiI fungicide, (b) a strobilurin fungicide, (c) a succinate dehydrogenase inhibitor (SDHI) fungicide, (d) a triazole fungicide and (e) a morpholine fungicide.

### METHOD AND USES

### Methods of Treatment, Applications, Rates and Content Embodiments #15

Embodiments of the present invention include providing methods of treating a plant or locus against fungal and/or bacterial infection comprising applying a combination of (1) an amount of a polyphenol-based component as previously described, and (2) at least one systemic fungicide(s) (A), selected from the group of QiI fungicide, strobilurin fungicide, SDHI fungicide, azole fungicide and morpholine fungicide, to the plant or locus so as to thereby treat the plant or locus against fungal and/or bacterial infection, wherein (i) the method is more effective against fungal and/or bacterial infection than when the amount of the polyphenol-based component and the amount of the fungicide(s) are applied alone, and/or (ii) the amount of the polyphenol-based component improves the fungicidal efficacy of the amount of the fungicide(s) compared to when the same amount of the additional fungicides are not applied in combination with the amount of the polyphenol-based component.

An embodiment of the present invention provides a combination for controlling disease caused by pathogen in plant, comprising (1) an amount of polyphenol-based component and as component (2), an amount of at least one fungicide selected from the group of QiI fungicide, strobilurin fungicide, SDHI fungicide, azole fungicide and morpholine fungicide.

An embodiment of present invention provides a method for controlling disease caused by pathogen in plant, comprising applying a combination of (1) an amount of polyphenol-based component and as component (2), an amount of at least one fungicides selected from the group of QiI fungicide, strobilurin fungicide, SDHI fungicide, azole fungicide and morpholine fungicide, to the plant, propagation material of the plant, and/or a locus of the plant

In some embodiments, the method comprises applying polyphenol-based component and the fungicide (A) at any one of the rates described herein.

The rate at which the combination, mixture, or composition according to embodiments of the invention is applied will depend upon the particular type of fungus and/or bacteria to be controlled, the degree of control required and the timing and method of application.

In some embodiments, the combination, mixture, or composition is applied at a rate from about 25 grams of total active ingredient per hectare (g a.i./ha) to about 2000 g a.i./ha based on the total amount of active ingredients in the combination, mixture, or composition.

In some embodiments, the polyphenol-based component is applied at a rate from about 10 g a.i./ha to about 350 g a.i./ha preferably 40 g a.i./ha to about 90 g a.i./ha. In some embodiments, the polyphenol-based component is applied at a rate about 90 g a.i./ha

In some embodiments, the fenpropidin is applied at a rate from about 100 g a.i./ha to about 300 g a.i./ha preferably 120 g a.i./ha to about 250 g a.i./ha. In some embodiments, the fenpropidin is applied at a rate about 150 g a.i./ha.

In some embodiments, the benzovindiflupyr is applied at a rate from about 20 g a.i./ha to about 80 g a.i./ha preferably 30 g a.i./ha to about 50 g a.i./ha. In some embodiments, the benzovindiflupyr is applied at a rate about 40 g a.i./ha.

In some embodiments, the Fluxapyroxad is applied at a rate from about 40 g a.i./ha to about 100 g a.i./ha. In some embodiments, the Fluxapyroxad is applied at a rate about 50 g a.i./ha

In some embodiments, the Bixafen is applied at a rate from about 40 g a.i./ha to about 100 g a.i./ha preferably 50 g a.i./ha to about 80 g a.i./ha. In some embodiments, the Bixafen is applied at a rate about 60 g a.i./ha

In some embodiments, the metominostrobin is applied at a rate from about 40 g a.i./ha to about 200 g a.i./ha preferably 45 g a.i./ha to about 100 g a.i./ha and more preferably 50 g a.i./ha to about 80 g a.i./ha. In some embodiments, the metominostrobin is applied at a rate about 80 g a.i./ha

In some embodiments, the Mancozeb is applied at a rate from about 400 g a.i./ha to about 1500 g a.i./ha. In some embodiments, the Mancozeb is applied at a rate about 700 g a.i./ha

In some embodiments, the Chlorothalonil is applied at a rate from about 400 g a.i./ha to about 1200 g a.i./ha. In some embodiments, the Chlorothalonil is applied at a rate from about 700 g a.i./ha

In some embodiments, the Fluazinam is applied at a rate from about 200 g a.i./ha to about 500 g a.i./ha. In some embodiments, the Fluazinam is applied at a rate about 300 g a.i./ha

In some embodiments, the Copper-based compound is applied at a metallic copper rate from about 30 g a.i./ha to about 350 g a.i./ha. In some embodiments, the Copper based compound is applied at a rate about 175 g a.i./ha

In some embodiments, the Tebuconazole is applied at a rate from about 40 g a.i./ha to about 150 g a.i./ha, preferably 75 g a.i./ha to about 110 g a.i./ha. In some embodiments, the Tebuconazole is applied at a rate about 80 g a.i./ha

In some embodiments, the Prothioconazole is applied at a rate from about 40 g a.i./ha to about 120 g a.i./ha, preferably 60 g a.i./ha to about 80 g a.i./ha. In some embodiments, the Prothioconazole is applied at a rate about 70 g a.i./ha In some embodiments, the Cyproconazole is applied at a rate from about 15 g a.i./ha to about 80 g a.i./ha preferable 24 g a.i./ha to about 42 g a.i./ha. In some embodiments, the Cyproconazole is applied at a rate about 30 g a.i./ha

In some embodiments, the Flutriafol is applied at a rate from about 50 g a.i./ha to about 150 g a.i./ha. In some embodiments, the Flutriafol is applied at a rate about 100 g a.i./ha

In some embodiments, the Difenoconazole is applied at a rate from about 50 g a.i./ha to about 120 g a.i./ha preferably 40 g a.i./ha to about 100 g a.i./ha more preferably 50 g a.i./ha to about 80 g a.i./ha. In some embodiments, the Difenoconazole is applied at a rate about 70 g a.i./ha

In some embodiments, the mefentrifluconazole is applied at a rate from about 50 g a.i./ha to about 150 g a.i./ha preferably 75 g a.i./ha to about 100 g a.i./ha. In some embodiments, the mefentrifluconazole is applied at a rate about 100 g a.i./ha

In some embodiments, the picoxystrobin is applied at a rate from about 40 g a.i./ha to about 200 g a.i./ha preferably 50 g a.i./ha to about 150 g a.i./ha. In some embodiments, the picoxystrobin is applied at a rate about 60 g a.i./ha

In some embodiments, the Azoxystrobin is applied at a rate from about 40 g a.i./ha to about 200 g a.i./ha preferably 50 g a.i./ha to about 80 g a.i./ha. In some embodiments, the Azoxystrobin is applied at a rate about 60 g a.i./ha

In some embodiments, the Mandestrobin is applied at a rate from about 50 g a.i./ha to about 300 g a.i./ha. In some embodiments, the Mandestrobin is applied at a rate about 120 g a.i./ha

In some embodiments, the combination, mixture, or composition of the present disclosure is applied at a rate from about 60 g a.i./ha to about 600 g a.i./ha. In some embodiments, the combination, mixture, or composition is applied at a rate from about 100 g a.i./ha to about 200 g a.i./ha. In some embodiments, the combination, mixture, or composition is applied at a rate from about 100 g a.i./ha to about 130 g a.i./ha.

The components of the combination, mixture or composition of the present disclosure can be applied either separately or as part of a multipart fungicidal system. The components of the combination, mixture or composition of the present disclosure can be applied either separately or as part of a multipart fungicidal system. Consequently, the methods and uses disclosed herein include preparation of the combination, mixture, and composition from the component parts prior to application or use.

In some embodiments, the components of the combination, mixture or composition of the present disclosure are applied simultaneously.

In some embodiments, the components of the combination, mixture or composition of the present disclosure are applied contemporaneously.

In some embodiments, the components of the combination, mixture or composition of the present disclosure are applied as a succession application.

In some embodiments, components of the combination, mixture or composition of the present disclosure are applied at least one time during a growth season.

In some embodiments, applying together according to the invention refers to simultaneously, contemporaneously and/or succession application.

In some embodiments, the components of the mixture or composition of the present disclosure are applied one or more times during a growth season.

In some embodiments, the components of the combination, mixture or composition of the present disclosure are applied as a soil application. In some embodiments, the mixtures and/or compositions described herein are applied as a foliar application. In some embodiments, the components of the mixture or the composition thereof are applied as seed treatment.

In some embodiments, the components of the combination, mixture or composition of the present disclosure are applied as a soil application, as a foliar application, as seed treatment and any combination thereof.

In some embodiments, the combination, mixture, or composition of the present disclosure is applied at least one time during a growth season.

In some embodiments, the combination, mixture, or composition of the present disclosure is applied one or more times during a growth season. In some embodiments, the combination, mixture, or composition described herein are applied as a soil application. In some embodiments, the combination, mixture, or composition described herein are applied as a foliar application.

In some embodiments, controlling refers but is not limited to curative treatment, preventive treatment, persistence treatment and any combination thereof.

In some embodiments, the method of controlling is a curative treatment.

In some embodiments, the method of controlling is a preventive treatment.

In some embodiments, the method of controlling is a persistence treatment.

Application can be before or after the infection by harmful fungi and/or bacteria.

The rate at which the mixture disclosed herein is applied depends upon the particular type of fungus and/or bacteria to be controlled, the degree of control required and the timing and method of application. In general, the mixture or composition described herein can be applied at an application rate of between about 60 grams per hectare (g/ha) and about 2600 g/ha.

In some embodiments, the mixture of the present invention is applied at a rate between 0.1-10000 g a.i./ha. In some embodiments, the mixture of the present invention is applied at a rate between 50-2000 g a.i./ha. In some embodiments, the mixture of the present invention is applied at a rate between 100-750 g a.i./ha.

In some embodiments, the mixture of the present invention, if applied as seed treatment, is to be applied at a rate between 2 g per 100 kg to 400 g per 100 kg of seed. In some embodiments, the mixture of the present invention, if applied as seed treatment, is to be applied at a rate between 2.5 g per 100 kg to 50 g per 100 kg of seed. In some embodiments, the mixture of the present invention, if applied as seed treatment, is to be applied at a rate between 2.5 g per 100 kg to 25 g per 100 kg of seed.

In some embodiments, the mixture of the present invention, if applied as soil application, is to be applied at a rate between 0.1 to 10,000 g/ha. In some embodiments, the mixture of the present invention, if applied as soil application, is to be applied at a rate between 1 to 5.000 g/ha.

In some embodiments, the mixture is a tank mix. Any of the combinations described herein may be in the form of a tank mix. In some embodiments, each of the polyphenol-based component and systemic fungicide are formulated in its own composition prior to tank mix.

In general, inventors have found that when polyphenol-based component is added to a composition comprising fungicides it is possible to reduce the amounts of systemic and protectant fungicidal active ingredients by between 10% and 50%. Typically, the reduction of systemic fungicides and protectant fungicides can be between about 20% and 40% without loss of efficacy and often with increased efficacy.

As illustrated later, several compositions comprising mancozeb picoxystrobin, tebuconazole and polyphenol-based component (polyphenols) were tested in field trials against Phakopsora pachyrhizi in soybean crops and compared to a product that contained mancozeb picoxystrobin, tebuconazole (Blindado® TOV), but without the polyphenols. Several tested combinations included copper compounds too.

It was found that superior fungicidal efficacy on soybean Asian rust were achieved when polyphenol-based component is added to a composition of the same doses of mancozeb picoxystrobin, tebuconazole, and equivalent fungicidal efficacy could be achieved with much lower dosing of mancozeb (e.g., 600 vs 880 g/ha) in the treatments that included the Polyphenol-based component.

Further, equivalent fungicidal efficacy could be achieved with all the fungicidal compounds in the compositions being reduced by between 20% and 40% as can be seen in results comparing the application of 1.8 L/Ha of the compositions to application of 2 L/Ha and 2.2 L/Ha.

See the table below detailing some of the combinations used in trials.

| | | | | Concentration | Product, | Dose A.I., |
|---|---|---|---|---|---|---|
| No | Treatments | Active Ingredient | Form. | A.I, g/L | mL g/ha | g/ha |
| 1 | Control | — | — | — | — | — |
| 2 | Blindado | Mancozeb + Picoxystrobin + | OD | 400 + 26.66 + | 2000 | 800 + 53.32 + |
| | TOV* | Tebuconazole | | 33.33 | | 66.66 |
| 3 | ADA FF | Mancozeb + Picoxystrobin + | OD | 400 + 26.2 + | 1800 | 720 + 47.16 + |
| | 322/22* | Tebuconazole + Polyphenol 100% | | 33.3 + 22.5 | | 59.94 + 40.5 |
| 4 | ADA FF | Mancozeb + Picoxystrobin + | OD | 400 + 26.2 + | 2000 | 800 + 52.4 + |
| | 322/22* | Tebuconazole + Polyphenol 100% | | 33.3 + 22.5 | | 66.6 + 45 |
| 5 | ADA FF | Mancozeb + Picoxystrobin + | OD | 400 + 26.2 + | 2200 | 880 + 57.64 + |
| | 322/22* | Tebuconazole + Polyphenol 100% | | 33.3 + 22.5 | | 73.26 + 49.5 |
| 6 | ADA FF | Mancozeb + Picoxystrobin + | OD | 300 + 32.5 + | 2000 | 600 + 65 + |
| | 316/22* | Tebuconazole + Polyphenol 100% | | 50 + 45 | | 100 + 90 |
| 7 | ADA FF | Mancozeb + Picoxystrobin + | OD | 300 + 32.5 + | 2000 | 600 + 65 + |
| | 317/22* | Tebuconazole + Polyphenol 100% | | 50 + 22.5 | | 100 + 45 |
| 8 | ADA FF | Mancozeb + Picoxystrobin + | OD | 300 + 32.5 + | 2000 | 600 + 65 + |
| | 321/22* | Tebuconazole + Copper + | | 50 + 4 + 45 | | 100 + 8 + 90 |
| | | Polyphenol 100% | | | | |
| 9 | ADA FF | Mancozeb + Picoxystrobin + | OD | 300 + 32.5 + | 2000 | 600 + 65 + |
| | 318/22* | Tebuconazole + Copper + | | 50 + 4 + 22.5 | | 100 + 8 + 45 |
| | | Polyphenol 100% | | | | |
| 10 | ADA FF | Mancozeb + Picoxystrobin + | OD | 300 + 32.5 + | 2000 | 600 + 65 + |
| | 319/22* | Tebuconazole + Copper + | | 50 + 25 + 45 | | 100 + 50 + 90 |
| | | Polyphenol 100% | | | | |

*added Rumba adjuvant at a dose of 0.25% v/v

Additionally, it was found that adding polyphenol-based component to fungicidal compositions resulted in the added benefits of lower defoliation and significantly higher yields in terms of tons of grains per hectare, in at least one trial this was of the order/magnitude of an increase from about 4800 kg/ha to about 5000 kg/ha (estimate based on yield per trial area).

It was additionally found that more and greener leaves were found on the crop plants when polyphenol was added to the combination of mancozeb, picoxystrobin and tebuconazole even at lower rates of application (1.8 L vs 2.0 L), and this was more pronounced when applied at the same concentration at the same rate of application.

Without being bound by theory, the greener more abundant leaves may be connected to the higher rates of efficacy against Asian Soybean Rust combined with an anti-stress and bio stimulant effect of the polyphenol-based components.

Similarly, it was found that addition of even small amounts of copper-based compounds significantly improved efficacy even when Mancozeb was reduced by 25% or more.

None of the treatments resulted in phytotoxicity when evaluated by visual inspection.

In the treatments referred to above, the compositions were applied from a spray mixture including 0.25 L/ha of commercial adjuvant, Rumba® which comprises 765 g/L Methyl Soyate. Thus, the applied Methyl Soyate was 191.25 g/L for each treatment.

### Compositions

### Compositions, Combinations, Mixtures formulating and Improvements Embodiments #16

In embodiments, the combinations or mixtures of the present invention may be formulated as one composition. The combinations of the present invention may be formulated as separate compositions. The combinations of the present invention may be formulated in more than one composition.

In embodiments the combinations of the present invention may be formulated as separate compositions. The composition of the polyphenol-based component (1) of the present inventive combination may be formulated and provided together with preparative instructions or otherwise adapted for combination with a separate, typically, commercially available composition of the systemic fungicide(s) of component (2).

In embodiments the combinations of the present invention may be formulated as separate compositions. The composition of the polyphenol-based component (1) of the present inventive combination may be formulated and provided together with preparative instructions or otherwise adapted for combination with a separate, typically, commercially available composition of the systemic fungicide(s) of component (2) and the protectant fungicides of component (3).

In embodiments the combinations of the present invention may be formulated as separate compositions. The composition of the polyphenol-based component (1) together with the copper-based compound of component (3), of the present inventive combination may be formulated and provided together with preparative instructions or otherwise adapted for combination with separate, typically, commercially available composition(s) of the systemic fungicide(s) of component (2).

In embodiments the combinations of the present invention may be formulated as separate compositions. The composition of the polyphenol-based component (1) together with the copper-based compound of component (3), of the present inventive combination may be formulated and provided together with preparative instructions or otherwise adapted for combination with separate, typically, commercially available composition(s) of the systemic fungicide(s) of component (2), in admixture with the Protectant fungicide(s) of component (3).

In embodiments the combinations of the present invention may be formulated as separate compositions. The composition of the polyphenol-based component (1) together with the Protectant fungicide of component (3), of the present inventive combination may be formulated and provided together with preparative instructions or otherwise adapted for combination with separate, typically, commercially available composition(s) of the systemic fungicide(s) of component (2).

In embodiments the present invention also provides a fungicidal composition comprising any one of the combinations disclosed herein, and an agriculturally acceptable carrier.

In embodiments the present invention also provides fungicidal composition(s) for the combinations comprising any one of the combinations disclosed herein, and an agriculturally acceptable carrier.

In some embodiments, the combination comprises a composition. Any of the combinations described herein may be in the form of a composition.

In embodiments the combination, mixture or composition comprising the polyphenol-based component and at least one systemic fungicide (A) may be an improved combination, mixture, or composition in any one or any combination of ways as described below.

In some embodiments, the combination comprises an amount of polyphenol-based component and an amount of at least one systemic fungicide (A). The combination comprising polyphenol-based component and at least one fungicide (A) may be an improved combination in any one or any combination of ways as described below.

In some embodiments, improving plant development comprises enhancing shoot of the plant. In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, improving plant development comprises enhancing plant vigor. In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, improving plant development comprises enhancing greening effect on leaves. In some embodiments, greening effect on leaves is assessed using the relative vigor index. In some embodiments, greening effect on leaves is increased by at least 1%, 5%, or 10%.

In some embodiments, improving plant development comprises enhancing plant yield. In some embodiments, plant yield is increased by at least 1%, 5%, 10, 20%, 30%, 40%, 50%, 60%, 70%, 80%, 90%, 100% or more, or each and any intermediate value.

In some embodiments, the combination comprises an improved combination in that it is anti-resistant. Anti-resistance refers to the effect of blocking the development or the spreading of resistance by increased efficacy of the combination.

In some embodiments, the combination comprises an improved combination in that it has improved potentiated efficacy, improved long lasting effect, improved anti-resistance activity, improving activity against resistant strains, improved green leaf area, improved greening effect, increased spectrum of disease activity, increased efficacy against disease not controlled by the solo fungicides, higher plant/crop yield, higher plant/crop protein content, higher plant/crop sugar content, higher plant/crop °Brix level, better color grading of fruits, higher thousand kernels weight, higher test weight or hectoliter weight, increased fruit size, increased number of marketable fruits, improved plant vigor, and/or reduced risks of adverse effects on plants.

### Pathogen, Disease and Crop

### Pathogen, Disease and Crop Embodiments #17

The fungal pathogen to be addressed by the combinations and methods herein disclosed can be one or more of Alternaria species on vegetables, oilseed rape, sugar beet and rice, such as, A. solani in tomatoes or A. cucumerina in cucumber or melon; Aphanomyces species on sugar beet and vegetables; Ascochyta species on cereals, legumes and vegetables; Bipolaris and Drechslera species on corn, cereals, rice and lawns, for example, D. maydis on corn; Blumeria graminis (powdery mildew) on cereals; Botrytis cinerea (gray mold) on strawberries, vegetables and flowers or B. aclada on onion; Bremia lactucae on lettuce; Cercospora species on corn, soybeans, rice, sugar beet and coffee as C. beticola in sugarbeet or C. kikuchii in soybean; Cladosporium species on several crops; Claviceps purpurea on rye; Cochliobolus species on corn, cereals, rice, for example Cochliobolus sativus on cereals, Cochliobolus miyabeanus on rice; Colletotrichum species on vegetables, soybeans and cotton, such as Colletotrichum truncatum in pepper and soybean; Drechslera species and Pyrenophora species on corn, cereals, rice and lawns, for example, D. teres on barley or D. tritici-repentis on wheat; Esca on grapevines, caused by Phaeoacremonium chlamydosporum, P. aleophilum and Fomitiporia punctata (syn. Phellinus punctatus), Exserohilum species on corn; Erysiphe cichoracearum and Sphaerotheca fuliginea on cucumbers; Fusarium and Verticillium species on various plants, for example, Fusarium graminearum or Fusarium culmorum on cereals or F. oxysporum on a multitude of plants, such as, for example, tomatoes; Gaeumannomyces graminis on cereals; Gibberella species on cereals and rice (for example Gibberella fujikuroi on rice); Grainstaining complex on rice; Helminthosporium species on corn and rice; Hemileia vastatrix on coffee; Microdochium nivale on cereals; Mycosphaerella species on several crops, for example, M. brassicicola on brassicas; Parastagonospora nodorum on cereals; Peronospora species on cabbages, legumes and bulbous plants, for example, P. brassicae on cabbage or P. destructor on onions; Phakopsora pachyrhizi and Phakopsora meibomiae on soybeans; Phoma species on soybean, cucurbits, tomato and brassicas; Phomopsis species on soybeans, sunflowers and grapes; Phytophthora infestans on potatoes and tomatoes; Phytophthora species on various plants, for example, P. capsici on bell pepper, P. citrophthora and P. citricola in citrus; Plasmopara viticola on grapevines; Pleosporales on various plants, for example, Pleospora herbarum in alfalfa, tomato and chickpeas; Pseudocercosporella herpotrichoides on cereals; Pseudoperonospora on various plants, for example, P. cubensis on cucumber or P. humili on hops; Pyricularia oryzae, Corticium sasakii, Sarocladium oryzae, S. attenuatum, Entyloma oryzae on rice; Pyricularia grisea on lawns and cereals; Pythium spp. on lawns, rice, corn, cotton, oilseed rape, sunflowers, sugar beet, vegetables and other plants, for example, P. ultimum on various plants, P. aphanidermatum on lawns; Ramularia species on cereals, barley and cotton, for example, Ramularia collo-cygni on barley and Ramularia areola on cotton; Rhizoctonia species on cotton, rice, potatoes, lawns, corn, oilseed rape, sugar beet, vegetables and on various plants, for example, R. solani on beet and various plants; Rhynchosporium secalis on barley, rye and triticale; Sclerotinia species on oilseed rape, sunflowers and lettuce; Septoria species on several crops as S. lactucae in lettuce; Erysiphe species on wheat such as Erysiphe graminis; Erysiphe (syn. Uncinula) necator on grapevines; Setosphaeria species on corn and lawns; Sphacelotheca reiliana on corn; Thielaviopsis species on soybeans and cotton; Tilletia species on cereals; Ustilago species on cereals, corn and sugar cane, for example, U. maydis on corn. Cercospora kikuchii on soybean; Septoria glycines (Late Season diseases) on soybean; Corynespora cassiicola (target Spot) on soybean; Microsphaera difusa (Powder Mildew) on soybean; Colletotrichum truncatum (Antrachnosis) on soybean Colletotrichum truncatum on soybean; Sclerotinia sclerotiorum (White mold) on soybean. Puccinia kuehnii (orange rust) on sugarcane; C. paradoxa (pineapple rot) on sugar cane.

In some embodiments, the fungal pathogen group is Hyponectriaceae. In some embodiments, the fungal pathogen group is Phyllostictaceae. In some embodiments, the fungal pathogen group is Mycosphaerellaceae. In some embodiments, the fungal pathogen group is Ceratobasidiaceae. In some embodiments, the fungal pathogen group is Erysiphaceae. In some embodiments, the fungal pathogen group is Trichocomaceae. In some embodiments, the fungal pathogen group is Sclerotiniaceae. In some embodiments, the fungal pathogen group is Dermateaceae. In some embodiments, the fungal pathogen group is Sclerotiniaceae. In some embodiments, the fungal pathogen group is Nectriaceae. In some embodiments, the fungal pathogen group is Peronosporaceae. In some embodiments, the fungal pathogen group is Glomerellaceae. In some embodiments, the fungal pathogen group is Pleosporaceae. In some embodiments, the fungal pathogen group is Leptosphaeriaceae. In some embodiments, the fungal pathogen group is Venturiaceae. In some embodiments, the fungal pathogen group is Didymellaceae. In some embodiments, the fungal pathogen group is Pleosporaceae. In some embodiments, the fungal pathogen group is Corynesporascaceae. In some embodiments, the fungal pathogen group is Pucciniaceae. In some embodiments, the fungal pathogen group is Chaconiaceae. In some embodiments, the fungal pathogen group is Phakopsoraceae. In some embodiments, the fungal pathogen group is Pucciniaceae. In some embodiments, the fungal pathogen group is Magnaporthales. In some embodiments, the fungal pathogen group is Taphrinaceae. In some embodiments, the fungal pathogen group is Ustilaginaceae.

In some embodiments, the pathogen class is Amphisphaeriales. In some embodiments, the pathogen class is Botryosphaeriales. In some embodiments, the pathogen class is Capnodiales. In some embodiments, the pathogen class is Ceratobasidiales. In some embodiments, the pathogen class is Erysiphales. In some embodiments, the pathogen class is Eurotiales. In some embodiments, the pathogen class is Helotiales. In some embodiments, the pathogen class is Hypocreales. In some embodiments, the pathogen class is Peronosporales. In some embodiments, the pathogen class is Phyllachorales. In some embodiments, the pathogen class is Pleosporales. In some embodiments, the pathogen class is Pucciniales. In some embodiments, the pathogen class is Pyriculariaceae. In some embodiments, the pathogen class is Taphrinales. In some embodiments, the pathogen class is Ustilaginales.

In some embodiments, the fungal pathogen is Botrytis cinerea. In some embodiments, the fungal pathogen is Microdochium sp. In some embodiments, the fungal pathogen is Phyllosticta ampelicida. In some embodiments, the fungal pathogen is Mycosphaerella fijiensis. In some embodiments, the fungal pathogen is Zymoseptoria tritici. In some embodiments, the fungal pathogen is Ramularia collo-cygni. In some embodiments, the fungal pathogen is Cercospora zeae-maydis. In some embodiments, the fungal pathogen is Ramularia areola. In some embodiments, the fungal pathogen is Cercospora beticola. In some embodiments, the fungal pathogen is Ramularia beticola. In some embodiments, the fungal pathogen is Rhizoctonia solani/Thanatephorus cucumeris. In some embodiments, the fungal pathogen is Blumeria graminis. In some embodiments, the fungal pathogen is Erysiphe cichoracearum. In some embodiments, the fungal pathogen is Sphaerotheca fuliginea. In some embodiments, the fungal pathogen is Erysiphe necator. In some embodiments, the fungal pathogen is Podosphaera macularis. In some embodiments, the fungal pathogen is Podosphaera leucotricha. In some embodiments, the fungal pathogen is Leveillula taurica. In some embodiments, the fungal pathogen is Oidium neolycopersici. In some embodiments, the fungal pathogen is Erysiphe betae. In some embodiments, the fungal pathogen is Erysiphe polygoni. In some embodiments, the fungal pathogen is Aspergillus sp. In some embodiments, the fungal pathogen is Botrytis cinerea. In some embodiments, the fungal pathogen is Pyrenopeziza brassicae. In some embodiments, the fungal pathogen is Sclerotinia sclerotiorum. In some embodiments, the fungal pathogen is Botrytis cinerea. In some embodiments, the fungal pathogen is Monilinia spp. In some embodiments, the fungal pathogen is Monilinia laxa. In some embodiments, the fungal pathogen is Monilia fructigena. In some embodiments, the fungal pathogen is Monilia fructicola. In some embodiments, the fungal pathogen is Fusarium sp. In some embodiments, the fungal pathogen is Phytophthora sp. In some embodiments, the fungal pathogen is Phytophthora palmivora. In some embodiments, the fungal pathogen is Phytophthora megakarya. In some embodiments, the fungal pathogen is Phytophthora capsica. In some embodiments, the fungal pathogen is Pseudoperonospora cubensis. In some embodiments, the fungal pathogen is Plasmopara viticola. In some embodiments, the fungal pathogen is Pseudoperonospora humula. In some embodiments, the fungal pathogen is Phytophthora infestans. In some embodiments, the fungal pathogen is Peronospora viciae. In some embodiments, the. fungal pathogen is Phytophtora sp. In some embodiments, the fungal pathogen is Phytophthora infestans. In some embodiments, the fungal pathogen is Colletotrichum kahawae. In some embodiments, the fungal pathogen is Colletotrichum sp. In some embodiments, the fungal pathogen is Pyrenophora tritici-repentis In some embodiments, the fungal pathogen is Drechslera tritici-repentis. In some embodiments, the fungal pathogen is Pyrenophora teres. In some embodiments, the fungal pathogen is Setosphaeria turcica. In some embodiments, the fungal pathogen is Cochliobolus heterostrophus. In some embodiments, the fungal pathogen is Cochliobolus carbonum. In some embodiments, the fungal pathogen is Alternaria spp. In some embodiments, the fungal pathogen is Alternaria cucumerina. In some embodiments, the fungal pathogen is Plenodomus lingam. In some embodiments, the fungal pathogen is Alternaria alternate. In some embodiments, the fungal pathogen is Pleospora allii. In some embodiments, the fungal pathogen is Alternaria mali. In some embodiments, the fungal pathogen is Alternaria sp. In some embodiments, the fungal pathogen is Venturia inaequalis. In some embodiments, the fungal pathogen is Venturia pyrina. In some embodiments, the fungal pathogen is Alternaria sp. In some embodiments, the fungal pathogen is Ascochyta rabiei. In some embodiments, the fungal pathogen is Alternaria sp. In some embodiments, the fungal pathogen is Corynespora cassiicola. In some embodiments, the fungal pathogen is Puccinia recondite. In some embodiments, the fungal pathogen is Puccinia triticina. In some embodiments, the fungal pathogen is Hemileia vastatrix. In some embodiments, the fungal pathogen is Phakopsora pachyrhizi. In some embodiments, the fungal pathogen is Uromyces betae. In some embodiments, the fungal pathogen is Pyricularia oryzae. In some embodiments, the fungal pathogen is Taphrina spp. In some embodiments, the fungal pathogen is Taphrina deformans. In some embodiments, the fungal pathogen is Ustilago maydis.

Methods of using the inventive Combination comprise uses for controlling fungal groups, fungal classes, and fungal pathogens, including the fungal groups, fungal classes and fungal pathogens described herein.

Fungal infection may cause fungal disease affecting the plant or soil. In some embodiments, the invention comprises treating a plant or soil against fungal infection comprising treating the plant or soil against fungal disease with the inventive combination(s).

In some embodiments, the fungal disease is apple scab disease. In some embodiments, the fungal disease is seedling blight. In some embodiments, the fungal disease is foliar & ear disease. In some embodiments, the fungal disease is Black rot. In some embodiments, the fungal disease is Black sigatoka. In some embodiments, the fungal disease is Septoria. In some embodiments, the fungal disease is Ramularia leaf spot. In some embodiments, the fungal disease is gray leaf spot. In some embodiments, the fungal disease is leaf spot of beet. In some embodiments, the fungal disease is sheath blight. In some embodiments, the fungal disease is powdery mildew. In some embodiments, the fungal disease is Aspergillus ear rot. In some embodiments, the fungal disease is grey mold. In some embodiments, the fungal disease is Sclerotinia. In some embodiments, the fungal disease is Monilia. In some embodiments, the fungal disease is Fusarium head blight. In some embodiments, the fungal disease is Maize Ear and Kernel Rot. In some embodiments, the fungal disease is Crown and root rot. In some embodiments, the fungal disease is Black pod. In some embodiments, the fungal disease is Downy mildew. In some embodiments, the fungal disease is Late blight. In some embodiments, the fungal disease is Coffee Berry Disease. In some embodiments, the fungal disease is Anthracnose. In some embodiments, Anthracnose. In some embodiments, the fungal disease is yellow spot. In some embodiments, the fungal disease is Net blotch. In some embodiments, the fungal disease is Northern Corn Leaf Blight. In some embodiments, the fungal disease is Northern Corn Leaf Spot. In some embodiments, the fungal disease is Phoma stem canker and leaf spot. In some embodiments, the fungal disease is Alternaria. In some embodiments, the fungal disease is Brown spot of pear. In some embodiments, the fungal disease is Alternaria blotch of apple. In some embodiments, the fungal disease is scab. In some embodiments, the fungal disease is Early blight. In some embodiments, the fungal disease is Didymella pisi. In some embodiments, the fungal disease is Target spot. In some embodiments, the fungal disease is Brown rust. In some embodiments, the fungal disease is yellow rust. In some embodiments, the fungal disease is Coffee Leaf Rust. In some embodiments, the fungal disease is Asian soybean rust. In some embodiments, the fungal disease is Rust. In some embodiments, the fungal disease is Rice Blast. In some embodiments, the fungal disease is leaf curl. In some embodiments, the fungal disease is Common Smut.

Additional fungicide is used for controlling broad spectrum of diseases, including the fungal diseases described herein. Additional fungicide may be used on a variety of plants, including the plants described herein. Preferably, additional fungicide is used for controlling the following fungal diseases. In some embodiments, the disease is Sheath blight in rice crop. In some embodiments, the disease is apple scab. In some embodiments, the disease is Early blight disease in vegetable crop. In some embodiments, the vegetable crop is potato. In some embodiments, the vegetable crop is tomato. In some embodiments, the vegetable crop is chili. In some embodiments, the disease is Anthracnose and/or Alternaria. In some embodiments, the disease is an early blight disease in potatoes. In some embodiments, the disease is an anthracnose disease in chili. In some embodiments, the disease is Septoria in cereals. In some embodiments, the disease is black sigatoka in banana. In some embodiments, the disease is Sphaerotheca fuliginea in melon. In some embodiments, the disease is Anthracnose and/or Alternaria chili. In some embodiments, the disease is Erysiphe necator in grape. In some embodiments, the disease is Phakopsora pachyrhizi in soybean. In some embodiments, the disease is Botrytis cinerea in strawberry. In some embodiments, the disease is Venturia inaequalis in apple. In some embodiments, the disease is Alternaria sp. or Phytophthora infestans in tomato. In some embodiments, the disease is Plasmopara viticola in grape. In some embodiments, the disease is caused by Colletotrichum capsica. In some embodiments, the disease is caused by Alternaria solani.

Each embodiment disclosed herein is contemplated as being applicable to each of the other disclosed embodiments. Thus, all combinations of the various elements described herein are within the scope of the invention. In addition, the elements recited in the composition embodiments can be used in the combination, mixture (including synergistic mixture), package, method and use embodiments described herein and vice versa. In addition, the elements recited in the combination embodiments can be used in the composition, kit, method and use embodiments described herein and vice versa.

The following representative examples illustrate the practice of the present invention in some of its embodiments but should not be construed as limiting the scope of the invention in any way. Other embodiments will be apparent to one skilled in the art from consideration of the specification and examples. It is intended that the specification, including the examples, is considered exemplary and/or illustrative only, without limiting the scope and coverage of the invention

A synergistic effect exists whenever the action of an active ingredient combination is greater than the sum of the actions of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22

The action expected for a given combination of one active components can be calculated as follows:

$$E = - X + Y - \frac{XY}{100}$$

The action expected for a given combination of three active components can be calculated as follows:

$$E = X + Y + Z - \frac{XY + XZ + YZ}{100} + \frac{XYZ}{10000}$$

in which E represents the expected effect, e.g., percentage of pest control, for the combination of the active ingredients at defined doses (for example equal to x and y respectively), X is the effect, e.g., percentage of pest control, observed for compound (I) at a defined dose (equal to x), Y is the effect, e.g., percentage of pest control, observed for compound (II) at a defined dose (equal to y). Here, efficacy or percent inhibition is determined in %. 0% means efficacy that corresponds to the Control, i.e., as if no treatment had been applied. Whereas a percent inhibition of 100% means that complete control is observed. When the percent control observed for the combination is greater than E, there is a synergistic effect. When the percent control observed for the combination is equal to E, there is an additive effect and wherein the percent control observed for the combination is lower than E, there is an antagonistic effect.

In some embodiments, the combination is synergistic for controlling pathogen. In some embodiments, the combination is synergistic for enhancing crop plant. In some embodiments, the combination is synergistic for enhancing plant development. In some other embodiments, the combination is synergistic for enhancing root system. In some embodiments, the combination is synergistic for improving plant quality. In some embodiments, the combination is synergistic for regulating plant growth. In some embodiments, the combination is synergistic for controlling different species of pathogen.

While the present disclosure of the invention may be susceptible to various modifications and alternative forms, specific embodiments have been described by way of example in detail herein. However, it is understood that the present disclosure is not intended to be limited to the particular forms disclosed. Rather, the present disclosure is to cover all modifications, equivalents, and alternatives falling within the scope of the present disclosure as defined by the following claims and their legal equivalents.

### REPRESENTATIVE EXAMPLES

### Example 1—Embodiments of the Multi-Component Combination and Preparation

### Composition (1)

picoxystrobin 32.5 g/L/Tebuconazole
40 g/L
Mancozeb 300 g/L
Polyphenols (35%) 125 g/L
Copper Hydroxide (90%) 7.5 g/L

| INGREDIENTS | g/100 mL | g/3000 ml |
|---|---|---|
| picoxystrobin 98% | 3.32 | 99.6 |
| Tebuconazole 98% | 4.08 | 122.4 |
| Aromatic hydrocarbons | 11.65 | 349.5 |
| Tristyrylphenol Ethoxylate16EO | 0.7 | 21 |
| Dimethyl Adipate | 3.2 | 96 |
| Dimethyl Glutarate | | |
| Dimethyl Succinate | | |
| Water | 3.2 | 96 |
| Copper Hydroxide 90% | 0.64 | 19.2 |
| EDTA (Acid) | 2 | 60 |
| Sodium Hydroxide | 1.63 | 48.9 |
| Glycine | 0.65 | 19.5 |
| Polyphenol (BASEL 35%) | 12.5 | 375 |
| propylene glycol | 5.18 | 155.4 |
| Mancozeb | 34.9 | 1047 |
| Sodium Lignosulphonate | 6 | 180 |
| Antifoam AE 15 | 0.5 | 15 |
| 1,2-benzisothiazolin-3-one | 0.1 | 3 |
| Xanthan Gum | 0.1 | 3 |

### Composition (2)

picoxystrobin 32.5 g/L/Tebuconazole
40 g/L
Mancozeb 300 g/L
Polyphenols (35%) 62.5 g/L
Copper Hydroxide (90%) 7.5 g/L

| Ingredients | g/100 mL | g/3000 ml |
|---|---|---|
| picoxystrobin 98% | 3.32 | 99.60 |
| Tebuconazole 98% | 4.08 | 122.4 |
| Aromatic hydrocarbons | 11.65 | 349.5 |
| Tristyrylphenol | 0.7 | 21 |
| Dimethyl Adipate | 3.2 | 96 |
| Dimethyl Glutarate | | |
| Dimethyl Succinate | | |
| Water | 9.5 | 284 |
| Copper Hydroxide 90% | 0.64 | 19.20 |
| EDTA (Acid) | 2 | 60 |
| Sodium Hydroxide 50% | 1.63 | 48.9 |
| Glycine | 0.65 | 19.5 |
| Polyphenol (BASEL 35%) | 6.25 | 188 |
| propylene glycol | 5.18 | 155.4 |
| Mancozeb | 34.9 | 1047 |
| Sodium Lignosulphonate | 6 | 180 |
| Antifoam AE 15 | 0.5 | 15 |
| 1,2-benzisothiazolin-3-one | 0.1 | 3 |
| Xanthan Gum | 0.1 | 3 |

### A. Preparation of Copper-Based Component (3)+Polyphenol-Based Component (1)

i. add the Polyphenol-based compound (component 1) to the Copper-based compound (Copper component 3)
ii. add Propylene Glycol

### B. Preparation of Multi-Component Combination Including Protectant

iii. add under high agitation (exemplified by 1500 rpm) a combination of picoxystrobin and Tebuconazole (component 2) in organic solvents and surfactant
iv. add under high agitation (exemplified by 1500 rpm) a combination of Mancozeb (Protectant component 3) and dispersant lignosulphonate in water.

The order in which steps are performed is not critical and is presented for illustration only.

### Example 2—Embodiments of the Multi-Component Combination

### Composition (3)

### Picoxystrobin/Tebuconazole/Mancozeb/Polyphenols

| Ingredients | g/100 mL | g/2000 ml |
|---|---|---|
| picoxystrobin | 2.7 | 54 |
| Tebuconazole | 3.4 | 68 |
| Aromatic hydrocarbons | 14.5 | 290 |
| Tristyrylphenol Ethoxylate16EO | 2 | 400 |
| Calcium Dodecyl Benzene | 8.5 | 170 |
| Sulphonate | | |
| Poly(EO-block-PO) copolymer | 0.4 | 8 |
| Methyl Soyate | 15 | 300 |
| Tall Oil Fatty Acid | 5 | 100 |
| Tween 24 | 14 | 280 |
| Hexamethylenetetramine | 0.05 | 1 |
| Polyphenol (BASEL 44%) | 8 | 160 |
| Mancozeb d-1,92 | 46.5 | 930. |
| Antifoam AE 15 | 0.05 | 1 |

### Example 3

A field trial was carried out during the 2020/2021 growing season in the municipality of Rio Verde, state of Goiais, Brazil.

The soybean variety used for the trial was BMX FOCO (Brasmax Co.). It was sown on Dec. 28, 2020.

Each fungicide treatment and untreated control was composed of 4 replications. The size of each experimental plot was 15 m² (5×3 m) and 60 m² total per treatment/non treatment. The experiment was conducted under a randomized block design.

Fungicide treatments were applied three (3) times during the experiment, the first on Feb. 11, 2021, and the second and third application with 15-day intervals.

Fungicides were applied with a CO₂ propellant backpack sprayer equipped with nozzles type XR 110.02 (TeeJet Co.) and 150 L/ha of spray volume.

The evaluations were based on severity of Asian Soybean Rust, being the 1st at the 1st application, at the 2nd and at the 3rd application, 7 days, and 14 days after the 3rd. application.

Statistical analysis was performed using the Scott-Knott test (a hierarchical clustering algorithm used in the application of ANOVA).

TABLE A
Experimental treatments (Untreated and Tested Products)

| | | Concentration/ | | | | Volume Applied | |
|---|---|---|---|---|---|---|---|
| | | Form | | | Ingredient Rate | (ml/ha) | |
| No.. | Treatment | (g a.i/L) | | Ingredient | (g/ha) | % of Dose/L | |
| 1 | Untreated | — | | — | — | — | |
| 2 | Component (2) | 120 + 200 | EC | picoxystrobin/ | 60 + 100 | 500 | mL |
| | | | | Tebuconazole | | 0.50% | |
| | Adjuvant | 765 | EC | Soybean Methyl ester | 0.3825 | | |
| 3 | Component (2) | 120 + 200 | EC | picoxystrobin/ | 60 + 100 | 500 | mL |
| | | | | Tebuconazole | | 0.50% | |
| | Adjuvant | 226 + 355 | XX | Soybean Methyl ester + | 0.1775 + 0.113 | | |
| | | | | Tall oil fatty acid | | | |
| 4 | Component (2) | 120 + 200 | EC | picoxystrobin/ | 60 + 100 | 500 | mL |
| | | | | Tebuconazole | | 0.50% | |
| | Adjuvant | 48.6 | XX | Nitrogen | 0.0243 | | |
| 5 | Component (2) | 120 + 200 | EC | picoxystrobin/ | 60 + 100 | 500 | mL |
| | | | | Tebuconazole | | | |
| | Adjuvant | 765 | EC | Soybean Methyl ester | 0.3825 | 0.50% | |
| | Biocide | 15 | XX | 3-iodo-2-propynyl | 0.0075 | 0.50% | |
| | | | | butyl carbamate | | | |
| 6 | component (2) | 120 + 200 | EC | picoxystrobin/ | 60 + 100 | 500 | mL |
| | | | | Tebuconazole | | | |
| | Adjuvant | 765 | EC | Soybean Methyl ester | 0.3825 | 0.50% | |
| | Biocide | 15 | XX | 3-iodo-2-propynyl | 0.015 | 1% | |
| | | | | butyl carbamate | | | |
| 7 | Component (2) | 120 + 200 | EC | picoxystrobin/ | 60 + 100 | 500 | mL |
| | | | | Tebuconazole | | | |
| | Component (1) + | 15 + 20 | SC | Castalagin/Copper | 7.5 + 10 | 500 | mL |
| | Cu Component (3) | | | | | | |
| | Adjuvant | 765 | EC | Soybean Methyl ester | 0.3825 | 0.50% | |
| 8 | Component (2) | 120 + 200 | EC | picoxystrobin/ | 60 + 100 | 500 | mL |
| | | | | Tebuconazole | | | |
| | Component (1) + | 15 + 20 | SC | Castalagin/Copper | 15 + 20 | 1000 | mL |
| | Cu Component (3) | | | | | | |

| | | | | | |
|---|---|---|---|---|---|
| Adjuvant | 765 | EC | Soybean Methyl ester | 0.3825 | 0.50% |

Based on the results obtained, the area under the disease progress curve (AUDPC) and respective % of control was calculated, as shown in the graph below.

Based on the results, it is observed that the addition of polyphenol+Copper (Castalagin/Copper) promoted an increase in the performance of component (2) fungicides picoxystrobin and Tebuconazole in the adjuvant Methyl Soyate (treatment 2) by 9.5% (treatment 7) and 10.9% (treatment 8) respectively.

It was observed that addition of polyphenol+Copper reduced the phytotoxicity by about 50% (treatments 7 and 8), when added to picoxystrobin and Tebuconazole in Methyl Soyate (treatment 2).

It was observed that the addition of polyphenol+Copper was statistically different, promoting a yield increase of 2.8% (treatment 7) and 5.6% (treatment and 8), when added to the component (2) fungicides picoxystrobin and Tebuconazole in the adjuvant Methyl Soyate (treatment 2).

### Example 4

A field trial was conducted at Formosa district, Goias State during the growing season of 2022/2023.

Four fungicide spray applications were applied with an interval of 15 days between sprays.
Location of the trial: Experimental Station—Formosa/GO;
Initiation and conclusion of the trial: Jan. 24, 2023 and Apr. 26, 2023
Crop: soybean. Variety: BMX Olimpo IPRO.
   Sowing date: Dec. 12, 2022;
   Planter: Semeato SHM 11-13;
   System: no till
   Emergence date: Dec. 19, 2022;
   Plant population: 23.5 plants/m²;
   Plant density: 235,714 plants/ha;
   Row spacing: 0.42 m;
   Fertilizer: 00-46-00 (NPK) up to 150 kg/ha.

### Spray:

Number of spray: 4;
Interval between spray: 15 days
spray method: terrestrial
Equipment: Backpack CO₂ spray
Boom: 5 nozzles XR 110:02 WK 0.5 m apart;
Spray pressure: 30 psi;
Spray speed: 1.5 m/s;
Spray volume: 150 L/ha.
   Products Used in this Trial

| Code | Composition and concentration(g ai/L) |
|---|---|
| ADA FF 322/22 | Mancozeb 400 + picoxystrobin 26.6 + |
| | Tebuconazole 33.3 + Polyphenol 22.5 g ai/L OD |
| Blindado ® TOV | Mancozeb 400 + picoxystrobin 26.6 + |
| | Tebuconazole 33.3 g ai/L OD |

The efficacy on soybean Asian rust were superior when polyphenol was added (treatment number 3 and 4 versus treatment number 2 (without polyphenol, see efficacy Table 3):

TABLE 3
Results - Severity of Asian rust (Phakopsora pachyrhizi) in soybean
(BMX Olimpo IPRO) with different treatments. Formosa/GO, GO, 2023.

| | | | Mar. 28, 2023 | | | Apr. 4, 2023 | | |
|---|---|---|---|---|---|---|---|---|
| | | | 21 DAA4 | | | 28 DAA4 | | |
| | Dose | | Disease | | Efficacy | Disease | | Efficiency |
| Treatment | (L, Kg/ha) | | Pressure | p < 0.05 ¹ | (%) | Pressure | p < 0.05 ¹ | (%) |
| 1. CONTROL | — | | 45.7 | | 0.0 | 68.4 | | 0.0 |
| 2. Blindado ® TOV ^{ABCD} | 2 | L | 10.5 | B | 77.0 | 18.0 | B | 73.7 |
| 3. ADA FF 322-22 ^{ABCD} | 1.8 | L | 9.8 | B | 78.5 | 15.0 | w | 78.1 |
| 4. ADA FF 322-22 ^{ABCD} | 2 | L | 9.5 | B | 79.3 | 13.6 | d | 80.1 |

We could see a benefit of lower defoliation when polyphenol was added. See the Table 4

TABLE 4
Area under the disease progress curve (AUDPC) and defoliation (%) in soybean
(BMX Olimpo IPRO) with different treatments. Formosa/GO, GO, 2023.

| | | | | | | defoliation | | |
|---|---|---|---|---|---|---|---|---|
| | | | AUDPC | | | Apr. 6, 2023 | | |
| | Dose | | | | Efficiency | | | Efficiency |
| Treatment | (L, Kg/ha) | | averages | p < 0.05 ¹ | (%) | averages | p < 0.051 | (%) |
| CONTROL | — | | 968.7 | | 0.0 | 100.0 | | 0.0 |
| Blindado ® TOV ^{ABCD} | 2 | L | 223.7 | B | 76.9 | 29.5 | B | 70.6 |
| ADA FF 322-22 ^{ABCD} | 1.8 | L | 204.1 | B | 78.9 | 26.4 | B | 73.6 |
| ADA FF 322-22 ^{ABCD} | 2 | L | 193.4 | B | 80.0 | 25.8 | B | 74.2 |

In Table 5, we can see the beneficial yield increase of about 200 kg/ha of treatment 3 and 4 (with polyphenol) versus treatment number 2 (without polyphenol-based component):

TABLE 5
Yield (kg/ha) and mass of a thousand grains (g) in soybean (BMX
Olimpo IPRO) with different treatments. Formosa/GO, GO, 2023.

| | | Apr. 26, 2023 | | | Apr. 27, 2023 | | |
|---|---|---|---|---|---|---|---|
| | Dose | Productivity (kg · ha) | | | Mass of one thousand grains (g) | | |
| Treatment | (L, Kg/ha) | averages | p < 0.05 ¹ | Δ (%) | averages | p < 0.051 | Δ (%) |
| CONTROL | — | 3,227.3 | B | 0.0 | 150.8 | B | 0.0 |
| Blindado ®TOV ^{ABCD} | 2,000 | 4,800.5 | The | 48.7 | 180.3 | 0 | 19.6 |
| ADA FF 322-22 ^{ABCD} | 1,800 | 4,999.6 | The | 54.9 | 184.9 | 0 | 22.6 |
| ADA FF 322-22 ^{ABCD} | 2,000 | 5,034.5 | The | 56.0 | 184.8 | 0 | 22.5 |

The benefits of adding Polyphenol-based component as regards plant quality, greener leaves etc. We note the lack of leaves in the control plants, versus treatment number 2 with Blindado® at 2,000 ml/ha, and ADA FF 322-22 (the same concentrations of the 3 fungicides of Blindado®, with the addition of 22.5 g/L of Polyphenol-based component at a lower rate of application (1800 ml/ha) showing more green leaves. The treatment number 4, with the ADA FF 322-22 at 2,000 ml/ha (equivalent to Blindado® TOV on the fungicide rates with the addition of 22.5 g/L of polyphenol), also, with more and greener leaves due to the higher rust efficacy+anti-stress and bio stimulant effect of the polyphenol.

### Conclusion

The addition of polyphenol to the fungicides improved the efficacy on Asian soybean rust control and increased the yield in terms of grain weight and total yield and allowed for the reduction in applied amounts of fungicide with equivalent efficacy etc.

### Example 5 Systemic Fungicide/Mancozeb Rate Reduction

In general the inclusion of the polyphenol-based component can allow for reduction of all fungicide components in the combinations by about 10-50% without significant loss of fungicidal efficacy as well as plant health related benefits.

It was shown during the same trials that, when polyphenol-based component is included/used, it was possible to reduce the rate of application of all the fungicides in the tested combinations by between 20 and 40% which can immediately be seen when comparing the efficacy of composition that were sprayed at 1.8 L/Ha to those applied at 2.0 L and 2.2 L/Ha.

It was shown during the same trials that, when polyphenol-based component is included/used, it was possible to significantly reduce the mancozeb application rate by at least 25% from a regular rate which as previously explained provides added formulation and application quality benefits over and above simply reducing costs and the environmental impact.

Thus, compared with Blindado® treatment comprising 880 g ai/ha of mancozeb, treatment number 2 versus the treatments numbers 3 to 7 in the table below, where 600 g ia/ha of mancozeb was applied together with the polyphenol-based component, showing equivalent or no loss of efficacy.

| | Dose | | | | | Efficiency | | | Efficiency |
|---|---|---|---|---|---|---|---|---|---|
| Treatment | (L, Kg/ha) | Averages | Averages | Averages | | (%) | averages | | (%) |
| 1. CONTROL | — | 0.0 | 0.0 | 0.3 | | 0.0 | 7.3 | | 0.0 |
| 2. Blindado ® TOV ^{ABCD} | 2,000 | 0.0 | 0.0 | 0.0 | B | 100.0 | 1.6 | B | 78.7 |
| 3. ADA FF 316-22 ^{ABCD} | 2,000 | 0.0 | 0.0 | 0.0 | B | 100.0 | 1.5 | B | 80.1 |
| 4. ADA FF 317-22 ^{ABCD} | 2,000 | 0.0 | 0.0 | 0.0 | B | 100.0 | 1.5 | B | 79.0 |
| 5. ADA FF 321-22 ^{ABCD} | 2,000 | 0.0 | 0.0 | 0.0 | B | 100.0 | 1.5 | B | 79.7 |
| 6. ADA FF 318-22 ^{ABCDD} | 2,000 | 0.0 | 0.0 | 0.0 | B | 100.0 | 1.5 | B | 79.0 |
| 7. ADA FF 319-22 ^{ABCD} | 2,000 | 0.0 | 0.0 | 0.0 | B | 100.0 | 1.5 | B | 80.1 |
| CV(%) | | | | | 73.02 | | | 8.16 | |

See the components of each of the treatments:

| code | Composition and concentration(g i.a./L) |
|---|---|
| ADA FF 316/22 | Mancozeb 300 + picoxystrobin 32.5 + |
| | Tebuconazole 50 + Polyphenol 45 |
| ADA FF 317/22 | Mancozeb 300 + picoxystrobin 32.5 + |
| | Tebuconazole 50 + Polyphenol 22.5 |
| ADA FF 321/22 | Mancozeb 300 + picoxystrobin 32.5 + |
| | Tebuconazole 50 + Copper 4 + Polyphenol 45 |
| ADA FF 318/22 | Mancozeb 300 + picoxystrobin 32.5 + |
| | Tebuconazole 50 + Copper 4 + Polyphenol 22.5 |
| ADA FF 319/22 | Mancozeb 300 + picoxystrobin 32.5 + |
| | Tebuconazole 50 + Copper 25 + Polyphenol 45 |
| BLINDADO ® TOV | Mancozeb 400 + picoxystrobin 26.66 + |
| | Tebuconazole 33.33 |

Treatments—Product, active ingredients, concentration and doses applied in soybeans (BMX Olimpo IPRO). Formosa/GO, GO/2023.

| | | Dose p.c. | | Active | Concentration | Dose i.a |
|---|---|---|---|---|---|---|
| No. | Products* | (L/ha) | | Ingredient(i.a.) | i.a. (g/L) | (g/ha) |
| 1 | CONTROL | — | | — | — | — |
| 2 | BLINDADO ® | 2 | L | Mancozeb | 400 | 800 |
| | TOV | | | picoxystrobin | 26.7 | 53.3 |
| | | | | Tebuconazole | 33.3 | 66.7 |
| 3 | ADA FF | 1.8 | L | Mancozeb | 400 | 720 |
| | 322/22 OD | | | picoxystrobin | 26.7 | 48 |
| | | | | Tebuconazole | 33 | 59.4 |
| | | | | Polyphenol 100% | 22.5 | 40.5 |
| 4 | ADA FF | 2 | L | Mancozeb | 400 | 800 |
| | 322/22 OD | | | picoxystrobin | 26.7 | 53.3 |
| | | | | Tebuconazole | 33 | 66 |
| | | | | Polyphenol 100% | 22.5 | 45 |
| 5 | ADA FF | 2.2 | L | Mancozeb | 400 | 880 |

| | | | | | |
|---|---|---|---|---|---|
| | 322/22 OD | | picoxystrobin | 26.7 | 58.7 |
| | | | Tebuconazole | 33 | 72.6 |
| | | | Polyphenol 100% | 22.5 | 49.5 |
| 6 | ADA FF | 2,000 | Mancozeb | 300 | 600 |
| | 316/22 OD | | picoxystrobin | 32.5 | 65 |
| | | | Tebuconazole | 50 | 100 |
| | | | Polyphenol 100% | 45 | 90 |
| 7 | ADA FF | 2,000 | Mancozeb | 300 | 600 |
| | 317/22 OD | | picoxystrobin | 32.5 | 65 |
| | | | Tebuconazole | 50 | 100 |
| | | | Polyphenol 100% | 22.5 | 45 |
| 8 | ADA FF | 2,000 | Mancozeb | 300 | 600 |
| | 321/22 ID | | picoxystrobin | 32.5 | 65 |
| | | | Tebuconazole | 50 | 100 |
| | | | Copper | 4 | 8 |
| | | | Polyphenol 100% | 45 | 90 |
| 9 | ADA FF | 2,000 | Mancozeb | 300 | 600 |
| | 318/22 OD | | picoxystrobin | 32.5 | 65 |
| | | | Tebuconazole | 50 | 100 |
| | | | Copper | 4 | 8 |
| | | | 100% Polyphenol | 22.5 | 45 |
| 10 | ADA FF | 2,000 | Mancozeb | 300 | 600 |
| | 319/22 OD | | picoxystrobin | 32.5 | 65 |
| | | | Tebuconazole | 50 | 100 |
| | | | Copper | 25 | 50 |
| | | | Polyphenol 100% | 45 | 90 |

Added adjuvant Rumba (Soybean oil methyl ester - 765 g/L) at a dose of 0.250 L/ha (191.25 g.i.a./ha) in treatments 2 to 10.

### Evaluations:

Biological targets: Phakopsora pachyrhizi;
Parameters evaluated:
   Phytotoxicity—general evaluation of the plot for symptoms such as chlorosis or necrosis resulting from the application of treatments;
   Severity—visual note of the percentage (%) of leaf area attacked by the pathogen.
   Defoliation—visual note of the percentage (%) of defoliation in the useful area of each experimental plot.
   Productivity—two central rows of each plot, equivalent to 4.54 m², were harvested using a Almaco SPC 20 plot harvester. The volume of grains obtained was weighed and its moisture was determined to estimate the yield.
   Mass of a thousand grains—three samples of 100 grains were counted and weighed for the estimate of the mass of a thousand grains.

### Area Under the Disease Progression Curve (AUDPC):

$${{A U D P C}_{i = 1}}^{n} = \sum [ ( ( {Y}_{i + 1} + {Y}_{i} ) * 0 , 5 ) * ( {T}_{i + 1} - {T}_{i} )$$

Yi: disease severity at the time of evaluation i (i=1, . . . , n);
Yi+1 disease severity at the time of evaluation i+1;
Ti: time of initial assessment (i);
Ti+1: time of the next evaluation (i+1);
n=number of evaluations;

Efficiency calculation: The ABBOTT formula (1925) was used to calculate the efficiency percentages resulting from the action of the tested fungicides:

$$\% E = ( ( T - F ) / T ) \times 100$$

T=% severity in the control
F=% severity of treatment.

### RESULTS AND DISCUSSION

The environmental conditions recorded during the period of the experiment were of abundant precipitation before in the months of December and January, summer conditions in February and normality in the month of March, with the temperature and relative humidity following the normality for the period.

These conditions, combined with the use of a susceptible soybean cultivar and the availability of inoculum of the pathogen, provided by late planting, resulted in the occurrence of Asian rust naturally and with high severity.

The fungicide treatments applied did not cause visual symptoms of phytotoxicity to soybean plants, as observed in evaluations performed at 7 days after each application of the products. (see Table 6)

TABLE 6
Phytotoxicity in soybean (BMX Olimpo IPRO) with different treatments.

| | | | 31 Jan. 2023 | | 15 Feb. 2023 | | 2 Mar. 2023 | | 14 Mar. 2023 | |
|---|---|---|---|---|---|---|---|---|---|---|
| | Dose | | 7 DAA1 | | 7 DAA2 | | 7 DAA3 | | 7 DAA4 | |
| Treatment | (L, Kg/ha) | | Average | | Average | | Average | | Average | |
| CONTROL | — | | 0.0 | ns | 0.0 | ns | 0.0 | ns | 0.0 | ns |
| BLINDADO ® TOV^{A B C D} | 2 | L | 0.0 | | 0.0 | | 0.0 | | 0.0 | |
| ADA FF 322-22^{A B C D} | 1.8 | L | 0.0 | | 0.0 | | 0.0 | | 0.0 | |
| ADA FF 322-22^{A B C D} | 2 | L | 0.0 | | 0.0 | | 0.0 | | 0.0 | |
| ADA FF 322-22^{A B C D} | 2.2 | L | 0.0 | | 0.0 | | 0.0 | | 0.0 | |
| ADA FF 316-22^{A B C D} | 2 | L | 0.0 | | 0.0 | | 0.0 | | 0.0 | |
| ADA FF 317-22^{A B C D} | 2 | L | 0.0 | | 0.0 | | 0.0 | | 0.0 | |
| ADA FF 321-22^{A B C D} | 2 | L | 0.0 | | 0.0 | | 0.0 | | 0.0 | |
| ADA FF 318-22^{A B C D D} | 2 | L | 0.0 | | 0.0 | | 0.0 | | 0.0 | |
| ADA FF 319-22^{A B C D} | 2 | L | 0.0 | | 0.0 | | 0.0 | | 0.0 | |
| CV(%) | | | | | | | | | | |

¹ Means followed by the same letter in the column do not differ from each other by the Scott Knott test (p < 0.05).
Application Stage: ^{A}36 DAE; ^{B}51 DAE; ^{C}66 DAE; ^{D}78 DAE.
**Additional Rumba ® [Methyl Soyate] adjuvant (0.250 L/ha) in treatments 2 to 10.

These results show the selectivity of BMX Desafio IPRO soybean treatments in foliar applications.

The first two applications of the fungicide treatments were carried out preventively, without the presence of symptoms of Asian rust in soybean plants. In the evaluation prior to the third application, the first symptoms of the disease were detected in the experiment, but only in the control treatment, without application of fungicides. In the next evaluation, prior to the fourth application, the disease was already present in all treatments and with significantly higher severity in the control without control, with no difference between the fungicides tested (Table 7).

TABLE 7
Severity of Asian rust (Phakopsora pachyrhizi) in soybean
(BMX Olimpo IPRO) with different treatments . . .

| | | | | | | | 23 Feb. 2023 | | | 7 Mar. 2023 | | |
|---|---|---|---|---|---|---|---|---|---|---|---|---|
| | | | 24 Jan. 2023 | | 08 Feb. 2023 | | Pre-spray 3 | | | Pre-spray 4 | | |
| | Dose | | Pre-spray 1 | | Pre-spray 2 | | | | Efic. | | | Efic. |
| Treatment | (L, Kg/ha) | | Media | | Media | | Media | | (%) | Media | | (%) |
| CONTROL | — | | 0.0 | ns | 0.0 | ns | 0.3 | a | 0.0 | 7.3 | a | 0.0 |
| Blindado ® TOV^{A B C D} | 2 | L | 0.0 | | 0.0 | | 0.0 | b | 100 | 1.6 | b | 78.7 |
| ADA FF 322-22^{A B C D} | 1.8 | L | 0.0 | | 0.0 | | 0.0 | b | 100 | 1.5 | b | 79.4 |
| ADA FF 322-22^{A B C D} | 2 | L | 0.0 | | 0.0 | | 0.0 | b | 100 | 1.4 | b | 80.4 |
| ADA FF 322-22^{A B C D} | 2.2 | L | 0.0 | | 0.0 | | 0.0 | b | 100 | 1.4 | b | 81.4 |
| ADA FF 316-22^{A B C D} | 2 | L | 0.0 | | 0.0 | | 0.0 | b | 100 | 1.5 | b | 80.1 |
| ADA FF 317-22^{A B C D} | 2 | L | 0.0 | | 0.0 | | 0.0 | b | 100 | 1.5 | b | 79.0 |
| ADA FF 321-22^{A B C D} | 2 | L | 0.0 | | 0.0 | | 0.0 | b | 100 | 1.5 | b | 79.7 |
| ADA FF 318-22^{A B C D} | 2 | L | 0.0 | | 0.0 | | 0.0 | b | 100 | 1.5 | b | 79.0 |
| ADA FF 319-22^{A B C D} | 2 | L | 0.0 | | 0.0 | | 0.0 | b | 100 | 1.5 | b | 80.1 |

| | | |
|---|---|---|
| CV(%) | 73.02 | 8.16 |

¹ Means followed by the same letter in the column do not differ from each other by the Scott Knott test (p < 0.05).
Application Stage: ^{A}36 DAE; ^{B}51 DAE; ^{C}66 DAE; ^{D}78 DAE.
**Additional Rumba [Methyl Soyate] adjuvant (0.250 L/ha) in treatments 2 to 10.

In the following severity assessments, performed at 7, 14, 21 and 28 DAA4, Asian Soybean Rust evolved rapidly and there was greater differentiation between treatments with regard to control efficiency. In general, there was a superior performance of all treatments compared to the Blindado® TOV, and this effect was clearly significant at 7 and 28 DAA4 (Tables 8 and 9). In the specific case of the fungicide ADA FF 322-22, it was responsive to dose increase, with better performance of 2 L and 2.2 L/ha, compared to 1.8 L/ha.

TABLE 8
Severity of Asian rust (Phakopsora pachyrhizi) in
soybean (BMX Olimpo IPRO) with different treatments.

| | | | 7 DAA4 | | | 14 DAA4 | | |
|---|---|---|---|---|---|---|---|---|
| | Dose | | | | Efic. | | | Efic. |
| Treatment | (L, Kg/ha) | | Media | p < 0.05 ¹ | (%) | Media | p < 0.05 ¹ | (%) |
| CONTROL | — | | 15.8 | a | 0.0 | 32.4 | a | 0.0 |
| Blindado ® TOV^{A B C D} | 2 | L | 3.8 | b | 75.8 | 6.5 | b | 79.9 |
| ADA FF 322-22^{A B C D} | 1.8 | L | 3.4 | c | 78.3 | 6.4 | b | 80.3 |
| ADA FF 322-22^{A B C D} | 2 | L | 3.2 | d | 79.7 | 6.2 | b | 80.8 |
| ADA FF 322-22^{A B C D} | 2.2 | L | 3.3 | d | 79.4 | 5.8 | b | 82.2 |
| ADA FF 316-22^{A B C D} | 2 | L | 3.1 | d | 80.5 | 6.8 | b | 79.1 |
| ADA FF 317-22^{A B C D} | 2 | L | 2.9 | d | 81.5 | 6.9 | b | 78.8 |
| ADA FF 321-22^{A B C D} | 2 | L | 3.1 | d | 80.7 | 6.5 | b | 79.8 |
| ADA FF 318-22^{A B C D} | 2 | L | 3.2 | d | 79.9 | 7.0 | b | 78.4 |
| ADA FF 319-22^{A B C D} | 2 | L | 3.0 | d | 80.9 | 6.5 | b | 79.8 |

| | | |
|---|---|---|
| CV(%) | 5.1 | 10.59 |

¹ Means followed by the same letter in the column do not differ from each other by the Scott Knott test (p < 0.05).
Application Stage: ^{A}36 DAE; ^{B}51 DAE; ^{C}66 DAE; ^{D}78 DAE.
**Additional Rumba adjuvant (0.250 L/ha) in treatments 2 to 10.

TABLE 9
Severity of Asian Soybean Rust in soybean with different treatments.

| | | | 21 DAA4 | | | 28 DAA4 | | |
|---|---|---|---|---|---|---|---|---|
| | Dose | | | | Efic. | | | Efic. |
| Treatment | (L, Kg/ha) | | Media | p < 0.05 ¹ | (%) | Media | p < 0.05 ¹ | (%) |
| CONTROL | — | | 45.7 | a | 0.0 | 68.4 | a | 0.0 |
| Blindado ® TOV^{A B C D} | 2 | L | 10.5 | b | 77.0 | 18.0 | b | 73.7 |
| ADA FF 322-22^{A B C D} | 1.8 | L | 9.8 | b | 78.5 | 15.0 | c | 78.1 |
| ADA FF 322-22^{A B C D} | 2 | L | 9.5 | b | 79.3 | 13.6 | d | 80.1 |
| ADA FF 322-22^{A B C D} | 2.2 | L | 9.5 | b | 79.1 | 13.3 | d | 80.5 |
| ADA FF 316-22^{A B C D} | 2 | L | 9.2 | b | 79.9 | 12.5 | d | 81.8 |
| ADA FF 317-22^{A B C D} | 2 | L | 8.8 | b | 80.7 | 12.0 | d | 82.5 |
| ADA FF 321-22^{A B C D} | 2 | L | 9.5 | b | 79.3 | 11.9 | d | 82.7 |
| ADA FF 318-22^{A B C D} | 2 | L | 9.5 | b | 79.1 | 13.0 | d | 80.9 |
| ADA FF 319-22^{A B C D} | 2 | L | 9.1 | b | 80.2 | 12.2 | d | 82.1 |

| | | |
|---|---|---|
| CV(%) | 7.56 | 8.01 |

¹ Means followed by the same letter in the column do not differ from each other by the Scott Knott test (p < 0.05).
Application Stage: ^{A}36 DAE; ^{B}51 DAE; ^{C}66 DAE; ^{D}78 DAE.
**Additional Rumba adjuvant (0.250 L/ha) in treatments 2 to 10.

The AUDPC and defoliation data confirm these results and show high control efficiency in all fungicide treatments, with a reduction ranging from 76.9% to 80.7% in AUDPC of Asian Rust (Table 10). There was a trend of superiority of the treatments with application of ADA FF 322-22, ADA FF 316-22, ADA FF 317-22, ADA FF 321-22, ADA FF 318-22 and ADA FF 319-22 compared to the treatment with Blindado® TOV.

TABLE 10
Area under the disease progress curve (AACPD) and defoliation
(%) in soybean (BMX Olimpo IPRO) with different treatments.

| | | AUDPC | | | DEFOLIATION | | |
|---|---|---|---|---|---|---|---|
| | Dose | | | Efic. | | | Efic. |
| Treatment | (L, Kg/ha) | Media | p < 0.05 ¹ | (%) | Media | p < 0.05 ¹ | (%) |
| Witness | — | 968.7 | a | 0.0 | 100.0 | a | 0.0 |
| Armored TOV^{A B C D} | 2,000 | 223.7 | b | 76.9 | 29.5 | b | 70.6 |
| ADA FF 322-22^{A B C D} | 1,800 | 204.1 | b | 78.9 | 26.4 | b | 73.6 |
| ADA FF 322-22^{A B C D} | 2,000 | 193.4 | b | 80.0 | 25.8 | b | 74.2 |
| ADA FF 322-22^{A B C D} | 2,200 | 189.3 | b | 80.5 | 23.7 | b | 76.3 |
| ADA FF 316-22^{A B C D} | 2,000 | 190.6 | b | 80.3 | 23.6 | b | 76.4 |
| ADA FF 317-22^{A B C D} | 2,000 | 186.7 | b | 80.7 | 26.0 | b | 74.0 |
| ADA FF 321-22^{A B C D} | 2,000 | 188.7 | b | 80.5 | 26.7 | b | 73.3 |
| ADA FF 318-22^{A B C DD} | 2,000 | 198.0 | b | 79.6 | 26.5 | b | 73.6 |
| ADA FF 319-22^{A B C D} | 2,000 | 186.8 | b | 80.7 | 23.4 | b | 76.6 |
| CV(%) | | | 6.35 | | | 9.36 | |

¹ Means followed by the same letter in the column do not differ from each other by the Scott Knott test (p < 0.05).
Application Stage: ^{A}36 DAE; ^{B}51 DAE; ^{C}66 DAE; ^{D}78 DAE.
**Additional Rumba adjuvant (0.250 L/ha) in treatments 2 to 10.

All treatments with fungicide application produced more disease control than the untreated control, with increments ranging from 48.7% to 58.1%. This result was also verified for the mass of one thousand grains, where the treatments with fungicide application obtained grains 19.6% to 24.1% heavier. (Table 11).

TABLE 11
Produtivity (kg/ha) and mass of one thousand grains (g) in soybean
(BMX Olimpo IPRO) with different treatments. Formosa/GO, GO, 2023.

| | | 26 Apr. 2023 | | | 27 Apr. 2023 | | |
|---|---|---|---|---|---|---|---|
| | Dose | Productivity (kg · ha) | | | Mass of a thousand grains (g) | | |
| Treatment | (L, Kg/ha) | Media | p < 0.05 ¹ | D (%) | Media | p < 0.05 ¹ | D (%) |
| Witness | — | 3,227.3 | b | 0.0 | 150.8 | b | 0.0 |
| Armored TOV^{A B C D} | 2,000 | 4,800.5 | a | 48.7 | 180.3 | a | 19.6 |
| ADA FF 322-22^{A B C D} | 1,800 | 4,999.6 | a | 54.9 | 184.9 | a | 22.6 |
| ADA FF 322-22^{A B C D} | 2,000 | 5,034.5 | a | 56.0 | 184.8 | a | 22.5 |
| ADA FF 322-22^{A B C D} | 2,200 | 5,078.6 | a | 57.4 | 185.3 | a | 22.8 |
| ADA FF 316-22^{A B C D} | 2,000 | 4,871.6 | a | 50.9 | 181.2 | a | 20.1 |
| ADA FF 317-22^{A B C D} | 2,000 | 4,955.1 | a | 53.5 | 183.5 | a | 21.7 |
| ADA FF 321-22^{A B C D} | 2,000 | 5,101.5 | a | 58.1 | 187.2 | a | 24.1 |
| ADA FF 318-22^{A B C D D} | 2,000 | 4,995.0 | a | 54.8 | 184.1 | a | 22.0 |
| ADA FF 319-22^{A B C D} | 2,000 | 4,926.5 | a | 52.7 | 183.5 | a | 21.6 |
| CV(%) | | | 3.58 | | | 3.42 | |

¹ Means followed by the same letter in the column do not differ from each other by the Scott Knott test (p < 0.05).
Application Stage: ^{A}36 DAE; ^{B}51 DAE; ^{C}66 DAE; ^{D}78 DAE.
**Additional Rumba adjuvant (0.250 L/ha) in treatments 2 to 10.

1) A multi-component combination comprising at least two components
(1) polyphenol-based component; and
(2) at least one fungicide (A) selected from the group of QiI fungicide; strobilurin fungicide; SDHI fungicide; azole fungicide; morpholine fungicide and any and all mixtures of two or more thereof; and optionally,
(3) compounds selected from the group of,
i. protectant fungicide(s);
ii. copper-based compound(s); and
iii. any and all mixtures thereof;
with the proviso that the polyphenol-based component (1), contains naturally sourced or derived, polyphenol-based compounds, and that lignosulphonates, if present in the combination, or in compositions comprising the combination, are not the sole polyphenol-based compound.

2) A multi-component combination comprising at least two components
(1) polyphenol-based component; and
(2) at least one fungicide (A) selected from the group of QiI fungicide; strobilurin fungicide; SDHI fungicide; azole fungicide; morpholine fungicide and any and all mixtures of two or more thereof; and optionally,
(3) compounds selected from the group of,
i. protectant fungicide(s);
ii. copper-based compound(s); and
iii. any and all mixtures thereof;
with the proviso that the polyphenol-based component (1), contains at least one polyphenol which is not a lignosulfonate, and that lignosulphonates, if present in the combination, or in compositions comprising the combination, are not the sole polyphenol-based compound.

3) A multi-component combination comprising at least two components,
(1) polyphenol-based component; and
(2) at least one fungicide (A) selected from the group of:
(a) QiI fungicide;
(b) strobilurin fungicide;
(c) succinate dehydrogenase inhibitor (SDHI) fungicide;
(d) triazole fungicide;
(e) morpholine fungicide; and
any and all mixtures of two or more of (a)-(e); and optionally,
(3) compounds selected from the group of,
i. protectant fungicide(s);
ii. copper-based compound(s); and
iii. any and all mixtures thereof;
wherein the combination is more effective for treating a plant or soil against fungal disease than when each fungicide at the same amount is applied either alone or as a mixture of fungicides, without the polyphenol-based component, with the proviso that the polyphenol-based component (1) contains naturally sourced, or derived, polyphenol-based compounds, and that lignosulphonates, if present in the combination, or in compositions comprising the combination, are not the sole polyphenol-based compound.

4) A multi-component combination comprising at least two components,
(1) polyphenol-based component; and
(2) at least one fungicide (A) selected from the group of:
(a) QiI fungicide;
(b) strobilurin fungicide;
(c) succinate dehydrogenase inhibitor (SDHI) fungicide;
(d) triazole fungicide;
(e) morpholine fungicide; and
any and all mixtures of two or more of (a)-(e); and optionally,
(3) compounds selected from the group of,
i. protectant fungicide(s);
ii. copper-based compound(s); and
iii. any and all mixtures thereof;
wherein the combination is more effective for treating a plant or soil against fungal disease than when each fungicide at the same amount is applied either alone or as a mixture of fungicides, without the polyphenol-based component, with the proviso that the polyphenol-based component (1) contains at least one polyphenol which is not a lignosulfonate, and that lignosulphonates, if present in the combination, or in compositions comprising the combination, are not the sole polyphenol-based compound.

5) A multi-component combination comprising at least two components,
(1) polyphenol-based component and as component,
(2), at least one fungicide (A) selected from the group of:
(a) QiI fungicide;
(b) strobilurin fungicide;
(c) succinate dehydrogenase inhibitor (SDHI) fungicide;
(d) triazole fungicide;
(e) morpholine fungicide; and
any and all mixtures of two or more of (a)-(e); and optionally,
(3) compounds selected from the group of,
i. protectant fungicide(s);
ii. copper-based compound(s); and
iii. any and all mixtures thereof;
wherein, the amount of polyphenol-based component and the amount of the fungicide(s) (A) if applied together is more effective for treating a plant or soil against fungal infection than when each component at the same amount is applied alone with the proviso that the polyphenol-based component (1) contains naturally sourced or derived, polyphenol-based compounds, and that lignosulphonates, if present in the combination, or in compositions comprising the combination, are not the sole polyphenol-based compound.

6) A multi-component combination comprising at least two components,
(1) polyphenol-based component and as component,
(2), at least one fungicide (A) selected from the group of:
(a) QiI fungicide;
(b) strobilurin fungicide;
(c) succinate dehydrogenase inhibitor (SDHI) fungicide;
(d) triazole fungicide;
(e) morpholine fungicide; and
any and all mixtures of two or more of (a)-(e); and optionally,
(3) compounds selected from the group of,
i. protectant fungicide(s);
ii. copper-based compound(s); and
iii. any and all mixtures thereof;
wherein, the amount of polyphenol-based component and the amount of the fungicide(s) (A) if applied together is more effective for treating a plant or soil against fungal infection than when each component at the same amount is applied alone with the proviso that the polyphenol-based component (1) contains at least one polyphenol which is not a lignosulfonate, and that lignosulphonates, if present in the combination, or in compositions comprising the combination, are not the sole polyphenol-based compound.

7) A multi-component combination comprising at least two components,
(1) polyphenol-based component, and
as component (2), at least one fungicide (A) selected from the group consisting of:
(a) QiI fungicide,
(b) strobilurin fungicide,
(c) succinate dehydrogenase inhibitor (SDHI) fungicide,
(d) triazole fungicide and
(e) morpholine fungicide; and
any and all mixtures of two or more of (a)-(e); and optionally,
(3) compounds selected from the group of,
i. protectant fungicide(s);
ii. copper-based compound(s); and
iii. any and all mixtures thereof;
wherein, the amount of the fungicide(s) (A) in the combination is less than the fungicidally effective amount of the fungicide (A) if the fungicide (A) is used alone, with the proviso that the polyphenol-based component (1) contains naturally sourced or derived, polyphenol-based compounds, and that lignosulphonates, if present in the combination, or in compositions comprising the combination, are not the sole polyphenol-based compound.

8) A multi-component combination comprising at least two components,
(1) polyphenol-based component, and
(2), at least one fungicide (A) selected from the group consisting of:
(a) QiI fungicide,
(b) strobilurin fungicide,
(c) succinate dehydrogenase inhibitor (SDHI) fungicide,
(d) triazole fungicide and
(e) morpholine fungicide; and
any and all mixtures of two or more of (a)-(e); and optionally,
(3) compounds selected from the group of,
i. protectant fungicide(s);
ii. copper-based compound(s); and
iii. any and all mixtures thereof;
wherein, the amount of the fungicide(s) (A) in the combination is less than the fungicidally effective amount of the fungicide (A) if the fungicide (A) is used alone, with the proviso that the polyphenol-based component (1) contains at least one polyphenol which is not a lignosulfonate, and that lignosulphonates, if present in the combination, or in compositions comprising the combination, are not the sole polyphenol-based compound.

9) The multi-component combination of any one of claims 1-8, wherein the combination comprises polyphenol-based component, an QiI fungicide and an azole fungicide.

10) The multi-component combination of any one of claims 1-8, wherein the combination comprises polyphenol-based component, a morpholine fungicide and an SDHI fungicide.

11) The multi-component combination of any one of claims 1-8, wherein the combination comprises polyphenol-based component, a morpholine fungicide and a strobilurin fungicide.

12) The multi-component combination of any one of claims 1-8, wherein the combination comprises polyphenol-based component, a morpholine fungicide and an azole fungicide

13) The multi-component combination of any one of claims 1-8, wherein the combination comprises polyphenol-based component, an SDHI fungicide and a strobilurin fungicide.

14) The multi-component combination of any one of claims 1-8, wherein the combination comprises polyphenol-based component, morpholine fungicide and a strobilurin fungicide.

15) The multi-component combination of any one of claims 1-8, wherein the strobilurin is selected from the group of picoxystrobin, trifloxystrobin, azoxystrobin, pyraclostrobin, metominostrobin, metyltetraprole, mandestrobin and any combination of two or more thereof.

16) The multi-component combination of any one of claims 1-8, wherein the QiI fungicide (Quinone inside Inhibitor) is selected from the group of fenpicoxamid, cyazofamid, amisulbrom and any combination thereof

17) The multi-component combination of any one of claims 1-8, wherein the SDHI fungicide is selected from the group of penthiopyrad, boscalid, flutolanil, fluxapyroxad, fluopyram, fluindapyr, benzovindiflupyr, bixafen, pydiflumetofen and combination thereof.

18) The multi-component combination of any one of claims 1-8, wherein the SDHI is selected from the group of penthiopyrad, boscalid, flutolanil, fluxapyroxad, fluopyram, fluindapyr, benzovindiflupyr, bixafen, pydiflumetofen and any combination thereof.

19) The multi-component combination of any one of claims 1-8, wherein triazole fungicide is selected from the group of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole and any combination of two or more thereof.

20) The multi-component combination of any one of claims 1-19, comprising at least three components,
(1) polyphenol-based component,
(2) at least one fungicide (A) selected from the group of, QiI fungicide; strobilurin fungicide; SDHI fungicide; azole fungicide; morpholine fungicide and any and all mixtures of two or more thereof, and
(3) compounds selected from the group of,
i. Protectant fungicide(s);
ii. Copper-based compound(s); and
iii. any and all mixtures thereof.

21) The multi-component combination of any one of claims 1-8 and 20, wherein, the protectant fungicide(s) is selected from the group of fluazinam, chlorothalonil; (EBDC); dithiocarbamate; mancozeb, sulfur, folpet; captan; maneb; metiram; polycarbamate; propineb; zineb; and any and all mixtures thereof.

22) The multi-component combination of any one of claims 1-8 and 20-21, wherein, the copper-based compounds(s) is selected from the group of, cupric acetate; cupric chloride; cupric chlorate; cupric formate; cupric hexafluorosilicate; cupric nitrate; cupric chromate; copper sulfate pentahydrate; bordeaux mixture; copper hydroxide; copper oxychloride sulfate; tribasic copper sulfate; cupric sulfate; tricupric hydroxide; hemihydrate; chelated copper; Copper chelated with amino acids; copper complexed; copper glycinate; copper alaninates; and any and all combinations thereof, and any and all mixtures thereof.

23) The multi-component combination of any one of claims 1-8 and 20-22, wherein, the copper-based compounds(s) is selected from the group of, copper chelated with chelating agents exemplified by, EDTA; Copper complexed with amino acid(s); copper glycinate; copper alaninates; and any and all combinations thereof; and any and all mixtures thereof.

24) The multi-component combination of any one of claims 1-8 and 20-23, wherein, the copper-based compounds(s) is selected from the group of, chelated copper; copper complexed with at least one amino acid; and any mixtures thereof.

25) The multi-component combination of any one of claims 1-8 and 20-24, wherein, component (3) comprises Copper-based compound(s) and is free of protectant fungicide compounds.

26) A composition comprising the multi-component combination of any one of claims 1-8 and 20-25, and an agriculturally acceptable carrier.

27) The composition of claim 26 comprising the multi-component combination of claim 25.

28) The multi-component combination of claim 25, or compositions comprising the combination, wherein the combination has comparable efficacy to a combination of the same fungicide(s) (A) combined with protectant fungicide compound(s), absent the polyphenol-based component (1), wherein, the protectant fungicide is selected from the group of fluazinam, chlorothalonil; (EBDC); dithiocarbamate; mancozeb, sulfur, folpet; captan; maneb; metiram; polycarbamate; propineb; zineb; and any and all mixtures thereof.

29) The multi-component combination of any one of claims 1-8, and 20-24, or compositions comprising the combination and an agriculturally acceptable carrier, wherein said component (3) comprises reduced amount of protectant fungicide compound(s) as compared with the “fungicidally effective amount”, wherein, said combination has comparable or equivalent efficacy to a combination of the same fungicide(s) (A) and the “fungicidally effective amount” of the same protectant fungicide compound(s), absent the polyphenol-based component (1).

30) The multi-component combination of claim 29, wherein said reduced amount of protectant fungicide compound(s) is no more than about 75% of the “fungicidally effective amount” of the protectant fungicide compound(s) as compared to the “fungicidally effective amount” contained in a combination of the same fungicide(s) (A) and the same protectant fungicide compound(s), absent the polyphenol-based component (1), having at least equivalent efficacy.

31) The multi-component combination of any one of claims 28-30 wherein the efficacy is fungicidal efficacy.

32) A method for reducing the amount of Protectant fungicide required for the fungicidal efficacy of a combination with a systemic fungicide selected from the group consisting of:
a) QiI fungicide,
b) strobilurin fungicide,
c) succinate dehydrogenase inhibitor (SDHI) fungicide,
d) triazole fungicide and
e) morpholine fungicide; and
f) any and all mixtures of two or more of (a)-(e),
wherein the method comprises combining at least one, polyphenol-based compound with the systemic fungicide, with the proviso that,
i. the polyphenol-based compound(s) comprises naturally sourced or derived polyphenol-based compounds, and/or
ii. the polyphenol-based compound(s) contains at least one polyphenol which is not a lignosulfonate, and
that lignosulphonates, if present in the combination, or compositions comprising the combinations are not the sole polyphenol-based compound.

33) A polyphenol-based compound for the use of reducing the amount of Protectant fungicide required for the fungicidal efficacy of a combination with a systemic fungicide selected from the group consisting of:
a) QiI fungicide,
b) strobilurin fungicide,
c) succinate dehydrogenase inhibitor (SDHI) fungicide,
d) triazole fungicide and
e) morpholine fungicide; and
f) any and all mixtures of two or more of (a)-(e),
wherein the polyphenol-based compound is combined with the systemic fungicide, with the proviso that,
i. the polyphenol-based compound(s) comprises naturally sourced or derived polyphenol-based compounds, and/or
ii. the polyphenol-based compound(s) contains at least one polyphenol which is not a lignosulfonate, and
that lignosulphonates, if present in the combination, or compositions comprising the combinations are not the sole polyphenol-based compound.

34) The multi-component combination of claim 20 comprising,
a) a composition comprising
i) polyphenol-based component (1) and
ii) at least one component (3) compound selected from the group of, Protectant fungicide(s); Copper-based compound(s); and any and all mixtures thereof,
and
b) a composition comprising systemic fungicide(s) (A) as component (2) selected from the group of, QiI fungicide; strobilurin fungicide; SDHI fungicide;
azole fungicide; morpholine fungicide and any and all mixtures of two or more thereof.

35) The multi-component combination of claim 34 wherein composition (a.), comprising polyphenol-based component (1) and component (3) compounds selected from the group of, Protectant fungicide(s); Copper-based compound(s); and any and all mixtures thereof, is adapted for the use for combining with one or more compositions (b.), comprising systemic fungicide(s) (A) as component (2) selected from the group of, QiI fungicide; strobilurin fungicide; SDHI fungicide; azole fungicide; morpholine fungicide and any and all mixtures of two or more thereof.

36) The multi-component combination of claim 35 wherein said adaptation comprises one or more of,
I. providing instructions for combining composition (a.) with one or more compositions (b.), preferably packaged with composition (a.) exemplified by a package insert or as labeling as a package insert or as marketing recommendations for use of the composition (a.),
II. providing composition (a.) comprising amounts of Protectant fungicide(s), Copper-based compound(s), or any and all mixtures thereof, as component (3) which are reduced below the fungicidal efficacy of the compounds comprising component (3) in the absence of polyphenol-based component (1).
III. Providing a kit of parts comprising composition (a.) together with one or more III. compositions (b.)
IV. any combination of adaptations I-III, and/or
V. any packaging or composition adaptation with similar effect in the use for combining composition (a.) with one or more compositions (b.).

37) The multi-component combination of claim 20 comprising,
a) a composition comprising,
i) polyphenol-based component (1) and
ii) component (3) Copper-based compound(s); and
b) a composition comprising
i) systemic fungicide(s) (A) as component (2) selected from the group of, QiI fungicide; strobilurin fungicide; SDHI fungicide; azole fungicide; morpholine fungicide and any and all mixtures of two or more thereof, and
ii) component (3) Protectant fungicide(s), compound(s) selected from the group of fluazinam, chlorothalonil; (EBDC); dithiocarbamate; mancozeb, sulfur, folpet; captan; maneb; metiram; polycarbamate; propineb; zineb; and any and all mixtures thereof.

38) The multi-component combination of claim 37 wherein composition (a.), comprising polyphenol-based component (1) and component (3) Copper-based compound(s), is adapted for the use for combining with one or more compositions (b.), comprising systemic fungicide(s) (A) as component (2) selected from the group of, QiI fungicide; strobilurin fungicide; SDHI fungicide; azole fungicide; morpholine fungicide and any and all mixtures of two or more thereof, and component (3) Protectant fungicide(s), compound(s) selected from the group of fluazinam, chlorothalonil; (EBDC); dithiocarbamate; mancozeb, sulfur, folpet; captan; maneb; metiram; polycarbamate; propineb; zineb; and any and all mixtures thereof.

39) The multi-component combination of claim 38 wherein said adaptation comprises one or more of,
I. Providing instructions for combining composition (a.) with one or more compositions (b.), preferably packaged with, or supplied with, composition (a.) exemplified by a package insert or as labeling or as marketing recommendations for use of the composition (a.);
II. Providing composition (a.) comprising amounts of copper-based compound(s), as component (3) which are reduced below the fungicidal efficacy of the Copper-based compound(s) comprising component (3) when mixed with the composition (b.) comprising systemic fungicide(s) (A) as component (2) and Protectant fungicide(s) compound(s) as component (3), in the absence of polyphenol-based component (1);
III. Providing a kit of parts comprising composition (a.) together with one or more compositions (b.)
IV. Any combination of adaptations I-III, or
V. any packaging or composition adaptation with similar effect in the use for combining composition (a.) with one or more compositions (b.)

40) The composition (a.) of claim 34 comprising polyphenol-based component (1) and component (3) compounds selected from the group of, Protectant fungicide(s); Copper-based compound(s); and any and all mixtures thereof, adapted for the use for combining with one or more of,
i. composition (b1.), comprising systemic fungicide(s) (A) as component (2) selected from the group of, QiI fungicide; strobilurin fungicide; SDHI fungicide; azole fungicide; morpholine fungicide and any and all mixtures of two or more thereof, or
ii. composition (b2.), comprising systemic fungicide(s) (A) as component (2) selected from the group of, QiI fungicide; strobilurin fungicide; SDHI fungicide;
azole fungicide; morpholine fungicide and any and all mixtures of two or more thereof and component (3) Protectant fungicide(s), compound(s) selected from the group of fluazinam, chlorothalonil; (EBDC); dithiocarbamate; mancozeb, sulfur, folpet; captan; maneb; metiram; polycarbamate; propineb; zineb; and any and all mixtures thereof.

41) The composition (a.) of claim 37 comprising polyphenol-based component (1) and Copper-based compound(s) of component (3), adapted for the use for combining with one or more compositions (b.) selected from the group of,
i. composition (b1.), comprising systemic fungicide(s) (A) as component (2) selected from the group of, QiI fungicide; strobilurin fungicide; SDHI fungicide; azole fungicide; morpholine fungicide and any and all mixtures of two or more thereof, or
ii. composition (b2.), comprising systemic fungicide(s) (A) as component (2) selected from the group of, QiI fungicide; strobilurin fungicide; SDHI fungicide; azole fungicide; morpholine fungicide and any and all mixtures of two or more thereof and component (3) Protectant fungicide(s), compound(s) selected from the group of fluazinam, chlorothalonil; (EBDC); dithiocarbamate; mancozeb, sulfur, folpet; captan; maneb; metiram; polycarbamate; propineb; zineb; and any and all mixtures thereof.

42) The composition (a.) of any one of claim 40 or 41 wherein said adaptation comprises one or more of,
I. Providing instructions for combining composition (a.) with one or more compositions (b.), preferably packaged with composition (a.) exemplified by a package insert or as labeling or as marketing recommendations for use of the composition (a.);
II. Providing composition (a.) comprising amounts of Copper-based compound(s), as component (3) which are reduced below the fungicidal effective amount of the Copper-based compound(s) comprising component (3) when mixed with the composition (b.) comprising systemic fungicide(s) (A) as component (2) and Protectant fungicide(s) compound(s) as component (3), in the absence of polyphenol-based component (1);
III. Providing a kit of parts comprising composition (a.) together with one or more compositions (b.)
IV. any combination of adaptations I-III, or
V. any packaging or composition adaptation with similar effect in the use for combining composition (a.) with one or more compositions (b.).

43) The multi-component combination as claimed in any one of claims 1-38, wherein the combination or composition containing the combination, is fungicidally or bactericidally effective, exemplified in any of curative application, curative treatment, possessing curative activity, protectant application, preventative treatment, having preventative activity and any and all combinations thereof.

44) A method of increasing the fungicidal performance of a composition comprising a combination of picoxystrobin and Tebuconazole, said method comprising adding at least one polyphenol-based compound and at least one copper-based compound to the composition comprising a combination of picoxystrobin and Tebuconazole.

45) A method of reducing the phytotoxicity associated with fungicidal treatment with a composition comprising a combination of picoxystrobin and Tebuconazole, said method comprising adding at least one polyphenol-based compound and at least one copper-based compound to the composition comprising a combination of picoxystrobin and Tebuconazole.

46) A method of increasing the yield from plants associated with fungicidal treatment with a composition comprising a combination of picoxystrobin and Tebuconazole, said method comprising adding at least one polyphenol-based compound and at least one copper-based compound to the composition comprising a combination of picoxystrobin and Tebuconazole.

47) The method of any one of claims 32 and 44-46 wherein the at least one polyphenol-based compound is selected from the group comprising Castalagin; extracts of water-soluble tannins; extracts of water-soluble Proanthocyanidins; and combinations thereof, either alone or with other naturally sourced polyphenol compounds.

48) The method of any one of claims 32 and 44-47 wherein a composition comprising the combination for use in the method, comprises an adjuvant.

49) The method of claim 48 wherein the adjuvant comprises methyl soyate.

50) A multi-component combination comprising,
(1) an amount of polyphenol-based component,
(2) an amount of at least one fungicide (A) selected from the group of,
QiI fungicide;
strobilurin fungicide (QoI);
SDHI fungicide;
azole fungicide (DMI);
morpholine fungicide, and
(3) at least one compound selected from the group of,
fluazinam;
chlorothalonil;
mancozeb;
sulphur,
folpet;
captan; and
copper-based compounds,
wherein the amount of polyphenol-based component (1) and the amount of the fungicide (A) of component (2), if applied together is more effective for treating and/or protecting plants or soil against fungal and/or bacterial infection than if each component at the same amount is applied alone,

51) The multi-component combination of claim 50 wherein the amount of component (3) compound in the combination, is reduced as compared to fungicidally effective combinations absent the polyphenol-based component, comprising the same amount of the same component (2) combined with the same component (3) compound, wherein the multi-component combination is characterized by equivalent or superior fungicidal activity with reduced incidence of phytotoxicity.

52) A multi-component combination comprising at least three components,
(1) polyphenol-based component,
(2) strobilurin and/or triazole (DMI) systemic fungicide component, and
(3) ethylene bisdithiocarbamate (EBDC), fungicide component,
wherein the EBDC fungicide content is reduced by 25% or more compared with the fungicidally effective amount of the EBDC fungicide when applied together with the same systemic fungicide absent the polyphenol-based component without loss of activity or reduction in efficacy.

53) The multi-component combination as claimed in claim 52 comprising
(1) polyphenol-based component,
(2) strobilurin and/or triazole systemic fungicide component,
(3) ethylene bisdithiocarbamate (EBDC), fungicide component, and 50 g/ha or less of copper-based compound,
wherein the combination is characterized by enhanced fungicidal efficacy as compared to a combination of the same polyphenol-based compound of component (1) the same systemic fungicide of component (2) and the same EBDC fungicide of component (3) absent the copper-based compound.

54) The multi-component combination of any one of claims 1-8, wherein the polyphenol-based component, is one or more of, phenolic acids; stilbenes; lignans; hydrolyzable tannins; tannic acid; lignins; flavonoids; flavones, aurones, anthocyanins, leucoanthocyanidins; flavonols; flavanols; flavanones; chalcones; isoflavonoids; proanthocyanidins, and extracts which comprise at least one structure/source of polyphenols such as extracts of water-soluble tannins and proanthocyanidins.

55) The multi-component combination of any one of claims 1-8, comprising
(1) polyphenol-based component,
(2) systemic fungicide component,
(3) protectant fungicide and copper-based compound,
wherein the protectant fungicide is selected from the group of fluazinam; chlorothalonil; mancozeb; sulfur; folpet; captan and combinations thereof.

56) The multi-component combination of any one of claims 1-8, comprising,
(1) polyphenol-based component,
(2) systemic fungicide component,
(3) copper-based compound,
wherein the copper-based compound is one or more of cupric acetate; cupric chloride; cupric chlorate; cupric formate; cupric hexafluorosilicate; cupric nitrate; cupric chromate; copper sulfate pentahydrate; bordeaux mixture; copper hydroxide; copper oxychloride sulfate (COCS); tribasic copper sulfate such as cupric sulfate; tricupric hydroxide hemihydrate; chelated (or complexed) copper with EDTA; Copper chelated or complexed with amino acids; copper chelated and/or complexed with both EDTA and amino acid; copper glycinate; copper alaninate; and any and all combinations thereof.

57) The multi-component combination as claimed in any one of claims 1-8 wherein the copper-based compound is one or more of copper complex, and/or chelated copper compound.

58) A method of enhancing the fungicidal effect of systemic fungicides (A) comprising combining said fungicides with polyphenolic compounds and less than 50 g/ha copper-based compound, wherein said systemic fungicide is selected from the group of QiI fungicide; strobilurin fungicide; SDHI fungicide; azole fungicide; morpholine fungicide and any and all mixtures of two or more thereof, characterized in that the copper-based compound is not a fungicidally effective amount and said combination has minimal or no phytotoxic effects.

59) The multi-component combination of any one of claims 1-8, wherein the combination comprises a combination independently selected from the group of,
polyphenol-based component and QiI fungicide;
polyphenol-based component and azole fungicide;
polyphenol-based component and morpholine fungicide;
polyphenol-based component and SDHI fungicide;
polyphenol-based component and strobilurin fungicide;
polyphenol-based component, QiI fungicide and azole fungicide;
polyphenol-based component, morpholine fungicide and SDHI fungicide;
polyphenol-based component, morpholine fungicide and strobilurin fungicide;
polyphenol-based component, morpholine fungicide and azole fungicide;
polyphenol-based component, SDHI fungicide and strobilurin fungicide;
polyphenol-based component, morpholine fungicide and strobilurin fungicide;
polyphenol-based component, QiI fungicide, azole fungicide and protectant fungicide;
polyphenol-based component, morpholine fungicide, SDHI and protectant fungicide;
polyphenol-based component, morpholine fungicide, strobilurin fungicide and protectant fungicide;
polyphenol-based component, morpholine fungicide, azole fungicide and protectant fungicide;
polyphenol-based component, SDHI fungicide, strobilurin fungicide and protectant fungicide;
polyphenol-based component, morpholine fungicide, strobilurin fungicide and protectant fungicide;
polyphenol-based component, QiI fungicide and protectant fungicide;
polyphenol-based component, azole fungicide and protectant fungicide;
polyphenol-based component, morpholine fungicide and protectant fungicide;
polyphenol-based component, SDHI fungicide and protectant fungicide;
polyphenol-based component, strobilurin fungicide and protectant fungicide;
polyphenol-based component, copper-based compound, and QiI fungicide;
polyphenol-based component, copper-based compound, and azole fungicide;
polyphenol-based component, copper-based compound, and morpholine fungicide
polyphenol-based component, copper-based compound, and SDHI fungicide;
polyphenol-based component, copper-based compound, and strobilurin fungicide;
polyphenol-based component, copper-based compound, QiI fungicide and azole fungicide;
polyphenol-based component, copper-based compound, morpholine fungicide, and SDHI fungicide;
polyphenol-based component, copper-based compound, morpholine fungicide and strobilurin fungicide;
polyphenol-based component, copper-based compound, morpholine fungicide and azole fungicide;
polyphenol-based component, copper-based compound, SDHI fungicide and strobilurin fungicide;
polyphenol-based component, copper-based compound, morpholine fungicide and strobilurin fungicide;
polyphenol-based component, copper-based compound, QiI fungicide, azole fungicide and protectant fungicide;
polyphenol-based component, copper-based compound, morpholine fungicide, SDHI and protectant fungicide;
polyphenol-based component, copper-based compound, morpholine fungicide, strobilurin fungicide and protectant fungicide;
polyphenol-based component, copper-based compound, morpholine fungicide, azole fungicide and protectant fungicide;
polyphenol-based component, copper-based compound, SDHI fungicide, strobilurin fungicide and protectant fungicide;
polyphenol-based component, copper-based compound, morpholine fungicide, strobilurin fungicide and protectant fungicide;
polyphenol-based component, copper-based compound, QiI fungicide and protectant fungicide;
polyphenol-based component, copper-based compound, an azole fungicide, and protectant fungicide;
polyphenol-based component, copper-based compound, morpholine fungicide and protectant fungicide;
polyphenol-based component, copper-based compound, SDHI fungicide and protectant fungicide; and
polyphenol-based component, copper-based compound, strobilurin fungicide and protectant fungicide,
wherein, said azole fungicide is selected from one or more of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole, mefentrifluconazole,
wherein, said strobilurin fungicide is selected from one or more of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, metyltetraprole, and fluoxastrobin,
wherein, said SDHI fungicide is selected from one or more of penthiopyrad, boscalid, flutolanil, fluxapyroxad, inpyrfluxam, fluopyram, fluindapyr, benzovindiflupyr, bixafen, pydiflumetofen,
wherein, said QiI fungicide is selected from one or more of cyazofamid, amisulbrom, fenpicoxamid,
wherein, said morpholine fungicide is selected from one or more of aldimorph, benzamorf, carbamorph, dimethomorph, fenpropimorph, flumorph, tridemorph, trimorphamide, dodemorph, spiroxamine, piperalin, fenpropidin, and wherein, said protectant fungicide is selected from one or more of mancozeb, sulfur, folpet, captan, captafol, fluazinam, chlorothalonil, dithiocarbamate, zineb, propineb, and maneb.

60) The multi-component combination of any one of claims 1-8, wherein the combination is independently selected from the group of,
polyphenol-based component, picoxystrobin, tebuconazole and Bordeaux mixture;
polyphenol-based component, picoxystrobin, tebuconazole and fluazinam;
polyphenol-based component, picoxystrobin, Tebuconazole and Folpet;
polyphenol-based component, picoxystrobin, Tebuconazole and Sulphur;
polyphenol-based component, picoxystrobin, Prothioconazole and Mancozeb;
polyphenol-based component, picoxystrobin, Prothioconazole and Copper Oxychloride;
polyphenol-based component, picoxystrobin, Prothioconazole and Copper Hydroxide;
polyphenol-based component, picoxystrobin, Prothioconazole and Bordeaux mixture;
polyphenol-based component, picoxystrobin, Prothioconazole and Fluazinam;
polyphenol-based component, picoxystrobin, Prothioconazole and Captan;
polyphenol-based component, picoxystrobin, Prothioconazole and Folpet;
polyphenol-based component, picoxystrobin, Prothioconazole and Sulphur;
polyphenol-based component, fluxapyroxad, Tebuconazole and Mancozeb;
polyphenol-based component, fluxapyroxad, Tebuconazole and Copper Oxychloride;
polyphenol-based component, fluxapyroxad, Tebuconazole and Copper Hydroxide;
polyphenol-based component, fluxapyroxad, Tebuconazole and Bordeaux mixture;
polyphenol-based component, fluxapyroxad, Tebuconazole and Fluazinam;
polyphenol-based component, fluxapyroxad, Tebuconazole and Chlorothalonil;
polyphenol-based component, fluxapyroxad, Tebuconazole and Captan;
polyphenol-based component, fluxapyroxad, Tebuconazole and Folpet;
polyphenol-based component, fluxapyroxad, Tebuconazole and Sulphur;
polyphenol-based component, fluxapyroxad, Prothioconazole and Mancozeb;
polyphenol-based component, fluxapyroxad, Prothioconazole and Copper Oxychloride;
polyphenol-based component, fluxapyroxad, Prothioconazole and Copper Hydroxide;
polyphenol-based component, fluxapyroxad, Prothioconazole and Bordeaux mixture;
polyphenol-based component, fluxapyroxad, Prothioconazole and Fluazinam;
polyphenol-based component, fluxapyroxad, Prothioconazole and Chlorothalonil;
polyphenol-based component, fluxapyroxad, Prothioconazole and Captan;
polyphenol-based component, fluxapyroxad, Prothioconazole and Folpet;
polyphenol-based component, Fluxapyroxad, Prothioconazole and Sulphur;
polyphenol-based component, picoxystrobin, Fenpropidin and Mancozeb;
polyphenol-based component, picoxystrobin, Fenpropidin and Copper Oxychloride;
polyphenol-based component, picoxystrobin, Fenpropidin and Copper Hydroxide;
polyphenol-based component, picoxystrobin, Fenpropidin and Bordeaux Mixture;
polyphenol-based component, picoxystrobin, Fenpropidin and Fluazinam;
polyphenol-based component, picoxystrobin, Fenpropidin and Chlorothalonil;
polyphenol-based component, picoxystrobin, Fenpropidin and Captan;
polyphenol-based component, picoxystrobin, Fenpropidin and Folpet;
polyphenol-based component, picoxystrobin, Fenpropidin and Sulphur;
polyphenol-based component, Fluxapyroxad, Fenpropidin and Mancozeb;
polyphenol-based component, Fluxapyroxad, Fenpropidin and Copper Oxychloride;
polyphenol-based component, Fluxapyroxad, Fenpropidin and Copper Hydroxide;
polyphenol-based component, Fluxapyroxad, Fenpropidin and Bordeaux mixture;
polyphenol-based component, Fluxapyroxad, Fenpropidin and Fluazinam;
polyphenol-based component, fenpropidin, Fluxapyroxad and Chlorothalonil;
polyphenol-based component, Fluxapyroxad, Fenpropidin and Captan;
polyphenol-based component, Fluxapyroxad Fenpropidin and Folpet;
polyphenol-based component, Fluxapyroxad, Fenpropidin and Sulphur;
polyphenol-based component, Prothioconazole, Fenpropidin and Mancozeb;
polyphenol-based component, Prothioconazole, Fenpropidin and Copper Oxychloride;
polyphenol-based component, Prothioconazole, Fenpropidin and Copper Hydroxide;
polyphenol-based component, Prothioconazole, Fenpropidin and Bordeaux mixture;
polyphenol-based component, Prothioconazole, Fenpropidin and Fluazinam;
polyphenol-based component, Prothioconazole, Fenpropidin and Chlorothalonil;
polyphenol-based component, Prothioconazole, Fenpropidin and Captan;
polyphenol-based component, Prothioconazole, Fenpropidin and Folpet;
polyphenol-based component, Prothioconazole, Fenpropidin and Sulphur;
polyphenol-based component, Tebuconazole, Fenpropidin and Mancozeb;
polyphenol-based component, Tebuconazole, Fenpropidin and Copper Oxychloride;
polyphenol-based component, Tebuconazole, Fenpropidin and Copper Hydroxide;
polyphenol-based component, Tebuconazole, Fenpropidin and Bordeaux mixture;
polyphenol-based component, Tebuconazole, Fenpropidin and Fluazinam;
polyphenol-based component, Tebuconazole, Fenpropidin and Chlorothalonil;
polyphenol-based component, Tebuconazole, Fenpropidin and Captan;
polyphenol-based component, Tebuconazole, Fenpropidin and Folpet;
polyphenol-based component, Tebuconazole, Fenpropidin and Sulphur;
polyphenol-based component, Azoxystrobin, Difenoconazole and Chlorothalonil;
polyphenol-based component, cyproconazole, mancozeb and metyltetraprole;
polyphenol-based component, cyproconazole, mancozeb and metyltetraprole;
polyphenol-based component, mancozeb, Cyproconazole and metyltetraprole;
polyphenol-based component, mancozeb, Cyproconazole and picoxystrobin;
polyphenol-based component, mancozeb, Cyproconazole and Fluxapyroxad;
polyphenol-based component, mancozeb, Cyproconazole and Azoxystrobin;
polyphenol-based component, mancozeb, Cyproconazole and Trifloxystrobin;
polyphenol-based component, mancozeb, Cyproconazole and Pyraclostrobin;
polyphenol-based component, mancozeb, Cyproconazole and metominostrobin;
polyphenol-based component, mancozeb, Cyproconazole and Bixafen;
polyphenol-based component, mancozeb, Cyproconazole and Inpyrfluxam;
polyphenol-based component, mancozeb, Cyproconazole and Fluindapyr;
polyphenol-based component, mancozeb, Cyproconazole and benzovindiflupyr;
polyphenol-based component, mancozeb, Cyproconazole and pydiflumetofen;
polyphenol-based component, mancozeb, difenoconazole and metyltetraprole;
polyphenol-based component, mancozeb, difenoconazole and picoxystrobin;
polyphenol-based component, mancozeb, difenoconazole and Fluxapyroxad;
polyphenol-based component, mancozeb, difenoconazole and Azoxystrobin;
polyphenol-based component, mancozeb, difenoconazole and trifloxystrobin;
polyphenol-based component, mancozeb, difenoconazole and pyraclostrobin;
polyphenol-based component, mancozeb, difenoconazole and metominostrobin;
polyphenol-based component, mancozeb, difenoconazole and Bixafen;
polyphenol-based component, mancozeb, difenoconazole and inpyrfluxam;
polyphenol-based component, mancozeb, difenoconazole and fluindapyr;
polyphenol-based component, mancozeb, difenoconazole and benzovindiflupyr;
polyphenol-based component, mancozeb, difenoconazole and pydiflumetofen;
polyphenol-based component, mancozeb, difenoconazole and fenpicoxamid;
polyphenol-based component, mancozeb, mefentrifluconazole and metyltetraprole;
polyphenol-based component, mancozeb, mefentrifluconazole and picoxystrobin;
polyphenol-based component, mancozeb, mefentrifluconazole and fluxapyroxad;
polyphenol-based component, mancozeb, mefentrifluconazole and Azoxystrobin;
polyphenol-based component, mancozeb, mefentrifluconazole and Trifloxystrobin;
polyphenol-based component, mancozeb, mefentrifluconazole and Pyraclostrobin;
polyphenol-based component, mancozeb, mefentrifluconazole and metominostrobin;
polyphenol-based component, mancozeb, mefentrifluconazole and Bixafen;
polyphenol-based component, mancozeb, mefentrifluconazole and Inpyrfluxam;
polyphenol-based component, mancozeb, mefentrifluconazole and Fluindapyr;
polyphenol-based component, mancozeb, mefentrifluconazole and benzovindiflupyr;
polyphenol-based component, mancozeb, mefentrifluconazole and pydiflumetofen;
polyphenol-based component, mancozeb, mefentrifluconazole and fenpicoxamid;
polyphenol-based component, mancozeb, difenoconazole and fenpicoxamid;
polyphenol-based component, mancozeb, mefentrifluconazole and metyltetraprole;
polyphenol-based component, mancozeb, mefentrifluconazole and picoxystrobin;
polyphenol-based component, mancozeb, mefentrifluconazole and Fluxapyroxad;
polyphenol-based component, mancozeb, mefentrifluconazole and Azoxystrobin;
polyphenol-based component, mancozeb, mefentrifluconazole and Trifloxystrobin;
polyphenol-based component, mancozeb, mefentrifluconazole and Pyraclostrobin;
polyphenol-based component, mancozeb, mefentrifluconazole and metominostrobin;
polyphenol-based component, mancozeb, mefentrifluconazole and Bixafen;
polyphenol-based component, mancozeb, mefentrifluconazole and Inpyrfluxam polyphenol-based component, mancozeb, mefentrifluconazole and Fluindapyr;
polyphenol-based component, mancozeb, mefentrifluconazole and benzovindiflupyr;
polyphenol-based component, mancozeb, mefentrifluconazole and pydiflumetofen;
polyphenol-based component, mancozeb, mefentrifluconazole and fenpicoxamid;
polyphenol-based component, mancozeb, prothioconazole and fenpicoxamid;
polyphenol-based component, mancozeb, prothioconazole and metyltetraprole;
polyphenol-based component, mancozeb, prothioconazole and picoxystrobin;
polyphenol-based component, mancozeb, prothioconazole and Fluxapyroxad;
polyphenol-based component, mancozeb, prothioconazole and Azoxystrobin;
polyphenol-based component, mancozeb, prothioconazole and Trifloxystrobin;
polyphenol-based component, mancozeb, prothioconazole and Pyraclostrobin;
polyphenol-based component, mancozeb, prothioconazole and metominostrobin;
polyphenol-based component, mancozeb, prothioconazole and Bixafen;
polyphenol-based component, mancozeb, prothioconazole and Inpyrfluxam;
polyphenol-based component, mancozeb, prothioconazole and Fluindapyr;
polyphenol-based component, mancozeb, prothioconazole and benzovindiflupyr;
polyphenol-based component, mancozeb, prothioconazole and pydiflumetofen;
polyphenol-based component, mancozeb, prothioconazole and fenpicoxamid;
polyphenol-based component, mancozeb, tebuconazole and fenpicoxamid;
polyphenol-based component, mancozeb, prothioconazole and metyltetraprole;
polyphenol-based component, mancozeb, tebuconazole and Fluxapyroxad;
polyphenol-based component, mancozeb, prothioconazole and Fluxapyroxad;
polyphenol-based component, mancozeb, tebuconazole and Azoxystrobin;
polyphenol-based component, mancozeb, tebuconazole and Trifloxystrobin;
polyphenol-based component, mancozeb, tebuconazole and Pyraclostrobin;
polyphenol-based component, mancozeb, tebuconazole and metominostrobin;
polyphenol-based component, mancozeb, tebuconazole and Bixafen;
polyphenol-based component, mancozeb, tebuconazole and Inpyrfluxam;
polyphenol-based component, mancozeb, tebuconazole and Fluindapyr;
polyphenol-based component, mancozeb, tebuconazole and benzovindiflupyr;
polyphenol-based component, mancozeb, prothioconazole and pydiflumetofen;
polyphenol-based component, mancozeb, prothioconazole and fenpicoxamid;
polyphenol-based component, mancozeb, tebuconazole and Mandestrobin;
polyphenol-based component, mancozeb, tebuconazole and metyltetraprole polyphenol-based component, mancozeb, tebuconazole and pydiflumetofen;
polyphenol-based component, cyproconazole, copper-based compound and metyltetraprole;
polyphenol-based component, cyproconazole, copper-based compound and metyltetraprole;
polyphenol-based component, copper-based fungicide, Cyproconazole and metyltetraprole;
polyphenol-based component, copper-based fungicide, Cyproconazole and picoxystrobin;
polyphenol-based component, copper-based fungicide, Cyproconazole and Fluxapyroxad;
polyphenol-based component, copper-based fungicide, Cyproconazole and Azoxystrobin;
polyphenol-based component, copper-based fungicide, Cyproconazole and Trifloxystrobin;
polyphenol-based component, copper-based fungicide, Cyproconazole and Pyraclostrobin;
polyphenol-based component, copper-based fungicide, Cyproconazole and metominostrobin;
polyphenol-based component, copper-based fungicide, Cyproconazole and Bixafen;
polyphenol-based component, copper-based fungicide, Cyproconazole and Inpyrfluxam;
polyphenol-based component, copper-based fungicide, Cyproconazole and Fluindapyr;
polyphenol-based component, copper-based fungicide, Cyproconazole and benzovindiflupyr polyphenol-based component, copper-based fungicide, Cyproconazole and pydiflumetofen;
polyphenol-based component, copper-based fungicide, difenoconazole and metyltetraprole;
polyphenol-based component, copper-based fungicide, difenoconazole and picoxystrobin;
polyphenol-based component, copper-based fungicide, difenoconazole and Fluxapyroxad;
polyphenol-based component, copper-based fungicide, difenoconazole and Azoxystrobin;
polyphenol-based component, copper-based fungicide, difenoconazole and trifloxystrobin;
polyphenol-based component, copper-based fungicide, difenoconazole and pyraclostrobin;
polyphenol-based component, copper-based fungicide, difenoconazole and metominostrobin;
polyphenol-based component, copper-based fungicide, difenoconazole and Bixafen;
polyphenol-based component, copper-based fungicide, difenoconazole and inpyrfluxam;
polyphenol-based component, copper-based fungicide, difenoconazole and fluindapyr;
polyphenol-based component, copper-based fungicide, difenoconazole and benzovindiflupyr;
polyphenol-based component, copper-based fungicide, difenoconazole and pydiflumetofen;
polyphenol-based component, copper-based fungicide, difenoconazole and fenpicoxamid;
polyphenol-based component, copper-based fungicide, mefentrifluconazole and metyltetraprole;
polyphenol-based component, copper-based fungicide, mefentrifluconazole and picoxystrobin;
polyphenol-based component, copper-based fungicide, mefentrifluconazole and fluxapyroxad;
polyphenol-based component, copper-based fungicide, mefentrifluconazole and Azoxystrobin;
polyphenol-based component, copper-based fungicide, mefentrifluconazole and Trifloxystrobin;
polyphenol-based component, copper-based fungicide, mefentrifluconazole and Pyraclostrobin;
polyphenol-based component, copper-based fungicide, mefentrifluconazole and metominostrobin;
polyphenol-based component, copper-based fungicide, mefentrifluconazole and Bixafen;
polyphenol-based component, copper-based fungicide, mefentrifluconazole and Inpyrfluxam;
polyphenol-based component, copper-based fungicide, mefentrifluconazole and Fluindapyr;
polyphenol-based component, copper-based fungicide, mefentrifluconazole and benzovindiflupyr;
polyphenol-based component, copper-based fungicide, mefentrifluconazole and pydiflumetofen;
polyphenol-based component, copper-based fungicide, mefentrifluconazole and fenpicoxamid;
polyphenol-based component, copper-based fungicide, difenoconazole and fenpicoxamid;
polyphenol-based component, copper-based fungicide, mefentrifluconazole and metyltetraprole;
polyphenol-based component, copper-based fungicide, mefentrifluconazole and picoxystrobin;
polyphenol-based component, copper-based fungicide, mefentrifluconazole and Fluxapyroxad;
polyphenol-based component, copper-based fungicide, mefentrifluconazole and Azoxystrobin;
polyphenol-based component, copper-based fungicide, mefentrifluconazole and Trifloxystrobin;
polyphenol-based component, copper-based fungicide, mefentrifluconazole and Pyraclostrobin;
ispolyphenol-based component, copper-based fungicide, mefentrifluconazole and metominostrobin;
polyphenol-based component, copper-based fungicide, mefentrifluconazole and Bixafen;
polyphenol-based component, copper-based fungicide, mefentrifluconazole and Inpyrfluxam;
polyphenol-based component, copper-based fungicide, mefentrifluconazole and Fluindapyr;
polyphenol-based component, copper-based fungicide, mefentrifluconazole and benzovindiflupyr;
polyphenol-based component, copper-based fungicide, mefentrifluconazole and pydiflumetofen;
polyphenol-based component, copper-based fungicide, mefentrifluconazole and fenpicoxamid;
polyphenol-based component, copper-based fungicide, prothioconazole and fenpicoxamid;
polyphenol-based component, copper-based fungicide, prothioconazole and metyltetraprole;
polyphenol-based component, copper-based fungicide, prothioconazole and picoxystrobin;
polyphenol-based component, copper-based fungicide, prothioconazole and Fluxapyroxad;
polyphenol-based component, copper-based fungicide, prothioconazole and Azoxystrobin;
polyphenol-based component, copper-based fungicide, prothioconazole and Trifloxystrobin;
polyphenol-based component, copper-based fungicide, prothioconazole and Pyraclostrobin;
polyphenol-based component, copper-based fungicide, prothioconazole and metominostrobin;
polyphenol-based component, copper-based fungicide, prothioconazole and Bixafen;
polyphenol-based component, copper-based fungicide, prothioconazole and Inpyrfluxam;
polyphenol-based component, copper-based fungicide, prothioconazole and Fluindapyr;
polyphenol-based component, copper-based fungicide, prothioconazole and Benzodiflupyr (benzovindiflupyr);
polyphenol-based component, copper-based fungicide, prothioconazole and pydiflumetofen;
polyphenol-based component, copper-based fungicide, prothioconazole and fenpicoxamid;
polyphenol-based component, copper-based fungicide, tebuconazole and picoxystrobin;
polyphenol-based component, copper-based fungicide, tebuconazole and fenpicoxamid;
polyphenol-based component, copper-based fungicide, prothioconazole and metyltetraprole;
polyphenol-based component, copper-based fungicide, tebuconazole and picoxystrobin;
polyphenol-based component, copper-based fungicide, tebuconazole and Fluxapyroxad;
polyphenol-based component, copper-based fungicide, prothioconazole and Fluxapyroxad;
polyphenol-based component, copper-based fungicide, tebuconazole and Azoxystrobin;
polyphenol-based component, copper-based fungicide, tebuconazole and Trifloxystrobin;
polyphenol-based component, copper-based fungicide, tebuconazole and Pyraclostrobin;
polyphenol-based component, copper-based fungicide, tebuconazole and metominostrobin;
polyphenol-based component, copper-based fungicide, tebuconazole and Bixafen;
polyphenol-based component, copper-based fungicide, tebuconazole and Inpyrfluxam;
polyphenol-based component, copper-based fungicide, tebuconazole and Fluindapyr;
polyphenol-based component, copper-based fungicide, tebuconazole and benzovindiflupyr;
polyphenol-based component, copper-based fungicide, prothioconazole and pydiflumetofen;
polyphenol-based component, copper-based fungicide, prothioconazole and fenpicoxamid;
polyphenol-based component, copper-based fungicide, tebuconazole and Mandestrobin;
polyphenol-based component, copper-based fungicide, tebuconazole and metyltetraprole; and
polyphenol-based component, copper-based fungicide, tebuconazole and pydiflumetofen,
wherein the polyphenol-based component comprises combined extracts of natural water-soluble Tannins and/or Proanthocyanidins or derivatives thereof.

61) The multi-component combination of any one of claims 1-8, wherein the combination is one or more selected from combinations 1 to 1792 as defined in Table 1 wherein in each selected combination the polyphenol-based component (1) is one or more of, phenolic acids; stilbenes; lignans; hydrolyzable tannins; tannic acid; lignins; flavonoids; castalagin; extracts of water-soluble tannins; extracts of water-soluble proanthocyanidins; combined extracts of natural water-soluble tannins and/or proanthocyanidins, derivatives of extracts of natural water-soluble tannins and/or proanthocyanidins.
TABLE 1

| | Component (1) | Component (3) | | COMPONENT (2) Fungicide (A) | | | |
|---|---|---|---|---|---|---|---|
| | Polyphenol | Copper | Protectant | Azole | Strobilurin | SDHI | Morpholine |
| 1 | Polyphenol | Copper | Fluazinam | | azoxystrobin | Adepidyn | Fenpropidin |
| 2 | Polyphenol | Copper | Fluazinam | | azoxystrobin | benzovindiflupyr | Fenpropidin |
| 3 | Polyphenol | Copper | Fluazinam | | azoxystrobin | bixafen | Fenpropidin |
| 4 | Polyphenol | Copper | Fluazinam | | azoxystrobin | Fluindapyr | Fenpropidin |
| 5 | Polyphenol | Copper | Fluazinam | | azoxystrobin | fluxapyroxad | Fenpropidin |
| 6 | Polyphenol | Copper | Fluazinam | | azoxystrobin | Inpyrfluxam | Fenpropidin |
| 7 | Polyphenol | Copper | Fluazinam | | azoxystrobin | Adepidyn | Fenpropimorph |
| 8 | Polyphenol | Copper | Fluazinam | | azoxystrobin | benzovindiflupyr | Fenpropimorph |
| 9 | Polyphenol | Copper | Fluazinam | | azoxystrobin | bixafen | Fenpropimorph |
| 10 | Polyphenol | Copper | Fluazinam | | azoxystrobin | Fluindapyr | Fenpropimorph |
| 11 | Polyphenol | Copper | Fluazinam | | azoxystrobin | fluxapyroxad | Fenpropimorph |
| 12 | Polyphenol | Copper | Fluazinam | | azoxystrobin | Inpyrfluxam | Fenpropimorph |
| 13 | Polyphenol | Copper | Fluazinam | | azoxystrobin | Adepidyn | |
| 14 | Polyphenol | Copper | Fluazinam | | azoxystrobin | benzovindiflupyr | |
| 15 | Polyphenol | Copper | Fluazinam | | azoxystrobin | bixafen | |
| 16 | Polyphenol | Copper | Fluazinam | | azoxystrobin | Fluindapyr | |
| 17 | Polyphenol | Copper | Fluazinam | | azoxystrobin | fluxapyroxad | |
| 18 | Polyphenol | Copper | Fluazinam | | azoxystrobin | Inpyrfluxam | |
| 19 | Polyphenol | Copper | Fluazinam | cyproconazole | azoxystrobin | | |
| 20 | Polyphenol | Copper | Fluazinam | difenoconazole | azoxystrobin | | |
| 21 | Polyphenol | Copper | Fluazinam | flutriafol | azoxystrobin | | |
| 22 | Polyphenol | Copper | Fluazinam | mefentrifluconazole | azoxystrobin | | |
| 23 | Polyphenol | Copper | Fluazinam | prothioconazole | azoxystrobin | | |
| 24 | Polyphenol | Copper | Fluazinam | tebuconazole | azoxystrobin | | |
| 25 | Polyphenol | Copper | Fluazinam | tetraconazole | azoxystrobin | | |
| 26 | Polyphenol | Copper | Fluazinam | | Mandestrobin | Adepidyn | fenpropidin |
| 27 | Polyphenol | Copper | Fluazinam | | Mandestrobin | benzovindiflupyr | fenpropidin |
| 28 | Polyphenol | Copper | Fluazinam | | Mandestrobin | bixafen | fenpropidin |
| 29 | Polyphenol | Copper | Fluazinam | | Mandestrobin | Fluindapyr | fenpropidin |
| 30 | Polyphenol | Copper | Fluazinam | | Mandestrobin | fluxapyroxad | fenpropidin |
| 31 | Polyphenol | Copper | Fluazinam | | Mandestrobin | Inpyrfluxam | fenpropidin |
| 32 | Polyphenol | Copper | Fluazinam | | Mandestrobin | Adepidyn | Fenpropimorph |
| 33 | Polyphenol | Copper | Fluazinam | | Mandestrobin | benzovindiflupyr | Fenpropimorph |
| 34 | Polyphenol | Copper | Fluazinam | | Mandestrobin | bixafen | Fenpropimorph |
| 35 | Polyphenol | Copper | Fluazinam | | Mandestrobin | Fluindapyr | Fenpropimorph |
| 36 | Polyphenol | Copper | Fluazinam | | Mandestrobin | fluxapyroxad | Fenpropimorph |
| 37 | Polyphenol | Copper | Fluazinam | | Mandestrobin | Inpyrfluxam | Fenpropimorph |
| 38 | Polyphenol | Copper | Fluazinam | | Mandestrobin | | Fenpropimorph |
| 39 | Polyphenol | Copper | Fluazinam | | Mandestrobin | | Fenpropidin |
| 40 | Polyphenol | Copper | Fluazinam | | Mandestrobin | Adepidyn | |
| 41 | Polyphenol | Copper | Fluazinam | | Mandestrobin | benzovindiflupyr | |
| 42 | Polyphenol | Copper | Fluazinam | | Mandestrobin | bixafen | |
| 43 | Polyphenol | Copper | Fluazinam | | Mandestrobin | Fluindapyr | |
| 44 | Polyphenol | Copper | Fluazinam | | Mandestrobin | fluxapyroxad | |
| 45 | Polyphenol | Copper | Fluazinam | | Mandestrobin | Inpyrfluxam | |
| 46 | Polyphenol | Copper | Fluazinam | cyproconazole | Mandestrobin | | |
| 47 | Polyphenol | Copper | Fluazinam | difenoconazole | Mandestrobin | | |
| 48 | Polyphenol | Copper | Fluazinam | flutriafol | Mandestrobin | | |
| 49 | Polyphenol | Copper | Fluazinam | mefentrifluconazole | Mandestrobin | | |
| 50 | Polyphenol | Copper | Fluazinam | prothioconazole | Mandestrobin | | |
| 51 | Polyphenol | Copper | Fluazinam | tebuconazole | Mandestrobin | | |
| 52 | Polyphenol | Copper | Fluazinam | tetraconazole | Mandestrobin | | |
| 53 | Polyphenol | Copper | Fluazinam | | Metyltetraprole | Adepidyn | fenpropidin |
| 54 | Polyphenol | Copper | Fluazinam | | Metyltetraprole | benzovindiflupyr | fenpropidin |
| 55 | Polyphenol | Copper | Fluazinam | | Metyltetraprole | bixafen | fenpropidin |
| 56 | Polyphenol | Copper | Fluazinam | | Metyltetraprole | Fluindapyr | fenpropidin |
| 57 | Polyphenol | Copper | Fluazinam | | Metyltetraprole | fluxapyroxad | fenpropidin |
| 58 | Polyphenol | Copper | Fluazinam | | Metyltetraprole | Inpyrfluxam | fenpropidin |
| 59 | Polyphenol | Copper | Fluazinam | | Metyltetraprole | Adepidyn | Fenpropimorph |
| 60 | Polyphenol | Copper | Fluazinam | | Metyltetraprole | benzovindiflupyr | Fenpropimorph |
| 61 | Polyphenol | Copper | Fluazinam | | Metyltetraprole | bixafen | Fenpropimorph |
| 62 | Polyphenol | Copper | Fluazinam | | Metyltetraprole | Fluindapyr | Fenpropimorph |
| 63 | Polyphenol | Copper | Fluazinam | | Metyltetraprole | fluxapyroxad | Fenpropimorph |
| 64 | Polyphenol | Copper | Fluazinam | | Metyltetraprole | Inpyrfluxam | Fenpropimorph |
| 65 | Polyphenol | Copper | Fluazinam | | Metyltetraprole | | Fenpropimorph |
| 66 | Polyphenol | Copper | Fluazinam | | Metyltetraprole | | Fenpropidin |
| 67 | Polyphenol | Copper | Fluazinam | | Metyltetraprole | Adepidyn | |
| 68 | Polyphenol | Copper | Fluazinam | | Metyltetraprole | benzovindiflupyr | |
| 69 | Polyphenol | Copper | Fluazinam | | Metyltetraprole | bixafen | |
| 70 | Polyphenol | Copper | Fluazinam | | Metyltetraprole | Fluindapyr | |
| 71 | Polyphenol | Copper | Fluazinam | | Metyltetraprole | fluxapyroxad | |
| 72 | Polyphenol | Copper | Fluazinam | | Metyltetraprole | Inpyrfluxam | |
| 73 | Polyphenol | Copper | Fluazinam | cyproconazole | Metyltetraprole | | |
| 74 | Polyphenol | Copper | Fluazinam | difenoconazole | Metyltetraprole | | |
| 75 | Polyphenol | Copper | Fluazinam | flutriafol | Metyltetraprole | | |
| 76 | Polyphenol | Copper | Fluazinam | mefentrifluconazole | Metyltetraprole | | |
| 77 | Polyphenol | Copper | Fluazinam | prothioconazole | Metyltetraprole | | |
| 78 | Polyphenol | Copper | Fluazinam | tebuconazole | Metyltetraprole | | |
| 79 | Polyphenol | Copper | Fluazinam | tetraconazole | Metyltetraprole | | |
| 80 | Polyphenol | Copper | Fluazinam | | metominostrobin | Adepidyn | fenpropidin |
| 81 | Polyphenol | Copper | Fluazinam | | metominostrobin | benzovindiflupyr | fenpropidin |
| 82 | Polyphenol | Copper | Fluazinam | | metominostrobin | Bixafen | fenpropidin |
| 83 | Polyphenol | Copper | Fluazinam | | metominostrobin | Fluindapyr | fenpropidin |
| 84 | Polyphenol | Copper | Fluazinam | | metominostrobin | fluxapyroxad | fenpropidin |
| 85 | Polyphenol | Copper | Fluazinam | | metominostrobin | Inpyrfluxam | fenpropidin |
| 86 | Polyphenol | Copper | Fluazinam | | metominostrobin | Adepidyn | Fenpropimorph |
| 87 | Polyphenol | Copper | Fluazinam | | metominostrobin | benzovindiflupyr | Fenpropimorph |
| 88 | Polyphenol | Copper | Fluazinam | | metominostrobin | Bixafen | Fenpropimorph |
| 89 | Polyphenol | Copper | Fluazinam | | metominostrobin | Fluindapyr | Fenpropimorph |
| 90 | Polyphenol | Copper | Fluazinam | | metominostrobin | fluxapyroxad | Fenpropimorph |
| 91 | Polyphenol | Copper | Fluazinam | | metominostrobin | Inpyrfluxam | Fenpropimorph |
| 92 | Polyphenol | Copper | Fluazinam | | metominostrobin | | Fenpropimorph |
| 93 | Polyphenol | Copper | Fluazinam | | metominostrobin | | Fenpropidin |
| 94 | Polyphenol | Copper | Fluazinam | | metominostrobin | Adepidyn | |
| 95 | Polyphenol | Copper | Fluazinam | | metominostrobin | benzovindiflupyr | |
| 96 | Polyphenol | Copper | Fluazinam | | metominostrobin | bixafen | |
| 97 | Polyphenol | Copper | Fluazinam | | metominostrobin | Fluindapyr | |
| 98 | Polyphenol | Copper | Fluazinam | | metominostrobin | fluxapyroxad | |
| 99 | Polyphenol | Copper | Fluazinam | | metominostrobin | Inpyrfluxam | |
| 100 | Polyphenol | Copper | Fluazinam | cyproconazole | metominostrobin | | |
| 101 | Polyphenol | Copper | Fluazinam | difenoconazole | metominostrobin | | |
| 102 | Polyphenol | Copper | Fluazinam | flutriafol | metominostrobin | | |
| 103 | Polyphenol | Copper | Fluazinam | mefentrifluconazole | metominostrobin | | |
| 104 | Polyphenol | Copper | Fluazinam | prothioconazole | metominostrobin | | |
| 105 | Polyphenol | Copper | Fluazinam | tebuconazole | metominostrobin | | |
| 106 | Polyphenol | Copper | Fluazinam | tetraconazole | metominostrobin | | |
| 107 | Polyphenol | Copper | Fluazinam | | picoxystrobin | Adepidyn | Fenpropidin |
| 108 | Polyphenol | Copper | Fluazinam | | picoxystrobin | benzovindiflupyr | Fenpropidin |
| 109 | Polyphenol | Copper | Fluazinam | | picoxystrobin | bixafen | Fenpropidin |
| 110 | Polyphenol | Copper | Fluazinam | | picoxystrobin | Fluindapyr | Fenpropidin |
| 111 | Polyphenol | Copper | Fluazinam | | picoxystrobin | fluxapyroxad | Fenpropidin |
| 112 | Polyphenol | Copper | Fluazinam | | picoxystrobin | Inpyrfluxam | Fenpropidin |
| 113 | Polyphenol | Copper | Fluazinam | | picoxystrobin | Adepidyn | Fenpropimorph |
| 114 | Polyphenol | Copper | Fluazinam | | picoxystrobin | benzovindiflupyr | Fenpropimorph |
| 115 | Polyphenol | Copper | Fluazinam | | picoxystrobin | bixafen | Fenpropimorph |
| 116 | Polyphenol | Copper | Fluazinam | | picoxystrobin | Fluindapyr | Fenpropimorph |
| 117 | Polyphenol | Copper | Fluazinam | | picoxystrobin | fluxapyroxad | Fenpropimorph |
| 118 | Polyphenol | Copper | Fluazinam | | picoxystrobin | Inpyrfluxam | Fenpropimorph |
| 119 | Polyphenol | Copper | Fluazinam | | picoxystrobin | | Fenpropimorph |
| 120 | Polyphenol | Copper | Fluazinam | | picoxystrobin | | Fenpropidin |
| 121 | Polyphenol | Copper | Fluazinam | | picoxystrobin | Adepidyn | |
| 122 | Polyphenol | Copper | Fluazinam | | picoxystrobin | benzovindiflupyr | |
| 123 | Polyphenol | Copper | Fluazinam | | picoxystrobin | Bixafen | |
| 124 | Polyphenol | Copper | Fluazinam | | picoxystrobin | Fluindapyr | |
| 125 | Polyphenol | Copper | Fluazinam | | picoxystrobin | fluxapyroxad | |
| 126 | Polyphenol | Copper | Fluazinam | | picoxystrobin | Inpyrfluxam | |
| 127 | Polyphenol | Copper | Fluazinam | cyproconazole | picoxystrobin | | |
| 128 | Polyphenol | Copper | Fluazinam | difenoconazole | picoxystrobin | | |
| 129 | Polyphenol | Copper | Fluazinam | flutriafol | picoxystrobin | | |
| 130 | Polyphenol | Copper | Fluazinam | mefentrifluconazole | picoxystrobin | | |
| 131 | Polyphenol | Copper | Fluazinam | prothioconazole | picoxystrobin | | |
| 132 | Polyphenol | Copper | Fluazinam | tebuconazole | picoxystrobin | | |
| 133 | Polyphenol | Copper | Fluazinam | tetraconazole | picoxystrobin | | |
| 134 | Polyphenol | Copper | Fluazinam | | Pyraclostrobin | Adepidyn | fenpropidin |
| 135 | Polyphenol | Copper | Fluazinam | | Pyraclostrobin | benzovindiflupyr | fenpropidin |
| 136 | Polyphenol | Copper | Fluazinam | | Pyraclostrobin | bixafen | fenpropidin |
| 137 | Polyphenol | Copper | Fluazinam | | Pyraclostrobin | Fluindapyr | fenpropidin |
| 138 | Polyphenol | Copper | Fluazinam | | Pyraclostrobin | fluxapyroxad | fenpropidin |
| 139 | Polyphenol | Copper | Fluazinam | | Pyraclostrobin | Inpyrfluxam | fenpropidin |
| 140 | Polyphenol | Copper | Fluazinam | | Pyraclostrobin | Adepidyn | Fenpropimorph |
| 141 | Polyphenol | Copper | Fluazinam | | Pyraclostrobin | benzovindiflupyr | Fenpropimorph |
| 142 | Polyphenol | Copper | Fluazinam | | Pyraclostrobin | bixafen | Fenpropimorph |
| 143 | Polyphenol | Copper | Fluazinam | | Pyraclostrobin | Fluindapyr | Fenpropimorph |
| 144 | Polyphenol | Copper | Fluazinam | | Pyraclostrobin | fluxapyroxad | Fenpropimorph |
| 145 | Polyphenol | Copper | Fluazinam | | Pyraclostrobin | Inpyrfluxam | Fenpropimorph |
| 146 | Polyphenol | Copper | Fluazinam | | Pyraclostrobin | | Fenpropimorph |
| 147 | Polyphenol | Copper | Fluazinam | | Pyraclostrobin | | Fenpropidin |
| 148 | Polyphenol | Copper | Fluazinam | | Pyraclostrobin | Adepidyn | |
| 149 | Polyphenol | Copper | Fluazinam | | Pyraclostrobin | benzovindiflupyr | |
| 150 | Polyphenol | Copper | Fluazinam | | Pyraclostrobin | bixafen | |
| 151 | Polyphenol | Copper | Fluazinam | | Pyraclostrobin | Fluindapyr | |
| 152 | Polyphenol | Copper | Fluazinam | | Pyraclostrobin | fluxapyroxad | |
| 153 | Polyphenol | Copper | Fluazinam | | Pyraclostrobin | Inpyrfluxam | |
| 154 | Polyphenol | Copper | Fluazinam | cyproconazole | Pyraclostrobin | | |
| 155 | Polyphenol | Copper | Fluazinam | difenoconazole | Pyraclostrobin | | |
| 156 | Polyphenol | Copper | Fluazinam | flutriafol | Pyraclostrobin | | |
| 157 | Polyphenol | Copper | Fluazinam | mefentrifluconazole | Pyraclostrobin | | |
| 158 | Polyphenol | Copper | Fluazinam | prothioconazole | Pyraclostrobin | | |
| 159 | Polyphenol | Copper | Fluazinam | tebuconazole | Pyraclostrobin | | |
| 160 | Polyphenol | Copper | Fluazinam | tetraconazole | Pyraclostrobin | | |
| 161 | Polyphenol | Copper | Fluazinam | | trifloxystrobin | Adepidyn | fenpropidin |
| 162 | Polyphenol | Copper | Fluazinam | | trifloxystrobin | benzovindiflupyr | fenpropidin |
| 163 | Polyphenol | Copper | Fluazinam | | trifloxystrobin | bixafen | fenpropidin |
| 164 | Polyphenol | Copper | Fluazinam | | trifloxystrobin | Fluindapyr | fenpropidin |
| 165 | Polyphenol | Copper | Fluazinam | | trifloxystrobin | fluxapyroxad | fenpropidin |
| 166 | Polyphenol | Copper | Fluazinam | | trifloxystrobin | Inpyrfluxam | fenpropidin |
| 167 | Polyphenol | Copper | Fluazinam | | trifloxystrobin | Adepidyn | Fenpropimorph |
| 168 | Polyphenol | Copper | Fluazinam | | trifloxystrobin | benzovindiflupyr | Fenpropimorph |
| 169 | Polyphenol | Copper | Fluazinam | | trifloxystrobin | bixafen | Fenpropimorph |
| 170 | Polyphenol | Copper | Fluazinam | | trifloxystrobin | Fluindapyr | Fenpropimorph |
| 171 | Polyphenol | Copper | Fluazinam | | trifloxystrobin | fluxapyroxad | Fenpropimorph |
| 172 | Polyphenol | Copper | Fluazinam | | trifloxystrobin | Inpyrfluxam | Fenpropimorph |
| 173 | Polyphenol | Copper | Fluazinam | | trifloxystrobin | | Fenpropimorph |
| 174 | Polyphenol | Copper | Fluazinam | | trifloxystrobin | | Fenpropidin |
| 175 | Polyphenol | Copper | Fluazinam | | trifloxystrobin | Adepidyn | |
| 176 | Polyphenol | Copper | Fluazinam | | trifloxystrobin | benzovindiflupyr | |
| 177 | Polyphenol | Copper | Fluazinam | | trifloxystrobin | bixafen | |
| 178 | Polyphenol | Copper | Fluazinam | | trifloxystrobin | Fluindapyr | |
| 179 | Polyphenol | Copper | Fluazinam | | trifloxystrobin | fluxapyroxad | |
| 180 | Polyphenol | Copper | Fluazinam | | trifloxystrobin | Inpyrfluxam | |
| 181 | Polyphenol | Copper | Fluazinam | cyproconazole | trifloxystrobin | | |
| 182 | Polyphenol | Copper | Fluazinam | difenoconazole | trifloxystrobin | | |
| 183 | Polyphenol | Copper | Fluazinam | flutriafol | trifloxystrobin | | |
| 184 | Polyphenol | Copper | Fluazinam | mefentrifluconazole | trifloxystrobin | | |
| 185 | Polyphenol | Copper | Fluazinam | prothioconazole | trifloxystrobin | | |
| 186 | Polyphenol | Copper | Fluazinam | tebuconazole | trifloxystrobin | | |
| 187 | Polyphenol | Copper | Fluazinam | tetraconazole | trifloxystrobin | | |
| 188 | Polyphenol | Copper | Fluazinam | cyproconazole | | | Fenpropidin |
| 189 | Polyphenol | Copper | Fluazinam | difenoconazole | | | Fenpropidin |
| 190 | Polyphenol | Copper | Fluazinam | flutriafol | | | Fenpropidin |
| 191 | Polyphenol | Copper | Fluazinam | mefentrifluconazole | | | Fenpropidin |
| 192 | Polyphenol | Copper | Fluazinam | prothioconazole | | | Fenpropidin |
| 193 | Polyphenol | Copper | Fluazinam | tebuconazole | | | Fenpropidin |
| 194 | Polyphenol | Copper | Fluazinam | tetraconazole | | | Fenpropidin |
| 195 | Polyphenol | Copper | Fluazinam | cyproconazole | | | Fenpropimorph |
| 196 | Polyphenol | Copper | Fluazinam | difenoconazole | | | Fenpropimorph |
| 197 | Polyphenol | Copper | Fluazinam | flutriafol | | | Fenpropimorph |
| 198 | Polyphenol | Copper | Fluazinam | mefentrifluconazole | | | Fenpropimorph |
| 199 | Polyphenol | Copper | Fluazinam | prothioconazole | | | Fenpropimorph |
| 200 | Polyphenol | Copper | Fluazinam | tebuconazole | | | Fenpropimorph |
| 201 | Polyphenol | Copper | Fluazinam | tetraconazole | | | Fenpropimorph |
| 202 | Polyphenol | Copper | Fluazinam | | | Adepidyn | Fenpropimorph |
| 203 | Polyphenol | Copper | Fluazinam | | | benzovindiflupyr | Fenpropimorph |
| 204 | Polyphenol | Copper | Fluazinam | | | bixafen | Fenpropimorph |
| 205 | Polyphenol | Copper | Fluazinam | | | Fluindapyr | Fenpropimorph |
| 206 | Polyphenol | Copper | Fluazinam | | | fluxapyroxad | Fenpropimorph |
| 207 | Polyphenol | Copper | Fluazinam | | | Inpyrfluxam | Fenpropimorph |
| 208 | Polyphenol | Copper | Fluazinam | | | Adepidyn | Fenpropidin |
| 209 | Polyphenol | Copper | Fluazinam | | | benzovindiflupyr | Fenpropidin |
| 210 | Polyphenol | Copper | Fluazinam | | | bixafen | Fenpropidin |
| 211 | Polyphenol | Copper | Fluazinam | | | Fluindapyr | Fenpropidin |
| 212 | Polyphenol | Copper | Fluazinam | | | fluxapyroxad | Fenpropidin |
| 213 | Polyphenol | Copper | Fluazinam | | | Inpyrfluxam | Fenpropidin |
| 214 | Polyphenol | Copper | Fluazinam | cyproconazole | | Adepidyn | |
| 215 | Polyphenol | Copper | Fluazinam | difenoconazole | | Adepidyn | |
| 216 | Polyphenol | Copper | Fluazinam | flutriafol | | Adepidyn | |
| 217 | Polyphenol | Copper | Fluazinam | flutriafol | | Adepidyn | |
| 218 | Polyphenol | Copper | Fluazinam | flutriafol | | Adepidyn | |
| 219 | Polyphenol | Copper | Fluazinam | mefentrifluconazole | | Adepidyn | |
| 220 | Polyphenol | Copper | Fluazinam | prothioconazole | | Adepidyn | |
| 221 | Polyphenol | Copper | Fluazinam | tebuconazole | | Adepidyn | |
| 222 | Polyphenol | Copper | Fluazinam | tetraconazole | | Adepidyn | |
| 223 | Polyphenol | Copper | Fluazinam | cyproconazole | | benzovindiflupyr | |
| 224 | Polyphenol | Copper | Fluazinam | difenoconazole | | benzovindiflupyr | |
| 225 | Polyphenol | Copper | Fluazinam | flutriafol | | benzovindiflupyr | |
| 226 | Polyphenol | Copper | Fluazinam | mefentrifluconazole | | benzovindiflupyr | |
| 227 | Polyphenol | Copper | Fluazinam | prothioconazole | | benzovindiflupyr | |
| 228 | Polyphenol | Copper | Fluazinam | tebuconazole | | benzovindiflupyr | |
| 229 | Polyphenol | Copper | Fluazinam | tetraconazole | | benzovindiflupyr | |
| 230 | Polyphenol | Copper | Fluazinam | cyproconazole | | bixafen | |
| 231 | Polyphenol | Copper | Fluazinam | difenoconazole | | bixafen | |
| 232 | Polyphenol | Copper | Fluazinam | flutriafol | | bixafen | |
| 233 | Polyphenol | Copper | Fluazinam | mefentrifluconazole | | bixafen | |
| 234 | Polyphenol | Copper | Fluazinam | prothioconazole | | bixafen | |
| 235 | Polyphenol | Copper | Fluazinam | tebuconazole | | bixafen | |
| 236 | Polyphenol | Copper | Fluazinam | tetraconazole | | bixafen | |
| 237 | Polyphenol | Copper | Fluazinam | cyproconazole | | Fluindapyr | |
| 238 | Polyphenol | Copper | Fluazinam | difenoconazole | | Fluindapyr | |
| 239 | Polyphenol | Copper | Fluazinam | mefentrifluconazole | | Fluindapyr | |
| 240 | Polyphenol | Copper | Fluazinam | prothioconazole | | Fluindapyr | |
| 241 | Polyphenol | Copper | Fluazinam | tebuconazole | | Fluindapyr | |
| 242 | Polyphenol | Copper | Fluazinam | tetraconazole | | Fluindapyr | |
| 243 | Polyphenol | Copper | Fluazinam | cyproconazole | | fluxapyroxad | |
| 244 | Polyphenol | Copper | Fluazinam | difenoconazole | | fluxapyroxad | |
| 245 | Polyphenol | Copper | Fluazinam | flutriafol | | fluxapyroxad | |
| 246 | Polyphenol | Copper | Fluazinam | mefentrifluconazole | | fluxapyroxad | |
| 247 | Polyphenol | Copper | Fluazinam | prothioconazole | | fluxapyroxad | |
| 248 | Polyphenol | Copper | Fluazinam | tebuconazole | | fluxapyroxad | |
| 249 | Polyphenol | Copper | Fluazinam | tetraconazole | | fluxapyroxad | |
| 250 | Polyphenol | Copper | Fluazinam | cyproconazole | | Inpyrfluxam | |
| 251 | Polyphenol | Copper | Fluazinam | difenoconazole | | Inpyrfluxam | |
| 252 | Polyphenol | Copper | Fluazinam | flutriafol | | Inpyrfluxam | |
| 253 | Polyphenol | Copper | Fluazinam | mefentrifluconazole | | Inpyrfluxam | |
| 254 | Polyphenol | Copper | Fluazinam | prothioconazole | | Inpyrfluxam | |
| 255 | Polyphenol | Copper | Fluazinam | tebuconazole | | Inpyrfluxam | |
| 256 | Polyphenol | Copper | Fluazinam | tetraconazole | | Inpyrfluxam | |
| 257 | Polyphenol | | Fluazinam | | azoxystrobin | Adepidyn | Fenpropidin |
| 258 | Polyphenol | | Fluazinam | | azoxystrobin | benzovindiflupyr | Fenpropidin |
| 259 | Polyphenol | | Fluazinam | | azoxystrobin | bixafen | Fenpropidin |
| 260 | Polyphenol | | Fluazinam | | azoxystrobin | Fluindapyr | Fenpropidin |
| 261 | Polyphenol | | Fluazinam | | azoxystrobin | fluxapyroxad | Fenpropidin |
| 262 | Polyphenol | | Fluazinam | | azoxystrobin | Inpyrfluxam | Fenpropidin |
| 263 | Polyphenol | | Fluazinam | | azoxystrobin | Adepidyn | Fenpropimorph |
| 264 | Polyphenol | | Fluazinam | | azoxystrobin | benzovindiflupyr | Fenpropimorph |
| 265 | Polyphenol | | Fluazinam | | azoxystrobin | bixafen | Fenpropimorph |
| 266 | Polyphenol | | Fluazinam | | azoxystrobin | Fluindapyr | Fenpropimorph |
| 267 | Polyphenol | | Fluazinam | | azoxystrobin | fluxapyroxad | Fenpropimorph |
| 268 | Polyphenol | | Fluazinam | | azoxystrobin | Inpyrfluxam | Fenpropimorph |
| 269 | Polyphenol | | Fluazinam | | azoxystrobin | Adepidyn | |
| 270 | Polyphenol | | Fluazinam | | azoxystrobin | benzovindiflupyr | |
| 271 | Polyphenol | | Fluazinam | | azoxystrobin | Bixafen | |
| 272 | Polyphenol | | Fluazinam | | azoxystrobin | Fluindapyr | |
| 273 | Polyphenol | | Fluazinam | | azoxystrobin | fluxapyroxad | |
| 274 | Polyphenol | | Fluazinam | | azoxystrobin | Inpyrfluxam | |
| 275 | Polyphenol | | Fluazinam | cyproconazole | azoxystrobin | | |
| 276 | Polyphenol | | Fluazinam | difenoconazole | azoxystrobin | | |
| 277 | Polyphenol | | Fluazinam | flutriafol | azoxystrobin | | |
| 278 | Polyphenol | | Fluazinam | mefentrifluconazole | azoxystrobin | | |
| 279 | Polyphenol | | Fluazinam | prothioconazole | azoxystrobin | | |
| 280 | Polyphenol | | Fluazinam | tebuconazole | azoxystrobin | | |
| 281 | Polyphenol | | Fluazinam | tetraconazole | azoxystrobin | | |
| 282 | Polyphenol | | Fluazinam | | Mandestrobin | Adepidyn | fenpropidin |
| 283 | Polyphenol | | Fluazinam | | Mandestrobin | benzovindiflupyr | fenpropidin |
| 284 | Polyphenol | | Fluazinam | | Mandestrobin | bixafen | fenpropidin |
| 285 | Polyphenol | | Fluazinam | | Mandestrobin | Fluindapyr | fenpropidin |
| 286 | Polyphenol | | Fluazinam | | Mandestrobin | fluxapyroxad | fenpropidin |
| 287 | Polyphenol | | Fluazinam | | Mandestrobin | Inpyrfluxam | fenpropidin |
| 288 | Polyphenol | | Fluazinam | | Mandestrobin | Adepidyn | Fenpropimorph |
| 289 | Polyphenol | | Fluazinam | | Mandestrobin | benzovindiflupyr | Fenpropimorph |
| 290 | Polyphenol | | Fluazinam | | Mandestrobin | bixafen | Fenpropimorph |
| 291 | Polyphenol | | Fluazinam | | Mandestrobin | Fluindapyr | Fenpropimorph |
| 292 | Polyphenol | | Fluazinam | | Mandestrobin | fluxapyroxad | Fenpropimorph |
| 293 | Polyphenol | | Fluazinam | | Mandestrobin | Inpyrfluxam | Fenpropimorph |
| 294 | Polyphenol | | Fluazinam | | Mandestrobin | | Fenpropimorph |
| 295 | Polyphenol | | Fluazinam | | Mandestrobin | | Fenpropidin |
| 296 | Polyphenol | | Fluazinam | | Mandestrobin | Adepidyn | |
| 297 | Polyphenol | | Fluazinam | | Mandestrobin | benzovindiflupyr | |
| 298 | Polyphenol | | Fluazinam | | Mandestrobin | bixafen | |
| 299 | Polyphenol | | Fluazinam | | Mandestrobin | Fluindapyr | |
| 300 | Polyphenol | | Fluazinam | | Mandestrobin | fluxapyroxad | |
| 301 | Polyphenol | | Fluazinam | | Mandestrobin | Inpyrfluxam | |
| 302 | Polyphenol | | Fluazinam | cyproconazole | Mandestrobin | | |
| 303 | Polyphenol | | Fluazinam | difenoconazole | Mandestrobin | | |
| 304 | Polyphenol | | Fluazinam | flutriafol | Mandestrobin | | |
| 305 | Polyphenol | | Fluazinam | mefentrifluconazole | Mandestrobin | | |
| 306 | Polyphenol | | Fluazinam | prothioconazole | Mandestrobin | | |
| 307 | Polyphenol | | Fluazinam | tebuconazole | Mandestrobin | | |
| 308 | Polyphenol | | Fluazinam | tetraconazole | Mandestrobin | | |
| 309 | Polyphenol | | Fluazinam | | Metyltetraprole | Adepidyn | fenpropidin |
| 310 | Polyphenol | | Fluazinam | | Metyltetraprole | benzovindiflupyr | fenpropidin |
| 311 | Polyphenol | | Fluazinam | | Metyltetraprole | bixafen | fenpropidin |
| 312 | Polyphenol | | Fluazinam | | Metyltetraprole | Fluindapyr | fenpropidin |
| 313 | Polyphenol | | Fluazinam | | Metyltetraprole | fluxapyroxad | fenpropidin |
| 314 | Polyphenol | | Fluazinam | | Metyltetraprole | Inpyrfluxam | fenpropidin |
| 315 | Polyphenol | | Fluazinam | | Metyltetraprole | Adepidyn | Fenpropimorph |
| 316 | Polyphenol | | Fluazinam | | Metyltetraprole | benzovindiflupyr | Fenpropimorph |
| 317 | Polyphenol | | Fluazinam | | Metyltetraprole | bixafen | Fenpropimorph |
| 318 | Polyphenol | | Fluazinam | | Metyltetraprole | Fluindapyr | Fenpropimorph |
| 319 | Polyphenol | | Fluazinam | | Metyltetraprole | fluxapyroxad | Fenpropimorph |
| 320 | Polyphenol | | Fluazinam | | Metyltetraprole | Inpyrfluxam | Fenpropimorph |
| 321 | Polyphenol | | Fluazinam | | Metyltetraprole | | Fenpropimorph |
| 322 | Polyphenol | | Fluazinam | | Metyltetraprole | | Fenpropidin |
| 323 | Polyphenol | | Fluazinam | | Metyltetraprole | Adepidyn | |
| 324 | Polyphenol | | Fluazinam | | Metyltetraprole | benzovindiflupyr | |
| 325 | Polyphenol | | Fluazinam | | Metyltetraprole | bixafen | |
| 326 | Polyphenol | | Fluazinam | | Metyltetraprole | Fluindapyr | |
| 327 | Polyphenol | | Fluazinam | | Metyltetraprole | fluxapyroxad | |
| 328 | Polyphenol | | Fluazinam | | Metyltetraprole | Inpyrfluxam | |
| 329 | Polyphenol | | Fluazinam | cyproconazole | Metyltetraprole | | |
| 330 | Polyphenol | | Fluazinam | difenoconazole | Metyltetraprole | | |
| 331 | Polyphenol | | Fluazinam | flutriafol | Metyltetraprole | | |
| 332 | Polyphenol | | Fluazinam | mefentrifluconazole | Metyltetraprole | | |
| 333 | Polyphenol | | Fluazinam | prothioconazole | Metyltetraprole | | |
| 334 | Polyphenol | | Fluazinam | tebuconazole | Metyltetraprole | | |
| 335 | Polyphenol | | Fluazinam | tetraconazole | Metyltetraprole | | |
| 336 | Polyphenol | | Fluazinam | | metominostrobin | Adepidyn | fenpropidin |
| 337 | Polyphenol | | Fluazinam | | metominostrobin | benzovindiflupyr | fenpropidin |
| 338 | Polyphenol | | Fluazinam | | metominostrobin | Bixafen | fenpropidin |
| 339 | Polyphenol | | Fluazinam | | metominostrobin | Fluindapyr | fenpropidin |
| 340 | Polyphenol | | Fluazinam | | metominostrobin | fluxapyroxad | fenpropidin |
| 341 | Polyphenol | | Fluazinam | | metominostrobin | Inpyrfluxam | fenpropidin |
| 342 | Polyphenol | | Fluazinam | | metominostrobin | Adepidyn | Fenpropimorph |
| 343 | Polyphenol | | Fluazinam | | metominostrobin | benzovindiflupyr | Fenpropimorph |
| 344 | Polyphenol | | Fluazinam | | metominostrobin | bixafen | Fenpropimorph |
| 345 | Polyphenol | | Fluazinam | | metominostrobin | Fluindapyr | Fenpropimorph |
| 346 | Polyphenol | | Fluazinam | | metominostrobin | fluxapyroxad | Fenpropimorph |
| 347 | Polyphenol | | Fluazinam | | metominostrobin | Inpyrfluxam | Fenpropimorph |
| 348 | Polyphenol | | Fluazinam | | metominostrobin | | Fenpropimorph |
| 349 | Polyphenol | | Fluazinam | | metominostrobin | | Fenpropidin |
| 350 | Polyphenol | | Fluazinam | | metominostrobin | Adepidyn | |
| 351 | Polyphenol | | Fluazinam | | metominostrobin | benzovindiflupyr | |
| 352 | Polyphenol | | Fluazinam | | metominostrobin | bixafen | |
| 353 | Polyphenol | | Fluazinam | | metominostrobin | Fluindapyr | |
| 354 | Polyphenol | | Fluazinam | | metominostrobin | fluxapyroxad | |
| 355 | Polyphenol | | Fluazinam | | metominostrobin | Inpyrfluxam | |
| 356 | Polyphenol | | Fluazinam | cyproconazole | metominostrobin | | |
| 357 | Polyphenol | | Fluazinam | difenoconazole | metominostrobin | | |
| 358 | Polyphenol | | Fluazinam | flutriafol | metominostrobin | | |
| 359 | Polyphenol | | Fluazinam | mefentrifluconazole | metominostrobin | | |
| 360 | Polyphenol | | Fluazinam | prothioconazole | metominostrobin | | |
| 361 | Polyphenol | | Fluazinam | tebuconazole | metominostrobin | | |
| 362 | Polyphenol | | Fluazinam | tetraconazole | metominostrobin | | |
| 363 | Polyphenol | | Fluazinam | | picoxystrobin | Adepidyn | Fenpropidin |
| 364 | Polyphenol | | Fluazinam | | picoxystrobin | benzovindiflupyr | Fenpropidin |
| 365 | Polyphenol | | Fluazinam | | picoxystrobin | bixafen | Fenpropidin |
| 366 | Polyphenol | | Fluazinam | | picoxystrobin | Fluindapyr | Fenpropidin |
| 367 | Polyphenol | | Fluazinam | | picoxystrobin | fluxapyroxad | Fenpropidin |
| 368 | Polyphenol | | Fluazinam | | picoxystrobin | Inpyrfluxam | Fenpropidin |
| 369 | Polyphenol | | Fluazinam | | picoxystrobin | Adepidyn | Fenpropimorph |
| 370 | Polyphenol | | Fluazinam | | picoxystrobin | benzovindiflupyr | Fenpropimorph |
| 371 | Polyphenol | | Fluazinam | | picoxystrobin | bixafen | Fenpropimorph |
| 372 | Polyphenol | | Fluazinam | | picoxystrobin | Fluindapyr | Fenpropimorph |
| 373 | Polyphenol | | Fluazinam | | picoxystrobin | fluxapyroxad | Fenpropimorph |
| 374 | Polyphenol | | Fluazinam | | picoxystrobin | Inpyrfluxam | Fenpropimorph |
| 375 | Polyphenol | | Fluazinam | | picoxystrobin | | Fenpropimorph |
| 376 | Polyphenol | | Fluazinam | | picoxystrobin | | Fenpropidin |
| 377 | Polyphenol | | Fluazinam | | picoxystrobin | Adepidyn | |
| 378 | Polyphenol | | Fluazinam | | picoxystrobin | benzovindiflupyr | |
| 379 | Polyphenol | | Fluazinam | | picoxystrobin | bixafen | |
| 380 | Polyphenol | | Fluazinam | | picoxystrobin | Fluindapyr | |
| 381 | Polyphenol | | Fluazinam | | picoxystrobin | fluxapyroxad | |
| 382 | Polyphenol | | Fluazinam | | picoxystrobin | Inpyrfluxam | |
| 383 | Polyphenol | | Fluazinam | cyproconazole | picoxystrobin | | |
| 384 | Polyphenol | | Fluazinam | difenoconazole | picoxystrobin | | |
| 385 | Polyphenol | | Fluazinam | flutriafol | picoxystrobin | | |
| 386 | Polyphenol | | Fluazinam | mefentrifluconazole | picoxystrobin | | |
| 387 | Polyphenol | | Fluazinam | prothioconazole | picoxystrobin | | |
| 388 | Polyphenol | | Fluazinam | tebuconazole | picoxystrobin | | |
| 389 | Polyphenol | | Fluazinam | tetraconazole | picoxystrobin | | |
| 390 | Polyphenol | | Fluazinam | | Pyraclostrobin | Adepidyn | fenpropidin |
| 391 | Polyphenol | | Fluazinam | | Pyraclostrobin | benzovindiflupyr | fenpropidin |
| 392 | Polyphenol | | Fluazinam | | Pyraclostrobin | bixafen | fenpropidin |
| 393 | Polyphenol | | Fluazinam | | Pyraclostrobin | Fluindapyr | fenpropidin |
| 394 | Polyphenol | | Fluazinam | | Pyraclostrobin | fluxapyroxad | fenpropidin |
| 395 | Polyphenol | | Fluazinam | | Pyraclostrobin | Inpyrfluxam | fenpropidin |
| 396 | Polyphenol | | Fluazinam | | Pyraclostrobin | Adepidyn | Fenpropimorph |
| 397 | Polyphenol | | Fluazinam | | Pyraclostrobin | benzovindiflupyr | Fenpropimorph |
| 398 | Polyphenol | | Fluazinam | | Pyraclostrobin | bixafen | Fenpropimorph |
| 399 | Polyphenol | | Fluazinam | | Pyraclostrobin | Fluindapyr | Fenpropimorph |
| 400 | Polyphenol | | Fluazinam | | Pyraclostrobin | fluxapyroxad | Fenpropimorph |
| 401 | Polyphenol | | Fluazinam | | Pyraclostrobin | Inpyrfluxam | Fenpropimorph |
| 402 | Polyphenol | | Fluazinam | | Pyraclostrobin | | Fenpropimorph |
| 403 | Polyphenol | | Fluazinam | | Pyraclostrobin | | Fenpropidin |
| 404 | Polyphenol | | Fluazinam | | Pyraclostrobin | Adepidyn | |
| 405 | Polyphenol | | Fluazinam | | Pyraclostrobin | benzovindiflupyr | |
| 406 | Polyphenol | | Fluazinam | | Pyraclostrobin | bixafen | |
| 407 | Polyphenol | | Fluazinam | | Pyraclostrobin | Fluindapyr | |
| 408 | Polyphenol | | Fluazinam | | Pyraclostrobin | fluxapyroxad | |
| 409 | Polyphenol | | Fluazinam | | Pyraclostrobin | Inpyrfluxam | |
| 410 | Polyphenol | | Fluazinam | cyproconazole | Pyraclostrobin | | |
| 411 | Polyphenol | | Fluazinam | difenoconazole | Pyraclostrobin | | |
| 412 | Polyphenol | | Fluazinam | flutriafol | Pyraclostrobin | | |
| 413 | Polyphenol | | Fluazinam | mefentrifluconazole | Pyraclostrobin | | |
| 414 | Polyphenol | | Fluazinam | prothioconazole | Pyraclostrobin | | |
| 415 | Polyphenol | | Fluazinam | tebuconazole | Pyraclostrobin | | |
| 416 | Polyphenol | | Fluazinam | tetraconazole | Pyraclostrobin | | |
| 417 | Polyphenol | | Fluazinam | | trifloxystrobin | Adepidyn | fenpropidin |
| 418 | Polyphenol | | Fluazinam | | trifloxystrobin | benzovindiflupyr | fenpropidin |
| 419 | Polyphenol | | Fluazinam | | trifloxystrobin | bixafen | fenpropidin |
| 420 | Polyphenol | | Fluazinam | | trifloxystrobin | Fluindapyr | fenpropidin |
| 421 | Polyphenol | | Fluazinam | | trifloxystrobin | fluxapyroxad | fenpropidin |
| 422 | Polyphenol | | Fluazinam | | trifloxystrobin | Inpyrfluxam | fenpropidin |
| 423 | Polyphenol | | Fluazinam | | trifloxystrobin | Adepidyn | Fenpropimorph |
| 424 | Polyphenol | | Fluazinam | | trifloxystrobin | benzovindiflupyr | Fenpropimorph |
| 425 | Polyphenol | | Fluazinam | | trifloxystrobin | bixafen | Fenpropimorph |
| 426 | Polyphenol | | Fluazinam | | trifloxystrobin | Fluindapyr | Fenpropimorph |
| 427 | Polyphenol | | Fluazinam | | trifloxystrobin | fluxapyroxad | Fenpropimorph |
| 428 | Polyphenol | | Fluazinam | | trifloxystrobin | Inpyrfluxam | Fenpropimorph |
| 429 | Polyphenol | | Fluazinam | | trifloxystrobin | | Fenpropimorph |
| 430 | Polyphenol | | Fluazinam | | trifloxystrobin | | Fenpropidin |
| 431 | Polyphenol | | Fluazinam | | trifloxystrobin | Adepidyn | |
| 432 | Polyphenol | | Fluazinam | | trifloxystrobin | benzovindiflupyr | |
| 433 | Polyphenol | | Fluazinam | | trifloxystrobin | bixafen | |
| 434 | Polyphenol | | Fluazinam | | trifloxystrobin | Fluindapyr | |
| 435 | Polyphenol | | Fluazinam | | trifloxystrobin | fluxapyroxad | |
| 436 | Polyphenol | | Fluazinam | | trifloxystrobin | Inpyrfluxam | |
| 437 | Polyphenol | | Fluazinam | cyproconazole | trifloxystrobin | | |
| 438 | Polyphenol | | Fluazinam | difenoconazole | trifloxystrobin | | |
| 439 | Polyphenol | | Fluazinam | flutriafol | trifloxystrobin | | |
| 440 | Polyphenol | | Fluazinam | mefentrifluconazole | trifloxystrobin | | |
| 441 | Polyphenol | | Fluazinam | prothioconazole | trifloxystrobin | | |
| 442 | Polyphenol | | Fluazinam | tebuconazole | trifloxystrobin | | |
| 443 | Polyphenol | | Fluazinam | tetraconazole | trifloxystrobin | | |
| 444 | Polyphenol | | Fluazinam | cyproconazole | | | Fenpropidin |
| 445 | Polyphenol | | Fluazinam | difenoconazole | | | Fenpropidin |
| 446 | Polyphenol | | Fluazinam | flutriafol | | | Fenpropidin |
| 447 | Polyphenol | | Fluazinam | mefentrifluconazole | | | Fenpropidin |
| 448 | Polyphenol | | Fluazinam | prothioconazole | | | Fenpropidin |
| 449 | Polyphenol | | Fluazinam | tebuconazole | | | Fenpropidin |
| 450 | Polyphenol | | Fluazinam | tetraconazole | | | Fenpropidin |
| 451 | Polyphenol | | Fluazinam | cyproconazole | | | Fenpropimorph |
| 452 | Polyphenol | | Fluazinam | difenoconazole | | | Fenpropimorph |
| 453 | Polyphenol | | Fluazinam | flutriafol | | | Fenpropimorph |
| 454 | Polyphenol | | Fluazinam | mefentrifluconazole | | | Fenpropimorph |
| 455 | Polyphenol | | Fluazinam | prothioconazole | | | Fenpropimorph |
| 456 | Polyphenol | | Fluazinam | tebuconazole | | | Fenpropimorph |
| 457 | Polyphenol | | Fluazinam | tetraconazole | | | Fenpropimorph |
| 458 | Polyphenol | | Fluazinam | | | Adepidyn | Fenpropimorph |
| 459 | Polyphenol | | Fluazinam | | | benzovindiflupyr | Fenpropimorph |
| 460 | Polyphenol | | Fluazinam | | | bixafen | Fenpropimorph |
| 461 | Polyphenol | | Fluazinam | | | Fluindapyr | Fenpropimorph |
| 462 | Polyphenol | | Fluazinam | | | fluxapyroxad | Fenpropimorph |
| 463 | Polyphenol | | Fluazinam | | | Inpyrfluxam | Fenpropimorph |
| 464 | Polyphenol | | Fluazinam | | | Adepidyn | Fenpropidin |
| 465 | Polyphenol | | Fluazinam | | | benzovindiflupyr | Fenpropidin |
| 466 | Polyphenol | | Fluazinam | | | bixafen | Fenpropidin |
| 467 | Polyphenol | | Fluazinam | | | Fluindapyr | Fenpropidin |
| 468 | Polyphenol | | Fluazinam | | | fluxapyroxad | Fenpropidin |
| 469 | Polyphenol | | Fluazinam | | | Inpyrfluxam | Fenpropidin |
| 470 | Polyphenol | | Fluazinam | cyproconazole | | Adepidyn | |
| 471 | Polyphenol | | Fluazinam | difenoconazole | | Adepidyn | |
| 472 | Polyphenol | | Fluazinam | flutriafol | | Adepidyn | |
| 473 | Polyphenol | | Fluazinam | flutriafol | | Adepidyn | |
| 474 | Polyphenol | | Fluazinam | flutriafol | | Adepidyn | |
| 475 | Polyphenol | | Fluazinam | mefentrifluconazole | | Adepidyn | |
| 476 | Polyphenol | | Fluazinam | prothioconazole | | Adepidyn | |
| 477 | Polyphenol | | Fluazinam | tebuconazole | | Adepidyn | |
| 478 | Polyphenol | | Fluazinam | tetraconazole | | Adepidyn | |
| 479 | Polyphenol | | Fluazinam | cyproconazole | | benzovindiflupyr | |
| 480 | Polyphenol | | Fluazinam | difenoconazole | | benzovindiflupyr | |
| 481 | Polyphenol | | Fluazinam | flutriafol | | benzovindiflupyr | |
| 482 | Polyphenol | | Fluazinam | mefentrifluconazole | | benzovindiflupyr | |
| 483 | Polyphenol | | Fluazinam | prothioconazole | | benzovindiflupyr | |
| 484 | Polyphenol | | Fluazinam | tebuconazole | | benzovindiflupyr | |
| 485 | Polyphenol | | Fluazinam | tetraconazole | | benzovindiflupyr | |
| 486 | Polyphenol | | Fluazinam | cyproconazole | | bixafen | |
| 487 | Polyphenol | | Fluazinam | difenoconazole | | bixafen | |
| 488 | Polyphenol | | Fluazinam | flutriafol | | bixafen | |
| 489 | Polyphenol | | Fluazinam | mefentrifluconazole | | bixafen | |
| 490 | Polyphenol | | Fluazinam | prothioconazole | | bixafen | |
| 491 | Polyphenol | | Fluazinam | tebuconazole | | bixafen | |
| 492 | Polyphenol | | Fluazinam | tetraconazole | | bixafen | |
| 493 | Polyphenol | | Fluazinam | cyproconazole | | Fluindapyr | |
| 494 | Polyphenol | | Fluazinam | difenoconazole | | Fluindapyr | |
| 495 | Polyphenol | | Fluazinam | mefentrifluconazole | | Fluindapyr | |
| 496 | Polyphenol | | Fluazinam | prothioconazole | | Fluindapyr | |
| 497 | Polyphenol | | Fluazinam | tebuconazole | | Fluindapyr | |
| 498 | Polyphenol | | Fluazinam | tetraconazole | | Fluindapyr | |
| 499 | Polyphenol | | Fluazinam | cyproconazole | | fluxapyroxad | |
| 500 | Polyphenol | | Fluazinam | difenoconazole | | fluxapyroxad | |
| 501 | Polyphenol | | Fluazinam | flutriafol | | fluxapyroxad | |
| 502 | Polyphenol | | Fluazinam | mefentrifluconazole | | fluxapyroxad | |
| 503 | Polyphenol | | Fluazinam | prothioconazole | | fluxapyroxad | |
| 504 | Polyphenol | | Fluazinam | tebuconazole | | fluxapyroxad | |
| 505 | Polyphenol | | Fluazinam | tetraconazole | | fluxapyroxad | |
| 506 | Polyphenol | | Fluazinam | cyproconazole | | Inpyrfluxam | |
| 507 | Polyphenol | | Fluazinam | difenoconazole | | Inpyrfluxam | |
| 508 | Polyphenol | | Fluazinam | flutriafol | | Inpyrfluxam | |
| 509 | Polyphenol | | Fluazinam | mefentrifluconazole | | Inpyrfluxam | |
| 510 | Polyphenol | | Fluazinam | prothioconazole | | Inpyrfluxam | |
| 511 | Polyphenol | | Fluazinam | tebuconazole | | Inpyrfluxam | |
| 512 | Polyphenol | | Fluazinam | tetraconazole | | Inpyrfluxam | |
| 513 | Polyphenol | Copper | Mancozeb | | azoxystrobin | Adepidyn | Fenpropidin |
| 514 | Polyphenol | Copper | Mancozeb | | azoxystrobin | benzovindiflupyr | Fenpropidin |
| 515 | Polyphenol | Copper | Mancozeb | | azoxystrobin | bixafen | Fenpropidin |
| 516 | Polyphenol | Copper | Mancozeb | | azoxystrobin | Fluindapyr | Fenpropidin |
| 517 | Polyphenol | Copper | Mancozeb | | azoxystrobin | fluxapyroxad | Fenpropidin |
| 518 | Polyphenol | Copper | Mancozeb | | azoxystrobin | Inpyrfluxam | Fenpropidin |
| 519 | Polyphenol | Copper | Mancozeb | | azoxystrobin | Adepidyn | Fenpropimorph |
| 520 | Polyphenol | Copper | Mancozeb | | azoxystrobin | benzovindiflupyr | Fenpropimorph |
| 521 | Polyphenol | Copper | Mancozeb | | azoxystrobin | bixafen | Fenpropimorph |
| 522 | Polyphenol | Copper | Mancozeb | | azoxystrobin | Fluindapyr | Fenpropimorph |
| 523 | Polyphenol | Copper | Mancozeb | | azoxystrobin | fluxapyroxad | Fenpropimorph |
| 524 | Polyphenol | Copper | Mancozeb | | azoxystrobin | Inpyrfluxam | Fenpropimorph |
| 525 | Polyphenol | Copper | Mancozeb | | azoxystrobin | Adepidyn | |
| 526 | Polyphenol | Copper | Mancozeb | | azoxystrobin | benzovindiflupyr | |
| 527 | Polyphenol | Copper | Mancozeb | | azoxystrobin | Bixafen | |
| 528 | Polyphenol | Copper | Mancozeb | | azoxystrobin | Fluindapyr | |
| 529 | Polyphenol | Copper | Mancozeb | | azoxystrobin | fluxapyroxad | |
| 530 | Polyphenol | Copper | Mancozeb | | azoxystrobin | Inpyrfluxam | |
| 531 | Polyphenol | Copper | Mancozeb | cyproconazole | azoxystrobin | | |
| 532 | Polyphenol | Copper | Mancozeb | difenoconazole | azoxystrobin | | |
| 533 | Polyphenol | Copper | Mancozeb | flutriafol | azoxystrobin | | |
| 534 | Polyphenol | Copper | Mancozeb | mefentrifluconazole | azoxystrobin | | |
| 535 | Polyphenol | Copper | Mancozeb | prothioconazole | azoxystrobin | | |
| 536 | Polyphenol | Copper | Mancozeb | tebuconazole | azoxystrobin | | |
| 537 | Polyphenol | Copper | Mancozeb | tetraconazole | azoxystrobin | | |
| 538 | Polyphenol | Copper | Mancozeb | | Mandestrobin | Adepidyn | fenpropidin |
| 539 | Polyphenol | Copper | Mancozeb | | Mandestrobin | benzovindiflupyr | fenpropidin |
| 540 | Polyphenol | Copper | Mancozeb | | Mandestrobin | bixafen | fenpropidin |
| 541 | Polyphenol | Copper | Mancozeb | | Mandestrobin | Fluindapyr | fenpropidin |
| 542 | Polyphenol | Copper | Mancozeb | | Mandestrobin | fluxapyroxad | fenpropidin |
| 543 | Polyphenol | Copper | Mancozeb | | Mandestrobin | Inpyrfluxam | fenpropidin |
| 544 | Polyphenol | Copper | Mancozeb | | Mandestrobin | Adepidyn | Fenpropimorph |
| 545 | Polyphenol | Copper | Mancozeb | | Mandestrobin | benzovindiflupyr | Fenpropimorph |
| 546 | Polyphenol | Copper | Mancozeb | | Mandestrobin | bixafen | Fenpropimorph |
| 547 | Polyphenol | Copper | Mancozeb | | Mandestrobin | Fluindapyr | Fenpropimorph |
| 548 | Polyphenol | Copper | Mancozeb | | Mandestrobin | fluxapyroxad | Fenpropimorph |
| 549 | Polyphenol | Copper | Mancozeb | | Mandestrobin | Inpyrfluxam | Fenpropimorph |
| 550 | Polyphenol | Copper | Mancozeb | | Mandestrobin | | Fenpropimorph |
| 551 | Polyphenol | Copper | Mancozeb | | Mandestrobin | | Fenpropidin |
| 552 | Polyphenol | Copper | Mancozeb | | Mandestrobin | Adepidyn | |
| 553 | Polyphenol | Copper | Mancozeb | | Mandestrobin | benzovindiflupyr | |
| 554 | Polyphenol | Copper | Mancozeb | | Mandestrobin | bixafen | |
| 555 | Polyphenol | Copper | Mancozeb | | Mandestrobin | Fluindapyr | |
| 556 | Polyphenol | Copper | Mancozeb | | Mandestrobin | fluxapyroxad | |
| 557 | Polyphenol | Copper | Mancozeb | | Mandestrobin | Inpyrfluxam | |
| 558 | Polyphenol | Copper | Mancozeb | cyproconazole | Mandestrobin | | |
| 559 | Polyphenol | Copper | Mancozeb | difenoconazole | Mandestrobin | | |
| 560 | Polyphenol | Copper | Mancozeb | flutriafol | Mandestrobin | | |
| 561 | Polyphenol | Copper | Mancozeb | mefentrifluconazole | Mandestrobin | | |
| 562 | Polyphenol | Copper | Mancozeb | prothioconazole | Mandestrobin | | |
| 563 | Polyphenol | Copper | Mancozeb | tebuconazole | Mandestrobin | | |
| 564 | Polyphenol | Copper | Mancozeb | tetraconazole | Mandestrobin | | |
| 565 | Polyphenol | Copper | Mancozeb | | Metyltetraprole | Adepidyn | fenpropidin |
| 566 | Polyphenol | Copper | Mancozeb | | Metyltetraprole | benzovindiflupyr | fenpropidin |
| 567 | Polyphenol | Copper | Mancozeb | | Metyltetraprole | bixafen | fenpropidin |
| 568 | Polyphenol | Copper | Mancozeb | | Metyltetraprole | Fluindapyr | fenpropidin |
| 569 | Polyphenol | Copper | Mancozeb | | Metyltetraprole | fluxapyroxad | fenpropidin |
| 570 | Polyphenol | Copper | Mancozeb | | Metyltetraprole | Inpyrfluxam | fenpropidin |
| 571 | Polyphenol | Copper | Mancozeb | | Metyltetraprole | Adepidyn | Fenpropimorph |
| 572 | Polyphenol | Copper | Mancozeb | | Metyltetraprole | benzovindiflupyr | Fenpropimorph |
| 573 | Polyphenol | Copper | Mancozeb | | Metyltetraprole | bixafen | Fenpropimorph |
| 574 | Polyphenol | Copper | Mancozeb | | Metyltetraprole | Fluindapyr | Fenpropimorph |
| 575 | Polyphenol | Copper | Mancozeb | | Metyltetraprole | fluxapyroxad | Fenpropimorph |
| 576 | Polyphenol | Copper | Mancozeb | | Metyltetraprole | Inpyrfluxam | Fenpropimorph |
| 577 | Polyphenol | Copper | Mancozeb | | Metyltetraprole | | Fenpropimorph |
| 578 | Polyphenol | Copper | Mancozeb | | Metyltetraprole | | Fenpropidin |
| 579 | Polyphenol | Copper | Mancozeb | | Metyltetraprole | Adepidyn | |
| 580 | Polyphenol | Copper | Mancozeb | | Metyltetraprole | benzovindiflupyr | |
| 581 | Polyphenol | Copper | Mancozeb | | Metyltetraprole | bixafen | |
| 582 | Polyphenol | Copper | Mancozeb | | Metyltetraprole | Fluindapyr | |
| 583 | Polyphenol | Copper | Mancozeb | | Metyltetraprole | fluxapyroxad | |
| 584 | Polyphenol | Copper | Mancozeb | | Metyltetraprole | Inpyrfluxam | |
| 585 | Polyphenol | Copper | Mancozeb | cyproconazole | Metyltetraprole | | |
| 586 | Polyphenol | Copper | Mancozeb | difenoconazole | Metyltetraprole | | |
| 587 | Polyphenol | Copper | Mancozeb | flutriafol | Metyltetraprole | | |
| 588 | Polyphenol | Copper | Mancozeb | mefentrifluconazole | Metyltetraprole | | |
| 589 | Polyphenol | Copper | Mancozeb | prothioconazole | Metyltetraprole | | |
| 590 | Polyphenol | Copper | Mancozeb | tebuconazole | Metyltetraprole | | |
| 591 | Polyphenol | Copper | Mancozeb | tetraconazole | Metyltetraprole | | |
| 592 | Polyphenol | Copper | Mancozeb | | metominostrobin | Adepidyn | fenpropidin |
| 593 | Polyphenol | Copper | Mancozeb | | metominostrobin | benzovindiflupyr | fenpropidin |
| 594 | Polyphenol | Copper | Mancozeb | | metominostrobin | Bixafen | fenpropidin |
| 595 | Polyphenol | Copper | Mancozeb | | metominostrobin | Fluindapyr | fenpropidin |
| 596 | Polyphenol | Copper | Mancozeb | | metominostrobin | fluxapyroxad | fenpropidin |
| 597 | Polyphenol | Copper | Mancozeb | | metominostrobin | Inpyrfluxam | fenpropidin |
| 598 | Polyphenol | Copper | Mancozeb | | metominostrobin | Adepidyn | Fenpropimorph |
| 599 | Polyphenol | Copper | Mancozeb | | metominostrobin | benzovindiflupyr | Fenpropimorph |
| 600 | Polyphenol | Copper | Mancozeb | | metominostrobin | Bixafen | Fenpropimorph |
| 601 | Polyphenol | Copper | Mancozeb | | metominostrobin | Fluindapyr | Fenpropimorph |
| 602 | Polyphenol | Copper | Mancozeb | | metominostrobin | fluxapyroxad | Fenpropimorph |
| 603 | Polyphenol | Copper | Mancozeb | | metominostrobin | Inpyrfluxam | Fenpropimorph |
| 604 | Polyphenol | Copper | Mancozeb | | metominostrobin | | Fenpropimorph |
| 605 | Polyphenol | Copper | Mancozeb | | metominostrobin | | Fenpropidin |
| 606 | Polyphenol | Copper | Mancozeb | | metominostrobin | Adepidyn | |
| 607 | Polyphenol | Copper | Mancozeb | | metominostrobin | benzovindiflupyr | |
| 608 | Polyphenol | Copper | Mancozeb | | metominostrobin | Bixafen | |
| 609 | Polyphenol | Copper | Mancozeb | | metominostrobin | Fluindapyr | |
| 610 | Polyphenol | Copper | Mancozeb | | metominostrobin | fluxapyroxad | |
| 611 | Polyphenol | Copper | Mancozeb | | metominostrobin | Inpyrfluxam | |
| 612 | Polyphenol | Copper | Mancozeb | cyproconazole | metominostrobin | | |
| 613 | Polyphenol | Copper | Mancozeb | difenoconazole | metominostrobin | | |
| 614 | Polyphenol | Copper | Mancozeb | flutriafol | metominostrobin | | |
| 615 | Polyphenol | Copper | Mancozeb | mefentrifluconazole | metominostrobin | | |
| 616 | Polyphenol | Copper | Mancozeb | prothioconazole | metominostrobin | | |
| 617 | Polyphenol | Copper | Mancozeb | tebuconazole | metominostrobin | | |
| 618 | Polyphenol | Copper | Mancozeb | tetraconazole | metominostrobin | | |
| 619 | Polyphenol | Copper | Mancozeb | | picoxystrobin | Adepidyn | Fenpropidin |
| 620 | Polyphenol | Copper | Mancozeb | | picoxystrobin | benzovindiflupyr | Fenpropidin |
| 621 | Polyphenol | Copper | Mancozeb | | picoxystrobin | bixafen | Fenpropidin |
| 622 | Polyphenol | Copper | Mancozeb | | picoxystrobin | Fluindapyr | Fenpropidin |
| 623 | Polyphenol | Copper | Mancozeb | | picoxystrobin | fluxapyroxad | Fenpropidin |
| 624 | Polyphenol | Copper | Mancozeb | | picoxystrobin | Inpyrfluxam | Fenpropidin |
| 625 | Polyphenol | Copper | Mancozeb | | picoxystrobin | Adepidyn | Fenpropimorph |
| 626 | Polyphenol | Copper | Mancozeb | | picoxystrobin | benzovindiflupyr | Fenpropimorph |
| 627 | Polyphenol | Copper | Mancozeb | | picoxystrobin | bixafen | Fenpropimorph |
| 628 | Polyphenol | Copper | Mancozeb | | picoxystrobin | Fluindapyr | Fenpropimorph |
| 629 | Polyphenol | Copper | Mancozeb | | picoxystrobin | fluxapyroxad | Fenpropimorph |
| 630 | Polyphenol | Copper | Mancozeb | | picoxystrobin | Inpyrfluxam | Fenpropimorph |
| 631 | Polyphenol | Copper | Mancozeb | | picoxystrobin | | Fenpropimorph |
| 632 | Polyphenol | Copper | Mancozeb | | picoxystrobin | | Fenpropidin |
| 633 | Polyphenol | Copper | Mancozeb | | picoxystrobin | Adepidyn | |
| 634 | Polyphenol | Copper | Mancozeb | | picoxystrobin | benzovindiflupyr | |
| 635 | Polyphenol | Copper | Mancozeb | | picoxystrobin | bixafen | |
| 636 | Polyphenol | Copper | Mancozeb | | picoxystrobin | Fluindapyr | |
| 637 | Polyphenol | Copper | Mancozeb | | picoxystrobin | fluxapyroxad | |
| 638 | Polyphenol | Copper | Mancozeb | | picoxystrobin | Inpyrfluxam | |
| 639 | Polyphenol | Copper | Mancozeb | cyproconazole | picoxystrobin | | |
| 640 | Polyphenol | Copper | Mancozeb | difenoconazole | picoxystrobin | | |
| 641 | Polyphenol | Copper | Mancozeb | flutriafol | picoxystrobin | | |
| 642 | Polyphenol | Copper | Mancozeb | mefentrifluconazole | picoxystrobin | | |
| 643 | Polyphenol | Copper | Mancozeb | prothioconazole | picoxystrobin | | |
| 644 | Polyphenol | Copper | Mancozeb | tebuconazole | picoxystrobin | | |
| 645 | Polyphenol | Copper | Mancozeb | tetraconazole | picoxystrobin | | |
| 646 | Polyphenol | Copper | Mancozeb | | Pyraclostrobin | Adepidyn | fenpropidin |
| 647 | Polyphenol | Copper | Mancozeb | | Pyraclostrobin | benzovindiflupyr | fenpropidin |
| 648 | Polyphenol | Copper | Mancozeb | | Pyraclostrobin | bixafen | fenpropidin |
| 649 | Polyphenol | Copper | Mancozeb | | Pyraclostrobin | Fluindapyr | fenpropidin |
| 650 | Polyphenol | Copper | Mancozeb | | Pyraclostrobin | fluxapyroxad | fenpropidin |
| 651 | Polyphenol | Copper | Mancozeb | | Pyraclostrobin | Inpyrfluxam | fenpropidin |
| 652 | Polyphenol | Copper | Mancozeb | | Pyraclostrobin | Adepidyn | Fenpropimorph |
| 653 | Polyphenol | Copper | Mancozeb | | Pyraclostrobin | benzovindiflupyr | Fenpropimorph |
| 654 | Polyphenol | Copper | Mancozeb | | Pyraclostrobin | bixafen | Fenpropimorph |
| 655 | Polyphenol | Copper | Mancozeb | | Pyraclostrobin | Fluindapyr | Fenpropimorph |
| 656 | Polyphenol | Copper | Mancozeb | | Pyraclostrobin | fluxapyroxad | Fenpropimorph |
| 657 | Polyphenol | Copper | Mancozeb | | Pyraclostrobin | Inpyrfluxam | Fenpropimorph |
| 658 | Polyphenol | Copper | Mancozeb | | Pyraclostrobin | | Fenpropimorph |
| 659 | Polyphenol | Copper | Mancozeb | | Pyraclostrobin | | Fenpropidin |
| 660 | Polyphenol | Copper | Mancozeb | | Pyraclostrobin | Adepidyn | |
| 661 | Polyphenol | Copper | Mancozeb | | Pyraclostrobin | benzovindiflupyr | |
| 662 | Polyphenol | Copper | Mancozeb | | Pyraclostrobin | bixafen | |
| 663 | Polyphenol | Copper | Mancozeb | | Pyraclostrobin | Fluindapyr | |
| 664 | Polyphenol | Copper | Mancozeb | | Pyraclostrobin | fluxapyroxad | |
| 665 | Polyphenol | Copper | Mancozeb | | Pyraclostrobin | Inpyrfluxam | |
| 666 | Polyphenol | Copper | Mancozeb | cyproconazole | Pyraclostrobin | | |
| 667 | Polyphenol | Copper | Mancozeb | difenoconazole | Pyraclostrobin | | |
| 668 | Polyphenol | Copper | Mancozeb | flutriafol | Pyraclostrobin | | |
| 669 | Polyphenol | Copper | Mancozeb | mefentrifluconazole | Pyraclostrobin | | |
| 670 | Polyphenol | Copper | Mancozeb | prothioconazole | Pyraclostrobin | | |
| 671 | Polyphenol | Copper | Mancozeb | tebuconazole | Pyraclostrobin | | |
| 672 | Polyphenol | Copper | Mancozeb | tetraconazole | Pyraclostrobin | | |
| 673 | Polyphenol | Copper | Mancozeb | | trifloxystrobin | Adepidyn | fenpropidin |
| 674 | Polyphenol | Copper | Mancozeb | | trifloxystrobin | benzovindiflupyr | fenpropidin |
| 675 | Polyphenol | Copper | Mancozeb | | trifloxystrobin | bixafen | fenpropidin |
| 676 | Polyphenol | Copper | Mancozeb | | trifloxystrobin | Fluindapyr | fenpropidin |
| 677 | Polyphenol | Copper | Mancozeb | | trifloxystrobin | fluxapyroxad | fenpropidin |
| 678 | Polyphenol | Copper | Mancozeb | | trifloxystrobin | Inpyrfluxam | fenpropidin |
| 679 | Polyphenol | Copper | Mancozeb | | trifloxystrobin | Adepidyn | Fenpropimorph |
| 680 | Polyphenol | Copper | Mancozeb | | trifloxystrobin | benzovindiflupyr | Fenpropimorph |
| 681 | Polyphenol | Copper | Mancozeb | | trifloxystrobin | bixafen | Fenpropimorph |
| 682 | Polyphenol | Copper | Mancozeb | | trifloxystrobin | Fluindapyr | Fenpropimorph |
| 683 | Polyphenol | Copper | Mancozeb | | trifloxystrobin | fluxapyroxad | Fenpropimorph |
| 684 | Polyphenol | Copper | Mancozeb | | trifloxystrobin | Inpyrfluxam | Fenpropimorph |
| 685 | Polyphenol | Copper | Mancozeb | | trifloxystrobin | | Fenpropimorph |
| 686 | Polyphenol | Copper | Mancozeb | | trifloxystrobin | | Fenpropidin |
| 687 | Polyphenol | Copper | Mancozeb | | trifloxystrobin | Adepidyn | |
| 688 | Polyphenol | Copper | Mancozeb | | trifloxystrobin | benzovindiflupyr | |
| 689 | Polyphenol | Copper | Mancozeb | | trifloxystrobin | bixafen | |
| 690 | Polyphenol | Copper | Mancozeb | | trifloxystrobin | Fluindapyr | |
| 691 | Polyphenol | Copper | Mancozeb | | trifloxystrobin | fluxapyroxad | |
| 692 | Polyphenol | Copper | Mancozeb | | trifloxystrobin | Inpyrfluxam | |
| 693 | Polyphenol | Copper | Mancozeb | cyproconazole | trifloxystrobin | | |
| 694 | Polyphenol | Copper | Mancozeb | difenoconazole | trifloxystrobin | | |
| 695 | Polyphenol | Copper | Mancozeb | flutriafol | trifloxystrobin | | |
| 696 | Polyphenol | Copper | Mancozeb | mefentrifluconazole | trifloxystrobin | | |
| 697 | Polyphenol | Copper | Mancozeb | prothioconazole | trifloxystrobin | | |
| 698 | Polyphenol | Copper | Mancozeb | tebuconazole | trifloxystrobin | | |
| 699 | Polyphenol | Copper | Mancozeb | tetraconazole | trifloxystrobin | | |
| 700 | Polyphenol | Copper | Mancozeb | cyproconazole | | | Fenpropidin |
| 701 | Polyphenol | Copper | Mancozeb | difenoconazole | | | Fenpropidin |
| 702 | Polyphenol | Copper | Mancozeb | flutriafol | | | Fenpropidin |
| 703 | Polyphenol | Copper | Mancozeb | mefentrifluconazole | | | Fenpropidin |
| 704 | Polyphenol | Copper | Mancozeb | prothioconazole | | | Fenpropidin |
| 705 | Polyphenol | Copper | Mancozeb | tebuconazole | | | Fenpropidin |
| 706 | Polyphenol | Copper | Mancozeb | tetraconazole | | | Fenpropidin |
| 707 | Polyphenol | Copper | Mancozeb | cyproconazole | | | Fenpropimorph |
| 708 | Polyphenol | Copper | Mancozeb | difenoconazole | | | Fenpropimorph |
| 709 | Polyphenol | Copper | Mancozeb | flutriafol | | | Fenpropimorph |
| 710 | Polyphenol | Copper | Mancozeb | mefentrifluconazole | | | Fenpropimorph |
| 711 | Polyphenol | Copper | Mancozeb | prothioconazole | | | Fenpropimorph |
| 712 | Polyphenol | Copper | Mancozeb | tebuconazole | | | Fenpropimorph |
| 713 | Polyphenol | Copper | Mancozeb | tetraconazole | | | Fenpropimorph |
| 714 | Polyphenol | Copper | Mancozeb | | | Adepidyn | Fenpropimorph |
| 715 | Polyphenol | Copper | Mancozeb | | | benzovindiflupyr | Fenpropimorph |
| 716 | Polyphenol | Copper | Mancozeb | | | bixafen | Fenpropimorph |
| 717 | Polyphenol | Copper | Mancozeb | | | Fluindapyr | Fenpropimorph |
| 718 | Polyphenol | Copper | Mancozeb | | | fluxapyroxad | Fenpropimorph |
| 719 | Polyphenol | Copper | Mancozeb | | | Inpyrfluxam | Fenpropimorph |
| 720 | Polyphenol | Copper | Mancozeb | | | Adepidyn | Fenpropidin |
| 721 | Polyphenol | Copper | Mancozeb | | | benzovindiflupyr | Fenpropidin |
| 722 | Polyphenol | Copper | Mancozeb | | | bixafen | Fenpropidin |
| 723 | Polyphenol | Copper | Mancozeb | | | Fluindapyr | Fenpropidin |
| 724 | Polyphenol | Copper | Mancozeb | | | fluxapyroxad | Fenpropidin |
| 725 | Polyphenol | Copper | Mancozeb | | | Inpyrfluxam | Fenpropidin |
| 726 | Polyphenol | Copper | Mancozeb | cyproconazole | | Adepidyn | |
| 727 | Polyphenol | Copper | Mancozeb | difenoconazole | | Adepidyn | |
| 728 | Polyphenol | Copper | Mancozeb | flutriafol | | Adepidyn | |
| 729 | Polyphenol | Copper | Mancozeb | flutriafol | | Adepidyn | |
| 730 | Polyphenol | Copper | Mancozeb | flutriafol | | Adepidyn | |
| 731 | Polyphenol | Copper | Mancozeb | mefentrifluconazole | | Adepidyn | |
| 732 | Polyphenol | Copper | Mancozeb | prothioconazole | | Adepidyn | |
| 733 | Polyphenol | Copper | Mancozeb | tebuconazole | | Adepidyn | |
| 734 | Polyphenol | Copper | Mancozeb | tetraconazole | | Adepidyn | |
| 735 | Polyphenol | Copper | Mancozeb | cyproconazole | | benzovindiflupyr | |
| 736 | Polyphenol | Copper | Mancozeb | difenoconazole | | benzovindiflupyr | |
| 737 | Polyphenol | Copper | Mancozeb | flutriafol | | benzovindiflupyr | |
| 738 | Polyphenol | Copper | Mancozeb | mefentrifluconazole | | benzovindiflupyr | |
| 739 | Polyphenol | Copper | Mancozeb | prothioconazole | | benzovindiflupyr | |
| 740 | Polyphenol | Copper | Mancozeb | tebuconazole | | benzovindiflupyr | |
| 741 | Polyphenol | Copper | Mancozeb | tetraconazole | | benzovindiflupyr | |
| 742 | Polyphenol | Copper | Mancozeb | cyproconazole | | bixafen | |
| 743 | Polyphenol | Copper | Mancozeb | difenoconazole | | bixafen | |
| 744 | Polyphenol | Copper | Mancozeb | flutriafol | | bixafen | |
| 745 | Polyphenol | Copper | Mancozeb | mefentrifluconazole | | bixafen | |
| 746 | Polyphenol | Copper | Mancozeb | prothioconazole | | bixafen | |
| 747 | Polyphenol | Copper | Mancozeb | tebuconazole | | bixafen | |
| 748 | Polyphenol | Copper | Mancozeb | tetraconazole | | bixafen | |
| 749 | Polyphenol | Copper | Mancozeb | cyproconazole | | Fluindapyr | |
| 750 | Polyphenol | Copper | Mancozeb | difenoconazole | | Fluindapyr | |
| 751 | Polyphenol | Copper | Mancozeb | mefentrifluconazole | | Fluindapyr | |
| 752 | Polyphenol | Copper | Mancozeb | prothioconazole | | Fluindapyr | |
| 753 | Polyphenol | Copper | Mancozeb | tebuconazole | | Fluindapyr | |
| 754 | Polyphenol | Copper | Mancozeb | tetraconazole | | Fluindapyr | |
| 755 | Polyphenol | Copper | Mancozeb | cyproconazole | | fluxapyroxad | |
| 756 | Polyphenol | Copper | Mancozeb | difenoconazole | | fluxapyroxad | |
| 757 | Polyphenol | Copper | Mancozeb | flutriafol | | fluxapyroxad | |
| 758 | Polyphenol | Copper | Mancozeb | mefentrifluconazole | | fluxapyroxad | |
| 759 | Polyphenol | Copper | Mancozeb | prothioconazole | | fluxapyroxad | |
| 760 | Polyphenol | Copper | Mancozeb | tebuconazole | | fluxapyroxad | |
| 761 | Polyphenol | Copper | Mancozeb | tetraconazole | | fluxapyroxad | |
| 762 | Polyphenol | Copper | Mancozeb | cyproconazole | | Inpyrfluxam | |
| 763 | Polyphenol | Copper | Mancozeb | difenoconazole | | Inpyrfluxam | |
| 764 | Polyphenol | Copper | Mancozeb | flutriafol | | Inpyrfluxam | |
| 765 | Polyphenol | Copper | Mancozeb | mefentrifluconazole | | Inpyrfluxam | |
| 766 | Polyphenol | Copper | Mancozeb | prothioconazole | | Inpyrfluxam | |
| 767 | Polyphenol | Copper | Mancozeb | tebuconazole | | Inpyrfluxam | |
| 768 | Polyphenol | Copper | Mancozeb | tetraconazole | | Inpyrfluxam | |
| 769 | Polyphenol | | Mancozeb | | azoxystrobin | Adepidyn | Fenpropidin |
| 770 | Polyphenol | | Mancozeb | | azoxystrobin | benzovindiflupyr | Fenpropidin |
| 771 | Polyphenol | | Mancozeb | | azoxystrobin | bixafen | Fenpropidin |
| 772 | Polyphenol | | Mancozeb | | azoxystrobin | Fluindapyr | Fenpropidin |
| 773 | Polyphenol | | Mancozeb | | azoxystrobin | fluxapyroxad | Fenpropidin |
| 774 | Polyphenol | | Mancozeb | | azoxystrobin | Inpyrfluxam | Fenpropidin |
| 775 | Polyphenol | | Mancozeb | | azoxystrobin | Adepidyn | Fenpropimorph |
| 776 | Polyphenol | | Mancozeb | | azoxystrobin | benzovindiflupyr | Fenpropimorph |
| 777 | Polyphenol | | Mancozeb | | azoxystrobin | bixafen | Fenpropimorph |
| 778 | Polyphenol | | Mancozeb | | azoxystrobin | Fluindapyr | Fenpropimorph |
| 779 | Polyphenol | | Mancozeb | | azoxystrobin | fluxapyroxad | Fenpropimorph |
| 780 | Polyphenol | | Mancozeb | | azoxystrobin | Inpyrfluxam | Fenpropimorph |
| 781 | Polyphenol | | Mancozeb | | azoxystrobin | Adepidyn | |
| 782 | Polyphenol | | Mancozeb | | azoxystrobin | benzovindiflupyr | |
| 783 | Polyphenol | | Mancozeb | | azoxystrobin | Bixafen | |
| 784 | Polyphenol | | Mancozeb | | azoxystrobin | Fluindapyr | |
| 785 | Polyphenol | | Mancozeb | | azoxystrobin | fluxapyroxad | |
| 786 | Polyphenol | | Mancozeb | | azoxystrobin | Inpyrfluxam | |
| 787 | Polyphenol | | Mancozeb | cyproconazole | azoxystrobin | | |
| 788 | Polyphenol | | Mancozeb | difenoconazole | azoxystrobin | | |
| 789 | Polyphenol | | Mancozeb | flutriafol | azoxystrobin | | |
| 790 | Polyphenol | | Mancozeb | mefentrifluconazole | azoxystrobin | | |
| 791 | Polyphenol | | Mancozeb | prothioconazole | azoxystrobin | | |
| 792 | Polyphenol | | Mancozeb | tebuconazole | azoxystrobin | | |
| 793 | Polyphenol | | Mancozeb | tetraconazole | azoxystrobin | | |
| 794 | Polyphenol | | Mancozeb | | Mandestrobin | Adepidyn | fenpropidin |
| 795 | Polyphenol | | Mancozeb | | Mandestrobin | benzovindiflupyr | fenpropidin |
| 796 | Polyphenol | | Mancozeb | | Mandestrobin | bixafen | fenpropidin |
| 797 | Polyphenol | | Mancozeb | | Mandestrobin | Fluindapyr | fenpropidin |
| 798 | Polyphenol | | Mancozeb | | Mandestrobin | fluxapyroxad | fenpropidin |
| 799 | Polyphenol | | Mancozeb | | Mandestrobin | Inpyrfluxam | fenpropidin |
| 800 | Polyphenol | | Mancozeb | | Mandestrobin | Adepidyn | Fenpropimorph |
| 801 | Polyphenol | | Mancozeb | | Mandestrobin | benzovindiflupyr | Fenpropimorph |
| 802 | Polyphenol | | Mancozeb | | Mandestrobin | bixafen | Fenpropimorph |
| 803 | Polyphenol | | Mancozeb | | Mandestrobin | Fluindapyr | Fenpropimorph |
| 804 | Polyphenol | | Mancozeb | | Mandestrobin | fluxapyroxad | Fenpropimorph |
| 805 | Polyphenol | | Mancozeb | | Mandestrobin | Inpyrfluxam | Fenpropimorph |
| 806 | Polyphenol | | Mancozeb | | Mandestrobin | | Fenpropimorph |
| 807 | Polyphenol | | Mancozeb | | Mandestrobin | | Fenpropidin |
| 808 | Polyphenol | | Mancozeb | | Mandestrobin | Adepidyn | |
| 809 | Polyphenol | | Mancozeb | | Mandestrobin | benzovindiflupyr | |
| 810 | Polyphenol | | Mancozeb | | Mandestrobin | bixafen | |
| 811 | Polyphenol | | Mancozeb | | Mandestrobin | Fluindapyr | |
| 812 | Polyphenol | | Mancozeb | | Mandestrobin | fluxapyroxad | |
| 813 | Polyphenol | | Mancozeb | | Mandestrobin | Inpyrfluxam | |
| 814 | Polyphenol | | Mancozeb | cyproconazole | Mandestrobin | | |
| 815 | Polyphenol | | Mancozeb | difenoconazole | Mandestrobin | | |
| 816 | Polyphenol | | Mancozeb | flutriafol | Mandestrobin | | |
| 817 | Polyphenol | | Mancozeb | mefentrifluconazole | Mandestrobin | | |
| 818 | Polyphenol | | Mancozeb | prothioconazole | Mandestrobin | | |
| 819 | Polyphenol | | Mancozeb | tebuconazole | Mandestrobin | | |
| 820 | Polyphenol | | Mancozeb | tetraconazole | Mandestrobin | | |
| 821 | Polyphenol | | Mancozeb | | Metyltetraprole | Adepidyn | fenpropidin |
| 822 | Polyphenol | | Mancozeb | | Metyltetraprole | benzovindiflupyr | fenpropidin |
| 823 | Polyphenol | | Mancozeb | | Metyltetraprole | bixafen | fenpropidin |
| 824 | Polyphenol | | Mancozeb | | Metyltetraprole | Fluindapyr | fenpropidin |
| 825 | Polyphenol | | Mancozeb | | Metyltetraprole | fluxapyroxad | fenpropidin |
| 826 | Polyphenol | | Mancozeb | | Metyltetraprole | Inpyrfluxam | fenpropidin |
| 827 | Polyphenol | | Mancozeb | | Metyltetraprole | Adepidyn | Fenpropimorph |
| 828 | Polyphenol | | Mancozeb | | Metyltetraprole | benzovindiflupyr | Fenpropimorph |
| 829 | Polyphenol | | Mancozeb | | Metyltetraprole | bixafen | Fenpropimorph |
| 830 | Polyphenol | | Mancozeb | | Metyltetraprole | Fluindapyr | Fenpropimorph |
| 831 | Polyphenol | | Mancozeb | | Metyltetraprole | fluxapyroxad | Fenpropimorph |
| 832 | Polyphenol | | Mancozeb | | Metyltetraprole | Inpyrfluxam | Fenpropimorph |
| 833 | Polyphenol | | Mancozeb | | Metyltetraprole | | Fenpropimorph |
| 834 | Polyphenol | | Mancozeb | | Metyltetraprole | | Fenpropidin |
| 835 | Polyphenol | | Mancozeb | | Metyltetraprole | Adepidyn | |
| 836 | Polyphenol | | Mancozeb | | Metyltetraprole | benzovindiflupyr | |
| 837 | Polyphenol | | Mancozeb | | Metyltetraprole | bixafen | |
| 838 | Polyphenol | | Mancozeb | | Metyltetraprole | Fluindapyr | |
| 839 | Polyphenol | | Mancozeb | | Metyltetraprole | fluxapyroxad | |
| 840 | Polyphenol | | Mancozeb | | Metyltetraprole | Inpyrfluxam | |
| 841 | Polyphenol | | Mancozeb | cyproconazole | Metyltetraprole | | |
| 842 | Polyphenol | | Mancozeb | difenoconazole | Metyltetraprole | | |
| 843 | Polyphenol | | Mancozeb | flutriafol | Metyltetraprole | | |
| 844 | Polyphenol | | Mancozeb | mefentrifluconazole | Metyltetraprole | | |
| 845 | Polyphenol | | Mancozeb | prothioconazole | Metyltetraprole | | |
| 846 | Polyphenol | | Mancozeb | tebuconazole | Metyltetraprole | | |
| 847 | Polyphenol | | Mancozeb | tetraconazole | Metyltetraprole | | |
| 848 | Polyphenol | | Mancozeb | | metominostrobin | Adepidyn | fenpropidin |
| 849 | Polyphenol | | Mancozeb | | metominostrobin | benzovindiflupyr | fenpropidin |
| 850 | Polyphenol | | Mancozeb | | metominostrobin | bixafen | fenpropidin |
| 851 | Polyphenol | | Mancozeb | | metominostrobin | Fluindapyr | fenpropidin |
| 852 | Polyphenol | | Mancozeb | | metominostrobin | fluxapyroxad | fenpropidin |
| 853 | Polyphenol | | Mancozeb | | metominostrobin | Inpyrfluxam | fenpropidin |
| 854 | Polyphenol | | Mancozeb | | metominostrobin | Adepidyn | Fenpropimorph |
| 855 | Polyphenol | | Mancozeb | | metominostrobin | benzovindiflupyr | Fenpropimorph |
| 856 | Polyphenol | | Mancozeb | | metominostrobin | bixafen | Fenpropimorph |
| 857 | Polyphenol | | Mancozeb | | metominostrobin | Fluindapyr | Fenpropimorph |
| 858 | Polyphenol | | Mancozeb | | metominostrobin | fluxapyroxad | Fenpropimorph |
| 859 | Polyphenol | | Mancozeb | | metominostrobin | Inpyrfluxam | Fenpropimorph |
| 860 | Polyphenol | | Mancozeb | | metominostrobin | | Fenpropimorph |
| 861 | Polyphenol | | Mancozeb | | metominostrobin | | Fenpropidin |
| 862 | Polyphenol | | Mancozeb | | metominostrobin | Adepidyn | |
| 863 | Polyphenol | | Mancozeb | | metominostrobin | benzovindiflupyr | |
| 864 | Polyphenol | | Mancozeb | | metominostrobin | bixafen | |
| 865 | Polyphenol | | Mancozeb | | metominostrobin | Fluindapyr | |
| 866 | Polyphenol | | Mancozeb | | metominostrobin | fluxapyroxad | |
| 867 | Polyphenol | | Mancozeb | | metominostrobin | Inpyrfluxam | |
| 868 | Polyphenol | | Mancozeb | cyproconazole | metominostrobin | | |
| 869 | Polyphenol | | Mancozeb | difenoconazole | metominostrobin | | |
| 870 | Polyphenol | | Mancozeb | flutriafol | metominostrobin | | |
| 871 | Polyphenol | | Mancozeb | mefentrifluconazole | metominostrobin | | |
| 872 | Polyphenol | | Mancozeb | prothioconazole | metominostrobin | | |
| 873 | Polyphenol | | Mancozeb | tebuconazole | metominostrobin | | |
| 874 | Polyphenol | | Mancozeb | tetraconazole | metominostrobin | | |
| 875 | Polyphenol | | Mancozeb | | picoxystrobin | Adepidyn | Fenpropidin |
| 876 | Polyphenol | | Mancozeb | | picoxystrobin | benzovindiflupyr | Fenpropidin |
| 877 | Polyphenol | | Mancozeb | | picoxystrobin | bixafen | Fenpropidin |
| 878 | Polyphenol | | Mancozeb | | picoxystrobin | Fluindapyr | Fenpropidin |
| 879 | Polyphenol | | Mancozeb | | picoxystrobin | fluxapyroxad | Fenpropidin |
| 880 | Polyphenol | | Mancozeb | | picoxystrobin | Inpyrfluxam | Fenpropidin |
| 881 | Polyphenol | | Mancozeb | | picoxystrobin | Adepidyn | Fenpropimorph |
| 882 | Polyphenol | | Mancozeb | | picoxystrobin | benzovindiflupyr | Fenpropimorph |
| 883 | Polyphenol | | Mancozeb | | picoxystrobin | bixafen | Fenpropimorph |
| 884 | Polyphenol | | Mancozeb | | picoxystrobin | Fluindapyr | Fenpropimorph |
| 885 | Polyphenol | | Mancozeb | | picoxystrobin | fluxapyroxad | Fenpropimorph |
| 886 | Polyphenol | | Mancozeb | | picoxystrobin | Inpyrfluxam | Fenpropimorph |
| 887 | Polyphenol | | Mancozeb | | picoxystrobin | | Fenpropimorph |
| 888 | Polyphenol | | Mancozeb | | picoxystrobin | | Fenpropidin |
| 889 | Polyphenol | | Mancozeb | | picoxystrobin | Adepidyn | |
| 890 | Polyphenol | | Mancozeb | | picoxystrobin | benzovindiflupyr | |
| 891 | Polyphenol | | Mancozeb | | picoxystrobin | bixafen | |
| 892 | Polyphenol | | Mancozeb | | picoxystrobin | Fluindapyr | |
| 893 | Polyphenol | | Mancozeb | | picoxystrobin | fluxapyroxad | |
| 894 | Polyphenol | | Mancozeb | | picoxystrobin | Inpyrfluxam | |
| 895 | Polyphenol | | Mancozeb | cyproconazole | picoxystrobin | | |
| 896 | Polyphenol | | Mancozeb | difenoconazole | picoxystrobin | | |
| 897 | Polyphenol | | Mancozeb | flutriafol | picoxystrobin | | |
| 898 | Polyphenol | | Mancozeb | mefentrifluconazole | picoxystrobin | | |
| 899 | Polyphenol | | Mancozeb | prothioconazole | picoxystrobin | | |
| 900 | Polyphenol | | Mancozeb | tebuconazole | picoxystrobin | | |
| 901 | Polyphenol | | Mancozeb | tetraconazole | picoxystrobin | | |
| 902 | Polyphenol | | Mancozeb | | Pyraclostrobin | Adepidyn | fenpropidin |
| 903 | Polyphenol | | Mancozeb | | Pyraclostrobin | benzovindiflupyr | fenpropidin |
| 904 | Polyphenol | | Mancozeb | | Pyraclostrobin | bixafen | fenpropidin |
| 905 | Polyphenol | | Mancozeb | | Pyraclostrobin | Fluindapyr | fenpropidin |
| 906 | Polyphenol | | Mancozeb | | Pyraclostrobin | fluxapyroxad | fenpropidin |
| 907 | Polyphenol | | Mancozeb | | Pyraclostrobin | Inpyrfluxam | fenpropidin |
| 908 | Polyphenol | | Mancozeb | | Pyraclostrobin | Adepidyn | Fenpropimorph |
| 909 | Polyphenol | | Mancozeb | | Pyraclostrobin | benzovindiflupyr | Fenpropimorph |
| 910 | Polyphenol | | Mancozeb | | Pyraclostrobin | bixafen | Fenpropimorph |
| 911 | Polyphenol | | Mancozeb | | Pyraclostrobin | Fluindapyr | Fenpropimorph |
| 912 | Polyphenol | | Mancozeb | | Pyraclostrobin | fluxapyroxad | Fenpropimorph |
| 913 | Polyphenol | | Mancozeb | | Pyraclostrobin | Inpyrfluxam | Fenpropimorph |
| 914 | Polyphenol | | Mancozeb | | Pyraclostrobin | | Fenpropimorph |
| 915 | Polyphenol | | Mancozeb | | Pyraclostrobin | | Fenpropidin |
| 916 | Polyphenol | | Mancozeb | | Pyraclostrobin | Adepidyn | |
| 917 | Polyphenol | | Mancozeb | | Pyraclostrobin | benzovindiflupyr | |
| 918 | Polyphenol | | Mancozeb | | Pyraclostrobin | bixafen | |
| 919 | Polyphenol | | Mancozeb | | Pyraclostrobin | Fluindapyr | |
| 920 | Polyphenol | | Mancozeb | | Pyraclostrobin | fluxapyroxad | |
| 921 | Polyphenol | | Mancozeb | | Pyraclostrobin | Inpyrfluxam | |
| 922 | Polyphenol | | Mancozeb | cyproconazole | Pyraclostrobin | | |
| 923 | Polyphenol | | Mancozeb | difenoconazole | Pyraclostrobin | | |
| 924 | Polyphenol | | Mancozeb | flutriafol | Pyraclostrobin | | |
| 925 | Polyphenol | | Mancozeb | mefentrifluconazole | Pyraclostrobin | | |
| 926 | Polyphenol | | Mancozeb | prothioconazole | Pyraclostrobin | | |
| 927 | Polyphenol | | Mancozeb | tebuconazole | Pyraclostrobin | | |
| 928 | Polyphenol | | Mancozeb | tetraconazole | Pyraclostrobin | | |
| 929 | Polyphenol | | Mancozeb | | trifloxystrobin | Adepidyn | fenpropidin |
| 930 | Polyphenol | | Mancozeb | | trifloxystrobin | benzovindiflupyr | fenpropidin |
| 931 | Polyphenol | | Mancozeb | | trifloxystrobin | bixafen | fenpropidin |
| 932 | Polyphenol | | Mancozeb | | trifloxystrobin | Fluindapyr | fenpropidin |
| 933 | Polyphenol | | Mancozeb | | trifloxystrobin | fluxapyroxad | fenpropidin |
| 934 | Polyphenol | | Mancozeb | | trifloxystrobin | Inpyrfluxam | fenpropidin |
| 935 | Polyphenol | | Mancozeb | | trifloxystrobin | Adepidyn | Fenpropimorph |
| 936 | Polyphenol | | Mancozeb | | trifloxystrobin | benzovindiflupyr | Fenpropimorph |
| 937 | Polyphenol | | Mancozeb | | trifloxystrobin | bixafen | Fenpropimorph |
| 938 | Polyphenol | | Mancozeb | | trifloxystrobin | Fluindapyr | Fenpropimorph |
| 939 | Polyphenol | | Mancozeb | | trifloxystrobin | fluxapyroxad | Fenpropimorph |
| 940 | Polyphenol | | Mancozeb | | trifloxystrobin | Inpyrfluxam | Fenpropimorph |
| 941 | Polyphenol | | Mancozeb | | trifloxystrobin | | Fenpropimorph |
| 942 | Polyphenol | | Mancozeb | | trifloxystrobin | | Fenpropidin |
| 943 | Polyphenol | | Mancozeb | | trifloxystrobin | Adepidyn | |
| 944 | Polyphenol | | Mancozeb | | trifloxystrobin | benzovindiflupyr | |
| 945 | Polyphenol | | Mancozeb | | trifloxystrobin | bixafen | |
| 946 | Polyphenol | | Mancozeb | | trifloxystrobin | Fluindapyr | |
| 947 | Polyphenol | | Mancozeb | | trifloxystrobin | fluxapyroxad | |
| 948 | Polyphenol | | Mancozeb | | trifloxystrobin | Inpyrfluxam | |
| 949 | Polyphenol | | Mancozeb | cyproconazole | trifloxystrobin | | |
| 950 | Polyphenol | | Mancozeb | difenoconazole | trifloxystrobin | | |
| 951 | Polyphenol | | Mancozeb | flutriafol | trifloxystrobin | | |
| 952 | Polyphenol | | Mancozeb | mefentrifluconazole | trifloxystrobin | | |
| 953 | Polyphenol | | Mancozeb | prothioconazole | trifloxystrobin | | |
| 954 | Polyphenol | | Mancozeb | tebuconazole | trifloxystrobin | | |
| 955 | Polyphenol | | Mancozeb | tetraconazole | trifloxystrobin | | |
| 956 | Polyphenol | | Mancozeb | cyproconazole | | | Fenpropidin |
| 957 | Polyphenol | | Mancozeb | difenoconazole | | | Fenpropidin |
| 958 | Polyphenol | | Mancozeb | flutriafol | | | Fenpropidin |
| 959 | Polyphenol | | Mancozeb | mefentrifluconazole | | | Fenpropidin |
| 960 | Polyphenol | | Mancozeb | prothioconazole | | | Fenpropidin |
| 961 | Polyphenol | | Mancozeb | tebuconazole | | | Fenpropidin |
| 962 | Polyphenol | | Mancozeb | tetraconazole | | | Fenpropidin |
| 963 | Polyphenol | | Mancozeb | cyproconazole | | | Fenpropimorph |
| 964 | Polyphenol | | Mancozeb | difenoconazole | | | Fenpropimorph |
| 965 | Polyphenol | | Mancozeb | flutriafol | | | Fenpropimorph |
| 966 | Polyphenol | | Mancozeb | mefentrifluconazole | | | Fenpropimorph |
| 967 | Polyphenol | | Mancozeb | prothioconazole | | | Fenpropimorph |
| 968 | Polyphenol | | Mancozeb | tebuconazole | | | Fenpropimorph |
| 969 | Polyphenol | | Mancozeb | tetraconazole | | | Fenpropimorph |
| 970 | Polyphenol | | Mancozeb | | | Adepidyn | Fenpropimorph |
| 971 | Polyphenol | | Mancozeb | | | benzovindiflupyr | Fenpropimorph |
| 972 | Polyphenol | | Mancozeb | | | bixafen | Fenpropimorph |
| 973 | Polyphenol | | Mancozeb | | | Fluindapyr | Fenpropimorph |
| 974 | Polyphenol | | Mancozeb | | | fluxapyroxad | Fenpropimorph |
| 975 | Polyphenol | | Mancozeb | | | Inpyrfluxam | Fenpropimorph |
| 976 | Polyphenol | | Mancozeb | | | Adepidyn | Fenpropidin |
| 977 | Polyphenol | | Mancozeb | | | benzovindiflupyr | Fenpropidin |
| 978 | Polyphenol | | Mancozeb | | | bixafen | Fenpropidin |
| 979 | Polyphenol | | Mancozeb | | | Fluindapyr | Fenpropidin |
| 980 | Polyphenol | | Mancozeb | | | fluxapyroxad | Fenpropidin |
| 981 | Polyphenol | | Mancozeb | | | Inpyrfluxam | Fenpropidin |
| 982 | Polyphenol | | Mancozeb | cyproconazole | | Adepidyn | |
| 983 | Polyphenol | | Mancozeb | difenoconazole | | Adepidyn | |
| 984 | Polyphenol | | Mancozeb | flutriafol | | Adepidyn | |
| 985 | Polyphenol | | Mancozeb | flutriafol | | Adepidyn | |
| 986 | Polyphenol | | Mancozeb | flutriafol | | Adepidyn | |
| 987 | Polyphenol | | Mancozeb | mefentrifluconazole | | Adepidyn | |
| 988 | Polyphenol | | Mancozeb | prothioconazole | | Adepidyn | |
| 989 | Polyphenol | | Mancozeb | tebuconazole | | Adepidyn | |
| 990 | Polyphenol | | Mancozeb | tetraconazole | | Adepidyn | |
| 991 | Polyphenol | | Mancozeb | cyproconazole | | benzovindiflupyr | |
| 992 | Polyphenol | | Mancozeb | difenoconazole | | benzovindiflupyr | |
| 993 | Polyphenol | | Mancozeb | flutriafol | | benzovindiflupyr | |
| 994 | Polyphenol | | Mancozeb | mefentrifluconazole | | benzovindiflupyr | |
| 995 | Polyphenol | | Mancozeb | prothioconazole | | benzovindiflupyr | |
| 996 | Polyphenol | | Mancozeb | tebuconazole | | benzovindiflupyr | |
| 997 | Polyphenol | | Mancozeb | tetraconazole | | benzovindiflupyr | |
| 998 | Polyphenol | | Mancozeb | cyproconazole | | bixafen | |
| 999 | Polyphenol | | Mancozeb | difenoconazole | | bixafen | |
| 1000 | Polyphenol | | Mancozeb | flutriafol | | bixafen | |
| 1001 | Polyphenol | | Mancozeb | mefentrifluconazole | | bixafen | |
| 1002 | Polyphenol | | Mancozeb | prothioconazole | | bixafen | |
| 1003 | Polyphenol | | Mancozeb | tebuconazole | | bixafen | |
| 1004 | Polyphenol | | Mancozeb | tetraconazole | | bixafen | |
| 1005 | Polyphenol | | Mancozeb | cyproconazole | | Fluindapyr | |
| 1006 | Polyphenol | | Mancozeb | difenoconazole | | Fluindapyr | |
| 1007 | Polyphenol | | Mancozeb | mefentrifluconazole | | Fluindapyr | |
| 1008 | Polyphenol | | Mancozeb | prothioconazole | | Fluindapyr | |
| 1009 | Polyphenol | | Mancozeb | tebuconazole | | Fluindapyr | |
| 1010 | Polyphenol | | Mancozeb | tetraconazole | | Fluindapyr | |
| 1011 | Polyphenol | | Mancozeb | cyproconazole | | fluxapyroxad | |
| 1012 | Polyphenol | | Mancozeb | difenoconazole | | fluxapyroxad | |
| 1013 | Polyphenol | | Mancozeb | flutriafol | | fluxapyroxad | |
| 1014 | Polyphenol | | Mancozeb | mefentrifluconazole | | fluxapyroxad | |
| 1015 | Polyphenol | | Mancozeb | prothioconazole | | fluxapyroxad | |
| 1016 | Polyphenol | | Mancozeb | tebuconazole | | fluxapyroxad | |
| 1017 | Polyphenol | | Mancozeb | tetraconazole | | fluxapyroxad | |
| 1018 | Polyphenol | | Mancozeb | cyproconazole | | Inpyrfluxam | |
| 1019 | Polyphenol | | Mancozeb | difenoconazole | | Inpyrfluxam | |
| 1020 | Polyphenol | | Mancozeb | flutriafol | | Inpyrfluxam | |
| 1021 | Polyphenol | | Mancozeb | mefentrifluconazole | | Inpyrfluxam | |
| 1022 | Polyphenol | | Mancozeb | prothioconazole | | Inpyrfluxam | |
| 1023 | Polyphenol | | Mancozeb | tebuconazole | | Inpyrfluxam | |
| 1024 | Polyphenol | | Mancozeb | tetraconazole | | Inpyrfluxam | |
| 1025 | Polyphenol | | Chlorothalonil | | azoxystrobin | Adepidyn | Fenpropidin |
| 1026 | Polyphenol | | Chlorothalonil | | azoxystrobin | benzovindiflupyr | Fenpropidin |
| 1027 | Polyphenol | | Chlorothalonil | | azoxystrobin | bixafen | Fenpropidin |
| 1028 | Polyphenol | | Chlorothalonil | | azoxystrobin | Fluindapyr | Fenpropidin |
| 1029 | Polyphenol | | Chlorothalonil | | azoxystrobin | fluxapyroxad | Fenpropidin |
| 1030 | Polyphenol | | Chlorothalonil | | azoxystrobin | Inpyrfluxam | Fenpropidin |
| 1031 | Polyphenol | | Chlorothalonil | | azoxystrobin | Adepidyn | Fenpropimorph |
| 1032 | Polyphenol | | Chlorothalonil | | azoxystrobin | benzovindiflupyr | Fenpropimorph |
| 1033 | Polyphenol | | Chlorothalonil | | azoxystrobin | bixafen | Fenpropimorph |
| 1034 | Polyphenol | | Chlorothalonil | | azoxystrobin | Fluindapyr | Fenpropimorph |
| 1035 | Polyphenol | | Chlorothalonil | | azoxystrobin | fluxapyroxad | Fenpropimorph |
| 1036 | Polyphenol | | Chlorothalonil | | azoxystrobin | Inpyrfluxam | Fenpropimorph |
| 1037 | Polyphenol | | Chlorothalonil | | azoxystrobin | Adepidyn | |
| 1038 | Polyphenol | | Chlorothalonil | | azoxystrobin | benzovindiflupyr | |
| 1039 | Polyphenol | | Chlorothalonil | | azoxystrobin | bixafen | |
| 1040 | Polyphenol | | Chlorothalonil | | azoxystrobin | Fluindapyr | |
| 1041 | Polyphenol | | Chlorothalonil | | azoxystrobin | fluxapyroxad | |
| 1042 | Polyphenol | | Chlorothalonil | | azoxystrobin | Inpyrfluxam | |
| 1043 | Polyphenol | | Chlorothalonil | cyproconazole | azoxystrobin | | |
| 1044 | Polyphenol | | Chlorothalonil | difenoconazole | azoxystrobin | | |
| 1045 | Polyphenol | | Chlorothalonil | flutriafol | azoxystrobin | | |
| 1046 | Polyphenol | | Chlorothalonil | mefentrifluconazole | azoxystrobin | | |
| 1047 | Polyphenol | | Chlorothalonil | prothioconazole | azoxystrobin | | |
| 1048 | Polyphenol | | Chlorothalonil | tebuconazole | azoxystrobin | | |
| 1049 | Polyphenol | | Chlorothalonil | tetraconazole | azoxystrobin | | |
| 1050 | Polyphenol | | Chlorothalonil | | Mandestrobin | Adepidyn | fenpropidin |
| 1051 | Polyphenol | | Chlorothalonil | | Mandestrobin | benzovindiflupyr | fenpropidin |
| 1052 | Polyphenol | | Chlorothalonil | | Mandestrobin | bixafen | fenpropidin |
| 1053 | Polyphenol | | Chlorothalonil | | Mandestrobin | Fluindapyr | fenpropidin |
| 1054 | Polyphenol | | Chlorothalonil | | Mandestrobin | fluxapyroxad | fenpropidin |
| 1055 | Polyphenol | | Chlorothalonil | | Mandestrobin | Inpyrfluxam | fenpropidin |
| 1056 | Polyphenol | | Chlorothalonil | | Mandestrobin | Adepidyn | Fenpropimorph |
| 1057 | Polyphenol | | Chlorothalonil | | Mandestrobin | benzovindiflupyr | Fenpropimorph |
| 1058 | Polyphenol | | Chlorothalonil | | Mandestrobin | bixafen | Fenpropimorph |
| 1059 | Polyphenol | | Chlorothalonil | | Mandestrobin | Fluindapyr | Fenpropimorph |
| 1060 | Polyphenol | | Chlorothalonil | | Mandestrobin | fluxapyroxad | Fenpropimorph |
| 1061 | Polyphenol | | Chlorothalonil | | Mandestrobin | Inpyrfluxam | Fenpropimorph |
| 1062 | Polyphenol | | Chlorothalonil | | Mandestrobin | | Fenpropimorph |
| 1063 | Polyphenol | | Chlorothalonil | | Mandestrobin | | Fenpropidin |
| 1064 | Polyphenol | | Chlorothalonil | | Mandestrobin | Adepidyn | |
| 1065 | Polyphenol | | Chlorothalonil | | Mandestrobin | benzovindiflupyr | |
| 1066 | Polyphenol | | Chlorothalonil | | Mandestrobin | bixafen | |
| 1067 | Polyphenol | | Chlorothalonil | | Mandestrobin | Fluindapyr | |
| 1068 | Polyphenol | | Chlorothalonil | | Mandestrobin | fluxapyroxad | |
| 1069 | Polyphenol | | Chlorothalonil | | Mandestrobin | Inpyrfluxam | |
| 1070 | Polyphenol | | Chlorothalonil | cyproconazole | Mandestrobin | | |
| 1071 | Polyphenol | | Chlorothalonil | difenoconazole | Mandestrobin | | |
| 1072 | Polyphenol | | Chlorothalonil | flutriafol | Mandestrobin | | |
| 1073 | Polyphenol | | Chlorothalonil | mefentrifluconazole | Mandestrobin | | |
| 1074 | Polyphenol | | Chlorothalonil | prothioconazole | Mandestrobin | | |
| 1075 | Polyphenol | | Chlorothalonil | tebuconazole | Mandestrobin | | |
| 1076 | Polyphenol | | Chlorothalonil | tetraconazole | Mandestrobin | | |
| 1077 | Polyphenol | | Chlorothalonil | | Metyltetraprole | Adepidyn | fenpropidin |
| 1078 | Polyphenol | | Chlorothalonil | | Metyltetraprole | benzovindiflupyr | fenpropidin |
| 1079 | Polyphenol | | Chlorothalonil | | Metyltetraprole | bixafen | fenpropidin |
| 1080 | Polyphenol | | Chlorothalonil | | Metyltetraprole | Fluindapyr | fenpropidin |
| 1081 | Polyphenol | | Chlorothalonil | | Metyltetraprole | fluxapyroxad | fenpropidin |
| 1082 | Polyphenol | | Chlorothalonil | | Metyltetraprole | Inpyrfluxam | fenpropidin |
| 1083 | Polyphenol | | Chlorothalonil | | Metyltetraprole | Adepidyn | Fenpropimorph |
| 1084 | Polyphenol | | Chlorothalonil | | Metyltetraprole | benzovindiflupyr | Fenpropimorph |
| 1085 | Polyphenol | | Chlorothalonil | | Metyltetraprole | bixafen | Fenpropimorph |
| 1086 | Polyphenol | | Chlorothalonil | | Metyltetraprole | Fluindapyr | Fenpropimorph |
| 1087 | Polyphenol | | Chlorothalonil | | Metyltetraprole | fluxapyroxad | Fenpropimorph |
| 1088 | Polyphenol | | Chlorothalonil | | Metyltetraprole | Inpyrfluxam | Fenpropimorph |
| 1089 | Polyphenol | | Chlorothalonil | | Metyltetraprole | | Fenpropimorph |
| 1090 | Polyphenol | | Chlorothalonil | | Metyltetraprole | | Fenpropidin |
| 1091 | Polyphenol | | Chlorothalonil | | Metyltetraprole | Adepidyn | |
| 1092 | Polyphenol | | Chlorothalonil | | Metyltetraprole | benzovindiflupyr | |
| 1093 | Polyphenol | | Chlorothalonil | | Metyltetraprole | bixafen | |
| 1094 | Polyphenol | | Chlorothalonil | | Metyltetraprole | Fluindapyr | |
| 1095 | Polyphenol | | Chlorothalonil | | Metyltetraprole | fluxapyroxad | |
| 1096 | Polyphenol | | Chlorothalonil | | Metyltetraprole | Inpyrfluxam | |
| 1097 | Polyphenol | | Chlorothalonil | cyproconazole | Metyltetraprole | | |
| 1098 | Polyphenol | | Chlorothalonil | difenoconazole | Metyltetraprole | | |
| 1099 | Polyphenol | | Chlorothalonil | flutriafol | Metyltetraprole | | |
| 1100 | Polyphenol | | Chlorothalonil | mefentrifluconazole | Metyltetraprole | | |
| 1101 | Polyphenol | | Chlorothalonil | prothioconazole | Metyltetraprole | | |
| 1102 | Polyphenol | | Chlorothalonil | tebuconazole | Metyltetraprole | | |
| 1103 | Polyphenol | | Chlorothalonil | tetraconazole | Metyltetraprole | | |
| 1104 | Polyphenol | | Chlorothalonil | | metominostrobin | Adepidyn | fenpropidin |
| 1105 | Polyphenol | | Chlorothalonil | | metominostrobin | benzovindiflupyr | fenpropidin |
| 1106 | Polyphenol | | Chlorothalonil | | metominostrobin | bixafen | fenpropidin |
| 1107 | Polyphenol | | Chlorothalonil | | metominostrobin | Fluindapyr | fenpropidin |
| 1108 | Polyphenol | | Chlorothalonil | | metominostrobin | fluxapyroxad | fenpropidin |
| 1109 | Polyphenol | | Chlorothalonil | | metominostrobin | Inpyrfluxam | fenpropidin |
| 1110 | Polyphenol | | Chlorothalonil | | metominostrobin | Adepidyn | Fenpropimorph |
| 1111 | Polyphenol | | Chlorothalonil | | metominostrobin | benzovindiflupyr | Fenpropimorph |
| 1112 | Polyphenol | | Chlorothalonil | | metominostrobin | bixafen | Fenpropimorph |
| 1113 | Polyphenol | | Chlorothalonil | | metominostrobin | Fluindapyr | Fenpropimorph |
| 1114 | Polyphenol | | Chlorothalonil | | metominostrobin | fluxapyroxad | Fenpropimorph |
| 1115 | Polyphenol | | Chlorothalonil | | metominostrobin | Inpyrfluxam | Fenpropimorph |
| 1116 | Polyphenol | | Chlorothalonil | | metominostrobin | | Fenpropimorph |
| 1117 | Polyphenol | | Chlorothalonil | | metominostrobin | | Fenpropidin |
| 1118 | Polyphenol | | Chlorothalonil | | metominostrobin | Adepidyn | |
| 1119 | Polyphenol | | Chlorothalonil | | metominostrobin | benzovindiflupyr | |
| 1120 | Polyphenol | | Chlorothalonil | | metominostrobin | bixafen | |
| 1121 | Polyphenol | | Chlorothalonil | | metominostrobin | Fluindapyr | |
| 1122 | Polyphenol | | Chlorothalonil | | metominostrobin | fluxapyroxad | |
| 1123 | Polyphenol | | Chlorothalonil | | metominostrobin | Inpyrfluxam | |
| 1124 | Polyphenol | | Chlorothalonil | cyproconazole | metominostrobin | | |
| 1125 | Polyphenol | | Chlorothalonil | difenoconazole | metominostrobin | | |
| 1126 | Polyphenol | | Chlorothalonil | flutriafol | metominostrobin | | |
| 1127 | Polyphenol | | Chlorothalonil | mefentrifluconazole | metominostrobin | | |
| 1128 | Polyphenol | | Chlorothalonil | prothioconazole | metominostrobin | | |
| 1129 | Polyphenol | | Chlorothalonil | tebuconazole | metominostrobin | | |
| 1130 | Polyphenol | | Chlorothalonil | tetraconazole | metominostrobin | | |
| 1131 | Polyphenol | | Chlorothalonil | | picoxystrobin | Adepidyn | Fenpropidin |
| 1132 | Polyphenol | | Chlorothalonil | | picoxystrobin | benzovindiflupyr | Fenpropidin |
| 1133 | Polyphenol | | Chlorothalonil | | picoxystrobin | bixafen | Fenpropidin |
| 1134 | Polyphenol | | Chlorothalonil | | picoxystrobin | Fluindapyr | Fenpropidin |
| 1135 | Polyphenol | | Chlorothalonil | | picoxystrobin | fluxapyroxad | Fenpropidin |
| 1136 | Polyphenol | | Chlorothalonil | | picoxystrobin | Inpyrfluxam | Fenpropidin |
| 1137 | Polyphenol | | Chlorothalonil | | picoxystrobin | Adepidyn | Fenpropimorph |
| 1138 | Polyphenol | | Chlorothalonil | | picoxystrobin | benzovindiflupyr | Fenpropimorph |
| 1139 | Polyphenol | | Chlorothalonil | | picoxystrobin | bixafen | Fenpropimorph |
| 1140 | Polyphenol | | Chlorothalonil | | picoxystrobin | Fluindapyr | Fenpropimorph |
| 1141 | Polyphenol | | Chlorothalonil | | picoxystrobin | fluxapyroxad | Fenpropimorph |
| 1142 | Polyphenol | | Chlorothalonil | | picoxystrobin | Inpyrfluxam | Fenpropimorph |
| 1143 | Polyphenol | | Chlorothalonil | | picoxystrobin | | Fenpropimorph |
| 1144 | Polyphenol | | Chlorothalonil | | picoxystrobin | | Fenpropidin |
| 1145 | Polyphenol | | Chlorothalonil | | picoxystrobin | Adepidyn | |
| 1146 | Polyphenol | | Chlorothalonil | | picoxystrobin | benzovindiflupyr | |
| 1147 | Polyphenol | | Chlorothalonil | | picoxystrobin | bixafen | |
| 1148 | Polyphenol | | Chlorothalonil | | picoxystrobin | Fluindapyr | |
| 1149 | Polyphenol | | Chlorothalonil | | picoxystrobin | fluxapyroxad | |
| 1150 | Polyphenol | | Chlorothalonil | | picoxystrobin | Inpyrfluxam | |
| 1151 | Polyphenol | | Chlorothalonil | cyproconazole | picoxystrobin | | |
| 1152 | Polyphenol | | Chlorothalonil | difenoconazole | picoxystrobin | | |
| 1153 | Polyphenol | | Chlorothalonil | flutriafol | picoxystrobin | | |
| 1154 | Polyphenol | | Chlorothalonil | mefentrifluconazole | picoxystrobin | | |
| 1155 | Polyphenol | | Chlorothalonil | prothioconazole | picoxystrobin | | |
| 1156 | Polyphenol | | Chlorothalonil | tebuconazole | picoxystrobin | | |
| 1157 | Polyphenol | | Chlorothalonil | tetraconazole | picoxystrobin | | |
| 1158 | Polyphenol | | Chlorothalonil | | Pyraclostrobin | Adepidyn | fenpropidin |
| 1159 | Polyphenol | | Chlorothalonil | | Pyraclostrobin | benzovindiflupyr | fenpropidin |
| 1160 | Polyphenol | | Chlorothalonil | | Pyraclostrobin | bixafen | fenpropidin |
| 1161 | Polyphenol | | Chlorothalonil | | Pyraclostrobin | Fluindapyr | fenpropidin |
| 1162 | Polyphenol | | Chlorothalonil | | Pyraclostrobin | fluxapyroxad | fenpropidin |
| 1163 | Polyphenol | | Chlorothalonil | | Pyraclostrobin | Inpyrfluxam | fenpropidin |
| 1164 | Polyphenol | | Chlorothalonil | | Pyraclostrobin | Adepidyn | Fenpropimorph |
| 1165 | Polyphenol | | Chlorothalonil | | Pyraclostrobin | benzovindiflupyr | Fenpropimorph |
| 1166 | Polyphenol | | Chlorothalonil | | Pyraclostrobin | bixafen | Fenpropimorph |
| 1167 | Polyphenol | | Chlorothalonil | | Pyraclostrobin | Fluindapyr | Fenpropimorph |
| 1168 | Polyphenol | | Chlorothalonil | | Pyraclostrobin | fluxapyroxad | Fenpropimorph |
| 1169 | Polyphenol | | Chlorothalonil | | Pyraclostrobin | Inpyrfluxam | Fenpropimorph |
| 1170 | Polyphenol | | Chlorothalonil | | Pyraclostrobin | | Fenpropimorph |
| 1171 | Polyphenol | | Chlorothalonil | | Pyraclostrobin | | Fenpropidin |
| 1172 | Polyphenol | | Chlorothalonil | | Pyraclostrobin | Adepidyn | |
| 1173 | Polyphenol | | Chlorothalonil | | Pyraclostrobin | benzovindiflupyr | |
| 1174 | Polyphenol | | Chlorothalonil | | Pyraclostrobin | bixafen | |
| 1175 | Polyphenol | | Chlorothalonil | | Pyraclostrobin | Fluindapyr | |
| 1176 | Polyphenol | | Chlorothalonil | | Pyraclostrobin | fluxapyroxad | |
| 1177 | Polyphenol | | Chlorothalonil | | Pyraclostrobin | Inpyrfluxam | |
| 1178 | Polyphenol | | Chlorothalonil | cyproconazole | Pyraclostrobin | | |
| 1179 | Polyphenol | | Chlorothalonil | difenoconazole | Pyraclostrobin | | |
| 1180 | Polyphenol | | Chlorothalonil | flutriafol | Pyraclostrobin | | |
| 1181 | Polyphenol | | Chlorothalonil | mefentrifluconazole | Pyraclostrobin | | |
| 1182 | Polyphenol | | Chlorothalonil | prothioconazole | Pyraclostrobin | | |
| 1183 | Polyphenol | | Chlorothalonil | tebuconazole | Pyraclostrobin | | |
| 1184 | Polyphenol | | Chlorothalonil | tetraconazole | Pyraclostrobin | | |
| 1185 | Polyphenol | | Chlorothalonil | | trifloxystrobin | Adepidyn | fenpropidin |
| 1186 | Polyphenol | | Chlorothalonil | | trifloxystrobin | benzovindiflupyr | fenpropidin |
| 1187 | Polyphenol | | Chlorothalonil | | trifloxystrobin | bixafen | fenpropidin |
| 1188 | Polyphenol | | Chlorothalonil | | trifloxystrobin | Fluindapyr | fenpropidin |
| 1189 | Polyphenol | | Chlorothalonil | | trifloxystrobin | fluxapyroxad | fenpropidin |
| 1190 | Polyphenol | | Chlorothalonil | | trifloxystrobin | Inpyrfluxam | fenpropidin |
| 1191 | Polyphenol | | Chlorothalonil | | trifloxystrobin | Adepidyn | Fenpropimorph |
| 1192 | Polyphenol | | Chlorothalonil | | trifloxystrobin | benzovindiflupyr | Fenpropimorph |
| 1193 | Polyphenol | | Chlorothalonil | | trifloxystrobin | bixafen | Fenpropimorph |
| 1194 | Polyphenol | | Chlorothalonil | | trifloxystrobin | Fluindapyr | Fenpropimorph |
| 1195 | Polyphenol | | Chlorothalonil | | trifloxystrobin | fluxapyroxad | Fenpropimorph |
| 1196 | Polyphenol | | Chlorothalonil | | trifloxystrobin | Inpyrfluxam | Fenpropimorph |
| 1197 | Polyphenol | | Chlorothalonil | | trifloxystrobin | | Fenpropimorph |
| 1198 | Polyphenol | | Chlorothalonil | | trifloxystrobin | | Fenpropidin |
| 1199 | Polyphenol | | Chlorothalonil | | trifloxystrobin | Adepidyn | |
| 1200 | Polyphenol | | Chlorothalonil | | trifloxystrobin | benzovindiflupyr | |
| 1201 | Polyphenol | | Chlorothalonil | | trifloxystrobin | bixafen | |
| 1202 | Polyphenol | | Chlorothalonil | | trifloxystrobin | Fluindapyr | |
| 1203 | Polyphenol | | Chlorothalonil | | trifloxystrobin | fluxapyroxad | |
| 1204 | Polyphenol | | Chlorothalonil | | trifloxystrobin | Inpyrfluxam | |
| 1205 | Polyphenol | | Chlorothalonil | cyproconazole | trifloxystrobin | | |
| 1206 | Polyphenol | | Chlorothalonil | difenoconazole | trifloxystrobin | | |
| 1207 | Polyphenol | | Chlorothalonil | flutriafol | trifloxystrobin | | |
| 1208 | Polyphenol | | Chlorothalonil | mefentrifluconazole | trifloxystrobin | | |
| 1209 | Polyphenol | | Chlorothalonil | prothioconazole | trifloxystrobin | | |
| 1210 | Polyphenol | | Chlorothalonil | tebuconazole | trifloxystrobin | | |
| 1211 | Polyphenol | | Chlorothalonil | tetraconazole | trifloxystrobin | | |
| 1212 | Polyphenol | | Chlorothalonil | cyproconazole | | | Fenpropidin |
| 1213 | Polyphenol | | Chlorothalonil | difenoconazole | | | Fenpropidin |
| 1214 | Polyphenol | | Chlorothalonil | flutriafol | | | Fenpropidin |
| 1215 | Polyphenol | | Chlorothalonil | mefentrifluconazole | | | Fenpropidin |
| 1216 | Polyphenol | | Chlorothalonil | prothioconazole | | | Fenpropidin |
| 1217 | Polyphenol | | Chlorothalonil | tebuconazole | | | Fenpropidin |
| 1218 | Polyphenol | | Chlorothalonil | tetraconazole | | | Fenpropidin |
| 1219 | Polyphenol | | Chlorothalonil | cyproconazole | | | Fenpropimorph |
| 1220 | Polyphenol | | Chlorothalonil | difenoconazole | | | Fenpropimorph |
| 1221 | Polyphenol | | Chlorothalonil | flutriafol | | | Fenpropimorph |
| 1222 | Polyphenol | | Chlorothalonil | mefentrifluconazole | | | Fenpropimorph |
| 1223 | Polyphenol | | Chlorothalonil | prothioconazole | | | Fenpropimorph |
| 1224 | Polyphenol | | Chlorothalonil | tebuconazole | | | Fenpropimorph |
| 1225 | Polyphenol | | Chlorothalonil | tetraconazole | | | Fenpropimorph |
| 1226 | Polyphenol | | Chlorothalonil | | | Adepidyn | Fenpropimorph |
| 1227 | Polyphenol | | Chlorothalonil | | | benzovindiflupyr | Fenpropimorph |
| 1228 | Polyphenol | | Chlorothalonil | | | bixafen | Fenpropimorph |
| 1229 | Polyphenol | | Chlorothalonil | | | Fluindapyr | Fenpropimorph |
| 1230 | Polyphenol | | Chlorothalonil | | | fluxapyroxad | Fenpropimorph |
| 1231 | Polyphenol | | Chlorothalonil | | | Inpyrfluxam | Fenpropimorph |
| 1232 | Polyphenol | | Chlorothalonil | | | Adepidyn | Fenpropidin |
| 1233 | Polyphenol | | Chlorothalonil | | | benzovindiflupyr | Fenpropidin |
| 1234 | Polyphenol | | Chlorothalonil | | | bixafen | Fenpropidin |
| 1235 | Polyphenol | | Chlorothalonil | | | Fluindapyr | Fenpropidin |
| 1236 | Polyphenol | | Chlorothalonil | | | fluxapyroxad | Fenpropidin |
| 1237 | Polyphenol | | Chlorothalonil | | | Inpyrfluxam | Fenpropidin |
| 1238 | Polyphenol | | Chlorothalonil | cyproconazole | | Adepidyn | |
| 1239 | Polyphenol | | Chlorothalonil | difenoconazole | | Adepidyn | |
| 1240 | Polyphenol | | Chlorothalonil | flutriafol | | Adepidyn | |
| 1241 | Polyphenol | | Chlorothalonil | flutriafol | | Adepidyn | |
| 1242 | Polyphenol | | Chlorothalonil | flutriafol | | Adepidyn | |
| 1243 | Polyphenol | | Chlorothalonil | mefentrifluconazole | | Adepidyn | |
| 1244 | Polyphenol | | Chlorothalonil | prothioconazole | | Adepidyn | |
| 1245 | Polyphenol | | Chlorothalonil | tebuconazole | | Adepidyn | |
| 1246 | Polyphenol | | Chlorothalonil | tetraconazole | | Adepidyn | |
| 1247 | Polyphenol | | Chlorothalonil | cyproconazole | | benzovindiflupyr | |
| 1248 | Polyphenol | | Chlorothalonil | difenoconazole | | benzovindiflupyr | |
| 1249 | Polyphenol | | Chlorothalonil | flutriafol | | benzovindiflupyr | |
| 1250 | Polyphenol | | Chlorothalonil | mefentrifluconazole | | benzovindiflupyr | |
| 1251 | Polyphenol | | Chlorothalonil | prothioconazole | | benzovindiflupyr | |
| 1252 | Polyphenol | | Chlorothalonil | tebuconazole | | benzovindiflupyr | |
| 1253 | Polyphenol | | Chlorothalonil | tetraconazole | | benzovindiflupyr | |
| 1254 | Polyphenol | | Chlorothalonil | cyproconazole | | bixafen | |
| 1255 | Polyphenol | | Chlorothalonil | difenoconazole | | bixafen | |
| 1256 | Polyphenol | | Chlorothalonil | flutriafol | | bixafen | |
| 1257 | Polyphenol | | Chlorothalonil | mefentrifluconazole | | bixafen | |
| 1258 | Polyphenol | | Chlorothalonil | prothioconazole | | bixafen | |
| 1259 | Polyphenol | | Chlorothalonil | tebuconazole | | bixafen | |
| 1260 | Polyphenol | | Chlorothalonil | tetraconazole | | bixafen | |
| 1261 | Polyphenol | | Chlorothalonil | cyproconazole | | Fluindapyr | |
| 1262 | Polyphenol | | Chlorothalonil | difenoconazole | | Fluindapyr | |
| 1263 | Polyphenol | | Chlorothalonil | mefentrifluconazole | | Fluindapyr | |
| 1264 | Polyphenol | | Chlorothalonil | prothioconazole | | Fluindapyr | |
| 1265 | Polyphenol | | Chlorothalonil | tebuconazole | | Fluindapyr | |
| 1266 | Polyphenol | | Chlorothalonil | tetraconazole | | Fluindapyr | |
| 1267 | Polyphenol | | Chlorothalonil | cyproconazole | | fluxapyroxad | |
| 1268 | Polyphenol | | Chlorothalonil | difenoconazole | | fluxapyroxad | |
| 1269 | Polyphenol | | Chlorothalonil | flutriafol | | fluxapyroxad | |
| 1270 | Polyphenol | | Chlorothalonil | mefentrifluconazole | | fluxapyroxad | |
| 1271 | Polyphenol | | Chlorothalonil | prothioconazole | | fluxapyroxad | |
| 1272 | Polyphenol | | Chlorothalonil | tebuconazole | | fluxapyroxad | |
| 1273 | Polyphenol | | Chlorothalonil | tetraconazole | | fluxapyroxad | |
| 1274 | Polyphenol | | Chlorothalonil | cyproconazole | | Inpyrfluxam | |
| 1275 | Polyphenol | | Chlorothalonil | difenoconazole | | Inpyrfluxam | |
| 1276 | Polyphenol | | Chlorothalonil | flutriafol | | Inpyrfluxam | |
| 1277 | Polyphenol | | Chlorothalonil | mefentrifluconazole | | Inpyrfluxam | |
| 1278 | Polyphenol | | Chlorothalonil | prothioconazole | | Inpyrfluxam | |
| 1279 | Polyphenol | | Chlorothalonil | tebuconazole | | Inpyrfluxam | |
| 1280 | Polyphenol | | Chlorothalonil | tetraconazole | | Inpyrfluxam | |
| 1281 | Polyphenol | Copper | | | azoxystrobin | Adepidyn | Fenpropidin |
| 1282 | Polyphenol | Copper | | | azoxystrobin | benzovindiflupyr | Fenpropidin |
| 1283 | Polyphenol | Copper | | | azoxystrobin | bixafen | Fenpropidin |
| 1284 | Polyphenol | Copper | | | azoxystrobin | Fluindapyr | Fenpropidin |
| 1285 | Polyphenol | Copper | | | azoxystrobin | fluxapyroxad | Fenpropidin |
| 1286 | Polyphenol | Copper | | | azoxystrobin | Inpyrfluxam | Fenpropidin |
| 1287 | Polyphenol | Copper | | | azoxystrobin | Adepidyn | Fenpropimorph |
| 1288 | Polyphenol | Copper | | | azoxystrobin | benzovindiflupyr | Fenpropimorph |
| 1289 | Polyphenol | Copper | | | azoxystrobin | bixafen | Fenpropimorph |
| 1290 | Polyphenol | Copper | | | azoxystrobin | Fluindapyr | Fenpropimorph |
| 1291 | Polyphenol | Copper | | | azoxystrobin | fluxapyroxad | Fenpropimorph |
| 1292 | Polyphenol | Copper | | | azoxystrobin | Inpyrfluxam | Fenpropimorph |
| 1293 | Polyphenol | Copper | | | azoxystrobin | Adepidyn | |
| 1294 | Polyphenol | Copper | | | azoxystrobin | benzovindiflupyr | |
| 1295 | Polyphenol | Copper | | | azoxystrobin | bixafen | |
| 1296 | Polyphenol | Copper | | | azoxystrobin | Fluindapyr | |
| 1297 | Polyphenol | Copper | | | azoxystrobin | fluxapyroxad | |
| 1298 | Polyphenol | Copper | | | azoxystrobin | Inpyrfluxam | |
| 1299 | Polyphenol | Copper | | cyproconazole | azoxystrobin | | |
| 1300 | Polyphenol | Copper | | difenoconazole | azoxystrobin | | |
| 1301 | Polyphenol | Copper | | flutriafol | azoxystrobin | | |
| 1302 | Polyphenol | Copper | | mefentrifluconazole | azoxystrobin | | |
| 1303 | Polyphenol | Copper | | prothioconazole | azoxystrobin | | |
| 1304 | Polyphenol | Copper | | tebuconazole | azoxystrobin | | |
| 1305 | Polyphenol | Copper | | tetraconazole | azoxystrobin | | |
| 1306 | Polyphenol | Copper | | | Mandestrobin | Adepidyn | fenpropidin |
| 1307 | Polyphenol | Copper | | | Mandestrobin | benzovindiflupyr | fenpropidin |
| 1308 | Polyphenol | Copper | | | Mandestrobin | bixafen | fenpropidin |
| 1309 | Polyphenol | Copper | | | Mandestrobin | Fluindapyr | fenpropidin |
| 1310 | Polyphenol | Copper | | | Mandestrobin | fluxapyroxad | fenpropidin |
| 1311 | Polyphenol | Copper | | | Mandestrobin | Inpyrfluxam | fenpropidin |
| 1312 | Polyphenol | Copper | | | Mandestrobin | Adepidyn | Fenpropimorph |
| 1313 | Polyphenol | Copper | | | Mandestrobin | benzovindiflupyr | Fenpropimorph |
| 1314 | Polyphenol | Copper | | | Mandestrobin | bixafen | Fenpropimorph |
| 1315 | Polyphenol | Copper | | | Mandestrobin | Fluindapyr | Fenpropimorph |
| 1316 | Polyphenol | Copper | | | Mandestrobin | fluxapyroxad | Fenpropimorph |
| 1317 | Polyphenol | Copper | | | Mandestrobin | Inpyrfluxam | Fenpropimorph |
| 1318 | Polyphenol | Copper | | | Mandestrobin | | Fenpropimorph |
| 1319 | Polyphenol | Copper | | | Mandestrobin | | Fenpropidin |
| 1320 | Polyphenol | Copper | | | Mandestrobin | Adepidyn | |
| 1321 | Polyphenol | Copper | | | Mandestrobin | benzovindiflupyr | |
| 1322 | Polyphenol | Copper | | | Mandestrobin | bixafen | |
| 1323 | Polyphenol | Copper | | | Mandestrobin | Fluindapyr | |
| 1324 | Polyphenol | Copper | | | Mandestrobin | fluxapyroxad | |
| 1325 | Polyphenol | Copper | | | Mandestrobin | Inpyrfluxam | |
| 1326 | Polyphenol | Copper | | cyproconazole | Mandestrobin | | |
| 1327 | Polyphenol | Copper | | difenoconazole | Mandestrobin | | |
| 1328 | Polyphenol | Copper | | flutriafol | Mandestrobin | | |
| 1329 | Polyphenol | Copper | | mefentrifluconazole | Mandestrobin | | |
| 1330 | Polyphenol | Copper | | prothioconazole | Mandestrobin | | |
| 1331 | Polyphenol | Copper | | tebuconazole | Mandestrobin | | |
| 1332 | Polyphenol | Copper | | tetraconazole | Mandestrobin | | |
| 1333 | Polyphenol | Copper | | | Metyltetraprole | Adepidyn | fenpropidin |
| 1334 | Polyphenol | Copper | | | Metyltetraprole | benzovindiflupyr | fenpropidin |
| 1335 | Polyphenol | Copper | | | Metyltetraprole | bixafen | fenpropidin |
| 1336 | Polyphenol | Copper | | | Metyltetraprole | Fluindapyr | fenpropidin |
| 1337 | Polyphenol | Copper | | | Metyltetraprole | fluxapyroxad | fenpropidin |
| 1338 | Polyphenol | Copper | | | Metyltetraprole | Inpyrfluxam | fenpropidin |
| 1339 | Polyphenol | Copper | | | Metyltetraprole | Adepidyn | Fenpropimorph |
| 1340 | Polyphenol | Copper | | | Metyltetraprole | benzovindiflupyr | Fenpropimorph |
| 1341 | Polyphenol | Copper | | | Metyltetraprole | bixafen | Fenpropimorph |
| 1342 | Polyphenol | Copper | | | Metyltetraprole | Fluindapyr | Fenpropimorph |
| 1343 | Polyphenol | Copper | | | Metyltetraprole | fluxapyroxad | Fenpropimorph |
| 1344 | Polyphenol | Copper | | | Metyltetraprole | Inpyrfluxam | Fenpropimorph |
| 1345 | Polyphenol | Copper | | | Metyltetraprole | | Fenpropimorph |
| 1346 | Polyphenol | Copper | | | Metyltetraprole | | Fenpropidin |
| 1347 | Polyphenol | Copper | | | Metyltetraprole | Adepidyn | |
| 1348 | Polyphenol | Copper | | | Metyltetraprole | benzovindiflupyr | |
| 1349 | Polyphenol | Copper | | | Metyltetraprole | bixafen | |
| 1350 | Polyphenol | Copper | | | Metyltetraprole | Fluindapyr | |
| 1351 | Polyphenol | Copper | | | Metyltetraprole | fluxapyroxad | |
| 1352 | Polyphenol | Copper | | | Metyltetraprole | Inpyrfluxam | |
| 1353 | Polyphenol | Copper | | cyproconazole | Metyltetraprole | | |
| 1354 | Polyphenol | Copper | | difenoconazole | Metyltetraprole | | |
| 1355 | Polyphenol | Copper | | flutriafol | Metyltetraprole | | |
| 1356 | Polyphenol | Copper | | mefentrifluconazole | Metyltetraprole | | |
| 1357 | Polyphenol | Copper | | prothioconazole | Metyltetraprole | | |
| 1358 | Polyphenol | Copper | | tebuconazole | Metyltetraprole | | |
| 1359 | Polyphenol | Copper | | tetraconazole | Metyltetraprole | | |
| 1360 | Polyphenol | Copper | | | metominostrobin | Adepidyn | fenpropidin |
| 1361 | Polyphenol | Copper | | | metominostrobin | benzovindiflupyr | fenpropidin |
| 1362 | Polyphenol | Copper | | | metominostrobin | bixafen | fenpropidin |
| 1363 | Polyphenol | Copper | | | metominostrobin | Fluindapyr | fenpropidin |
| 1364 | Polyphenol | Copper | | | metominostrobin | fluxapyroxad | fenpropidin |
| 1365 | Polyphenol | Copper | | | metominostrobin | Inpyrfluxam | fenpropidin |
| 1366 | Polyphenol | Copper | | | metominostrobin | Adepidyn | Fenpropimorph |
| 1367 | Polyphenol | Copper | | | metominostrobin | benzovindiflupyr | Fenpropimorph |
| 1368 | Polyphenol | Copper | | | metominostrobin | bixafen | Fenpropimorph |
| 1369 | Polyphenol | Copper | | | metominostrobin | Fluindapyr | Fenpropimorph |
| 1370 | Polyphenol | Copper | | | metominostrobin | fluxapyroxad | Fenpropimorph |
| 1371 | Polyphenol | Copper | | | metominostrobin | Inpyrfluxam | Fenpropimorph |
| 1372 | Polyphenol | Copper | | | metominostrobin | | Fenpropimorph |
| 1373 | Polyphenol | Copper | | | metominostrobin | | Fenpropidin |
| 1374 | Polyphenol | Copper | | | metominostrobin | Adepidyn | |
| 1375 | Polyphenol | Copper | | | metominostrobin | benzovindiflupyr | |
| 1376 | Polyphenol | Copper | | | metominostrobin | bixafen | |
| 1377 | Polyphenol | Copper | | | metominostrobin | Fluindapyr | |
| 1378 | Polyphenol | Copper | | | metominostrobin | fluxapyroxad | |
| 1379 | Polyphenol | Copper | | | metominostrobin | Inpyrfluxam | |
| 1380 | Polyphenol | Copper | | cyproconazole | metominostrobin | | |
| 1381 | Polyphenol | Copper | | difenoconazole | metominostrobin | | |
| 1382 | Polyphenol | Copper | | flutriafol | metominostrobin | | |
| 1383 | Polyphenol | Copper | | mefentrifluconazole | metominostrobin | | |
| 1384 | Polyphenol | Copper | | prothioconazole | metominostrobin | | |
| 1385 | Polyphenol | Copper | | tebuconazole | metominostrobin | | |
| 1386 | Polyphenol | Copper | | tetraconazole | metominostrobin | | |
| 1387 | Polyphenol | Copper | | | picoxystrobin | Adepidyn | Fenpropidin |
| 1388 | Polyphenol | Copper | | | picoxystrobin | benzovindiflupyr | Fenpropidin |
| 1389 | Polyphenol | Copper | | | picoxystrobin | bixafen | Fenpropidin |
| 1390 | Polyphenol | Copper | | | picoxystrobin | Fluindapyr | Fenpropidin |
| 1391 | Polyphenol | Copper | | | picoxystrobin | fluxapyroxad | Fenpropidin |
| 1392 | Polyphenol | Copper | | | picoxystrobin | Inpyrfluxam | Fenpropidin |
| 1393 | Polyphenol | Copper | | | picoxystrobin | Adepidyn | Fenpropimorph |
| 1394 | Polyphenol | Copper | | | picoxystrobin | benzovindiflupyr | Fenpropimorph |
| 1395 | Polyphenol | Copper | | | picoxystrobin | bixafen | Fenpropimorph |
| 1396 | Polyphenol | Copper | | | picoxystrobin | Fluindapyr | Fenpropimorph |
| 1397 | Polyphenol | Copper | | | picoxystrobin | fluxapyroxad | Fenpropimorph |
| 1398 | Polyphenol | Copper | | | picoxystrobin | Inpyrfluxam | Fenpropimorph |
| 1399 | Polyphenol | Copper | | | picoxystrobin | | Fenpropimorph |
| 1400 | Polyphenol | Copper | | | picoxystrobin | | Fenpropidin |
| 1401 | Polyphenol | Copper | | | picoxystrobin | Adepidyn | |
| 1402 | Polyphenol | Copper | | | picoxystrobin | benzovindiflupyr | |
| 1403 | Polyphenol | Copper | | | picoxystrobin | bixafen | |
| 1404 | Polyphenol | Copper | | | picoxystrobin | Fluindapyr | |
| 1405 | Polyphenol | Copper | | | picoxystrobin | fluxapyroxad | |
| 1406 | Polyphenol | Copper | | | picoxystrobin | Inpyrfluxam | |
| 1407 | Polyphenol | Copper | | cyproconazole | picoxystrobin | | |
| 1408 | Polyphenol | Copper | | difenoconazole | picoxystrobin | | |
| 1409 | Polyphenol | Copper | | flutriafol | picoxystrobin | | |
| 1410 | Polyphenol | Copper | | mefentrifluconazole | picoxystrobin | | |
| 1411 | Polyphenol | Copper | | prothioconazole | picoxystrobin | | |
| 1412 | Polyphenol | Copper | | tebuconazole | picoxystrobin | | |
| 1413 | Polyphenol | Copper | | tetraconazole | picoxystrobin | | |
| 1414 | Polyphenol | Copper | | | Pyraclostrobin | Adepidyn | fenpropidin |
| 1415 | Polyphenol | Copper | | | Pyraclostrobin | benzovindiflupyr | fenpropidin |
| 1416 | Polyphenol | Copper | | | Pyraclostrobin | bixafen | fenpropidin |
| 1417 | Polyphenol | Copper | | | Pyraclostrobin | Fluindapyr | fenpropidin |
| 1418 | Polyphenol | Copper | | | Pyraclostrobin | fluxapyroxad | fenpropidin |
| 1419 | Polyphenol | Copper | | | Pyraclostrobin | Inpyrfluxam | fenpropidin |
| 1420 | Polyphenol | Copper | | | Pyraclostrobin | Adepidyn | Fenpropimorph |
| 1421 | Polyphenol | Copper | | | Pyraclostrobin | benzovindiflupyr | Fenpropimorph |
| 1422 | Polyphenol | Copper | | | Pyraclostrobin | bixafen | Fenpropimorph |
| 1423 | Polyphenol | Copper | | | Pyraclostrobin | Fluindapyr | Fenpropimorph |
| 1424 | Polyphenol | Copper | | | Pyraclostrobin | fluxapyroxad | Fenpropimorph |
| 1425 | Polyphenol | Copper | | | Pyraclostrobin | Inpyrfluxam | Fenpropimorph |
| 1426 | Polyphenol | Copper | | | Pyraclostrobin | | Fenpropimorph |
| 1427 | Polyphenol | Copper | | | Pyraclostrobin | | Fenpropidin |
| 1428 | Polyphenol | Copper | | | Pyraclostrobin | Adepidyn | |
| 1429 | Polyphenol | Copper | | | Pyraclostrobin | benzovindiflupyr | |
| 1430 | Polyphenol | Copper | | | Pyraclostrobin | bixafen | |
| 1431 | Polyphenol | Copper | | | Pyraclostrobin | Fluindapyr | |
| 1432 | Polyphenol | Copper | | | Pyraclostrobin | fluxapyroxad | |
| 1433 | Polyphenol | Copper | | | Pyraclostrobin | Inpyrfluxam | |
| 1434 | Polyphenol | Copper | | cyproconazole | Pyraclostrobin | | |
| 1435 | Polyphenol | Copper | | difenoconazole | Pyraclostrobin | | |
| 1436 | Polyphenol | Copper | | flutriafol | Pyraclostrobin | | |
| 1437 | Polyphenol | Copper | | mefentrifluconazole | Pyraclostrobin | | |
| 1438 | Polyphenol | Copper | | prothioconazole | Pyraclostrobin | | |
| 1439 | Polyphenol | Copper | | tebuconazole | Pyraclostrobin | | |
| 1440 | Polyphenol | Copper | | tetraconazole | Pyraclostrobin | | |
| 1441 | Polyphenol | Copper | | | trifloxystrobin | Adepidyn | fenpropidin |
| 1442 | Polyphenol | Copper | | | trifloxystrobin | benzovindiflupyr | fenpropidin |
| 1443 | Polyphenol | Copper | | | trifloxystrobin | bixafen | fenpropidin |
| 1444 | Polyphenol | Copper | | | trifloxystrobin | Fluindapyr | fenpropidin |
| 1445 | Polyphenol | Copper | | | trifloxystrobin | fluxapyroxad | fenpropidin |
| 1446 | Polyphenol | Copper | | | trifloxystrobin | Inpyrfluxam | fenpropidin |
| 1447 | Polyphenol | Copper | | | trifloxystrobin | Adepidyn | Fenpropimorph |
| 1448 | Polyphenol | Copper | | | trifloxystrobin | benzovindiflupyr | Fenpropimorph |
| 1449 | Polyphenol | Copper | | | trifloxystrobin | bixafen | Fenpropimorph |
| 1450 | Polyphenol | Copper | | | trifloxystrobin | Fluindapyr | Fenpropimorph |
| 1451 | Polyphenol | Copper | | | trifloxystrobin | fluxapyroxad | Fenpropimorph |
| 1452 | Polyphenol | Copper | | | trifloxystrobin | Inpyrfluxam | Fenpropimorph |
| 1453 | Polyphenol | Copper | | | trifloxystrobin | | Fenpropimorph |
| 1454 | Polyphenol | Copper | | | trifloxystrobin | | Fenpropidin |
| 1455 | Polyphenol | Copper | | | trifloxystrobin | Adepidyn | |
| 1456 | Polyphenol | Copper | | | trifloxystrobin | benzovindiflupyr | |
| 1457 | Polyphenol | Copper | | | trifloxystrobin | bixafen | |
| 1458 | Polyphenol | Copper | | | trifloxystrobin | Fluindapyr | |
| 1459 | Polyphenol | Copper | | | trifloxystrobin | fluxapyroxad | |
| 1460 | Polyphenol | Copper | | | trifloxystrobin | Inpyrfluxam | |
| 1461 | Polyphenol | Copper | | cyproconazole | trifloxystrobin | | |
| 1462 | Polyphenol | Copper | | difenoconazole | trifloxystrobin | | |
| 1463 | Polyphenol | Copper | | flutriafol | trifloxystrobin | | |
| 1464 | Polyphenol | Copper | | mefentrifluconazole | trifloxystrobin | | |
| 1465 | Polyphenol | Copper | | prothioconazole | trifloxystrobin | | |
| 1466 | Polyphenol | Copper | | tebuconazole | trifloxystrobin | | |
| 1467 | Polyphenol | Copper | | tetraconazole | trifloxystrobin | | |
| 1468 | Polyphenol | Copper | | cyproconazole | | | Fenpropidin |
| 1469 | Polyphenol | Copper | | difenoconazole | | | Fenpropidin |
| 1470 | Polyphenol | Copper | | flutriafol | | | Fenpropidin |
| 1471 | Polyphenol | Copper | | mefentrifluconazole | | | Fenpropidin |
| 1472 | Polyphenol | Copper | | prothioconazole | | | Fenpropidin |
| 1473 | Polyphenol | Copper | | tebuconazole | | | Fenpropidin |
| 1474 | Polyphenol | Copper | | tetraconazole | | | Fenpropidin |
| 1475 | Polyphenol | Copper | | cyproconazole | | | Fenpropimorph |
| 1476 | Polyphenol | Copper | | difenoconazole | | | Fenpropimorph |
| 1477 | Polyphenol | Copper | | flutriafol | | | Fenpropimorph |
| 1478 | Polyphenol | Copper | | mefentrifluconazole | | | Fenpropimorph |
| 1479 | Polyphenol | Copper | | prothioconazole | | | Fenpropimorph |
| 1480 | Polyphenol | Copper | | tebuconazole | | | Fenpropimorph |
| 1481 | Polyphenol | Copper | | tetraconazole | | | Fenpropimorph |
| 1482 | Polyphenol | Copper | | | | Adepidyn | Fenpropimorph |
| 1483 | Polyphenol | Copper | | | | benzovindiflupyr | Fenpropimorph |
| 1484 | Polyphenol | Copper | | | | bixafen | Fenpropimorph |
| 1485 | Polyphenol | Copper | | | | Fluindapyr | Fenpropimorph |
| 1486 | Polyphenol | Copper | | | | fluxapyroxad | Fenpropimorph |
| 1487 | Polyphenol | Copper | | | | Inpyrfluxam | Fenpropimorph |
| 1488 | Polyphenol | Copper | | | | Adepidyn | Fenpropidin |
| 1489 | Polyphenol | Copper | | | | benzovindiflupyr | Fenpropidin |
| 1490 | Polyphenol | Copper | | | | bixafen | Fenpropidin |
| 1491 | Polyphenol | Copper | | | | Fluindapyr | Fenpropidin |
| 1492 | Polyphenol | Copper | | | | fluxapyroxad | Fenpropidin |
| 1493 | Polyphenol | Copper | | | | Inpyrfluxam | Fenpropidin |
| 1494 | Polyphenol | Copper | | cyproconazole | | Adepidyn | |
| 1495 | Polyphenol | Copper | | difenoconazole | | Adepidyn | |
| 1496 | Polyphenol | Copper | | flutriafol | | Adepidyn | |
| 1497 | Polyphenol | Copper | | flutriafol | | Adepidyn | |
| 1498 | Polyphenol | Copper | | flutriafol | | Adepidyn | |
| 1499 | Polyphenol | Copper | | mefentrifluconazole | | Adepidyn | |
| 1500 | Polyphenol | Copper | | prothioconazole | | Adepidyn | |
| 1501 | Polyphenol | Copper | | tebuconazole | | Adepidyn | |
| 1502 | Polyphenol | Copper | | tetraconazole | | Adepidyn | |
| 1503 | Polyphenol | Copper | | cyproconazole | | benzovindiflupyr | |
| 1504 | Polyphenol | Copper | | difenoconazole | | benzovindiflupyr | |
| 1505 | Polyphenol | Copper | | flutriafol | | benzovindiflupyr | |
| 1506 | Polyphenol | Copper | | mefentrifluconazole | | benzovindiflupyr | |
| 1507 | Polyphenol | Copper | | prothioconazole | | benzovindiflupyr | |
| 1508 | Polyphenol | Copper | | tebuconazole | | benzovindiflupyr | |
| 1509 | Polyphenol | Copper | | tetraconazole | | benzovindiflupyr | |
| 1510 | Polyphenol | Copper | | cyproconazole | | bixafen | |
| 1511 | Polyphenol | Copper | | difenoconazole | | bixafen | |
| 1512 | Polyphenol | Copper | | flutriafol | | bixafen | |
| 1513 | Polyphenol | Copper | | mefentrifluconazole | | bixafen | |
| 1514 | Polyphenol | Copper | | prothioconazole | | bixafen | |
| 1515 | Polyphenol | Copper | | tebuconazole | | bixafen | |
| 1516 | Polyphenol | Copper | | tetraconazole | | bixafen | |
| 1517 | Polyphenol | Copper | | cyproconazole | | Fluindapyr | |
| 1518 | Polyphenol | Copper | | difenoconazole | | Fluindapyr | |
| 1519 | Polyphenol | Copper | | mefentrifluconazole | | Fluindapyr | |
| 1520 | Polyphenol | Copper | | prothioconazole | | Fluindapyr | |
| 1521 | Polyphenol | Copper | | tebuconazole | | Fluindapyr | |
| 1522 | Polyphenol | Copper | | tetraconazole | | Fluindapyr | |
| 1523 | Polyphenol | Copper | | cyproconazole | | fluxapyroxad | |
| 1524 | Polyphenol | Copper | | difenoconazole | | fluxapyroxad | |
| 1525 | Polyphenol | Copper | | flutriafol | | fluxapyroxad | |
| 1526 | Polyphenol | Copper | | mefentrifluconazole | | fluxapyroxad | |
| 1527 | Polyphenol | Copper | | prothioconazole | | fluxapyroxad | |
| 1528 | Polyphenol | Copper | | tebuconazole | | fluxapyroxad | |
| 1529 | Polyphenol | Copper | | tetraconazole | | fluxapyroxad | |
| 1530 | Polyphenol | Copper | | cyproconazole | | Inpyrfluxam | |
| 1531 | Polyphenol | Copper | | difenoconazole | | Inpyrfluxam | |
| 1532 | Polyphenol | Copper | | flutriafol | | Inpyrfluxam | |
| 1533 | Polyphenol | Copper | | mefentrifluconazole | | Inpyrfluxam | |
| 1534 | Polyphenol | Copper | | prothioconazole | | Inpyrfluxam | |
| 1535 | Polyphenol | Copper | | tebuconazole | | Inpyrfluxam | |
| 1536 | Polyphenol | Copper | | tetraconazole | | Inpyrfluxam | |
| 1537 | Polyphenol | | | | azoxystrobin | Adepidyn | Fenpropidin |
| 1538 | Polyphenol | | | | azoxystrobin | benzovindiflupyr | Fenpropidin |
| 1539 | Polyphenol | | | | azoxystrobin | bixafen | Fenpropidin |
| 1540 | Polyphenol | | | | azoxystrobin | Fluindapyr | Fenpropidin |
| 1541 | Polyphenol | | | | azoxystrobin | fluxapyroxad | Fenpropidin |
| 1542 | Polyphenol | | | | azoxystrobin | Inpyrfluxam | Fenpropidin |
| 1543 | Polyphenol | | | | azoxystrobin | Adepidyn | Fenpropimorph |
| 1544 | Polyphenol | | | | azoxystrobin | benzovindiflupyr | Fenpropimorph |
| 1545 | Polyphenol | | | | azoxystrobin | bixafen | Fenpropimorph |
| 1546 | Polyphenol | | | | azoxystrobin | Fluindapyr | Fenpropimorph |
| 1547 | Polyphenol | | | | azoxystrobin | fluxapyroxad | Fenpropimorph |
| 1548 | Polyphenol | | | | azoxystrobin | Inpyrfluxam | Fenpropimorph |
| 1549 | Polyphenol | | | | azoxystrobin | Adepidyn | |
| 1550 | Polyphenol | | | | azoxystrobin | benzovindiflupyr | |
| 1551 | Polyphenol | | | | azoxystrobin | bixafen | |
| 1552 | Polyphenol | | | | azoxystrobin | Fluindapyr | |
| 1553 | Polyphenol | | | | azoxystrobin | fluxapyroxad | |
| 1554 | Polyphenol | | | | azoxystrobin | Inpyrfluxam | |
| 1555 | Polyphenol | | | cyproconazole | azoxystrobin | | |
| 1556 | Polyphenol | | | difenoconazole | azoxystrobin | | |
| 1557 | Polyphenol | | | flutriafol | azoxystrobin | | |
| 1558 | Polyphenol | | | mefentrifluconazole | azoxystrobin | | |
| 1559 | Polyphenol | | | prothioconazole | azoxystrobin | | |
| 1560 | Polyphenol | | | tebuconazole | azoxystrobin | | |
| 1561 | Polyphenol | | | tetraconazole | azoxystrobin | | |
| 1562 | Polyphenol | | | | Mandestrobin | Adepidyn | fenpropidin |
| 1563 | Polyphenol | | | | Mandestrobin | benzovindiflupyr | fenpropidin |
| 1564 | Polyphenol | | | | Mandestrobin | bixafen | fenpropidin |
| 1565 | Polyphenol | | | | Mandestrobin | Fluindapyr | fenpropidin |
| 1566 | Polyphenol | | | | Mandestrobin | fluxapyroxad | fenpropidin |
| 1567 | Polyphenol | | | | Mandestrobin | Inpyrfluxam | fenpropidin |
| 1568 | Polyphenol | | | | Mandestrobin | Adepidyn | Fenpropimorph |
| 1569 | Polyphenol | | | | Mandestrobin | benzovindiflupyr | Fenpropimorph |
| 1570 | Polyphenol | | | | Mandestrobin | bixafen | Fenpropimorph |
| 1571 | Polyphenol | | | | Mandestrobin | Fluindapyr | Fenpropimorph |
| 1572 | Polyphenol | | | | Mandestrobin | fluxapyroxad | Fenpropimorph |
| 1573 | Polyphenol | | | | Mandestrobin | Inpyrfluxam | Fenpropimorph |
| 1574 | Polyphenol | | | | Mandestrobin | | Fenpropimorph |
| 1575 | Polyphenol | | | | Mandestrobin | | Fenpropidin |
| 1576 | Polyphenol | | | | Mandestrobin | Adepidyn | |
| 1577 | Polyphenol | | | | Mandestrobin | benzovindiflupyr | |
| 1578 | Polyphenol | | | | Mandestrobin | bixafen | |
| 1579 | Polyphenol | | | | Mandestrobin | Fluindapyr | |
| 1580 | Polyphenol | | | | Mandestrobin | fluxapyroxad | |
| 1581 | Polyphenol | | | | Mandestrobin | Inpyrfluxam | |
| 1582 | Polyphenol | | | cyproconazole | Mandestrobin | | |
| 1583 | Polyphenol | | | difenoconazole | Mandestrobin | | |
| 1584 | Polyphenol | | | flutriafol | Mandestrobin | | |
| 1585 | Polyphenol | | | mefentrifluconazole | Mandestrobin | | |
| 1586 | Polyphenol | | | prothioconazole | Mandestrobin | | |
| 1587 | Polyphenol | | | tebuconazole | Mandestrobin | | |
| 1588 | Polyphenol | | | tetraconazole | Mandestrobin | | |
| 1589 | Polyphenol | | | | Metyltetraprole | Adepidyn | fenpropidin |
| 1590 | Polyphenol | | | | Metyltetraprole | benzovindiflupyr | fenpropidin |
| 1591 | Polyphenol | | | | Metyltetraprole | bixafen | fenpropidin |
| 1592 | Polyphenol | | | | Metyltetraprole | Fluindapyr | fenpropidin |
| 1593 | Polyphenol | | | | Metyltetraprole | fluxapyroxad | fenpropidin |
| 1594 | Polyphenol | | | | Metyltetraprole | Inpyrfluxam | fenpropidin |
| 1595 | Polyphenol | | | | Metyltetraprole | Adepidyn | Fenpropimorph |
| 1596 | Polyphenol | | | | Metyltetraprole | benzovindiflupyr | Fenpropimorph |
| 1597 | Polyphenol | | | | Metyltetraprole | bixafen | Fenpropimorph |
| 1598 | Polyphenol | | | | Metyltetraprole | Fluindapyr | Fenpropimorph |
| 1599 | Polyphenol | | | | Metyltetraprole | fluxapyroxad | Fenpropimorph |
| 1600 | Polyphenol | | | | Metyltetraprole | Inpyrfluxam | Fenpropimorph |
| 1601 | Polyphenol | | | | Metyltetraprole | | Fenpropimorph |
| 1602 | Polyphenol | | | | Metyltetraprole | | Fenpropidin |
| 1603 | Polyphenol | | | | Metyltetraprole | Adepidyn | |
| 1604 | Polyphenol | | | | Metyltetraprole | benzovindiflupyr | |
| 1605 | Polyphenol | | | | Metyltetraprole | bixafen | |
| 1606 | Polyphenol | | | | Metyltetraprole | Fluindapyr | |
| 1607 | Polyphenol | | | | Metyltetraprole | fluxapyroxad | |
| 1608 | Polyphenol | | | | Metyltetraprole | Inpyrfluxam | |
| 1609 | Polyphenol | | | cyproconazole | Metyltetraprole | | |
| 1610 | Polyphenol | | | difenoconazole | Metyltetraprole | | |
| 1611 | Polyphenol | | | flutriafol | Metyltetraprole | | |
| 1612 | Polyphenol | | | mefentrifluconazole | Metyltetraprole | | |
| 1613 | Polyphenol | | | prothioconazole | Metyltetraprole | | |
| 1614 | Polyphenol | | | tebuconazole | Metyltetraprole | | |
| 1615 | Polyphenol | | | tetraconazole | Metyltetraprole | | |
| 1616 | Polyphenol | | | | metominostrobin | Adepidyn | fenpropidin |
| 1617 | Polyphenol | | | | metominostrobin | benzovindiflupyr | fenpropidin |
| 1618 | Polyphenol | | | | metominostrobin | bixafen | fenpropidin |
| 1619 | Polyphenol | | | | metominostrobin | Fluindapyr | fenpropidin |
| 1620 | Polyphenol | | | | metominostrobin | fluxapyroxad | fenpropidin |
| 1621 | Polyphenol | | | | metominostrobin | Inpyrfluxam | fenpropidin |
| 1622 | Polyphenol | | | | metominostrobin | Adepidyn | Fenpropimorph |
| 1623 | Polyphenol | | | | metominostrobin | benzovindiflupyr | Fenpropimorph |
| 1624 | Polyphenol | | | | metominostrobin | bixafen | Fenpropimorph |
| 1625 | Polyphenol | | | | metominostrobin | Fluindapyr | Fenpropimorph |
| 1626 | Polyphenol | | | | metominostrobin | fluxapyroxad | Fenpropimorph |
| 1627 | Polyphenol | | | | metominostrobin | Inpyrfluxam | Fenpropimorph |
| 1628 | Polyphenol | | | | metominostrobin | | Fenpropimorph |
| 1629 | Polyphenol | | | | metominostrobin | | Fenpropidin |
| 1630 | Polyphenol | | | | metominostrobin | Adepidyn | |
| 1631 | Polyphenol | | | | metominostrobin | benzovindiflupyr | |
| 1632 | Polyphenol | | | | metominostrobin | bixafen | |
| 1633 | Polyphenol | | | | metominostrobin | Fluindapyr | |
| 1634 | Polyphenol | | | | metominostrobin | fluxapyroxad | |
| 1635 | Polyphenol | | | | metominostrobin | Inpyrfluxam | |
| 1636 | Polyphenol | | | cyproconazole | metominostrobin | | |
| 1637 | Polyphenol | | | difenoconazole | metominostrobin | | |
| 1638 | Polyphenol | | | flutriafol | metominostrobin | | |
| 1639 | Polyphenol | | | mefentrifluconazole | metominostrobin | | |
| 1640 | Polyphenol | | | prothioconazole | metominostrobin | | |
| 1641 | Polyphenol | | | tebuconazole | metominostrobin | | |
| 1642 | Polyphenol | | | tetraconazole | metominostrobin | | |
| 1643 | Polyphenol | | | | picoxystrobin | Adepidyn | Fenpropidin |
| 1644 | Polyphenol | | | | picoxystrobin | benzovindiflupyr | Fenpropidin |
| 1645 | Polyphenol | | | | picoxystrobin | Bixafen | Fenpropidin |
| 1646 | Polyphenol | | | | picoxystrobin | Fluindapyr | Fenpropidin |
| 1647 | Polyphenol | | | | picoxystrobin | fluxapyroxad | Fenpropidin |
| 1648 | Polyphenol | | | | picoxystrobin | Inpyrfluxam | Fenpropidin |
| 1649 | Polyphenol | | | | picoxystrobin | Adepidyn | Fenpropimorph |
| 1650 | Polyphenol | | | | picoxystrobin | benzovindiflupyr | Fenpropimorph |
| 1651 | Polyphenol | | | | picoxystrobin | Bixafen | Fenpropimorph |
| 1652 | Polyphenol | | | | picoxystrobin | Fluindapyr | Fenpropimorph |
| 1653 | Polyphenol | | | | picoxystrobin | fluxapyroxad | Fenpropimorph |
| 1654 | Polyphenol | | | | picoxystrobin | Inpyrfluxam | Fenpropimorph |
| 1655 | Polyphenol | | | | picoxystrobin | | Fenpropimorph |
| 1656 | Polyphenol | | | | picoxystrobin | | Fenpropidin |
| 1657 | Polyphenol | | | | picoxystrobin | Adepidyn | |
| 1658 | Polyphenol | | | | picoxystrobin | benzovindiflupyr | |
| 1659 | Polyphenol | | | | picoxystrobin | bixafen | |
| 1660 | Polyphenol | | | | picoxystrobin | Fluindapyr | |
| 1661 | Polyphenol | | | | picoxystrobin | fluxapyroxad | |
| 1662 | Polyphenol | | | | picoxystrobin | Inpyrfluxam | |
| 1663 | Polyphenol | | | cyproconazole | picoxystrobin | | |
| 1664 | Polyphenol | | | difenoconazole | picoxystrobin | | |
| 1665 | Polyphenol | | | flutriafol | picoxystrobin | | |
| 1666 | Polyphenol | | | mefentrifluconazole | picoxystrobin | | |
| 1667 | Polyphenol | | | prothioconazole | picoxystrobin | | |
| 1668 | Polyphenol | | | tebuconazole | picoxystrobin | | |
| 1669 | Polyphenol | | | tetraconazole | picoxystrobin | | |
| 1670 | Polyphenol | | | | Pyraclostrobin | Adepidyn | fenpropidin |
| 1671 | Polyphenol | | | | Pyraclostrobin | benzovindiflupyr | fenpropidin |
| 1672 | Polyphenol | | | | Pyraclostrobin | bixafen | fenpropidin |
| 1673 | Polyphenol | | | | Pyraclostrobin | Fluindapyr | fenpropidin |
| 1674 | Polyphenol | | | | Pyraclostrobin | fluxapyroxad | fenpropidin |
| 1675 | Polyphenol | | | | Pyraclostrobin | Inpyrfluxam | fenpropidin |
| 1676 | Polyphenol | | | | Pyraclostrobin | Adepidyn | Fenpropimorph |
| 1677 | Polyphenol | | | | Pyraclostrobin | benzovindiflupyr | Fenpropimorph |
| 1678 | Polyphenol | | | | Pyraclostrobin | bixafen | Fenpropimorph |
| 1679 | Polyphenol | | | | Pyraclostrobin | Fluindapyr | Fenpropimorph |
| 1680 | Polyphenol | | | | Pyraclostrobin | fluxapyroxad | Fenpropimorph |
| 1681 | Polyphenol | | | | Pyraclostrobin | Inpyrfluxam | Fenpropimorph |
| 1682 | Polyphenol | | | | Pyraclostrobin | | Fenpropimorph |
| 1683 | Polyphenol | | | | Pyraclostrobin | | Fenpropidin |
| 1684 | Polyphenol | | | | Pyraclostrobin | Adepidyn | |
| 1685 | Polyphenol | | | | Pyraclostrobin | benzovindiflupyr | |
| 1686 | Polyphenol | | | | Pyraclostrobin | bixafen | |
| 1687 | Polyphenol | | | | Pyraclostrobin | Fluindapyr | |
| 1688 | Polyphenol | | | | Pyraclostrobin | fluxapyroxad | |
| 1689 | Polyphenol | | | | Pyraclostrobin | Inpyrfluxam | |
| 1690 | Polyphenol | | | cyproconazole | Pyraclostrobin | | |
| 1691 | Polyphenol | | | difenoconazole | Pyraclostrobin | | |
| 1692 | Polyphenol | | | flutriafol | Pyraclostrobin | | |
| 1693 | Polyphenol | | | mefentrifluconazole | Pyraclostrobin | | |
| 1694 | Polyphenol | | | prothioconazole | Pyraclostrobin | | |
| 1695 | Polyphenol | | | tebuconazole | Pyraclostrobin | | |
| 1696 | Polyphenol | | | tetraconazole | Pyraclostrobin | | |
| 1697 | Polyphenol | | | | trifloxystrobin | Adepidyn | fenpropidin |
| 1698 | Polyphenol | | | | trifloxystrobin | benzovindiflupyr | fenpropidin |
| 1699 | Polyphenol | | | | trifloxystrobin | bixafen | fenpropidin |
| 1700 | Polyphenol | | | | trifloxystrobin | Fluindapyr | fenpropidin |
| 1701 | Polyphenol | | | | trifloxystrobin | fluxapyroxad | fenpropidin |
| 1702 | Polyphenol | | | | trifloxystrobin | Inpyrfluxam | fenpropidin |
| 1703 | Polyphenol | | | | trifloxystrobin | Adepidyn | Fenpropimorph |
| 1704 | Polyphenol | | | | trifloxystrobin | benzovindiflupyr | Fenpropimorph |
| 1705 | Polyphenol | | | | trifloxystrobin | bixafen | Fenpropimorph |
| 1706 | Polyphenol | | | | trifloxystrobin | Fluindapyr | Fenpropimorph |
| 1707 | Polyphenol | | | | trifloxystrobin | fluxapyroxad | Fenpropimorph |
| 1708 | Polyphenol | | | | trifloxystrobin | Inpyrfluxam | Fenpropimorph |
| 1709 | Polyphenol | | | | trifloxystrobin | | Fenpropimorph |
| 1710 | Polyphenol | | | | trifloxystrobin | | Fenpropidin |
| 1711 | Polyphenol | | | | trifloxystrobin | Adepidyn | |
| 1712 | Polyphenol | | | | trifloxystrobin | benzovindiflupyr | |
| 1713 | Polyphenol | | | | trifloxystrobin | bixafen | |
| 1714 | Polyphenol | | | | trifloxystrobin | Fluindapyr | |
| 1715 | Polyphenol | | | | trifloxystrobin | fluxapyroxad | |
| 1716 | Polyphenol | | | | trifloxystrobin | Inpyrfluxam | |
| 1717 | Polyphenol | | | cyproconazole | trifloxystrobin | | |
| 1718 | Polyphenol | | | difenoconazole | trifloxystrobin | | |
| 1719 | Polyphenol | | | flutriafol | trifloxystrobin | | |
| 1720 | Polyphenol | | | mefentrifluconazole | trifloxystrobin | | |
| 1721 | Polyphenol | | | prothioconazole | trifloxystrobin | | |
| 1722 | Polyphenol | | | tebuconazole | trifloxystrobin | | |
| 1723 | Polyphenol | | | tetraconazole | trifloxystrobin | | |
| 1724 | Polyphenol | | | cyproconazole | | | Fenpropidin |
| 1725 | Polyphenol | | | difenoconazole | | | Fenpropidin |
| 1726 | Polyphenol | | | flutriafol | | | Fenpropidin |
| 1727 | Polyphenol | | | mefentrifluconazole | | | Fenpropidin |
| 1728 | Polyphenol | | | prothioconazole | | | Fenpropidin |
| 1729 | Polyphenol | | | tebuconazole | | | Fenpropidin |
| 1730 | Polyphenol | | | tetraconazole | | | Fenpropidin |
| 1731 | Polyphenol | | | cyproconazole | | | Fenpropimorph |
| 1732 | Polyphenol | | | difenoconazole | | | Fenpropimorph |
| 1733 | Polyphenol | | | flutriafol | | | Fenpropimorph |
| 1734 | Polyphenol | | | mefentrifluconazole | | | Fenpropimorph |
| 1735 | Polyphenol | | | prothioconazole | | | Fenpropimorph |
| 1736 | Polyphenol | | | tebuconazole | | | Fenpropimorph |
| 1737 | Polyphenol | | | tetraconazole | | | Fenpropimorph |
| 1738 | Polyphenol | | | | | Adepidyn | Fenpropimorph |
| 1739 | Polyphenol | | | | | benzovindiflupyr | Fenpropimorph |
| 1740 | Polyphenol | | | | | bixafen | Fenpropimorph |
| 1741 | Polyphenol | | | | | Fluindapyr | Fenpropimorph |
| 1742 | Polyphenol | | | | | fluxapyroxad | Fenpropimorph |
| 1743 | Polyphenol | | | | | Inpyrfluxam | Fenpropimorph |
| 1744 | Polyphenol | | | | | Adepidyn | Fenpropidin |
| 1745 | Polyphenol | | | | | benzovindiflupyr | Fenpropidin |
| 1746 | Polyphenol | | | | | bixafen | Fenpropidin |
| 1747 | Polyphenol | | | | | Fluindapyr | Fenpropidin |
| 1748 | Polyphenol | | | | | fluxapyroxad | Fenpropidin |
| 1749 | Polyphenol | | | | | Inpyrfluxam | Fenpropidin |
| 1750 | Polyphenol | | | cyproconazole | | Adepidyn | |
| 1751 | Polyphenol | | | difenoconazole | | Adepidyn | |
| 1752 | Polyphenol | | | flutriafol | | Adepidyn | |
| 1753 | Polyphenol | | | flutriafol | | Adepidyn | |
| 1754 | Polyphenol | | | flutriafol | | Adepidyn | |
| 1755 | Polyphenol | | | mefentrifluconazole | | Adepidyn | |
| 1756 | Polyphenol | | | prothioconazole | | Adepidyn | |
| 1757 | Polyphenol | | | tebuconazole | | Adepidyn | |
| 1758 | Polyphenol | | | tetraconazole | | Adepidyn | |
| 1759 | Polyphenol | | | cyproconazole | | benzovindiflupyr | |
| 1760 | Polyphenol | | | difenoconazole | | benzovindiflupyr | |
| 1761 | Polyphenol | | | flutriafol | | benzovindiflupyr | |
| 1762 | Polyphenol | | | mefentrifluconazole | | benzovindiflupyr | |
| 1763 | Polyphenol | | | prothioconazole | | benzovindiflupyr | |
| 1764 | Polyphenol | | | tebuconazole | | benzovindiflupyr | |
| 1765 | Polyphenol | | | tetraconazole | | benzovindiflupyr | |
| 1766 | Polyphenol | | | cyproconazole | | bixafen | |
| 1767 | Polyphenol | | | difenoconazole | | bixafen | |
| 1768 | Polyphenol | | | flutriafol | | bixafen | |
| 1769 | Polyphenol | | | mefentrifluconazole | | bixafen | |
| 1770 | Polyphenol | | | prothioconazole | | bixafen | |
| 1771 | Polyphenol | | | tebuconazole | | bixafen | |
| 1772 | Polyphenol | | | tetraconazole | | bixafen | |
| 1773 | Polyphenol | | | cyproconazole | | Fluindapyr | |
| 1774 | Polyphenol | | | difenoconazole | | Fluindapyr | |
| 1775 | Polyphenol | | | mefentrifluconazole | | Fluindapyr | |
| 1776 | Polyphenol | | | prothioconazole | | Fluindapyr | |
| 1777 | Polyphenol | | | tebuconazole | | Fluindapyr | |
| 1778 | Polyphenol | | | tetraconazole | | Fluindapyr | |
| 1779 | Polyphenol | | | cyproconazole | | fluxapyroxad | |
| 1780 | Polyphenol | | | difenoconazole | | fluxapyroxad | |
| 1781 | Polyphenol | | | flutriafol | | fluxapyroxad | |
| 1782 | Polyphenol | | | mefentrifluconazole | | fluxapyroxad | |
| 1783 | Polyphenol | | | prothioconazole | | fluxapyroxad | |
| 1784 | Polyphenol | | | tebuconazole | | fluxapyroxad | |
| 1785 | Polyphenol | | | tetraconazole | | fluxapyroxad | |
| 1786 | Polyphenol | | | cyproconazole | | Inpyrfluxam | |
| 1787 | Polyphenol | | | difenoconazole | | Inpyrfluxam | |
| 1788 | Polyphenol | | | flutriafol | | Inpyrfluxam | |
| 1789 | Polyphenol | | | mefentrifluconazole | | Inpyrfluxam | |
| 1790 | Polyphenol | | | prothioconazole | | Inpyrfluxam | |
| 1791 | Polyphenol | | | tebuconazole | | Inpyrfluxam | |
| 1792 | Polyphenol | | | tetraconazole | | Inpyrfluxam | |

62) The multi-component combination as claimed in any one of claims 59-61 wherein in each selected combination, the copper-based component (3) when present, is one or more of, cupric acetate; cupric chloride; cupric chlorate; cupric formate; cupric hexafluorosilicate; cupric nitrate; cupric chromate; copper sulfate pentahydrate; bordeaux mixture; copper hydroxide; copper oxychloride sulfate (COCS); tribasic copper sulfate such as cupric sulfate; tricupric hydroxide; hemihydrate; chelated or complexed copper with EDTA; Copper chelated or complexed, with amino acids; copper chelated/complexed with both EDTA and amino acid; copper glycinate and copper alaninates.

63) The multi-component combination as claimed in claim 62 wherein in each selected combination, the copper-based component (3) when present, is one or more of, chelated or complexed copper with EDTA; copper chelated or complexed with amino acids; copper chelated or complexed with both EDTA and amino acid; copper glycinate and copper alaninates in an agriculturally acceptable carrier.

64) The multi-component combination of any one of claims 1-8 and 59-63 wherein the content of polyphenol-based component (1) is selected from the group of,
between about 10 g/ha and about 350 g/ha;
between about 40 g/ha and about 90 g/ha; and
between 43.75 g/ha and 87.5 g/ha.

65) The multi-component combination of any one of claims 1-8 and 59-63 wherein the content of the copper-based component (3) when present, is selected from the group of,
between about 1 g/ha-350 g/ha copper; and
between 5 g/ha-50 g/ha copper.

66) The combinations, of any one of claims 1-8 and 59-63 wherein the polyphenol-based component is provided as a solid or as a liquid comprising any of, 7.5%, 10%, 12.5%, 15%, 17.5%, 20%, 22.5%, 25%, 27.5%, 30%, 32.5%, 35%, 37.5%, 40%, 42.5% or 45%, of mixtures of several, preferably naturally sourced water-soluble Tannins and Proanthocyanidins.

67) The combinations of any one of claims 1-8 and 59-63 wherein the polyphenol-based components are tannins and/or their derivatives, characterized in that said tannins and/or their derivatives include condensed tannins of the procyanidin, prodelphinidin, prorobinetinidin or profisetinidin type, and/or hydrolyzed tannins and/or phlorotannins extracted from algae, or mixtures thereof.

68) A fungicidal multi-component composition based on tannins and/or their derivatives, for the treatment of cultivated plants and/or parts thereof and/or the locus of their growth, characterized in that it comprises:
a) a first component including tannins, in at least one solvent,
b) a second component including at least one systemic fungicide selected from the group of QiI fungicide; strobilurin fungicide; SDHI fungicide; azole fungicide; morpholine fungicide and any and all mixtures of two or more thereof,
said first and second components being mixed to form a solution or dispersion in solvent of said tannins and/or their derivatives and said at least one systemic fungicide, which is adapted to be applied on the plants by spraying or dipping.

69) A composition according to claim 68, characterized in that the amount of tannins in said first component used is selected from the group of,
between 0.1 and 75% by weight of the composition of said first component; and
between 0.5 and 45% by weight of the composition.

70) The composition according to claim 68, characterized in that said first component comprises at least one organic and/or mineral salt including a cation of at least one substance or element such as ammonium, potassium, phosphorus, calcium, molybdenum, iron, zinc, magnesium, manganese, copper, cobalt or boron (NH4, K, P, Ca, Mo, Fe, Zn, Mg, Mn, Cu, Co, B), or combinations thereof.

71) The composition according to claim 70, characterized in that said salt comprises an organic or inorganic anion, and it is in the form of a sulfate, chloride, nitrate, phosphate, carbonate, formate and/or acetate, or combinations thereof.

72) The composition as claimed in claim 26 comprising in liquid form a combination selected from the group of,
mancozeb 400 g/l, picoxystrobin 26.7 g/l, tebuconazole 33 g/l, polyphenol 22.5 g/l;
mancozeb 300 g/l, picoxystrobin 32.5 g/l, tebuconazole 50 g/l, polyphenol 45 g/l;
mancozeb 300 g/l, picoxystrobin 32.5 g/l, tebuconazole 50 g/l, polyphenol 22.5 g/l;
mancozeb 300 g/l, picoxystrobin 32.5 g/l, tebuconazole 50 g/l, copper 4 g/l, polyphenol 45 g/l;
mancozeb 300 g/l, picoxystrobin 32.5 g/l, tebuconazole 50 g/l, copper 4 g/l, polyphenol 22.5 g/l; and
mancozeb 300 g/l, picoxystrobin 32.5 g/l, tebuconazole 50 g/l, copper 25 g/l, polyphenol 45 g/l.

73) The multi-component combination of any one of claims 1-8, and 20-24, or compositions comprising the combination and an agriculturally acceptable carrier, wherein said combination or composition comprises between 10% and 50% reduced amounts of both component (2) fungicide (A) and component (3) protectant fungicide compound(s) as compared to fungicidally effective combinations of the same component (2) fungicide (A) and component (3) protectant fungicide compound(s), absent the polyphenol-based component characterised by displaying comparable or equivalent fungicidal efficacy when applied.

74) The multi-component combination and or composition of claim 73, wherein said combination or composition comprises between 20 and 40% reduced amounts of both component (2) fungicide (A) and component (3) protectant fungicide characterised by displaying comparable or equivalent efficacy when compared with fungicidally effective combinations of the same component (2) fungicide (A) and component (3) protectant fungicide compound(s), absent the polyphenol-based component when applied.

75) A method of treating a plant or locus against fungal and/or bacterial infection comprising applying the composition as claimed in claim 72 to the plant or locus so as to thereby treat the plant or locus against fungal and/or bacterial infection wherein the composition is applied at a rate selected from the group of,
mancozeb 720 g/ha, picoxystrobin 48 g/ha, tebuconazole 59.4 g/ha, polyphenol 40.5 g/ha;
mancozeb 800 g/ha, picoxystrobin 53.3 g/ha, tebuconazole 66 g/ha, polyphenol 45 g/ha;
mancozeb 880 g/ha, picoxystrobin 58.7 g/ha, tebuconazole 72.6 g/ha, polyphenol 49.5 g/ha;
mancozeb 600 g/ha, picoxystrobin 65 g/ha, tebuconazole 100 g/ha, polyphenol 90 g/ha;
mancozeb 600 g/ha, picoxystrobin 65 g/ha, tebuconazole 100 g/ha, polyphenol 45 g/ha;
mancozeb 600 g/ha, picoxystrobin 65 g/ha, tebuconazole 100 g/ha, copper 8 g/ha, polyphenol 90 g/ha;
mancozeb 600 g/ha, picoxystrobin 65 g/ha, tebuconazole 100 g/ha, copper 8 g/ha, polyphenol 45 g/ha; and
mancozeb 600 g/ha, picoxystrobin 65 g/ha, tebuconazole 100 g/ha, copper 50 g/ha, polyphenol 90 g/ha.

76) A method for improved treatment of crop plants comprising application of the combination as claimed in any one of claims 1-8, wherein the amount of the polyphenol-based component (1) improves the beneficial effects of applying the amount of the fungicide(s) component (2) compared to when the same amount of the fungicide(s) is not applied in combination with the amount of the polyphenol-based component, wherein the beneficial effects are selected from the group of, improved emergence; improved crop yields; improved protein content; improved oil content; improved starch content; more developed root system and/or improved root growth; improved stress tolerance and/or improved non biotic stress mitigation, including against drought, heat, salt, UV, water, or cold; reduced ethylene including, reduced production and/or inhibition of reception; reduced phytotoxicity; increase in plant height; bigger leaf blade, less dead basal leaves; stronger tillers; greener leaf color; improved pigment content, improved photosynthetic activity; less fertilizers or water input needed; fewer seeds needed; more productive tillers, earlier flowering; earlier grain maturity, less plant verse or lodging; shortening of stalks; increased diameter of stalks; increased shoot growth; enhanced plant vigor; increased plant stand; earlier and better germination; and any and all combinations thereof.

77) The method as claimed in claim 75 comprising applying the composition, such that the composition is applied at a rate of between about 10% and about 50% reduced amounts of both component (2) fungicide (A) compound(s) and component (3) protectant fungicide compound(s) as compared to the fungicidally effective application rate of combinations of the same component (2) fungicide (A) and component (3) protectant fungicide compound(s), absent the polyphenol-based component, wherein the method is characterised by displaying comparable or equivalent efficacy when applied.

78) A method for reducing the amount of systemic fungicide compound and protectant fungicide compound required for the fungicidal efficacy of a combination of protectant fungicide selected from fluazinam; chlorothalonil; mancozeb; sulfur; folpet; and captan, with systemic fungicide selected from the group of:
a) QiI fungicide,
b) strobilurin fungicide,
c) succinate dehydrogenase inhibitor (SDHI) fungicide,
d) triazole fungicide and
e) morpholine fungicide; and
f) any and all mixtures of two or more of (a)-(e),
wherein the method comprises combining at least one, polyphenol-based compound with the systemic fungicide, with the proviso that, the polyphenol-based compound(s) comprises naturally sourced or derived polyphenol-based compounds, and/or the polyphenol-based compound(s) contains at least one polyphenol which is not a lignosulfonate, and that lignosulphonates, if present in the combination, or compositions comprising the combinations are not the sole polyphenol-based compound.
